(19) United States
(12) Patent Application Publication
(10) Pub. No.: US 2004/0006520 A1
(43) Pub. Date: Jan. 8, 2004

(54) Methods and systems for offering and servicing financial instruments

(76) Inventors: James R. Birle JR., Summit, NJ (US); David K. Dolan, Annadale, VA (US); Jeffrey N. Edwards, Basking Ridge, NJ (US); Yonathan Epelbaum, Brooklyn, NY (US); Frederick J. Fiddle, Ridgewood, NJ (US); Emerson P. Jones, Greenwich, CT (US); Stuart C. Kaperst, New York, NY (US); Todd K. Kaplan, Winnetka, IL (US); Daniel Y. Kerstein, Woodmere, NY (US); Dragomir K. Kolev, New York, NY (US); Richard P. Luciano, Morristown, NJ (US); Thomas H. Patrick JR., New York, NY (US); Paul A. Pepe, New York, NY (US); Eric Steifman, New York, NY (US); Russell L. Stein, Engelwood Cliffs, NJ (US); Brennan J. Warble, Bronxville, NY (US); Richard J. Green, Woodbury, NY (US)

Correspondence Address: OPPEDAHL AND LARSON LLP, P O BOX 5068, DILLON, CO, 80435-5068, US

(21) Appl. No.: 10/218,124

(22) Filed: Aug. 12, 2002

Related U.S. Application Data
(60) Provisional application No. 60/311,574, filed on Aug. 10, 2001.

(51) Int. Cl. G06F 17/60

(52) U.S. Cl. 705/35; 705/36

(57) ABSTRACT

Methods and systems for offering and servicing financial instruments create a way for issuers to offer financial instruments with incentives to holders to not voluntarily convert or redeem such instruments so that issuers maintain greater flexibility and control over the maturity date of the instrument and the manner in which it is settled. Additionally, some embodiments of this invention provide issuers of convertible and exchangeable financial instruments with the ability to deduct an amount for tax purposes that approximates the true economic cost of the financial instrument.

### CROSS REFERENCE TO RELATED APPLICATION

This claims the benefit of U.S. Provisional Patent Application No. 60/311,574, filed Aug. 10, 2001, which is hereby incorporated by reference in its entirety.

### BACKGROUND OF THE INVENTION

This invention relates to convertible and exchangeable financial instruments (e.g., debt instruments, preferred instruments, trust preferred instruments, warrants, certain insurance contracts, and suitable derivatives thereof, or any security backed by any of the above) and methods and systems for offering and servicing the same.

A convertible instrument, which may be converted into something of value (e.g., common stock), may be referenced throughout this application. The scope of this invention may also include exchangeable instruments which may be exchanged for something of value.

A common financial instrument, for example, is a convertible bond which can be converted by holders into a fixed or formula amount of shares of the issuer. At issuance, the value of the bond is typically greater than the value of the fixed number of shares that the bond is convertible into. For example, a bond may be issued for $1,000 with a right to convert into ten shares of the issuer's common stock, at a time when the current market value per share is $83. Ordinarily, under these terms, the stock must appreciate to at least $100 per share before it would be economically rational for the holder to exercise its right to convert the bond. A convertible bond of this kind is described as having a roughly 20 percent conversion premium, because the stock must appreciate about 20 percent (i.e., $17) before the conversion right has intrinsic value.

In the example of the convertible bond, because the conversion right provides an investor with a possible appreciation in value that the fixed rate debt instrument of the issuer does not provide, the interest rate on a convertible bond may be lower than the interest rate on a fixed rate debt instrument. Economically, the conversion right is an option to acquire issuer stock, and the lower rate of interest compensates the issuer for providing this option. Convertible bonds have historically provided issuers with the ability to deduct for tax purposes only this lower stated amount of interest, which is often considerably below the true economic cost of the financial instrument.

Convertible instruments generally also provide that the issuer may optionally redeem the instrument prior to its stated maturity, subject to the holder's conversion rights. If at the time of the optional redemption the value of the stock has risen above the value of the debt, the holder generally will exercise its conversion right so that it receives the stock rather than the call redemption amount. A holder may also have the right to require an issuer to redeem the bond under specified circumstances.

Issuers prefer to have flexibility and control over their capital structure, including, for example, the time and manner in which a convertible financial instrument is settled. That flexibility and control is diminished when a holder exercises its conversion or redemption right before maturity and unrelated to an issuer's call of the financial instrument. Convertible financial instruments, and methods and systems for offering and servicing the same, which provide incentives to holders to not voluntarily convert such instruments, absent an issuer call, allow issuers to maintain greater flexibility and control over the maturity date of the instrument and the manner in which it is settled, have been used before.

Issuers also prefer to deduct an amount for tax purposes that approximates the true economic cost of the financial instrument. The tax law can limit an issuer's ability to deduct the true economic cost of a financial instrument under certain circumstances. It would be desirable, therefore, to provide convertible financial instruments, and methods and systems for offering and servicing the same, that provide issuers with the ability to deduct an amount for tax purposes that more closely approximates the true economic cost of the financial instrument.

### SUMMARY OF THE INVENTION

It is therefore, in some embodiments, an object of this invention to provide convertible financial instruments, and methods and systems for offering and servicing the same, which provide an incentive to holders to keep the instruments outstanding so that issuers maintain flexibility and control over the maturity date of the instrument and the manner in which it is settled.

In some embodiments, an object of this invention is to provide convertible financial instruments, and methods and systems for offering and servicing the same, which provide issuers with the ability to deduct an amount for tax purposes that approximate the true economic cost of the financial instrument.

Such financial instruments may be based on, for example, long-term zero coupon notes (e.g., Liquid Yield Option™ Notes (“LYONs™”)), cash pay or partial cash pay convertible bonds issued at a discount, debt instruments, preferred instruments, trust preferred instruments, warrants, certain insurance contracts, suitable derivatives thereof, or any security backed by any of the above). The issuer of the financial instrument may make contingent payments (which may include, for example, contingent interest, preferred distributions, contingent principal, dividends, and other pay-outs) to the holder in some circumstances, which may be based on formulae calculations, beginning after a predetermined time period since issuance. For example, this may occur when the trading value of the convertible instrument exceeds a predetermined value such as, for example, a certain percentage of the accreted value of the convertible instrument, or, for example, another circumstance that may trigger a contingent payment may be when the price of another financial instrument (e.g., the underlying security, the reference security, etc.) is below, higher or equal to a predetermined value. There may be restraints on the value of such contingent payments imposed at the time the convertible instrument was issued. For example, the payments may be capped at a maximum value or yield. In another example, the payments may be guaranteed to exceed a minimum value or yield.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIGS. 1-3 are generalized flowcharts of illustrative steps involved in providing a company with capital in accordance with some embodiments of the present invention;

FIG. 4 illustrates the information flow that occurs in issuing and servicing financial instruments, in accordance with some embodiments of the present invention;

FIG. 5 is illustrative of an exemplary system for implementing the method in accordance with some embodiments of the present invention;

FIG. 6 is a flowchart of illustrative steps involved in providing a company with capital in accordance with some embodiments of the present invention;

FIG. 7 is a cross-sectional view of a magnetic data storage medium encoded with a set of machine-executable instructions for performing the methods in accordance with some embodiments of the present invention; and

FIG. 8 is a cross-sectional view of an optically readable data storage medium encoded with a set of machine executable instructions for performing the methods in accordance with some embodiments of the present invention.

### DETAILED DESCRIPTION OF THE INVENTION

The present invention is a convertible or exchangeable contingent payment financial instrument (e.g., short or long-term zero coupon notes (including, for example, Liquid Yield Option™ Notes(“LYONs™”)), cash pay or partial cash pay convertible bonds, debt instruments, preferred instruments, trust preferred instruments, warrants, certain insurance contracts, and suitable derivatives thereof, or any securities backed by any of the above), and systems and methods for offering and servicing the same. The issuer of a financial instrument may make contingent payments to the holder under certain circumstances or according to predetermined formulae, such as, if the trading value of the financial instrument or any underlying security or index amount is equal to, greater than, or less than, a predetermined value such as, for example, a percentage of the accreted value.

In some embodiments, the issuer may make contingent payments after a predetermined period of delay since issuance. In some embodiments, for example, the predetermined period of delay since issuance may be greater than one financial quarter since issuance. The period of time such circumstances and formulae are monitored may, in some embodiments, be less than the predetermined period of delay after which contingent payments are made. In some embodiments where the predetermined period of delay is greater than one financial quarter, for example, the period of time such circumstances and formulae are monitored may be one month.

In some embodiments, an issuer may make contingent payments to holders equal to the value of dividends paid out by the issuer on the underlying security under certain circumstances. “Contingent payment” is inclusive of any additional value to a holder whether paid at the present time or over time, (e.g., contingent interest, contingent principal, accretion of interest, contingent servicing rights, or other contingent rights). In some embodiments, the contingent payment may tend to provide some holders with incentives that may tend to make such holder more likely to keep the instrument outstanding.

Moreover, some embodiments may provide some issuers with an increased amount of flexibility and control over the period of time the instrument remains outstanding. In some embodiments, the contingent payments may be based on, or equal to, (1) the dividends a holder of the underlying security would normally receive, (2) an index amount, (3) a reference security or index, (4) a predetermined fixed amount, or (5) a pool of securities or indices, or other market calculations or determinations, or any combination thereof. Increases or decreases in dividends (as compared to the announced dividend policy of the underlying security at the time of issue) may be reflected in the contingent payments to holders. In some embodiments, the timing and amount of contingent payment may be dependent on the trading price or yield of the financial instrument, the trading price or yield of a liability of the issuer, or any underlying security or index, or derivative thereof. For example, in some embodiments, the amount of the contingent payment may depend on the value of, e.g., a specified class of the issuer's capital stock or of, e.g., a specified debt security of the issuer. In some embodiments, the timing and amount of contingent payment may depend on the trading price or yield of a selected security issued by a disinterested party unaffiliated with the issuers of the financial instrument or underlying reference. The issuer of a contingent payment financial instrument may be, for example, a publicly-traded, widely-held company sometimes referred to herein as the issuer.

In some embodiments, the contingent payment financial instrument may be, for example, an instrument convertible into a number of shares of the issuer's stock (e.g., common or preferred) (the “conversion shares”), with an initial conversion premium of, for example, approximately 20 percent. The instrument may be callable by the issuer at its “accreted value” (the issue price plus an accrued “discount”), after a predetermined period of time and subject to a holder's conversion right.

In some embodiments, the contingent payment financial instrument is, for example, a convertible debt instrument. If the instrument is callable at any time after the first five years, holders may have the right to require the issuer to redeem the instrument at its accreted value on each fifth anniversary of the issue date, and upon a change in control of the issuer. The difference between the issue price and principal amount of the contingent payment debt instrument will accrue by a specified percentage. A three percent yield, for example, may be a reasonable rate under some market conditions. Beginning at a predetermined period of delay (e.g., five years) after issuance of the contingent payment instruments, or at the end of a non- call period, and for each period (e.g., semi-annual, annual, etc.) thereafter, or under circumstances or formulae calculations, the issuer may pay contingent interest if the trading value of the instrument exceeds a specified percentage of the accreted value of each instrument for some predetermined number of consecutive days (or any other specified period) immediately preceding the first day of the contingency monitoring period. In some embodiments, the specified percentage of the accreted value may change, for example, by a predetermined percentage on a periodic basis. Also, in some embodiments, the amount of the contingent payment may change based upon a contingency with multiple triggers that may be triggered at specified predetermined times. Other embodiments may have a contingency with multiple triggers that may be triggered at any time. In some embodiments, contingent payments may be triggered by only one trigger or by more than one trigger. In some embodiments, a contingency may be any event and may be associated with the financial instrument paying such contingent payments. In some embodiments, contingent payments may be based on several contingencies, each with their own triggers.

Some embodiments may have a contingency based upon a security issued by a non-interested party unaffiliated with the issuer of the instrument or the underlying reference. Some embodiments may have a contingency based upon the trading price or yield of a liability of the issuer of the instrument. For example, in some embodiments, such a liability may include bonds, fees, notes, loans, or debentures of the issuer of the instrument. In some embodiments, the trigger level may be set at a predetermined percentage, for example greater than 100%, of the contingent payment debt instrument's trading value. In some embodiments, the trigger level may be set based upon a multiple of a yield of a security. Another example of a trigger, in some embodiments, is the value of the prevailing market rate for another financial instrument, whether or not issued by the same issuer, by market price, by yield, by formula, or at the discretion of a calculation agent. Another example of a trigger level, in some embodiments, is the amount of the prevailing market price or yield of a class of the issuer's capital stock or the value of a financial market index (e.g., Standard & Poor's 500). Some embodiments may have a trigger level set below, at, or above a predetermined value of the underlying security. Some embodiments may have a trigger level set below, at, or above a formula or reference amount, such as a predetermined percentage of accreted value.

In some embodiments, the amount of a contingent payment with respect to a contingent payment financial instrument, for example, may be an amount equal to the cash dividends payable from time to time on the conversion shares, for example, of a convertible bond during the applicable interest period, if any. In some embodiments, there may be minimum guaranteed amounts. In some embodiments, these minimum guaranteed amounts may be fixed values or minimum yields. For example, in some embodiments, the amount of contingent interest payable may be no less than 25 basis points multiplied by the trading value of the contingent payment financial instrument (the “Base Amount”) or any other base amount formula or index. In some embodiments, the amount of the contingent payments may be capped at a fixed value or yield. For example, in some embodiments, the amount of contingent payment may be required to be less than a predetermined percentage of the trading value of the contingent payment financial instrument.

In some embodiments, investors may receive any contingent payments without reduction to the accreted value (including principal liquidation preference, par, or other amounts) of the contingent payment financial instrument, or other offset. In some embodiments, the accreted value may be reduced by some portion of the contingent payment paid. In some embodiments, a holder may not receive contingent payments currently but instead may receive those contingent payment on a later date. In some embodiments, for example, the contingent payment may be made in cash, shares of the underlying financial instrument, shares of other financial instruments, or a combination thereof.

In some embodiments, a projected payment schedule is calculated which may project the timing and amount of contingent payments for various purposes, including but not limited to, tax purposes. Based upon the terms of the issuance of the financial instrument such as, for example, in the case of a contingent payment convertible debt instrument, the issue price, maturity date, conversion premium, stated yield, and comparable yield, the projected payment schedule determines the stock price growth rate or dividend yield (or other formulae determining the contingent payment) and the timing of such payments that is necessary to produce a comparable yield equal to the non-contingent debt rate of the issuer. (See Table 1 which illustrates a projected payment schedule.)

The following terms are the underlying terms for the example analyses of Tables 1, 2, and 3:

| | |
|---|---|
| Issue Price | $638.00 |
| Par Value | $1000.00 |
| Yield | 1.50% |
| Maturity | 30 |
| Conversion Premium | 30.00% |
| Conversion Ratio | 16.3769 |
| Call Protection (in Years) | 5 |
| Contingent Intrest Trigger | 120.00% |
| Comparable Yield | 7.00% |

TABLE 1
ACME Company-Example 1
Projected Contingent Payments Schedule
Projected Payments Schedule
Deriving the Projected Payment Schedule: Stock Price CAGR (to Create) A Contingent Interest IRR =
Comparable Yield

| | | | |
|---|---|---|---|
| Stock Price CAGR: | 7.633% | LYONs Stated Yield: | 1.50% |
| Stock Price at Issue: | $30.00 | Issue Price Per LYON: | $638.70 |
| Quaterly Dividend Per Share: | $0.075 | Contingent Payment | 120.00% |
| | | Trigger: | |
| Assumed Dividend Growth: | 5.00% | Comparable Yield: | 7.00% |

| | | | Beg. | | End | | | | | |
|---|---|---|---|---|---|---|---|---|---|---|
| | | Semi- | Period | Plus: | Period | | | | Projected | |
| | | annual | Accr. | Interest | Accr. | LYONs Mkt | Trigger | Dividend | Contingent | IRR |
| Date | Quarter | Period | Value | Accretion | Value | Price/Sh | Price | Per Share | Interest | Calculation |
| Jun. 30, 2001 | | 0 | 638.70 | | 638.70 | 39.00 | 46.80 | | | 638.70 |
| Jul. 30, 2001 | 1 | | | | | | | $0.0750 | | — |
| Oct. 30, 2001 | 2 | | | | | | | $0.0750 | | — |
| Dec. 30, 2001 | | 1 | 638.70 | 4.79 | 643.49 | 39.29 | 47.15 | | | — |
| Jan. 30, 2002 | 3 | | | | | | | $0.0750 | — | — |
| Apr. 30, 2002 | 4 | | | | | | | $0.0750 | — | — |
| Jun. 30, 2002 | | 2 | 643.49 | 4.83 | 648.32 | 39.59 | 47.50 | | — | — |
| Jul. 30, 2002 | 5 | | | | | | | $0.0788 | — | — |
| Oct. 30, 2002 | 6 | | | | | | | $0.0788 | — | — |
| Dec. 30, 2002 | | 3 | 648.32 | 4.86 | 653.18 | 39.88 | 47.86 | | — | — |
| Jan. 30, 2003 | 7 | | | | | | | $0.0788 | — | — |
| Apr. 30, 2003 | 8 | | | | | | | $0.0788 | — | — |
| Jun. 30, 2003 | | 4 | 653.18 | 4.90 | 658.08 | 40.18 | 48.22 | | — | — |
| Jul. 30, 2003 | 9 | | | | | | | $0.0827 | — | — |
| Oct. 30, 2003 | 10 | | | | | | | $0.0827 | — | — |
| Dec. 30, 2003 | | 5 | 658.08 | 4.94 | 663.01 | 40.48 | 48.58 | | — | — |
| Jan. 30, 2004 | 11 | | | | | | | $0.0827 | — | — |
| Apr. 30, 2004 | 12 | | | | | | | $0.0827 | — | — |
| Jun. 30, 2004 | | 6 | 663.01 | 4.97 | 667.99 | 40.79 | 48.95 | | — | — |
| Jul. 30, 2004 | 13 | | | | | | | $0.0868 | — | — |
| Oct. 30, 2004 | 14 | | | | | | | $0.0868 | — | — |
| Dec. 30, 2004 | | 7 | 667.99 | 5.01 | 673.00 | 41.09 | 49.31 | | — | — |
| Jan. 30, 2005 | 15 | | | | | | | $0.0868 | — | — |
| Apr. 30, 2005 | 16 | | | | | | | $0.0868 | — | — |
| Jun. 30, 2005 | | 8 | 673.00 | 5.05 | 678.04 | 41.40 | 49.68 | | — | — |
| Jul. 30, 2005 | 17 | | | | | | | $0.0912 | — | — |
| Oct. 30, 2005 | 18 | | | | | | | $0.0912 | — | — |
| Dec. 30, 2005 | | 9 | 678.04 | 5.09 | 683.13 | 41.77 | 50.06 | | — | — |
| Jan. 30, 2006 | 19 | | | | | | | $0.0912 | — | — |
| Apr. 30, 2006 | 20 | | | | | | | $0.0912 | — | — |
| Jun. 30, 2006 | | 10 | 683.13 | 5.12 | 688.25 | 43.34 | 50.43 | | — | — |
| Jul. 30, 2006 | 21 | | | | | | | $0.0957 | — | — |
| Oct. 30, 2006 | 22 | | | | | | | $0.0957 | — | — |
| Dec. 30, 2006 | | 11 | 688.25 | 5.16 | 693.41 | 44.96 | 50.81 | | — | — |
| Jan. 30, 2007 | 23 | | | | | | | $0.0957 | — | — |
| Apr. 30, 2007 | 24 | | | | | | | $0.0957 | — | — |
| Jun. 30, 2007 | | 12 | 693.41 | 5.20 | 698.91 | 46.64 | 51.19 | | — | — |
| Jul. 30, 2007 | 25 | | | | | | | $0.1005 | — | — |
| Oct. 30, 2007 | 26 | | | | | | | $0.1005 | — | — |
| Dec. 30, 2007 | | 13 | 698.61 | 5.24 | 703.85 | 48.39 | 51.57 | | — | — |
| Jan. 30, 2008 | 27 | | | | | | | $0.1005 | — | — |
| Apr. 30, 2008 | 28 | | | | | | | $0.1005 | — | — |
| Jun. 30, 2008 | | 14 | 703.85 | 5.28 | 709.13 | 50.20 | 51.96 | | — | — |
| Jul. 30, 2008 | 29 | | | | | | | $0.1005 | — | — |
| Oct. 30, 2008 | 30 | | | | | | | $0.1005 | — | — |
| Dec. 30, 2008 | | 15 | 709.13 | 5.32 | 714.45 | 52.08 | 52.35 | | — | — |
| Jan. 30, 2009 | 31 | | | | | | | $0.1055 | — | — |
| Apr. 30, 2009 | 32 | | | | | | | $0.1005 | — | — |
| Jun. 30, 2009 | | 16 | 714.45 | 5.36 | 719.81 | 54.04 | 52.74 | | — | — |
| Jul. 30, 2009 | 33 | | | | | | | $0.1108 | — | (1.81) |
| Oct. 30, 2009 | 34 | | | | | | | $0.1108 | — | (1.81) |
| Dec. 30, 2009 | | 17 | 719.81 | 5.40 | 725.21 | 56.06 | 53.14 | | — | — |
| Jan. 30, 2010 | 35 | | | | | | | $0.1108 | — | (1.81) |
| Apr. 30, 2010 | 36 | | | | | | | $0.1108 | 1.81 | (1.81) |
| Jun. 30, 2010 | | 18 | 725.21 | 5.44 | 730.65 | 58.16 | 53.54 | | | — |
| Jul. 30, 2010 | 37 | | | | | | | $0.1163 | 1.91 | (1.91) |
| Oct. 30, 2010 | 38 | | | | | | | $0.1163 | 1.91 | (1.91) |
| Dec. 30, 2010 | | 19 | 730.65 | 5.48 | 736.13 | 60.34 | 53.94 | | | — |
| Jan. 30, 2011 | 39 | | | | | | | $0.1163 | 1.91 | (1.91) |
| Apr. 30, 2011 | 40 | | | | | | | $0.1163 | 1.91 | (1.91) |
| Jun. 30, 2011 | | 20 | 736.13 | 5.52 | 741.65 | 62.60 | 54.34 | | | — |
| Jul. 30, 2011 | 41 | | | | | | | $0.1222 | 2.00 | (2.00) |
| Oct. 30, 2011 | 42 | | | | | | | $0.1222 | 2.00 | (2.00) |
| Dec. 30, 2011 | | 21 | 741.65 | 5.56 | 747.21 | 64.95 | 54.75 | | | — |
| Jan. 30, 2012 | 43 | | | | | | | $0.1222 | 2.00 | (2.00) |
| Apr. 30, 2012 | 44 | | | | | | | $0.1222 | 2.00 | (2.00) |
| Jun. 30, 2012 | | 22 | 747.21 | 5.60 | 752.81 | 67.38 | 55.16 | | | — |
| Jul. 30, 2012 | 45 | | | | | | | $0.1283 | 2.10 | (2.10) |
| Oct. 30, 2012 | 46 | | | | | | | $0.1283 | 2.10 | (2.10) |
| Dec. 30, 2012 | | 23 | 752.81 | 5.65 | 758.46 | 69.90 | 55.58 | | | — |
| Jan. 30, 2013 | 47 | | | | | | | $0.1283 | 2.10 | (2.10) |
| Apr. 30, 2013 | 48 | | | | | | | $0.1283 | 2.10 | (2.10) |
| Jun. 30, 2013 | | 24 | 758.46 | 5.69 | 764.15 | 72.52 | 55.99 | | | — |
| Jul. 30, 2013 | 49 | | | | | | | $0.1347 | 2.21 | (2.21) |
| Oct. 30, 2013 | 50 | | | | | | | $0.1347 | 2.21 | (2.21) |
| Dec. 30, 2013 | | 25 | 764.15 | 5.73 | 769.88 | 75.24 | 56.41 | | | — |
| Jan. 30, 2014 | 51 | | | | | | | $0.1347 | 2.21 | (2.21) |
| Apr. 30, 2014 | 52 | | | | | | | $0.1347 | 2.21 | (2.21) |
| Jun. 30, 2014 | | 26 | 769.88 | 5.77 | 775.65 | 78.06 | 56.84 | | | — |
| Jul. 30, 2014 | 53 | | | | | | | $0.1414 | 2.32 | (2.32) |
| Oct. 30, 2014 | 54 | | | | | | | $0.1414 | 2.32 | (2.32) |
| Dec. 30, 2014 | | 27 | 775.65 | 5.82 | 781.47 | 80.98 | 57.26 | | | — |
| Jan. 30, 2015 | 55 | | | | | | | $0.1414 | 2.32 | (2.32) |
| Apr. 30, 2015 | 56 | | | | | | | $0.1414 | 2.32 | (2.32) |
| Jun. 30, 2015 | | 28 | 781.47 | 5.86 | 787.33 | 84.02 | 57.69 | | | — |
| Jul. 30, 2015 | 57 | | | | | | | $0.1485 | 2.43 | (2.43) |
| Oct. 30, 2015 | 58 | | | | | | | $0.1485 | 2.43 | (2.43) |
| Dec. 30, 2015 | | 29 | 787.33 | 5.90 | 793.24 | 87.16 | 58.12 | | | — |
| Jan. 30, 20156 | 59 | | | | | | | $0.1485 | 2.43 | (2.43) |
| Apr. 30, 2016 | 60 | | | | | | | $0.1485 | 2.43 | (2.43) |
| Jun. 30, 2016 | | 30 | 793.24 | 5.95 | 799.19 | 90.43 | 58.56 | | | — |
| Jul. 30, 2016 | 61 | | | | | | | $0.1559 | 2.55 | (2.55) |
| Oct. 30, 2016 | 62 | | | | | | | $0.1559 | 2.55 | (2.55) |
| Dec. 30, 2016 | | 31 | 799.19 | 5.99 | 805.18 | 93.82 | 59.00 | | | — |
| Jan. 30, 2017 | 63 | | | | | | | $0.1559 | 2.55 | (2.55) |
| Apr. 30, 2017 | 64 | | | | | | | $0.1559 | 2.55 | (2.55) |
| Jun. 30, 2017 | | 32 | 805.18 | 6.04 | 811.22 | 97.33 | 59.44 | | | — |
| Jul. 30, 2017 | 65 | | | | | | | $0.1637 | 2.68 | (2.68) |
| Oct. 30, 2017 | 66 | | | | | | | $0.1637 | 2.68 | (2.68) |
| Dec. 30, 2017 | | 33 | 811.22 | 6.08 | 817.30 | 100.98 | 59.89 | | | — |
| Jan. 30, 2018 | 67 | | | | | | | $0.1637 | 2.68 | (2.68) |
| Apr. 30, 2018 | 68 | | | | | | | $0.1637 | 2.68 | (2.68) |
| Jun. 30, 2018 | | 34 | 817.30 | 6.13 | 823.43 | 104.76 | 60.34 | | | — |
| Jul. 30, 2018 | 69 | | | | | | | $0.1719 | 2.82 | (2.82) |
| Oct. 30, 2018 | 70 | | | | | | | $0.1719 | 2.82 | (2.82) |
| Dec. 30, 2018 | | 35 | 823.43 | 6.18 | 829.61 | 108.68 | 60.79 | | | — |
| Jan. 30, 2019 | 71 | | | | | | | $0.1719 | 2.82 | (2.82) |
| Apr. 30, 2019 | 72 | | | | | | | $0.1719 | 2.82 | (2.82) |
| Jun. 30, 2019 | | 36 | 829.61 | 6.22 | 835.83 | 112.76 | 61.24 | | | — |
| Jul. 30, 2019 | 73 | | | | | | | %0.1805 | 2.96 | (2.96) |
| Oct. 30, 2019 | 74 | | | | | | | $0.1805 | 2.96 | (2.96) |
| Dec. 30, 2019 | | 37 | 835.83 | 6.27 | 842.10 | 116.98 | 61.70 | | | — |
| Jan. 30, 2020 | 75 | | | | | | | $0.1805 | 2.96 | (2.96) |
| Apr. 30, 2020 | 76 | | | | | | | $0.1805 | 2.96 | (2.96) |
| Jun. 30, 2020 | | 38 | 842.10 | 6.32 | 848.42 | 121.36 | 62.17 | | | — |
| Jul. 30, 2020 | 77 | | | | | | | $0.1895 | 3.10 | (3.10) |
| Oct. 30, 2020 | 78 | | | | | | | $0.1895 | 3.10 | (3.10) |
| Dec. 30, 2020 | | 39 | 848.42 | 6.36 | 854.78 | 125.91 | 62.63 | | | — |
| Jan. 30, 2021 | 79 | | | | | | | $0.1895 | 3.10 | (3.10) |
| Apr. 30, 2021 | 80 | | | | | | | $0.1895 | 3.10 | (3.10) |
| Jun. 30, 2021 | | 40 | 854.78 | 6.41 | 861.19 | 130.63 | 63.10 | | | — |
| Jul. 30, 2021 | 81 | | | | | | | $0.1990 | 3.26 | (3.26) |
| Oct. 30, 2021 | 82 | | | | | | | $0.1990 | 3.26 | (3.26) |
| Dec. 30, 2021 | | 41 | 861.19 | 6.46 | 867.65 | 135.52 | 63.58 | | | — |
| Jan. 30, 2022 | 83 | | | | | | | $0.1990 | 3.26 | (3.26) |
| Apr. 30, 2022 | 84 | | | | | | | $0.1990 | 3.26 | (3.26) |
| Jun. 30, 2022 | | 42 | 867.65 | 6.51 | 874.16 | 140.60 | 64.05 | | | — |
| Jul. 30, 2022 | 85 | | | | | | | $0.2089 | 3.42 | (3.42) |
| Oct. 30, 2022 | 86 | | | | | | | $0.2089 | 3.42 | (3.42) |
| Dec. 30, 2022 | | 43 | 874.16 | 6.56 | 880.71 | 145.86 | 64.53 | | | — |
| Jan. 30, 2023 | 87 | | | | | | | $0.2089 | 3.42 | (3.42) |
| Apr. 30, 2023 | 88 | | | | | | | $0.2089 | 3.42 | (3.42) |
| Jun. 30, 2023 | | 44 | 880.71 | 6.61 | 887.32 | 151.33 | 65.02 | | | — |
| Jul. 30, 2023 | 89 | | | | | | | $0.2194 | 3.59 | (3.59) |
| Oct. 30, 2023 | 90 | | | | | | | $0.2194 | 3.59 | (3.59) |
| Dec. 30, 2023 | | 45 | 887.32 | 6.65 | 893.97 | 157.00 | 65.50 | | | — |
| Jan. 30, 2024 | 91 | | | | | | | $0.2194 | 3.59 | (3.59) |
| Apr. 30, 2024 | 92 | | | | | | | $0.2194 | 3.59 | (3.59) |
| Jun. 30, 2024 | | 46 | 893.97 | 6.70 | 900.68 | 162.88 | 66.00 | | | — |
| Jul. 30, 2024 | 93 | | | | | | | $0.2304 | 3.77 | (3.77) |
| Oct. 30, 2024 | 94 | | | | | | | $0.2304 | 3.77 | (3.77) |
| Dec. 30, 2024 | | 47 | 900.68 | 6.76 | 907.43 | 168.98 | 66.49 | | | — |
| Jan. 30, 2025 | 95 | | | | | | | $0.2304 | 3.77 | (3.77) |
| Apr. 30, 2025 | 96 | | | | | | | $0.2304 | 3.77 | (3.77) |
| Jun. 30, 2025 | | 48 | 907.43 | 6.81 | 914.24 | 175.31 | 66.99 | | | — |
| Jul. 30, 2025 | 97 | | | | | | | $0.2419 | 3.96 | (3.96) |
| Oct. 30, 2025 | 98 | | | | | | | $0.2419 | 3.96 | (3.96) |
| Dec. 30, 2025 | | 49 | 914.24 | 6.86 | 921.10 | 181.88 | 67.49 | | | — |
| Jan. 30, 2026 | 99 | | | | | | | $0.2419 | 3.96 | (3.96) |
| Apr. 30, 2026 | 100 | | | | | | | $0.2419 | 3.96 | (3.96) |
| Jun. 30, 2026 | | 50 | 921.10 | 6.91 | 928.00 | 188.69 | 68.00 | | | — |
| Jul. 30, 2026 | 101 | | | | | | | $0.2540 | 4.16 | (4.16) |
| Oct. 30, 2026 | 102 | | | | | | | $0.2540 | 4.16 | (4.16) |
| Dec. 30, 2026 | | 51 | 928.00 | 6.96 | 934.96 | 195.76 | 68.51 | | | — |
| Jan. 30, 2027 | 103 | | | | | | | $0.2540 | 4.16 | (4.16) |
| Apr. 30, 2027 | 104 | | | | | | | $0.2540 | 4.16 | (4.16) |
| Jun. 30, 2027 | | 52 | 934.96 | 7.01 | 941.88 | 203.10 | 69.02 | | | — |
| Jul. 30, 2027 | 105 | | | | | | | $0.2667 | 4.37 | (4.37) |
| Oct. 30, 2027 | 106 | | | | | | | $0.2667 | 4.37 | (4.37) |
| Dec. 30, 2027 | | 53 | 941.88 | 7.06 | 949.04 | 210.71 | 69.54 | | | — |
| Jan. 30, 2028 | 107 | | | | | | | $0.2667 | 4.37 | (4.37) |
| Apr. 30, 2028 | 108 | | | | | | | $0.2667 | 4.37 | (4.37) |
| Jun. 30, 2028 | | 54 | 949.04 | 7.12 | 956.16 | 218.60 | 70.06 | | | — |
| Jul. 30, 2028 | 109 | | | | | | | $0.2800 | 4.59 | (4.59) |
| Oct. 30, 2028 | 110 | | | | | | | $0.2800 | 4.59 | (4.59) |
| Dec. 30, 2028 | | 55 | 956.16 | 7.17 | 963.33 | 226.79 | 70.59 | | | — |
| Jan. 30, 2029 | 111 | | | | | | | $0.2800 | 4.59 | (4.59) |
| Apr. 30, 2029 | 112 | | | | | | | $0.2800 | 4.59 | (4.59) |
| Jun. 30, 2029 | | 56 | 963.33 | 7.22 | 970.55 | 235.28 | 71.12 | | | — |
| Jul. 30, 2029 | 113 | | | | | | | $0.2940 | 4.81 | (4.81) |
| Oct. 30, 2029 | 114 | | | | | | | $0.2940 | 4.81 | (4.81) |
| Dec. 30, 2029 | | 57 | 970.55 | 7.28 | 977.83 | 244.10 | 71.65 | | | — |
| Jan. 30, 2030 | 115 | | | | | | | $0.2940 | 4.81 | (4.81) |
| Apr. 30, 2030 | 116 | | | | | | | $0.2940 | 4.81 | (4.81) |
| Jun. 30, 2030 | | 58 | 977.83 | 7.33 | 985.17 | 253.24 | 72.19 | | | — |
| Jul. 30, 2030 | 117 | | | | | | | $0.3087 | 5.06 | (5.06) |
| Oct. 30, 2030 | 118 | | | | | | | $0.3087 | 5.06 | (5.06) |
| Dec. 30, 2030 | | 59 | 985.17 | 7.39 | 992.56 | 262.73 | 72.73 | | | — |
| Jan. 30, 2031 | 119 | | | | | | | $0.2087 | 5.06 | (5.06) |
| Apr, 30, 2031 | 120 | | | | | | | $0.2087 | 5.06 | (5.06) |
| Jun. 30, 2031 | | 60 | 992.56 | 7.44 | 1,000.00 | 272.57 | 73.27 | | | |
| | | | | | | | | | | (4,463.93) |
| | | | | | | | | | Effective | 7.00% |
| | | | | | | | | | Yield | |

In some embodiments, amounts are calculated to determine whether the contingent payments are incidental (“incidental analysis”). For example, in the case of a contingent payment convertible debt instrument, an incidental analysis calculates the amount of contingent payments that may be made given different stock price growth rates (or other measure that would influence the amount of contingent payments to be made) in comparison to the issue price of the debt instrument (or other amount). The comparison may be calculated using varying assumptions as to the discount rate, if any. (See Table 2 which illustrates the results of an incidental analysis)

TABLE 2
Incidental Analysis

| After-tax discount rate of 8.00% | | | |
|---|---|---|---|
| Stock Price CAGR | 5.0% | 10.0% | 15.0% |
| NPV of Contingent Intrest Per Bond | $42.05 | $69.15 | $73.24 |
| As % of Bond Issue Price ($638.70) | 6.58% | 10.83% | 11.47% |
| After-tax discount rate of 10.00% | | | |
| Stock Price CAGR | 5.0% | 10.0% | 15.0% |
| NPV of Contingent Interest Per Bond | $28.23 | $50.81 | $54.50 |
| As % of Bond Issue Price ($638.70) | 4.42% | 7.96% | 8.53% |
| After-tax discount rate of 12.00% | | | |
| Stock Price CAGR | 5.0% | 10.0% | 15.0% |
| NPV of Contingent Interest Per Bond | $19.17 | $38.06 | $41.38 |
| As % of Bond Issue Price ($638.70) | 3.00% | 5.96% | 6.48% |

In some embodiments, a probability analysis is conducted which determines the likelihood that a contingent payment or payments will be made (“remoteness test”). For example, in the case of a contingent payment convertible debt instrument, the remoteness test may measure the likelihood that one or more contingent payments will be made after a predetermined period of delay greater than the contingency monitoring period, given different stock price growth rates (or other measure that would influence the amount of contingent payments to be made) and stock price volatilities (or other measure that would influence the amount of contingent payments to be made). (See Table 3 which illustrates the results of an remoteness test)

TABLE 3
Remote Analysis
Assumptions

| | |
|---|---|
| Convertible Instrument Premium | 30.0% |
| Convertible Instrument Yield | 1.5% |
| Dividend Yield | 1.0% |
| Contingent Interest Trigger (as % of Accreted) | 120% |

Probability that Convertible Instrument Trading Price will Exceed Convertible Instrument Trigger between Year 5 and 30

Stock Price CAGR

| Volatility | 7% | 10% | 13% | 16% | 19% |
|---|---|---|---|---|---|
| 20% | 33% | 46% | 59% | 70% | 80% |
| 22% | 33% | 44% | 56% | 67% | 77% |
| 24% | 32% | 43% | 53% | 64% | 73% |
| 26% | 32% | 41% | 51% | 61% | 70% |
| 28% | 31% | 40% | 49% | 58% | 67% |
| 30% | 31% | 47% | 56% | 64% | |

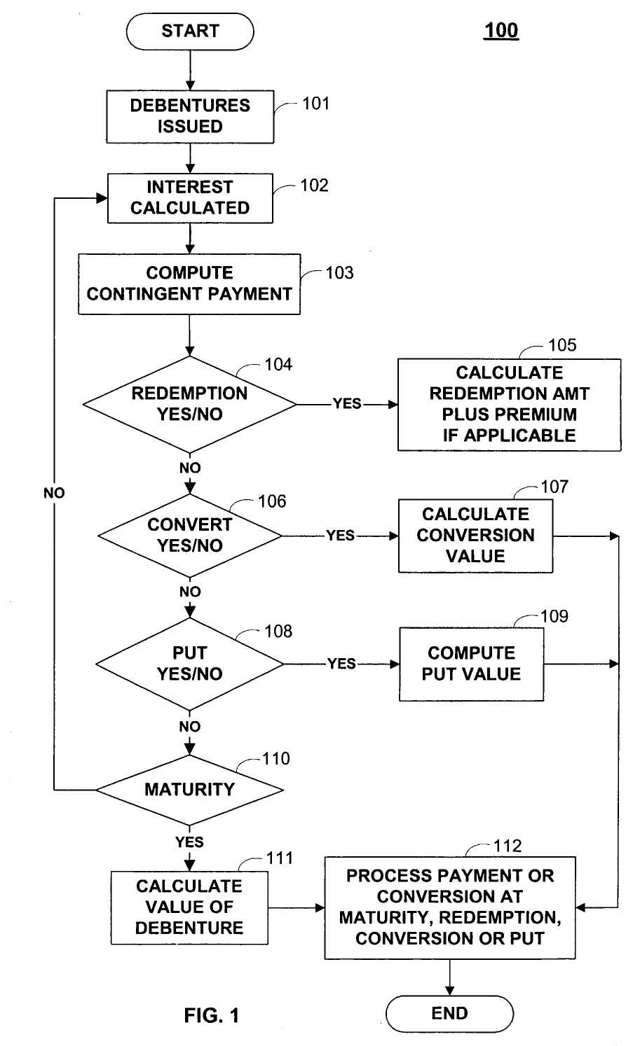

Systems and methods for offering and servicing financial instruments in accordance with the present invention may be described in conjunction with FIGS. 1-8.

FIG. 1 shows a generalized flowchart of illustrative steps involved in providing a company with capital by issuing, in this example, contingent payment debt instruments. The method starts at step 101 where a company, or other entity, issues the instrument. Furthermore, at step 101, the original principal amount of the instrument may equal an amount based on predetermined terms.

The method then proceeds to step 102, where interest payments are calculated. At step 103, contingent payments may be calculated if a predetermined contingency is met after a predetermined period of delay since issuance of the instrument in step 101.

Next, at step 104, if the issuer decides to redeem the instrument, the method proceeds to step 105 to calculate the redemption price. In some embodiments, when a company decides to redeem its instrument, it may redeem some or all of the instruments issued under the same offering. Moreover, in some embodiments, if the instruments are redeemed before a pre-selected date, the system may add a premium to the redemption amount.

The holder, under step 106, may convert an instrument for the underlying security at some time before maturity. The method may either allow a conversion at any time after issue, or may require that conversions occur during an allocated period of time after issue.

At step 108, automatically evaluates whether the holder has put the security. If yes, the method, at step 109, computes the put value.

If, however, the method evaluates that the holder has not put the security at step 108, the method proceeds to step 110. At step 110, if the bond has reached maturity, the method then calculates the value of the instrument under step 111. Otherwise, the method returns to step 102. Finally, at step 112, the method may process a conversion or a payment to the holder for the value of the matured instruments and any additional payments due.

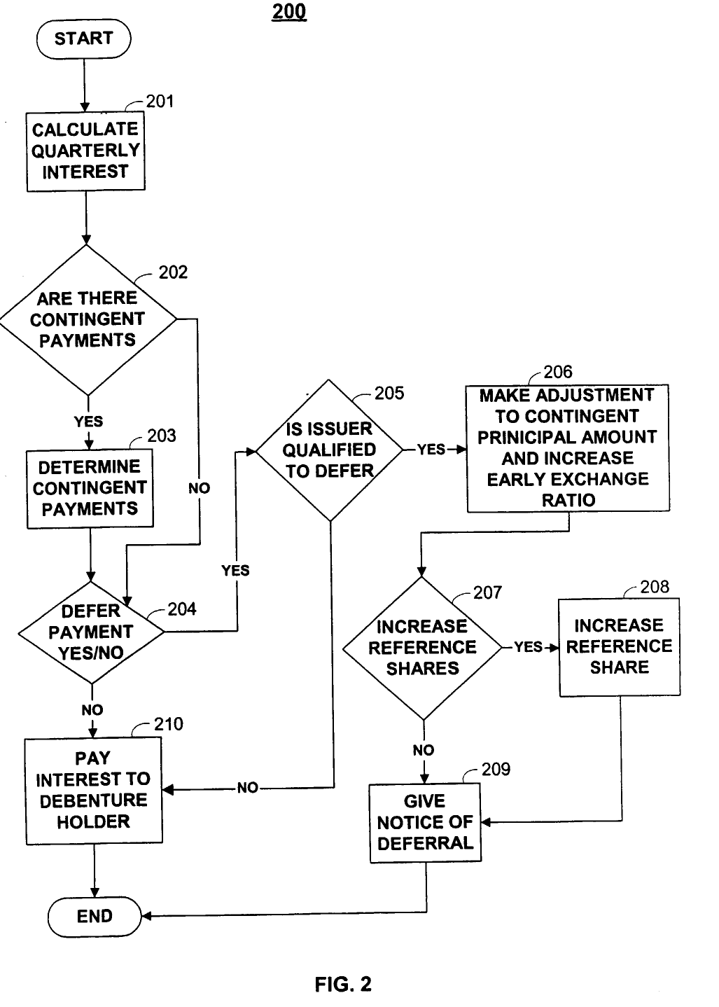

FIG. 2 is a flowchart of illustrative steps involved in calculating interest at step 102 of FIG. 1. At step 201, the rate of interest the issuer must pay to the holder is calculated using a predetermined interest rate. The predetermined interest rate may be applied to the original principal amount. Moreover, rather than applying a fixed rate throughout the term of the instrument, other variable or adjustable rates of interest may be used depending on the disclosure in the offering document.

After determining the issuer's interest liability in step 201, the method, at step 202, determines whether a contingent payment is owed to the holder. If a contingent payment is owed, this method proceeds to step 203 at which the method determines the amount of contingent owed to the holder. The method then proceeds to step 204. If, however, no contingent payment is owed to the holder at step 202, the method proceeds to step 204.

At step 204, the issuing company decides whether it wants to defer payments of interest. This may be decided based on predetermined terms as set forth in offering documents. If interest payments are not deferred, this method proceeds to step 210 and may pay some interest payments from at least one of steps 201 and 203 to holders. If, however, payments are to be deferred, at step 205, it must be determined whether the issuer is qualified to defer interest payments. This determination is made using criteria initially disclosed to the holder. Step 205 evaluates the payment history of the instruments, and if certain payments are not deferred, then the method proceeds to step 210, and pays the interest to the instrument holder.

The system handling some embodiments of this invention may not use step 206-208, but may provide notice of deferral at step 209.

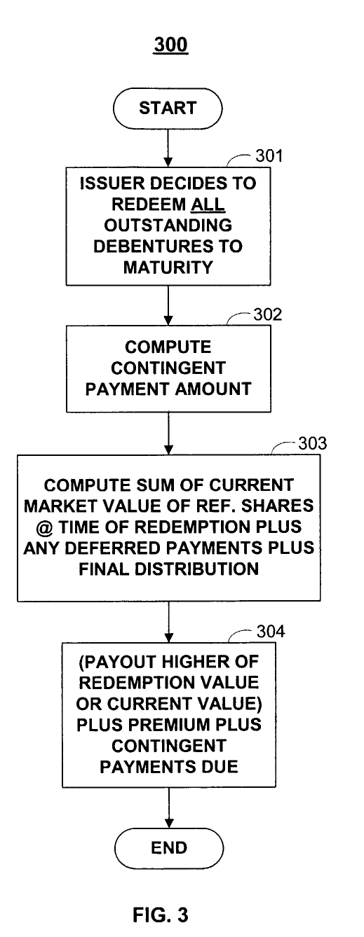

FIG. 3 is a flowchart of illustrative steps involved in redeeming the convertible financial instrument, as shown at step 104 of FIG. 1. The method 300 may be used when, for example, the issuer decides to redeem instruments issued under one offering document. At step 301, the issuer decides that it no longer wishes to keep the instruments outstanding and that it wants to redeem the instruments. Next, at step 302, the method determines if contingent payments are due and if so, the amount due. At step 303, the method calculates the current market value of underlying shares at the time of redemption plus any deferred payments. At step 304, the method pays out the appropriate redemption amount plus contingent payment amount, as calculated at steps 302 and 303.

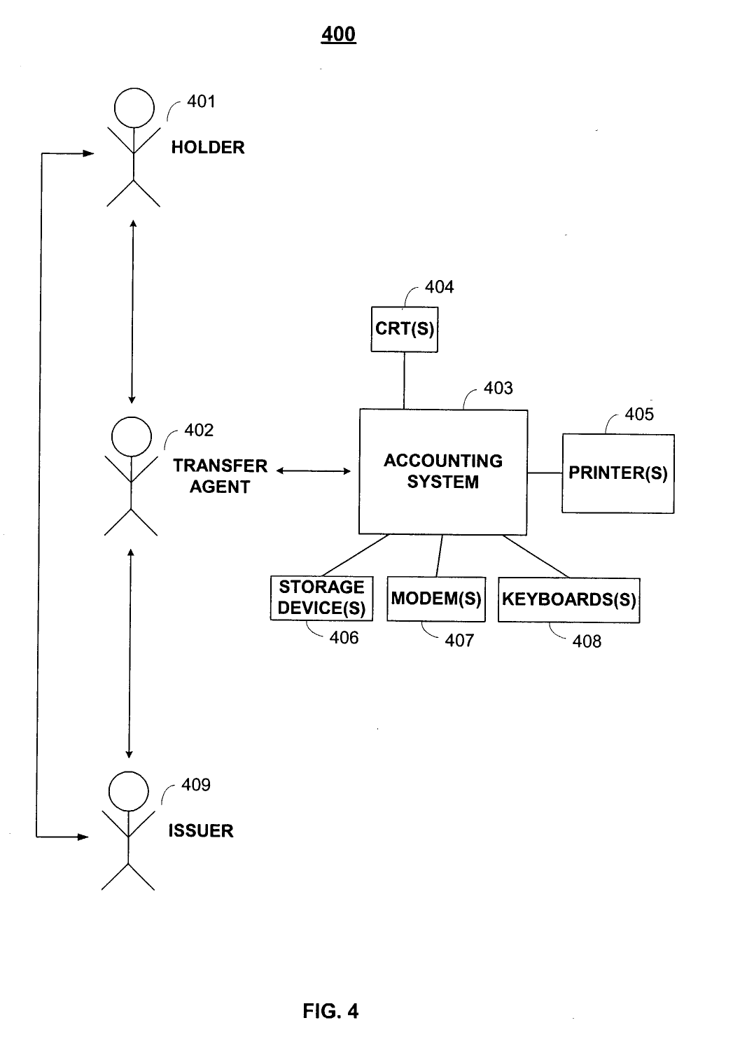

FIG. 4 illustrates the flow of information in a system 400 for issuing and servicing instruments. A potential holder 401 requests an offering document that describes the terms of the security. Upon receiving the offering document and purchasing an instrument, for example, from the issuer 409 or through a third party, the transfer agent 402 preferably will track the underlying reference security and service the security, for example, using the methods described in FIGS. 1-3. In doing so, the transfer agent may, for example, use a computerized accounting system 403 capable of tracking the underlying reference security via data lines (network (not shown) or modem 407), tracking any dividend and pay-out from the underlying security, making calculations as disclosed in the offering document of the instrument, and using a printer 405 to print periodic (e.g., annual) reports and statements reporting the instrument's value, and gains to the holder for tax reporting purposes.

In addition, the accounting system 403 may maintain pricing data (i.e., issue date, reference underlying instrument's price at time of issue, deferred dividends, etc.) in its mass storage system 406. In addition to the data received through the network or modem 407, the data may be inputted into the accounting system using keyboards 408. The system's modem 407 and network lines may be used to transfer funds to a holder or to a third party intermediary and the printer 405 may also print checks that are delivered directly to the third party or to a third party intermediary. Finally, the transfer agent may view the data from the accounting system using a CRT 404 or reports prepared by the accounting system 403 and printed using the system's printer 405.

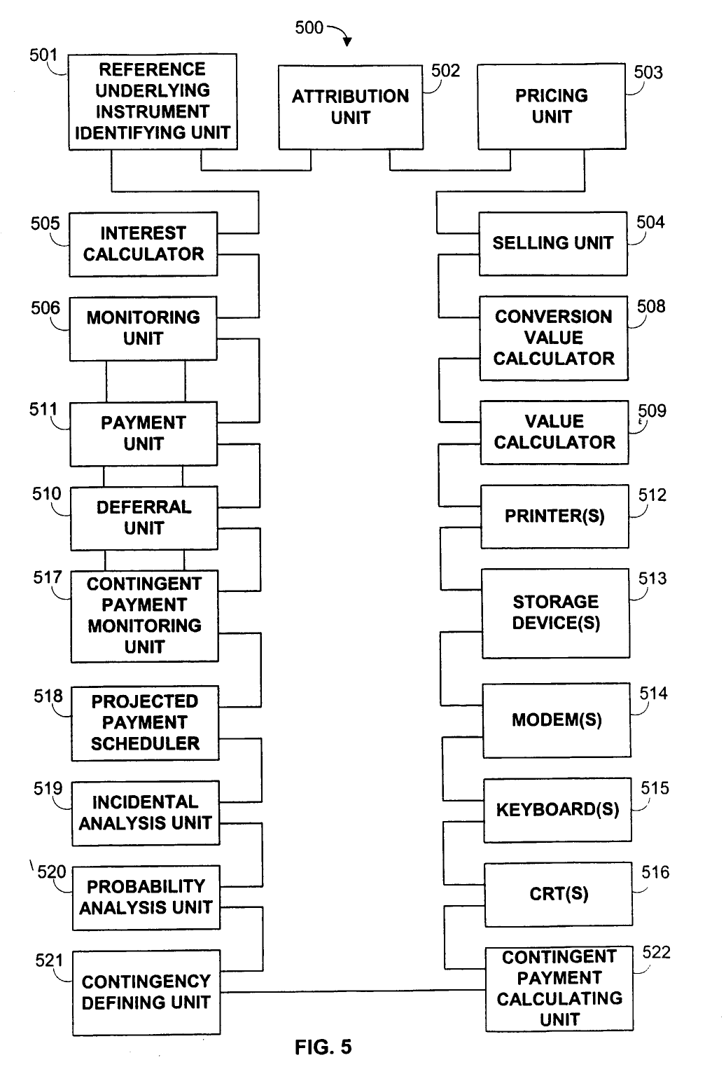

FIG. 5 offers some embodiments of a system 500 for implementing some methods according to the invention. A reference underlying instrument identifying unit 501 is provided to identify (e.g., by user keyboard entry) a reference underlying instrument. An attribution unit 502 is used to attribute a number of the reference underlying instrument's shares to the issuing instrument. Based on the price of the reference underlying instrument and the attributed number of reference instruments, a pricing unit 503 will establish a price for the issuing instrument.

A selling unit 504 processes sales of the instrument to interested investors or buyers at the price determined by pricing unit 503. An interest calculator 505, throughout the term of the instrument, calculates interest due to holders on a periodic basis. Furthermore, a monitoring unit 506 tracks any dividend or pay-out of the underlying security.

If during the term of the instrument, a holder decides to convert the instrument into the underlying security, a conversion value calculator 508 calculates the conversion value of the instrument. The value calculator 509 calculates the value of the instrument at the time of redemption (if the instrument is redeemed early by the issuer), and may also be used at maturity (if the instrument remains outstanding until maturity).

A deferral unit 510 processes the results of interest calculator 505, and additional interest calculator 507, to determine if the calculated amount will be paid or deferred. If the payment amount is not deferred, payment is made by payment unit 511. Furthermore, payment unit 511 processes and makes payment based on the results of conversion value calculator 508, monitoring unit 506, and value calculator 509. Payment may be made by check printed by a printer 512 as commanded by payment unit 511. Alternatively payment may be made via electronic transfer by modem 514. Reports listing payments of interest, and other financial data relevant to the holder for tax reporting purposes or other reportable data are printed using printer 512. Any such reports meant for holders preferably are printed and sent to holders periodically, and at least annually. Other reports may be required by regulatory agencies and are printed when required by the relevant regulations. Storage 513, modems 514, keyboards 515, and CRT 516 are used by the separate units of system 500, in a manner similar to that described in connection with FIG. 4.

A contingent payment monitoring unit 517 may be used to monitor for satisfaction of a contingency and a contingent payment calculating unit 522 may calculate payments due holders based on predetermined criteria as set forth in the offering documents. Such predetermined criteria may include, for example, a maximum payment cap or a minimum payment guarantee. A financial debt instrument may utilize the contingent payment monitoring unit 517 to determine that a contingency was satisfied within a contingency monitoring period. The payment monitoring unit 517, may determine that a contingency was satisfied based on a trigger, such as, for example, trading price of a financial instrument (e.g., the underlying security, the financial instrument itself, a security issued by an unaffiliated party, a liability of the issuer, a class of capital stock, etc.). The financial debt instrument then may utilize the contingent payment calculating unit 522 to determine the contingent payment amount based on, for example, trading price of a financial instrument (e.g., the underlying security, the financial instrument itself, a security issued by an unaffiliated party, a liability of the issuer, a class of capital stock, etc.).

A projected payment scheduler 518 utilizes data from the reference underlying instrument identifying unit 501 and criteria used by the contingent payment monitoring unit 517, the contingent payment calculating unit 522, and the contingency defining unit 521 to prepare a projected payment schedule. An incidental analysis unit 519 and probability analysis unit 520 are used to determine the probability of payments and whether payments may be incidental.

A contingency defining unit 521 defines a contingency that must be satisfied before a contingent payment will be paid.

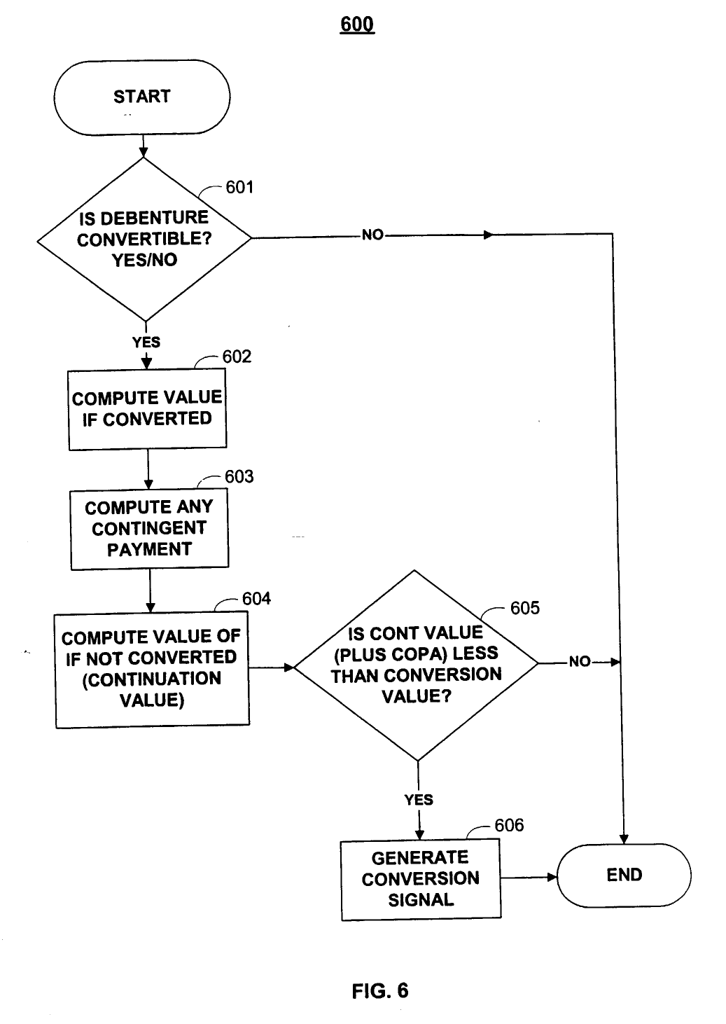

FIG. 6 is a flowchart of illustrative steps involved in determining whether to convert a contingent payment debt instrument in accordance with some embodiment of this invention. The method 600, at step 601 determines whether the instrument is convertible. If not, the method ends. If it is, the method, at step 602, computes the value of the instrument if converted. At step 603, the method computes any contingent payments. At step 604, the method computes the value of the debt instrument if not converted. At 605, the method determines whether the continuation value (including contingent payments) is less than the conversion value. If so, a signal to convert is generated at step 606. If not, the method ends.

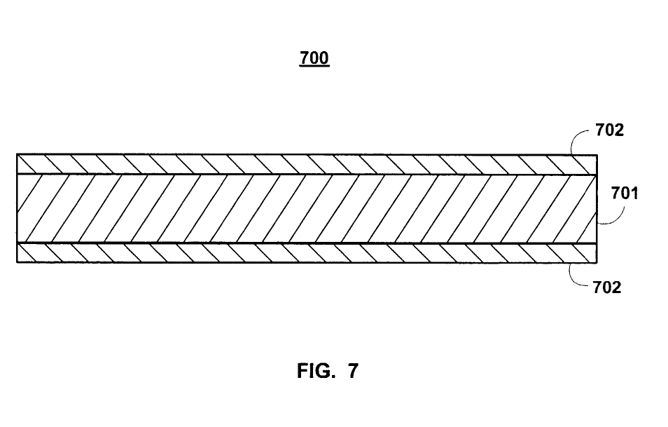

FIG. 7 presents a cross section of a magnetic data storage medium 700 which can be encoded with a machine executable program that can be carried out by a system such as system 400 of FIG. 4 or system 500 of FIG. 5. Medium 700 can be floppy diskette or hard disk, having a suitable substrate 701, which may be conventional, and a suitable coating 702, which may be conventional, on one or both sides, containing magnetic domains (not visible) whose polarity or orientation can be altered magnetically. Medium 700 may also have an opening (not shown) for receiving the spindle of a disk drive or other data storage device.

The magnetic domains of coating 702 of medium 700 are polarized or oriented so as to encode, in manner which may be conventional, a machine-executable program such as that described above in connection with FIGS. 1-3 and FIG. 6, for execution by a system such as system 400 of FIG. 4 or system 500 of FIG. 5.

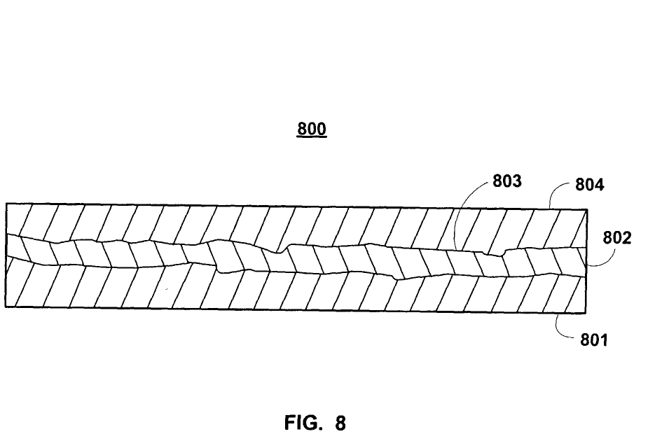

FIG. 8 shows a cross section of an optically- readable data storage medium 800 which also can be encoded with such a machine-executable program, which can be carried out by a system such as system 400 of FIG. 4 or system 500 of FIG. 5. Medium 800 can be a conventional compact disk read only memory (CD-ROM) or a rewritable medium such as a CD-R or CD-RW disk or a magneto-optical disk which is optically readable and magneto-optically writeable. Medium 800 preferably has a suitable substrate 801, which may be conventional, and a suitable coating 802, which may be conventional, usually on one side of substrate 801.

In the case of a CD-ROM, as is well known, coating 802 is reflective and is impressed with a plurality of pits 803 to encode the machine-executable program. The arrangement of pits is read by reflecting laser light off the surface of coating 802. A protective coating 804, which preferably is substantially transparent, is provided on top of coating 802.

In the case of magneto-optical disk, as is well known, coating 802 has no pits 803, but has a plurality of magnetic domains whose polarity or orientation can be changed magnetically when heated above a certain temperature, as by a laser (not shown). The orientation of the domains can be read by measuring the polarization of laser light reflected from coating 802. The arrangement of the domains encodes the program as described above.

Thus, a convertible financial instrument with contingent payments, and systems and methods for offering and servicing the same are provided. One skilled in the art will appreciate that the present invention can be practiced by other than the described embodiments, which are presented for purposes of illustration and not of limitation.

What is claimed is:

1. A financial services method associated with a financial instrument said method comprising:
identifying an underlying reference for said financial instrument, said underlying reference having a value;
attributing a number of said underlying references to said financial instrument;
defining a contingency, a payment becoming due on occurrence of said contingency after a predetermined period of delay.

2. The method of claim 1, further comprising:
establishing a value for said financial instrument.

3. The method of claim 2 further comprising:
selling said financial instrument.

4. The method of claim 3, wherein said selling said financial instrument comprises selling said financial instrument at a value based on at least one of:
a. said contingency;
b. said value of said underlying reference;
c. value of said payment;
d. length of said predetermined period of delay;
e. volatility in trading value of said underlying reference;
f. time until redemption, at option of issuer or holder;
g. time until maturity;
h. an interest rate; and
i. value for which said financial instrument must be redeemed on redemption date.

5. The method of claim 3, wherein said selling said financial instrument comprises auctioning said financial instrument.

6. The method of claim 3, wherein said selling said financial instrument comprises selling a derivative of said financial instrument.

7. The method of claim 3, wherein said selling said financial instrument comprises selling a part of said financial instrument.

8. The method of claim 3 further comprising:
monitoring for satisfaction of said contingency.

9. The method of claim 3, further comprising:
disbursing said payment.

10. The method of claim 3, further comprising:
calculating said payment.

11. The method of claim 2, further comprising:
monitoring for satisfaction of said contingency.

12. The method of claim 11, further comprising:
disbursing said payment.

13. The method of claim 11, further comprising:
calculating said payment.

14. The method of claim 2, further comprising:
disbursing said payment.

15. The method of claim 2, further comprising:
calculating said payment.

16. The method of claim 2, wherein said establishing a value for said financial instrument comprises basing said value for said financial instrument on at least one of:
a. said contingency;
b. said value of said underlying reference;
c. value of said payment;
d. length of said predetermined period of delay;
e. volatility in trading value of said underlying reference;
f. time until redemption, at option of issuer or holder;
g. time until maturity;
h. an interest rate; and
i. value for which said financial instrument must be redeemed on redemption date.

17. The method of claim 1 further comprising:
selling said financial instrument.

18. The method of claim 17, wherein said selling said financial instrument comprises selling said financial instrument at a value based on at least one of:
a. said contingency;
b. said value of said underlying reference;
c. value of said payment;
d. length of said predetermined period of delay;
e. volatility in trading value of said underlying reference;
f. time until redemption, at option of issuer or holder;
g. time until maturity;
h. an interest rate; and
i. value for which said financial instrument must be redeemed on redemption date.

19. The method of claim 17, wherein said selling said financial instrument comprises auctioning said financial instrument.

20. The method of claim 17, wherein said selling said financial instrument comprises selling a derivative of said financial instrument.

21. The method of claim 17, wherein said selling said financial instrument comprises selling a part of said financial instrument.

22. The method of claim 17 further comprising:
monitoring for satisfaction of said contingency.

23. The method of claim 17, further comprising:
disbursing said payment.

24. The method of claim 17, further comprising:
calculating said payment.

25. The method of claim 1 further comprising:
monitoring for satisfaction of said contingency.

26. The method of claim 25, wherein said monitoring for satisfaction comprises comparing market data to requirements of said contingency within at least one said contingency monitoring period.

27. The method of claim 25, wherein said monitoring comprises monitoring over many said contingency monitoring periods.

28. The method of claim 25, wherein said monitoring comprises monitoring realtime data.

29. The method of claim 25, further comprising:
disbursing said payment.

30. The method of claim 25, further comprising:
calculating said payment.

31. The method of claim 1, wherein said defining a contingency comprises basing said contingency on an event related to said financial instrument.

32. The method of claim 31, wherein said basing said contingency on an event related to said financial instrument comprises setting said contingency as satisfied once an observed value of said financial instrument at least:
a. exceeds a predetermined metric, or
b. is equal to a predetermined metric, or
c. is less than a predetermined metric.

33. The method of claim 1, wherein said defining a contingency comprises setting said contingency as satisfied when the closing sale value of said underlying reference within at least one said contingency monitoring period is greater than a predetermined percentage of the conversion value.

34. The method of claim 1, wherein said defining a contingency comprises setting said contingency as satisfied when the closing sale value of said underlying reference within at least one said contingency monitoring period is less than a predetermined percentage of the conversion value.

35. The method of claim 1, wherein said defining a contingency comprises basing said contingency on an instrument other than said financial instrument.

36. The method of claim 35, wherein said basing said contingency on said instrument other than said financial instrument comprises setting said contingency as satisfied once an observed value of said instrument at least:
a. exceeds a predetermined metric, or
b. is equal to a predetermined metric, or
c. is less than a predetermined metric.

37. The method of claim 1, wherein said defining a contingency comprises establishing at least one of:
a. contingency having at least one trigger, and
b. multiple contingencies each with at least one trigger.

38. The method of claim 37, wherein said establishing at least one trigger comprises setting said trigger at an amount equal to a multiple of a prevailing market rate for a financial instrument.

39. The method of claim 38, wherein said setting said trigger at an amount equal to a multiple comprises using a multiple equal to 1.

40. The method of claim 38, wherein said setting said trigger at an amount equal to a multiple comprises using a multiple less than 1.

41. The method of claim 38, wherein said setting said trigger at an amount equal to a multiple comprises using a multiple greater than 1.

42. The method of claim 37, wherein said establishing at least one trigger comprises setting said trigger equal to a multiple of a formula amount.

43. The method of claim 42, wherein said setting said trigger at an amount equal to a multiple comprises using a multiple equal to 1.

44. The method of claim 42, wherein said setting said trigger at an amount equal to a multiple comprises using a multiple less than 1.

45. The method of claim 42, wherein said setting said trigger at an amount equal to a multiple comprises using a multiple greater than 1.

46. The method of claim 1, further comprising:
a. disbursing said payment.

47. The method of claim 46, wherein said disbursing said payment comprises sending a negotiable instrument.

48. The method of claim 1, further comprising:
calculating said payment.

49. The method of claim 48, wherein said calculating said payment comprises establishing a formula for calculating said payment based on said value of said underlying reference.

50. The method of claim 49, wherein said establishing a formula comprises using a fixed rate formula.

51. The method of claim 49, wherein said establishing a formula comprises using a variable rate formula.

52. The method of claim 48, wherein said calculating said payment comprises calculating said payment using a periodic schedule.

53. The method of claim 52, wherein said calculating said payment using a periodic schedule comprises calculating said payment at least once per said contingency monitoring period.

54. The method of claim 52, wherein said calculating said payment using a periodic schedule comprises calculating said payment on a quarterly basis.

55. The method of claim 48, wherein said calculating said payment comprises calculating said payment based upon at least one of:
a. predetermined fixed amount,
b. trading value of said financial instrument,
c. trading yield of said financial instrument,
d. trading yield of a liability of said issuer of said financial instrument,
e. trading value of a liability of said issuer of said financial instrument,
f. trading value of a class of capital stock issued by an issuer other than said issuer of said financial instrument,
g. trading dividend yield of a class of capital stock issued by an issuer other than said issuer of said financial instrument,
h. trading value of a class of capital stock of said issuer of said financial instrument,
i. trading yield of a class of capital stock of said issuer of said financial instrument,
j. trading value of a security,
k. trading yield of a security, and
l. an index.

56. The method of claim 1, further comprising preparing at least one of:
a. a projected payment schedule;
b. an incidental analysis; and
c. a remoteness analysis.

57. The method of claim 56, wherein said preparing said projected payment schedule comprises determining a schedule of said payments based on payments necessary to produce a comparable yield.

58. The method of claim 56, wherein said preparing said incidental analysis comprises determining the amount of said payment based on assumptions regarding said contingency being satisfied.

59. The method of claim 58, wherein said determining the amount of said payment based on assumptions regarding the contingency being satisfied comprises determining the amount of said payment based on at least one of:
a. a stock price growth rate, and
b. discount rates.

60. The method of claim 56, wherein said preparing said remoteness analysis comprises determining the likelihood that said payment will be made given assumptions regarding said contingency being satisfied.

61. The method of claim 60, wherein said determining the likelihood that said payment will be made given assumptions regarding said contingency being satisfied comprises determining the likelihood that said payment will be made given a stock price growth rate and a volatility.

62. The method of claim 1, wherein said attributing a number of said underlying references to said financial instrument comprises attributing a variable number of said underlying references to each unit of said financial instrument.

63. The method of claim 1, wherein said attributing a number of said underlying references to said financial instrument comprises attributing a constant number of said underlying references to each unit of said financial instrument.

64. The method of claim 1, wherein said identifying an underlying reference comprises identifying said underlying reference that said financial instrument converts into.

65. The method of claim 1, wherein said identifying an underlying reference comprises basing an exchange value of said financial instrument on said underlying reference.

66. The method of claim 1, wherein said predetermined period of delay comprises a period of delay greater than a contingency monitoring period.

67. A financial services method comprising buying a financial instrument created by:
identifying an underlying reference for said financial instrument, said underlying reference having a value;
attributing a number of said underlying references to said financial instrument;
defining a contingency, a payment becoming due on occurrence of said contingency after a predetermined period of delay.

68. The method of claim 67, wherein said buying said financial instrument comprises buying said financial instrument at a value based on at least one of:
a. said contingency;
b. said value of said underlying reference;
c. value of said payment;
d. length of said predetermined period of delay;
e. volatility in trading value of said underlying reference;
f. time until redemption, at option of issuer or holder;
g. time until maturity;
h. an interest rate; and
i. value for which said financial instrument must be redeemed on redemption date.

69. The method of claim 67, wherein said buying said financial instrument comprises bidding for said financial instrument.

70. The method of claim 67, wherein said buying said financial instrument comprises buying a derivative of said financial instrument.

71. The method of claim 67, wherein said buying said financial instrument comprises buying a part of said financial instrument.

72. The method of claim 67, wherein said defining a contingency comprises basing said contingency on an event related to said financial instrument.

73. The method of claim 67, wherein said defining a contingency comprises basing said contingency on an instrument other than said financial instrument.

74. The method of claim 67, wherein said attributing a number of said underlying references to said financial instrument comprises attributing a variable number of said underlying references to each unit of said financial instrument.

75. The method of claim 67, wherein said attributing a number of said underlying references to said financial instrument comprises attributing a constant number of said underlying references to each unit of said financial instrument.

76. The method of claim 67, wherein said identifying an underlying reference comprises identifying said underlying reference that said financial instrument converts into.

77. The method of claim 67, wherein said identifying an underlying reference comprises basing an exchange value of said financial instrument on said underlying reference.

78. The method of claim 67, wherein said predetermined period of delay comprises a period of delay greater than a contingency monitoring period.

79. A financial services method associated with a financial instrument said method comprising:
identifying an underlying reference for said financial instrument, said underlying reference having a value;
attributing a number of said underlying references to said financial instrument;
defining a contingency having at least one trigger, a payment becoming due when said trigger drops below a predetermined value.

80. The method of claim 79, further comprising:
establishing a value for said financial instrument.

81. The method of claim 80, further comprising:
selling said financial instrument.

82. The method of claim 81, wherein said selling said financial instrument comprises selling said financial instrument at a value based on at least one of:
a. said contingency;
b. said value of said underlying reference;
c. value of said payment;
d. said predetermined value;
e. volatility in trading value of said underlying reference;
f. time until redemption, at option of issuer or holder;
g. time until maturity;
h. an interest rate; and
i. value for which said financial instrument must be redeemed on redemption date.

83. The method of claim 81, wherein said selling said financial instrument comprises auctioning said financial instrument.

84. The method of claim 81, wherein said selling said financial instrument comprises selling a derivative of said financial instrument.

85. The method of claim 81, wherein said selling said financial instrument comprises selling a part of said financial instrument.

86. The method of claim 81, further comprising:
monitoring for satisfaction of said contingency.

87. The method of claim 81, further comprising:
disbursing said payment.

88. The method of claim 81, further comprising:
calculating said payment.

89. The method of claim 80, further comprising:
monitoring for satisfaction of said contingency.

90. The method of claim 89, further comprising:
disbursing said payment.

91. The method of claim 89, further comprising:
calculating said payment.

92. The method of claim 80, further comprising:
disbursing said payment.

93. The method of claim 80, further comprising:
calculating said payment.

94. The method of claim 80, wherein said establishing a value for said financial instrument comprises basing said value for said financial instrument on at least one of:
a. said contingency;
b. said value of said underlying reference;
c. value of said payment;
d. said predetermined value;
e. volatility in trading value of said underlying reference;
f. time until redemption, at option of issuer or holder;
g. time until maturity;
h. an interest rate; and
i. value for which said financial instrument must be redeemed on redemption date.

95. The method of claim 79 further comprising:
selling said financial instrument.

96. The method of claim 95, wherein said selling said financial instrument comprises selling said financial instrument at a value based on at least one of:
a. said contingency;
b. said value of said underlying reference;
c. value of said payment;
d. said predetermined value;
e. volatility in trading value of said underlying reference;
f. time until redemption, at option of issuer or holder;
g. time until maturity;
h. an interest rate; and
i. value for which said financial instrument must be redeemed on redemption date.

97. The method of claim 95, wherein said selling said financial instrument comprises auctioning said financial instrument.

98. The method of claim 95, wherein said selling said financial instrument comprises selling a derivative of said financial instrument.

99. The method of claim 95, wherein said selling said financial instrument comprises selling a part of said financial instrument.

100. The method of claim 95 further comprising:
monitoring for satisfaction of said contingency.

101. The method of claim 95, further comprising:
disbursing said payment.

102. The method of claim 95, further comprising:
calculating said payment.

103. The method of claim 79 further comprising:
monitoring for satisfaction of said contingency.

104. The method of claim 103, wherein said monitoring for satisfaction comprises comparing market data to said trigger of said contingency.

105. The method of claim 103, wherein said monitoring comprises monitoring over many said contingency monitoring periods.

106. The method of claim 103, wherein said monitoring comprises monitoring realtime data.

107. The method of claim 103, further comprising:
disbursing said payment.

108. The method of claim 103, further comprising:
calculating said payment.

109. The method of claim 79, wherein said defining a contingency having at least one trigger comprises basing said trigger on an event related to said financial instrument.

110. The method of claim 79, wherein said defining a contingency having at least one trigger comprises basing said trigger on an instrument other than said financial instrument.

111. The method of claim 79, wherein said defining a contingency having at least one trigger comprises setting said trigger at an amount equal to a multiple of a prevailing market rate for a financial instrument.

112. The method of claim 111, wherein said setting said trigger at an amount equal to a multiple comprises using a multiple equal to 1.

113. The method of claim 111, wherein said setting said trigger at an amount equal to a multiple comprises using a multiple less than 1.

114. The method of claim 111, wherein said setting said trigger at an amount equal to a multiple comprises using a multiple greater than 1.

115. The method of claim 79, wherein said defining a contingency having at least one trigger comprises setting said trigger equal to a multiple of a formula amount.

116. The method of claim 115, wherein said setting said trigger at an amount equal to a multiple comprises using a multiple equal to 1.

117. The method of claim 115, wherein said setting said trigger at an amount equal to a multiple comprises using a multiple less than 1.

118. The method of claim 115, wherein said setting said trigger at an amount equal to a multiple comprises using a multiple greater than 1.

119. The method of claim 79, wherein said predetermined value comprises a predetermined percentage of the conversion value.

120. The method of claim 79, further comprising:
disbursing said payment.

121. The method of claim 120, wherein said disbursing said payment comprises sending a negotiable instrument.

122. The method of claim 79, further comprising:
calculating said payment.

123. The method of claim 122, wherein said calculating said payment comprises establishing a formula for calculating said payment based on said value of said underlying reference.

124. The method of claim 123, wherein said establishing a formula comprises using a fixed rate formula.

125. The method of claim 123, wherein said establishing a formula comprises using a variable rate formula.

126. The method of claim 122, wherein said calculating said payment comprises calculating said payment using a periodic schedule.

127. The method of claim 126, wherein said calculating said payment using a periodic schedule comprises calculating said payment at least once per said contingency monitoring period.

128. The method of claim 126, wherein said calculating said payment using a periodic schedule comprises calculating said payment on a quarterly basis.

129. The method of claim 122, wherein said calculating said payment comprises calculating said payment based upon at least one of:
a. predetermined fixed amount,
b. trading value of said financial instrument,
c. trading yield of said financial instrument,
d. trading yield of a liability of said issuer of said financial instrument,
e. trading value of a liability of said issuer of said financial instrument,
f. trading value of a class of capital stock issued by an issuer other than said issuer of said financial instrument,
g. trading dividend yield of a class of capital stock issued by an issuer other than said issuer of said financial instrument,
h. trading value of a class of capital stock of said issuer of said financial instrument,
i. trading yield of a class of capital stock of said issuer of said financial instrument,
j trading value of a security,
k. trading yield of a security, and
l. an index.

130. The method of claim 122, wherein said calculating said payment comprises calculating a payment only after a predetermined period of delay.

131. The method of claim 79, further comprising preparing at least one of:
a. a projected payment schedule;
b. an incidental analysis; and
c. a remoteness analysis.

132. The method of claim 131, wherein said preparing said projected payment schedule comprises determining a schedule of said payments based on payments necessary to produce a comparable yield.

133. The method of claim 131, wherein said preparing said incidental analysis comprises determining the amount of said payment based on assumptions regarding said contingency being satisfied.

134. The method of claim 133, wherein said determining the amount of said payment based on assumptions regarding the contingency being satisfied comprises determining the amount of said payment based on at least one of:
a. a stock price growth rate, and
b. discount rates.

135. The method of claim 131, wherein said preparing said remoteness analysis comprises determining the likelihood that said payment will be made given assumptions regarding said contingency being satisfied.

136. The method of claim 135, wherein said determining the likelihood that said payment will be made given assumptions regarding said contingency being satisfied comprises determining the likelihood that said payment will be made given a stock price growth rate and a volatility.

137. The method of claim 79, wherein said attributing a number of said underlying references to said financial instrument comprises attributing a variable number of said underlying references to each unit of said financial instrument.

138. The method of claim 79, wherein said attributing a number of said underlying references to said financial instrument comprises attributing a constant number of said underlying references to each unit of said financial instrument.

139. The method of claim 79, wherein said identifying an underlying reference comprises identifying said underlying reference that said financial instrument converts into.

140. The method of claim 79, wherein said identifying an underlying reference comprises basing an exchange value of said financial instrument on said underlying reference.

141. A financial services method comprising buying a financial instrument created by:
identifying an underlying reference for said financial instrument, said underlying reference having a value;
attributing a number of said underlying references to said financial instrument;
defining a contingency having at least one trigger, a payment becoming due when said trigger drops below a predetermined value.

142. The method of claim 141, wherein said buying said financial instrument comprises buying said financial instrument at a value based on at least one of:
a. said contingency;
b. said value of said underlying reference;
c. value of said payment;
d. length of said predetermined period of delay;
e. volatility in trading value of said underlying reference;
f. time until redemption, at option of issuer or holder;
g. time until maturity;
h. an interest rate; and
i. value for which said financial instrument must be redeemed on redemption date.

143. The method of claim 141, wherein said buying said financial instrument comprises bidding for said financial instrument.

144. The method of claim 141, wherein said buying said financial instrument comprises buying a derivative of said financial instrument.

145. The method of claim 141, wherein said buying said financial instrument comprises buying a part of said financial instrument.

146. The method of claim 141, wherein said defining a contingency comprises basing said contingency on an event related to said financial instrument.

147. The method of claim 141, wherein said defining a contingency comprises basing said contingency on an instrument other than said financial instrument.

148. The method of claim 141, wherein said attributing a number of said underlying references to said financial instrument comprises attributing a variable number of said underlying references to each unit of said financial instrument.

149. The method of claim 141, wherein said attributing a number of said underlying references to said financial instrument comprises attributing a constant number of said underlying references to each unit of said financial instrument.

150. The method of claim 141, wherein said identifying an underlying reference comprises identifying said underlying reference that said financial instrument converts into.

151. The method of claim 141, wherein said identifying an underlying reference comprises basing an exchange value of said financial instrument on said underlying reference.

152. A financial services method associated with a financial instrument said method comprising:
identifying an underlying reference for said financial instrument, said underlying reference having a value;
attributing a number of said underlying references to said financial instrument;
defining a contingency having multiple triggers, a payment becoming due when any one of said triggers drops below a predetermined value.

153. The method of claim 152, further comprising:
establishing a value for said financial instrument.

154. The method of claim 153, further comprising:
selling said financial instrument.

155. The method of claim 154, wherein said selling said financial instrument comprises selling said financial instrument at a value based on at least one of:
a. said contingency;
b. said value of said underlying reference;
c. value of said payment;
d. said predetermined value;
e. volatility in trading value of said underlying reference;
f. time until redemption, at option of issuer or holder;
g. time until maturity;
h. an interest rate; and
i. value for which said financial instrument must be redeemed on redemption date.

156. The method of claim 154, wherein said selling said financial instrument comprises auctioning said financial instrument.

157. The method of claim 154, wherein said selling said financial instrument comprises selling a derivative of said financial instrument.

158. The method of claim 154, wherein said selling said financial instrument comprises selling a part of said financial instrument.

159. The method of claim 154, further comprising:
monitoring for satisfaction of said contingency.

160. The method of claim 154, further comprising:
disbursing said payment.

161. The method of claim 154, further comprising:
calculating said payment.

162. The method of claim 153, further comprising:
monitoring for satisfaction of said contingency.

163. The method of claim 162, further comprising:
disbursing said payment.

164. The method of claim 162, further comprising:
calculating said payment.

165. The method of claim 153, further comprising:
disbursing said payment.

166. The method of claim 153, further comprising:
calculating said payment.

167. The method of claim 153, wherein said establishing a value for said financial instrument comprises basing said value for said financial instrument on at least one of:
a. said contingency;
b. said value of said underlying reference;
c. value of said payment;
d. said predetermined value;
e. volatility in trading value of said underlying reference;
f. time until redemption, at option of issuer or holder;
g. time until maturity;
h. an interest rate; and
i. value for which said financial instrument must be redeemed on redemption date.

168. The method of claim 152 further comprising:
selling said financial instrument.

169. The method of claim 168, wherein said selling said financial instrument comprises selling said financial instrument at a value based on at least one of:
a. said contingency;
b. said value of said underlying reference;
c. value of said payment;
d. said predetermined value;
e. volatility in trading value of said underlying reference;
f. time until redemption, at option of issuer or holder;
g. time until maturity;
h. an interest rate; and
i. value for which said financial instrument must be redeemed on redemption date.

170. The method of claim 168, wherein said selling said financial instrument comprises auctioning said financial instrument.

171. The method of claim 168, wherein said selling said financial instrument comprises selling a derivative of said financial instrument.

172. The method of claim 168, wherein said selling said financial instrument comprises selling a part of said financial instrument.

173. The method of claim 168 further comprising:
monitoring for satisfaction of said contingency.

174. The method of claim 168, further comprising:
disbursing said payment.

175. The method of claim 168, further comprising:
calculating said payment.

176. The method of claim 152 further comprising:
monitoring for satisfaction of said contingency.

177. The method of claim 176, wherein said monitoring for satisfaction comprises comparing market data to said trigger of said contingency.

178. The method of claim 176, wherein said monitoring comprises monitoring over many said contingency monitoring periods.

179. The method of claim 176, wherein said monitoring comprises monitoring realtime data.

180. The method of claim 176, further comprising:
disbursing said payment.

181. The method of claim 176, further comprising:
calculating said payment.

182. The method of claim 152, wherein said defining a contingency having multiple triggers comprises basing said triggers on events related to said financial instrument.

183. The method of claim 152, wherein said defining a contingency having multiple triggers comprises basing said triggers on instruments other than said financial instrument.

184. The method of claim 152, wherein said defining a contingency having multiple triggers comprises setting said triggers at amounts equal to a multiple of prevailing market rates for financial instruments.

185. The method of claim 184, wherein said setting said triggers at amounts equal to a multiple comprises using a multiple equal to 1.

186. The method of claim 184, wherein said setting said triggers at amounts equal to a multiple comprises using a multiple less than 1.

187. The method of claim 184, wherein said setting said triggers at amounts equal to a multiple comprises using a multiple greater than 1.

188. The method of claim 152, wherein said defining a contingency having multiple triggers comprises setting said triggers at amounts equal to a multiple of formulae amounts.

189. The method of claim 188, wherein said setting said triggers at amounts equal to a multiple comprises using a multiple equal to 1.

190. The method of claim 188, wherein said setting said triggers at amounts equal to a multiple comprises using a multiple less than 1.

191. The method of claim 188, wherein said setting said triggers at amounts equal to a multiple comprises using a multiple greater than 1.

192. The method of claim 152, wherein said predetermined value comprises a predetermined percentage of the conversion value.

193. The method of claim 152, further comprising:
disbursing said payment.

194. The method of claim 193, wherein said disbursing said payment comprises sending a negotiable instrument.

195. The method of claim 152, further comprising:
calculating said payment.

196. The method of claim 195, wherein said calculating said payment comprises establishing a formula for calculating said payment based on said value of said underlying reference.

197. The method of claim 196, wherein said establishing a formula comprises using a fixed rate formula.

198. The method of claim 196, wherein said establishing a formula comprises using a variable rate formula.

199. The method of claim 195, wherein said calculating said payment comprises calculating said payment using a periodic schedule.

200. The method of claim 199, wherein said calculating said payment using a periodic schedule comprises calculating said payment at least once per said contingency monitoring period.

201. The method of claim 199, wherein said calculating said payment using a periodic schedule comprises calculating said payment on a quarterly basis.

202. The method of claim 195, wherein said calculating said payment comprises calculating said payment based upon at least one of:
a. predetermined fixed amount,
b. trading value of said financial instrument,
c. trading yield of said financial instrument,
d. trading yield of a liability of said issuer of said financial instrument,
e. trading value of a liability of said issuer of said financial instrument,
f. trading value of a class of capital stock issued by an issuer other than said issuer of said financial instrument,
g. trading dividend yield of a class of capital stock issued by an issuer other than said issuer of said financial instrument,
h. trading value of a class of capital stock of said issuer of said financial instrument,
i. trading yield of a class of capital stock of said issuer of said financial instrument,
j. trading value of a security,
k. trading yield of a security, and
1. an index.

203. The method of claim 195, wherein said calculating said payment comprises calculating a payment only after a predetermined period of delay.

204. The method of claim 152, further comprising preparing at least one of:
a. a projected payment schedule;
b. an incidental analysis; and
c. a remoteness analysis.

205. The method of claim 204, wherein said preparing said projected payment schedule comprises determining a schedule of said payments based on payments necessary to produce a comparable yield.

206. The method of claim 204, wherein said preparing said incidental analysis comprises determining the amount of said payment based on assumptions regarding said contingency being satisfied.

207. The method of claim 206, wherein said determining the amount of said payment based on assumptions regarding the contingency being satisfied comprises determining the amount of said payment based on at least one of:
a. a stock price growth rate, and
b. discount rates.

208. The method of claim 204, wherein said preparing said remoteness analysis comprises determining the likelihood that said payment will be made given assumptions regarding said contingency being satisfied.

209. The method of claim 208, wherein said determining the likelihood that said payment will be made given assumptions regarding said contingency being satisfied comprises determining the likelihood that said payment will be made given a stock price growth rate and a volatility.

210. The method of claim 152, wherein said attributing a number of said underlying references to said financial instrument comprises attributing a variable number of said underlying references to each unit of said financial instrument.

211. The method of claim 152, wherein said attributing a number of said underlying references to said financial instrument comprises attributing a constant number of said underlying references to each unit of said financial instrument.

212. The method of claim 152, wherein said identifying an underlying reference comprises identifying said underlying reference that said financial instrument converts into.

213. The method of claim 152, wherein said identifying an underlying reference comprises basing an exchange value of said financial instrument on said underlying reference.

214. A financial services method comprising buying a financial instrument created by:
identifying an underlying reference for said financial instrument, said underlying reference having a value;
attributing a number of said underlying references to said financial instrument;
defining a contingency having multiple triggers, a payment becoming due when any one of said triggers drops below a predetermined value.

215. The method of claim 214, wherein said buying said financial instrument comprises buying said financial instrument at a value based on at least one of:
a. said contingency;
b. said value of said underlying reference;
c. value of said payment;
d. length of said predetermined period of delay;
e. volatility in trading value of said underlying reference;
f. time until redemption, at option of issuer or holder;
g. time until maturity;
h. an interest rate; and
i. value for which said financial instrument must be redeemed on redemption date.

216. The method of claim 214, wherein said buying said financial instrument comprises bidding for said financial instrument.

217. The method of claim 214, wherein said buying said financial instrument comprises buying a derivative of said financial instrument.

218. The method of claim 214, wherein said buying said financial instrument comprises buying a part of said financial instrument.

219. The method of claim 214, wherein said defining a contingency comprises basing said contingency on an event related to said financial instrument.

220. The method of claim 214, wherein said defining a contingency comprises basing said contingency on an instrument other than said financial instrument.

221. The method of claim 214, wherein said attributing a number of said underlying references to said financial instrument comprises attributing a variable number of said underlying references to each unit of said financial instrument.

222. The method of claim 214, wherein said attributing a number of said underlying references to said financial instrument comprises attributing a constant number of said underlying references to each unit of said financial instrument.

223. The method of claim 214, wherein said identifying an underlying reference comprises identifying said underlying reference that said financial instrument converts into.

224. The method of claim 214, wherein said identifying an underlying reference comprises basing an exchange value of said financial instrument on said underlying reference.

225. A financial services method associated with a financial instrument said method comprising:
identifying an underlying reference for said financial instrument, said underlying reference having a value;
attributing a number of said underlying references to said financial instrument;
defining a contingency having multiple triggers, a payment becoming due when multiple triggers drop below respective predetermined values.

226. The method of claim 225, further comprising:
establishing a value for said financial instrument.

227. The method of claim 226, further comprising:
selling said financial instrument.

228. The method of claim 227, wherein said selling said financial instrument comprises selling said financial instrument at a value based on at least one of:
a. said contingency;
b. said value of said underlying reference;
c. value of said payment;
d. said predetermined values
e. volatility in trading value of said underlying reference;
f. time until redemption, at option of issuer or holder;
g. time until maturity;
h. an interest rate; and
i. value for which said financial instrument must be redeemed on redemption date.

229. The method of claim 227, wherein said selling said financial instrument comprises auctioning said financial instrument.

230. The method of claim 227, wherein said selling said financial instrument comprises selling a derivative of said financial instrument.

231. The method of claim 227, wherein said selling said financial instrument comprises selling a part of said financial instrument.

232. The method of claim 227, further comprising:
monitoring for satisfaction of said contingency.

233. The method of claim 227, further comprising:
disbursing said payment.

234. The method of claim 227, further comprising:
calculating said payment.

235. The method of claim 226, further comprising:
monitoring for satisfaction of said contingency.

236. The method of claim 235, further comprising:
disbursing said payment.

237. The method of claim 235, further comprising:
calculating said payment.

238. The method of claim 226, further comprising:
disbursing said payment.

239. The method of claim 226, further comprising:
calculating said payment.

240. The method of claim 226, wherein said establishing a value for said financial instrument comprises basing said value for said financial instrument on at least one of:
a. said contingency;
b. said value of said underlying reference;
c. value of said payment;
d. said predetermined values
e. volatility in trading value of said underlying reference;
f. time until redemption, at option of issuer or holder;
g. time until maturity;
h. an interest rate; and
i. value for which said financial instrument must be redeemed on redemption date.

241. The method of claim 225 further comprising:
selling said financial instrument.

242. The method of claim 241, wherein said selling said financial instrument comprises selling said financial instrument at a value based on at least one of:
a. said contingency;
b. said value of said underlying reference;
c. value of said payment;
d. said predetermined values
e. volatility in trading value of said underlying reference;
f. time until redemption, at option of issuer or holder;
g. time until maturity;
h. an interest rate; and
i. value for which said financial instrument must be redeemed on redemption date.

243. The method of claim 241, wherein said selling said financial instrument comprises auctioning said financial instrument.

244. The method of claim 241, wherein said selling said financial instrument comprises selling a derivative of said financial instrument.

245. The method of claim 241, wherein said selling said financial instrument comprises selling a part of said financial instrument.

246. The method of claim 241 further comprising:
monitoring for satisfaction of said contingency.

247. The method of claim 241, further comprising:
disbursing said payment.

248. The method of claim 241, further comprising:
calculating said payment.

249. The method of claim 225 further comprising:
monitoring for satisfaction of said contingency.

250. The method of claim 249, wherein said monitoring for satisfaction comprises comparing market data to said trigger of said contingency.

251. The method of claim 249, wherein said monitoring comprises monitoring over many said contingency monitoring periods.

252. The method of claim 249, wherein said monitoring comprises monitoring realtime data.

253. The method of claim 249, further comprising:
disbursing said payment.

254. The method of claim 249, further comprising:
calculating said payment.

255. The method of claim 225, wherein said defining a contingency having multiple triggers comprises basing said triggers on events related to said financial instrument.

256. The method of claim 225, wherein said defining a contingency having multiple triggers comprises basing said triggers on instruments other than said financial instrument.

257. The method of claim 225, wherein said defining a contingency having multiple triggers comprises setting said triggers at amounts equal to a multiple of prevailing market rates for financial instruments.

258. The method of claim 257, wherein said setting said triggers at amounts equal to a multiple comprises using a multiple equal to 1.

259. The method of claim 257, wherein said setting said triggers at amounts equal to a multiple comprises using a multiple less than 1.

260. The method of claim 257, wherein said setting said triggers at amounts equal to a multiple comprises using a multiple greater than 1.

261. The method of claim 225, wherein said defining a contingency having multiple triggers comprises setting said triggers at amounts equal to multiples of formulae amounts.

262. The method of claim 261, wherein said setting said triggers at amounts equal to a multiple comprises using a multiple equal to 1.

263. The method of claim 261, wherein said setting said triggers at amounts equal to a multiple comprises using a multiple less than 1.

264. The method of claim 261, wherein said setting said triggers at amounts equal to a multiple comprises using a multiple greater than 1.

265. The method of claim 225, wherein said predetermined values comprise predetermined percentages of the conversion value.

266. The method of claim 225, further comprising:
disbursing said payment.

267. The method of claim 266, wherein said disbursing said payment comprises sending a negotiable instrument.

268. The method of claim 225, further comprising:
calculating said payment.

269. The method of claim 268, wherein said calculating said payment comprises establishing a formula for calculating said payment based on said value of said underlying reference.

270. The method of claim 269, wherein said establishing a formula comprises using a fixed rate formula.

271. The method of claim 269, wherein said establishing a formula comprises using a variable rate formula.

272. The method of claim 268, wherein said calculating said payment comprises calculating said payment using a periodic schedule.

273. The method of claim 272, wherein said calculating said payment using a periodic schedule comprises calculating said payment at least once per said contingency monitoring period.

274. The method of claim 272, wherein said calculating said payment using a periodic schedule comprises calculating said payment on a quarterly basis.

275. The method of claim 268, wherein said calculating said payment comprises calculating said payment based upon at least one of:
a. predetermined fixed amount,
b. trading value of said financial instrument,
c. trading yield of said financial instrument,
d. trading yield of a liability of said issuer of said financial instrument,
e. trading value of a liability of said issuer of said financial instrument,
f. trading value of a class of capital stock issued by an issuer other than said issuer of said financial instrument,
g. trading dividend yield of a class of capital stock issued by an issuer other than said issuer of said financial instrument,
h. trading value of a class of capital stock of said issuer of said financial instrument,
i. trading yield of a class of capital stock of said issuer of said financial instrument,
j. trading value of a security,
k. trading yield of a security, and
l. an index.

276. The method of claim 268, wherein said calculating said payment comprises calculating a payment only after a predetermined period of delay.

277. The method of claim 225, further comprising preparing at least one of:
a. a projected payment schedule;
b. an incidental analysis; and
c. a remoteness analysis.

278. The method of claim 277, wherein said preparing said projected payment schedule comprises determining a schedule of said payments based on payments necessary to produce a comparable yield.

279. The method of claim 277, wherein said preparing said incidental analysis comprises determining the amount of said payment based on assumptions regarding said contingency being satisfied.

280. The method of claim 279, wherein said determining the amount of said payment based on assumptions regarding the contingency being satisfied comprises determining the amount of said payment based on at least one of:
a. a stock price growth rate, and
b. discount rates.

281. The method of claim 277, wherein said preparing said remoteness analysis comprises determining the likelihood that said payment will be made given assumptions regarding said contingency being satisfied.

282. The method of claim 281, wherein said determining the likelihood that said payment will be made given assumptions regarding said contingency being satisfied comprises determining the likelihood that said payment will be made given a stock price growth rate and a volatility.

283. The method of claim 225, wherein said attributing a number of said underlying references to said financial instrument comprises attributing a variable number of said underlying references to each unit of said financial instrument.

284. The method of claim 225, wherein said attributing a number of said underlying references to said financial instrument comprises attributing a constant number of said underlying references to each unit of said financial instrument.

285. The method of claim 225, wherein said identifying an underlying reference comprises identifying said underlying reference that said financial instrument converts into.

286. The method of claim 225, wherein said identifying an underlying reference comprises basing an exchange value of said financial instrument on said underlying reference.

287. A financial services method comprising buying a financial instrument created by:
identifying an underlying reference for said financial instrument, said underlying reference having a value;
attributing a number of said underlying references to said financial instrument;
defining a contingency having multiple triggers, a payment becoming due when multiple triggers drop below respective predetermined values.

288. The method of claim 287, wherein said buying said financial instrument comprises buying said financial instrument at a value based on at least one of:
a. said contingency;
b. said value of said underlying reference;
c. value of said payment;
d. length of said predetermined period of delay;
e. volatility in trading value of said underlying reference;
f. time until redemption, at option of issuer or holder;
g. time until maturity;
h. an interest rate; and
i. value for which said financial instrument must be redeemed on redemption date.

289. The method of claim 287, wherein said buying said financial instrument comprises bidding for said financial instrument.

290. The method of claim 287, wherein said buying said financial instrument comprises buying a derivative of said financial instrument.

291. The method of claim 287, wherein said buying said financial instrument comprises buying a part of said financial instrument.

292. The method of claim 287, wherein said defining a contingency comprises basing said contingency on an event related to said financial instrument.

293. The method of claim 287, wherein said defining a contingency comprises basing said contingency on an instrument other than said financial instrument.

294. The method of claim 287, wherein said attributing a number of said underlying references to said financial instrument comprises attributing a variable number of said underlying references to each unit of said financial instrument.

295. The method of claim 287, wherein said attributing a number of said underlying references to said financial instrument comprises attributing a constant number of said underlying references to each unit of said financial instrument.

296. The method of claim 287, wherein said identifying an underlying reference comprises identifying said underlying reference that said financial instrument converts into.

297. The method of claim 287, wherein said identifying an underlying reference comprises basing an exchange value of said financial instrument on said underlying reference.

298. A financial services method associated with a financial instrument said method comprising:
identifying an underlying reference for said financial instrument, said underlying reference having a value;
attributing a number of said underlying references to said financial instrument;
defining multiple contingencies each having at least one trigger, a payment becoming due when any said trigger of any of said contingencies drops below a predetermined value.

299. The method of claim 298, further comprising:
establishing a value for said financial instrument.

300. The method of claim 299, further comprising:
selling said financial instrument.

301. The method of claim 300, wherein said selling said financial instrument comprises selling said financial instrument at a value based on at least one of:
a. said contingency;
b. said value of said underlying reference;
c. value of said payment;
d. said predetermined value;
e. volatility in trading value of said underlying reference;
f. time until redemption, at option of issuer or holder;
g. time until maturity;
h. an interest rate; and
i. value for which said financial instrument must be redeemed on redemption date.

302. The method of claim 300, wherein said selling said financial instrument comprises auctioning said financial instrument.

303. The method of claim 300, wherein said selling said financial instrument comprises selling a derivative of said financial instrument.

304. The method of claim 300, wherein said selling said financial instrument comprises selling a part of said financial instrument.

305. The method of claim 300, further comprising:
monitoring for satisfaction of said contingency.

306. The method of claim 300, further comprising:
disbursing said payment.

307. The method of claim 300, further comprising:
calculating said payment.

308. The method of claim 299, further comprising:
monitoring for satisfaction of said contingency.

309. The method of claim 308, further comprising:
disbursing said payment.

310. The method of claim 308, further comprising:
calculating said payment.

311. The method of claim 299, further comprising:
disbursing said payment.

312. The method of claim 299, further comprising:
calculating said payment.

313. The method of claim 299, wherein said establishing a value for said financial instrument comprises basing said value for said financial instrument on at least one of:
a. said contingency;
b. said value of said underlying reference;
c. value of said payment;
d. said predetermined value;
e. volatility in trading value of said underlying reference;
f. time until redemption, at option of issuer or holder;
g. time until maturity;
h. an interest rate; and
i. value for which said financial instrument must be redeemed on redemption date.

314. The method of claim 298 further comprising:
selling said financial instrument.

315. The method of claim 314, wherein said selling said financial instrument comprises selling said financial instrument at a value based on at least one of:
a. said contingency;
b. said value of said underlying reference;
c. value of said payment;
d. said predetermined value;
e. volatility in trading value of said underlying reference;
f. time until redemption, at option of issuer or holder;
g. time until maturity;
h. an interest rate; and
i. value for which said financial instrument must be redeemed on redemption date.

316. The method of claim 314, wherein said selling said financial instrument comprises auctioning said financial instrument.

317. The method of claim 314, wherein said selling said financial instrument comprises selling a derivative of said financial instrument.

318. The method of claim 314, wherein said selling said financial instrument comprises selling a part of said financial instrument.

319. The method of claim 314, further comprising:
monitoring for satisfaction of said contingency.

320. The method of claim 314, further comprising:
disbursing said payment.

321. The method of claim 314, further comprising:
calculating said payment.

322. The method of claim 298 further comprising:
monitoring for satisfaction of said contingency.

323. The method of claim 322, wherein said monitoring for satisfaction comprises comparing market data to said trigger of said contingency.

324. The method of claim 322, wherein said monitoring comprises monitoring over many said contingency monitoring periods.

325. The method of claim 322, wherein said monitoring comprises monitoring realtime data.

326. The method of claim 322, further comprising:
disbursing said payment.

327. The method of claim 322, further comprising:
calculating said payment.

328. The method of claim 298, wherein said defining a contingency having at least one trigger comprises basing said trigger on an event related to said financial instrument.

329. The method of claim 298, wherein said defining multiple contingencies each having at least one trigger comprises basing said trigger on an instrument other than said financial instrument.

330. The method of claim 298, wherein said defining multiple contingencies each having at least one trigger comprises setting said trigger at an amount equal to a multiple of a prevailing market rate for a financial instrument.

331. The method of claim 330, wherein said setting said trigger at an amount equal to a multiple comprises using a multiple equal to 1.

332. The method of claim 330, wherein said setting said trigger at an amount equal to a multiple comprises using a multiple less than 1.

333. The method of claim 330, wherein said setting said trigger at an amount equal to a multiple comprises using a multiple greater than 1.

334. The method of claim 298, wherein said defining multiple contingencies each having at least one trigger comprises setting said trigger at an amount equal to a multiple of a formula amount.

335. The method of claim 334, wherein said setting said trigger at an amount equal to a multiple comprises using a multiple equal to 1.

336. The method of claim 334, wherein said setting said trigger at an amount equal to a multiple comprises using a multiple less than 1.

337. The method of claim 334, wherein said setting said trigger at an amount equal to a multiple comprises using a multiple greater than 1.

338. The method of claim 298, wherein said predetermined value comprises a predetermined percentage of the conversion value.

339. The method of claim 298, further comprising:
disbursing said payment.

340. The method of claim 339, wherein said disbursing said payment comprises sending a negotiable instrument.

341. The method of claim 298, further comprising:
calculating said payment.

342. The method of claim 341, wherein said calculating said payment comprises establishing a formula for calculating said payment based on said value of said underlying reference.

343. The method of claim 342, wherein said establishing a formula comprises using a fixed rate formula.

344. The method of claim 342, wherein said establishing a formula comprises using a variable rate formula.

345. The method of claim 341, wherein said calculating said payment comprises calculating said payment using a periodic schedule.

346. The method of claim 345, wherein said calculating said payment using a periodic schedule comprises calculating said payment at least once per said contingency monitoring period.

347. The method of claim 345, wherein said calculating said payment using a periodic schedule comprises calculating said payment on a quarterly basis.

348. The method of claim 341, wherein said calculating said payment comprises calculating said payment based upon at least one of:
a. predetermined fixed amount,
b. trading value of said financial instrument,
c. trading yield of said financial instrument,
d. trading yield of a liability of said issuer of said financial instrument,
e. trading value of a liability of said issuer of said financial instrument,
f. trading value of a class of capital stock issued by an issuer other than said issuer of said financial instrument,
g. trading dividend yield of a class of capital stock issued by an issuer other than said issuer of said financial instrument,
h. trading value of a class of capital stock of said issuer of said financial instrument,
i. trading yield of a class of capital stock of said issuer of said financial instrument,
j. trading value of a security,
k. trading yield of a security, and
1. an index.

349. The method of claim 341, wherein said calculating said payment comprises calculating a payment only after a predetermined period of delay.

350. The method of claim 298, further comprising preparing at least one of:
a. a projected payment schedule;
b. an incidental analysis; and
c. a remoteness analysis.

351. The method of claim 350, wherein said preparing said projected payment schedule comprises determining a schedule of said payments based on payments necessary to produce a comparable yield.

352. The method of claim 350, wherein said preparing said incidental analysis comprises determining the amount of said payment based on assumptions regarding said contingency being satisfied.

353. The method of claim 352, wherein said determining the amount of said payment based on assumptions regarding the contingency being satisfied comprises determining the amount of said payment based on at least one of:
a. a stock price growth rate, and
b. discount rates.

354. The method of claim 350, wherein said preparing said remoteness analysis comprises determining the likelihood that said payment will be made given assumptions regarding said contingency being satisfied.

355. The method of claim 354, wherein said determining the likelihood that said payment will be made given assumptions regarding said contingency being satisfied comprises determining the likelihood that said payment will be made given a stock price growth rate and a volatility.

356. The method of claim 298, wherein said attributing a number of said underlying references to said financial instrument comprises attributing a variable number of said underlying references to each unit of said financial instrument.

357. The method of claim 298, wherein said attributing a number of said underlying references to said financial instrument comprises attributing a constant number of said underlying references to each unit of said financial instrument.

358. The method of claim 298, wherein said identifying an underlying reference comprises identifying said underlying reference that said financial instrument converts into.

359. The method of claim 298, wherein said identifying an underlying reference comprises basing an exchange value of said financial instrument on said underlying reference.

360. A financial services method comprising buying a financial instrument created by:
identifying an underlying reference for said financial instrument, said underlying reference having a value;
attributing a number of said underlying references to said financial instrument;
defining multiple contingencies each having at least one trigger, a payment becoming due when any said trigger of any of said contingencies drops below a predetermined value.

361. The method of claim 360, wherein said buying said financial instrument comprises buying said financial instrument at a value based on at least one of:
a. said contingency;
b. said value of said underlying reference;
c. value of said payment;
d. length of said predetermined period of delay;
e. volatility in trading value of said underlying reference;
f. time until redemption, at option of issuer or holder;
g. time until maturity;
h. an interest rate; and
i. value for which said financial instrument must be redeemed on redemption date.

362. The method of claim 360, wherein said buying said financial instrument comprises bidding for said financial instrument.

363. The method of claim 360, wherein said buying said financial instrument comprises buying a derivative of said financial instrument.

364. The method of claim 360, wherein said buying said financial instrument comprises buying a part of said financial instrument.

365. The method of claim 360, wherein said defining multiple contingencies comprises basing said multiple contingencies on events related to said financial instrument.

366. The method of claim 360, wherein said defining multiple contingencies comprises basing said multiple contingencies on instruments other than said financial instrument.

367. The method of claim 360, wherein said attributing a number of said underlying references to said financial instrument comprises attributing a variable number of said underlying references to each unit of said financial instrument.

368. The method of claim 360, wherein said attributing a number of said underlying references to said financial instrument comprises attributing a constant number of said underlying references to each unit of said financial instrument.

369. The method of claim 360, wherein said identifying an underlying reference comprises identifying said underlying reference that said financial instrument converts into.

370. The method of claim 360, wherein said identifying an underlying reference comprises basing an exchange value of said financial instrument on said underlying reference.

371. A financial services method associated with a financial instrument said method comprising:
identifying an underlying reference for said financial instrument, said underlying reference having a value;
attributing a number of said underlying references to said financial instrument;
defining multiple contingencies each with multiple triggers, a payment becoming due when one of said multiple triggers of any of said contingencies drops below a predetermined value.

372. The method of claim 371, further comprising:
establishing a value for said financial instrument.

373. The method of claim 372, further comprising:
selling said financial instrument.

374. The method of claim 373, wherein said selling said financial instrument comprises selling said financial instrument at a value based on at least one of:
a. said contingency;
b. said value of said underlying reference;
c. value of said payment;
d. said predetermined value;
e. volatility in trading value of said underlying reference;
f. time until redemption, at option of issuer or holder;
g. time until maturity;
h. an interest rate; and
i. value for which said financial instrument must be redeemed on redemption date.

375. The method of claim 373, wherein said selling said financial instrument comprises auctioning said financial instrument.

376. The method of claim 373, wherein said selling said financial instrument comprises selling a derivative of said financial instrument.

377. The method of claim 373, wherein said selling said financial instrument comprises selling a part of said financial instrument.

378. The method of claim 373, further comprising:
monitoring for satisfaction of said contingency.

379. The method of claim 373, further comprising:
disbursing said payment.

380. The method of claim 373, further comprising:
calculating said payment.

381. The method of claim 372, further comprising:
monitoring for satisfaction of said contingency.

382. The method of claim 381, further comprising:
disbursing said payment.

383. The method of claim 381, further comprising:
calculating said payment.

384. The method of claim 372, further comprising:
disbursing said payment.

385. The method of claim 372, further comprising:
calculating said payment.

386. The method of claim 372, wherein said establishing a value for said financial instrument comprises basing said value for said financial instrument on at least one of:
a. said contingency;
b. said value of said underlying reference;
c. value of said payment;
d. said predetermined value;
e. volatility in trading value of said underlying reference;
f. time until redemption, at option of issuer or holder;
g. time until maturity;
h. an interest rate; and
i. value for which said financial instrument must be redeemed on redemption date.

387. The method of claim 371 further comprising:
selling said financial instrument.

388. The method of claim 387, wherein said selling said financial instrument comprises selling said financial instrument at a value based on at least one of:
a. said contingency;
b. said value of said underlying reference;
c. value of said payment;
d. said predetermined value;
e. volatility in trading value of said underlying reference;
f. time until redemption, at option of issuer or holder;
g. time until maturity;
h. an interest rate; and
i. value for which said financial instrument must be redeemed on redemption date.

389. The method of claim 387, wherein said selling said financial instrument comprises auctioning said financial instrument.

390. The method of claim 387, wherein said selling said financial instrument comprises selling a derivative of said financial instrument.

391. The method of claim 387, wherein said selling said financial instrument comprises selling a part of said financial instrument.

392. The method of claim 387 further comprising:
monitoring for satisfaction of said contingency.

393. The method of claim 387, further comprising:
disbursing said payment.

394. The method of claim 387, further comprising:
calculating said payment.

395. The method of claim 371 further comprising:
monitoring for satisfaction of said contingency.

396. The method of claim 395, wherein said monitoring for satisfaction comprises comparing market data to said trigger of said contingency.

397. The method of claim 395, wherein said monitoring comprises monitoring over many said contingency monitoring periods.

398. The method of claim 395, wherein said monitoring comprises monitoring realtime data.

399. The method of claim 395, further comprising:
disbursing said payment.

400. The method of claim 395, further comprising:
calculating said payment.

401. The method of claim 371, wherein said defining multiple contingencies each with multiple triggers comprises basing said triggers on events related to said financial instrument.

402. The method of claim 371, wherein said defining multiple contingencies each with multiple triggers comprises basing said triggers on instruments other than said financial instrument.

403. The method of claim 371, wherein said defining multiple contingencies each with multiple triggers comprises setting said triggers at amounts equal to a multiple of prevailing market rates for financial instruments.

404. The method of claim 403, wherein said setting said triggers at amounts equal to a multiple comprises using a multiple equal to 1.

405. The method of claim 403, wherein said setting said triggers at amounts equal to a multiple comprises using a multiple less than 1.

406. The method of claim 403, wherein said setting said triggers at amounts equal to a multiple comprises using a multiple greater than 1.

407. The method of claim 371, wherein said defining multiple contingencies each with multiple triggers comprises setting said triggers at amounts equal to a multiple of formulae amounts.

408. The method of claim 407, wherein said setting said triggers at amounts equal to a multiple comprises using a multiple equal to 1.

409. The method of claim 407, wherein said setting said trigger at an amount equal to a multiple comprises using a multiple less than 1.

410. The method of claim 407, wherein said setting said trigger at an amount equal to a multiple comprises using a multiple greater than 1.

411. The method of claim 371, wherein said predetermined value comprises a predetermined percentage of the conversion value.

412. The method of claim 371, further comprising:
disbursing said payment.

413. The method of claim 412, wherein said disbursing said payment comprises sending a negotiable instrument.

414. The method of claim 371, further comprising:
calculating said payment.

415. The method of claim 414, wherein said calculating said payment comprises establishing a formula for calculating said payment based on said value of said underlying reference.

416. The method of claim 415, wherein said establishing a formula comprises using a fixed rate formula.

417. The method of claim 415, wherein said establishing a formula comprises using a variable rate formula.

418. The method of claim 414, wherein said calculating said payment comprises calculating said payment using a periodic schedule.

419. The method of claim 418, wherein said calculating said payment using a periodic schedule comprises calculating said payment at least once per said contingency monitoring period.

420. The method of claim 418, wherein said calculating said payment using a periodic schedule comprises calculating said payment on a quarterly basis.

421. The method of claim 414, wherein said calculating said payment comprises calculating said payment based upon at least one of:
a. predetermined fixed amount,
b. trading value of said financial instrument,
c. trading yield of said financial instrument,
d. trading yield of a liability of said issuer of said financial instrument,
e. trading value of a liability of said issuer of said financial instrument,
f. trading value of a class of capital stock issued by an issuer other than said issuer of said financial instrument,
g. trading dividend yield of a class of capital stock issued by an issuer other than said issuer of said financial instrument,
h. trading value of a class of capital stock of said issuer of said financial instrument,
i. trading yield of a class of capital stock of said issuer of said financial instrument,
j. trading value of a security,
k. trading yield of a security, and
l. an index.

422. The method of claim 414, wherein said calculating said payment comprises calculating a payment only after a predetermined period of delay.

423. The method of claim 371, further comprising preparing at least one of:
a. a projected payment schedule;
b. an incidental analysis; and
c. a remoteness analysis.

424. The method of claim 423, wherein said preparing said projected payment schedule comprises determining at least one of:
a. stock price growth rate;
b. dividend yield;
c. formula determining said payment; and
d. a schedule of said payments based on payments necessary to produce a comparable yield.

425. The method of claim 423, wherein said preparing said incidental analysis comprises determining the amount of said payment based on assumptions regarding said contingency being satisfied.

426. The method of claim 425, wherein said determining the amount of said payment based on assumptions regarding the contingency being satisfied comprises determining the amount of said payment based on at least one of:
a. a stock price growth rate, and
b. discount rates.

427. The method of claim 423, wherein said preparing said remoteness analysis comprises determining the likelihood that said payment will be made given assumptions regarding said contingency being satisfied.

428. The method of claim 427, wherein said determining the likelihood that said payment will be made given assumptions regarding said contingency being satisfied comprises determining the likelihood that said payment will be made given a stock price growth rate and a volatility.

429. The method of claim 371, wherein said attributing a number of said underlying references to said financial instrument comprises attributing a variable number of said underlying references to each unit of said financial instrument.

430. The method of claim 371, wherein said attributing a number of said underlying references to said financial instrument comprises attributing a constant number of said underlying references to each unit of said financial instrument.

431. The method of claim 371, wherein said identifying an underlying reference comprises identifying said underlying reference that said financial instrument converts into.

432. The method of claim 371, wherein said identifying an underlying reference comprises basing an exchange value of said financial instrument on said underlying reference.

433. A financial services method comprising buying a financial instrument created by:
identifying an underlying reference for said financial instrument, said underlying reference having a value;
attributing a number of said underlying references to said financial instrument;
defining multiple contingencies each with multiple triggers, a payment becoming due when one of said multiple triggers of any of said contingencies drops below a predetermined value.

434. The method of claim 433, wherein said buying said financial instrument comprises buying said financial instrument at a value based on at least one of
a. said contingency;
b. said value of said underlying reference;
c. value of said payment;
d. length of said predetermined period of delay;
e. volatility in trading value of said underlying reference;
f. time until redemption, at option of issuer or holder;
g. time until maturity;
h. an interest rate; and
i. value for which said financial instrument must be redeemed on redemption date.

435. The method of claim 433, wherein said buying said financial instrument comprises bidding for said financial instrument.

436. The method of claim 433, wherein said buying said financial instrument comprises buying a derivative of said financial instrument.

437. The method of claim 433, wherein said buying said financial instrument comprises buying a part of said financial instrument.

438. The method of claim 433, wherein said defining multiple contingencies comprises basing said multiple contingencies on events related to said financial instrument.

439. The method of claim 433, wherein said defining multiple contingencies comprises basing said multiple contingencies on instruments other than said financial instrument.

440. The method of claim 433, wherein said attributing a number of said underlying references to said financial instrument comprises attributing a variable number of said underlying references to each unit of said financial instrument.

441. The method of claim 433, wherein said attributing a number of said underlying references to said financial instrument comprises attributing a constant number of said underlying references to each unit of said financial instrument.

442. The method of claim 433, wherein said identifying an underlying reference comprises identifying said underlying reference that said financial instrument converts into.

443. The method of claim 433, wherein said identifying an underlying reference comprises basing an exchange value of said financial instrument on said underlying reference.

444. A financial services method associated with a financial instrument said method comprising:
identifying an underlying reference for said financial instrument, said underlying reference having a value;
attributing a number of said underlying references to said financial instrument;
defining multiple contingencies having multiple triggers, a payment becoming due when at least two of said multiple triggers drop below respective predetermined values, at least one of said at least two triggers being a trigger of a different contingency from any other of said at least two triggers.

445. The method of claim 444, further comprising:
establishing a value for said financial instrument.

446. The method of claim 445, further comprising:
selling said financial instrument.

447. The method of claim 446, wherein said selling said financial instrument comprises selling said financial instrument at a value based on at least one of:
a. said contingency;
b. said value of said underlying reference;
c. value of said payment;
d. said predetermined values
e. volatility in trading value of said underlying reference;
f. time until redemption, at option of issuer or holder;
g. time until maturity;
h. an interest rate; and
i. value for which said financial instrument must be redeemed on redemption date.

448. The method of claim 446, wherein said selling said financial instrument comprises auctioning said financial instrument.

449. The method of claim 446, wherein said selling said financial instrument comprises selling a derivative of said financial instrument.

450. The method of claim 446, wherein said selling said financial instrument comprises selling a part of said financial instrument.

451. The method of claim 446, further comprising:
monitoring for satisfaction of said contingency.

452. The method of claim 446, further comprising:
disbursing said payment.

453. The method of claim 446, further comprising:
calculating said payment.

454. The method of claim 445, further comprising:
monitoring for satisfaction of said contingency.

455. The method of claim 454, further comprising:
disbursing said payment.

456. The method of claim 454, further comprising:
calculating said payment.

457. The method of claim 445, further comprising:
disbursing said payment.

458. The method of claim 445, further comprising:
calculating said payment.

459. The method of claim 445, wherein said establishing a value for said financial instrument comprises basing said value for said financial instrument on at least one of:
a. said contingency;
b. said value of said underlying reference;
c. value of said payment;
d. said predetermined values;
e. volatility in trading value of said underlying reference;
f. time until redemption, at option of issuer or holder;
g. time until maturity;
h. an interest rate; and
i. value for which said financial instrument must be redeemed on redemption date.

460. The method of claim 444 further comprising:
selling said financial instrument.

461. The method of claim 460, wherein said selling said financial instrument comprises selling said financial instrument at a value based on at least one of:
a. said contingency;
b. said value of said underlying reference;
c. value of said payment;
d. said predetermined values;
e. volatility in trading value of said underlying reference;
f. time until redemption, at option of issuer or holder;
g. time until maturity;
h. an interest rate; and
i. value for which said financial instrument must be redeemed on redemption date.

462. The method of claim 460, wherein said selling said financial instrument comprises auctioning said financial instrument.

463. The method of claim 460, wherein said selling said financial instrument comprises selling a derivative of said financial instrument.

464. The method of claim 460, wherein said selling said financial instrument comprises selling a part of said financial instrument.

465. The method of claim 460 further comprising:
monitoring for satisfaction of said contingency.

466. The method of claim 460, further comprising:
disbursing said payment.

467. The method of claim 460, further comprising:
calculating said payment.

468. The method of claim 444 further comprising:
monitoring for satisfaction of said contingency.

469. The method of claim 468, wherein said monitoring for satisfaction comprises comparing market data to said trigger of said contingency.

470. The method of claim 468, wherein said monitoring comprises monitoring over many said contingency monitoring periods.

471. The method of claim 468, wherein said monitoring comprises monitoring realtime data.

472. The method of claim 468, further comprising:
disbursing said payment.

473. The method of claim 468, further comprising:
calculating said payment.

474. The method of claim 444, wherein said defining multiple contingencies having multiple triggers comprises basing said triggers on events related to said financial instrument.

475. The method of claim 444, wherein said defining multiple contingencies having multiple triggers comprises basing said triggers on instruments other than said financial instrument.

476. The method of claim 444, wherein said defining multiple contingencies having multiple triggers comprises setting said triggers at amounts equal to a multiple of prevailing market rates for financial instruments.

477. The method of claim 476, wherein said setting said triggers at amounts equal to a multiple comprises using a multiple equal to 1.

478. The method of claim 476, wherein said setting said triggers at amounts equal to a multiple comprises using a multiple less than 1.

479. The method of claim 476, wherein said setting said triggers at amounts equal to a multiple comprises using a multiple greater than 1.

480. The method of claim 444, wherein said defining multiple contingencies having multiple triggers comprises setting said triggers at amounts equal to a multiple of formulae amounts.

481. The method of claim 480, wherein said setting said triggers at amounts equal to a multiple comprises using a multiple equal to 1.

482. The method of claim 480, wherein said setting said triggers at amounts equal to a multiple comprises using a multiple less than 1.

483. The method of claim 480, wherein said setting said triggers at amounts equal to a multiple comprises using a multiple greater than 1.

484. The method of claim 444, wherein said predetermined values comprise predetermined percentages of the conversion value.

485. The method of claim 444, further comprising:
disbursing said payment.

486. The method of claim 485, wherein said disbursing said payment comprises sending a negotiable instrument.

487. The method of claim 444, further comprising:
calculating said payment.

488. The method of claim 487, wherein said calculating said payment comprises establishing a formula for calculating said payment based on said value of said underlying reference.

489. The method of claim 488, wherein said establishing a formula comprises using a fixed rate formula.

490. The method of claim 488, wherein said establishing a formula comprises using a variable rate formula.

491. The method of claim 487, wherein said calculating said payment comprises calculating said payment using a periodic schedule.

492. The method of claim 491, wherein said calculating said payment using a periodic schedule comprises calculating said payment at least once per said contingency monitoring period.

493. The method of claim 491, wherein said calculating said payment using a periodic schedule comprises calculating said payment on a quarterly basis.

494. The method of claim 487, wherein said calculating said payment comprises calculating said payment based upon at least one of:
a. predetermined fixed amount,
b. trading value of said financial instrument,
c. trading yield of said financial instrument,
d. trading yield of a liability of said issuer of said financial instrument,
e. trading value of a liability of said issuer of said financial instrument,
f. trading value of a class of capital stock issued by an issuer other than said issuer of said financial instrument,
g. trading dividend yield of a class of capital stock issued by an issuer other than said issuer of said financial instrument,
h. trading value of a class of capital stock of said issuer of said financial instrument,
i. trading yield of a class of capital stock of said issuer of said financial instrument,
j. trading value of a security,
k. trading yield of a security, and
l. an index.

495. The method of claim 487, wherein said calculating said payment comprises calculating a payment only after a predetermined period of delay.

496. The method of claim 444, further comprising preparing at least one of:
a. a projected payment schedule;
b. an incidental analysis; and
c. a remoteness analysis.

497. The method of claim 496, wherein said preparing said projected payment schedule comprises determining a schedule of said payments based on payments necessary to produce a comparable yield.

498. The method of claim 496, wherein said preparing said incidental analysis comprises determining the amount of said payment based on assumptions regarding said contingency being satisfied.

499. The method of claim 498, wherein said determining the amount of said payment based on assumptions regarding the contingency being satisfied comprises determining the amount of said payment based on at least one of:
a. a stock price growth rate, and
b. discount rates.

500. The method of claim 496, wherein said preparing said remoteness analysis comprises determining the likelihood that said payment will be made given assumptions regarding said contingency being satisfied.

501. The method of claim 500, wherein said determining the likelihood that said payment will be made given assumptions regarding said contingency being satisfied comprises determining the likelihood that said payment will be made given a stock price growth rate and a volatility.

502. The method of claim 444, wherein said attributing a number of said underlying references to said financial instrument comprises attributing a variable number of said underlying references to each unit of said financial instrument.

503. The method of claim 444, wherein said attributing a number of said underlying references to said financial instrument comprises attributing a constant number of said underlying references to each unit of said financial instrument.

504. The method of claim 444, wherein said identifying an underlying reference comprises identifying said underlying reference that said financial instrument converts into.

505. The method of claim 444, wherein said identifying an underlying reference comprises basing an exchange value of said financial instrument on said underlying reference.

506. A financial services method comprising buying a financial instrument created by:
identifying an underlying reference for said financial instrument, said underlying reference having a value;
attributing a number of said underlying references to said financial instrument;
defining multiple contingencies having multiple triggers, a payment becoming due when at least two of said multiple triggers drop below respective predetermined values, at least one of said at least two triggers being a trigger of a different contingency from any other of said at least two triggers.

507. The method of claim 506, wherein said buying said financial instrument comprises buying said financial instrument at a value based on at least one of:
a. said contingency;
b. said value of said underlying reference;
c. value of said payment;
d. length of said predetermined period of delay;
e. volatility in trading value of said underlying reference;
f. time until redemption, at option of issuer or holder;
g. time until maturity;
h. an interest rate; and
i. value for which said financial instrument must be redeemed on redemption date.

508. The method of claim 506, wherein said buying said financial instrument comprises bidding for said financial instrument.

509. The method of claim 506, wherein said buying said financial instrument comprises buying a derivative of said financial instrument.

510. The method of claim 506, wherein said buying said financial instrument comprises buying a part of said financial instrument.

511. The method of claim 506, wherein said defining multiple contingencies comprises basing said multiple contingencies on events related to said financial instrument.

512. The method of claim 506, wherein said defining multiple contingencies comprises basing said multiple contingencies on instruments other than said financial instrument.

513. The method of claim 506, wherein said attributing a number of said underlying references to said financial instrument comprises attributing a variable number of said underlying references to each unit of said financial instrument.

514. The method of claim 506, wherein said attributing a number of said underlying references to said financial instrument comprises attributing a constant number of said underlying references to each unit of said financial instrument.

515. The method of claim 506, wherein said identifying an underlying reference comprises identifying said underlying reference that said financial instrument converts into.

516. The method of claim 506, wherein said identifying an underlying reference comprises basing an exchange value of said financial instrument on said underlying reference.

517. A financial services method associated with a financial instrument, said financial instrument having an issuer, said method comprising:
identifying an underlying reference for said financial instrument, said underlying reference having a value;
attributing a number of said underlying references to said financial instrument;
defining a contingency, said contingency having a trigger based upon at least one of:
a. trading value of said financial instrument,
b. trading yield of said financial instrument,
c. dividend yield of said underlying reference,
d. trading yield of a liability of said issuer of said financial instrument,
e. trading value of a liability of said issuer of said financial instrument,
f. trading value of a class of capital stock other than said underlying reference,
g. trading dividend yield of a class of capital stock issued by an issuer other than said issuer of said financial instrument,
h. trading value of a class of capital stock of said issuer of said financial instrument other than common stock,
i. trading yield of a class of capital stock of said issuer of said financial instrument,
j. trading value of a security issued by an issuer other than said issuer of said financial instrument,
k. trading yield of a security,
l. an index; wherein:
a payment becomes due on occurrence of said contingency.

518. The method of claim 517, further comprising:
establishing a value for said financial instrument.

519. The method of claim 518 further comprising:
selling said financial instrument.

520. The method of claim 519, wherein said selling said financial instrument comprises selling said financial instrument at a value based on at least one of:
a. said contingency;
b. said value of said underlying reference;
C. value of said payment;
d. volatility in trading value of said underlying reference;
e. time until redemption, at option of issuer or holder;
f. time until maturity;
g. an interest rate; and
h. value for which said financial instrument must be redeemed on redemption date.

521. The method of claim 519, wherein said selling said financial instrument comprises auctioning said financial instrument.

522. The method of claim 519, wherein said selling said financial instrument comprises selling a derivative of said financial instrument.

523. The method of claim 519, wherein said selling said financial instrument comprises selling a part of said financial instrument.

524. The method of claim 519 further comprising:
monitoring for satisfaction of said contingency.

525. The method of claim 519, further comprising:
disbursing said payment.

526. The method of claim 519, further comprising:
calculating said payment.

527. The method of claim 518, further comprising:
monitoring for satisfaction of said contingency.

528. The method of claim 527, further comprising:
disbursing said payment.

529. The method of claim 527, further comprising:
calculating said payment.

530. The method of claim 518, further comprising:
disbursing said payment.

531. The method of claim 518, further comprising:
calculating said payment.

532. The method of claim 518, wherein said establishing a value for said financial instrument comprises basing said value for said financial instrument on at least one of:
a. said contingency;
b. said value of said underlying reference;
c. value of said payment;
d. volatility in trading value of said underlying reference;
e. time until redemption, at option of issuer or holder;
f. time until maturity;
g. an interest rate; and
h. value for which said financial instrument must be redeemed on redemption date.

533. The method of claim 517 further comprising:
selling said financial instrument.

534. The method of claim 533, wherein said selling said financial instrument comprises selling said financial instrument at a value based on at least one of:
a. said contingency;
b. said value of said underlying reference;
c. value of said payment;
d. volatility in trading value of said underlying reference;
e. time until redemption, at option of issuer or holder;
f. time until maturity;
g. an interest rate; and
h. value for which said financial instrument must be redeemed on redemption date.

535. The method of claim 533, wherein said selling said financial instrument comprises auctioning said financial instrument.

536. The method of claim 533, wherein said selling said financial instrument comprises selling a derivative of said financial instrument.

537. The method of claim 533, wherein said selling said financial instrument comprises selling a part of said financial instrument.

538. The method of claim 533 further comprising:
monitoring for satisfaction of said contingency.

539. The method of claim 533, further comprising:
disbursing said payment.

540. The method of claim 533, further comprising:
calculating said payment.

541. The method of claim 517 further comprising:
monitoring for satisfaction of said contingency.

542. The method of claim 541, wherein said monitoring for satisfaction comprises comparing market data to requirements of said contingency within at least one contingency monitoring period.

543. The method of claim 541, wherein said monitoring comprises monitoring over many contingency monitoring periods.

544. The method of claim 541, wherein said monitoring comprises monitoring realtime data.

545. The method of claim 541, further comprising:
disbursing said payment.

546. The method of claim 541, further comprising:
calculating said payment.

547. The method of claim 517, wherein said defining a contingency comprises establishing at least one of:
a. a contingency having at least one trigger, and
b. multiple contingencies having at least one trigger.

548. The method of claim 547, wherein said establishing at least one trigger comprises setting said trigger at an amount equal to a multiple of a formula amount.

549. The method of claim 548, wherein said setting said trigger at an amount equal to a multiple comprises using a multiple equal to 1.

550. The method of claim 548, wherein said setting said trigger at an amount equal to a multiple comprises using a multiple less than 1.

551. The method of claim 548, wherein said setting said trigger at an amount equal to a multiple comprises using a multiple greater than 1.

552. The method of claim 517, further comprising:
disbursing said payment.

553. The method of claim 552, wherein said disbursing said payment comprises sending a negotiable instrument.

554. The method of claim 517, further comprising:
calculating said payment.

555. The method of claim 554, wherein said calculating said payment comprises establishing a formula for calculating said payment based on said value of said underlying reference.

556. The method of claim 555, wherein said establishing a formula comprises using a fixed rate formula.

557. The method of claim 555, wherein said establishing a formula comprises using a variable rate formula.

558. The method of claim 554, wherein said calculating said payment comprises calculating said payment using a periodic schedule.

559. The method of claim 558, wherein said calculating said payment using a periodic schedule comprises calculating said payment at least once per said contingency monitoring period.

560. The method of claim 558, wherein said calculating said payment using a periodic schedule comprises calculating said payment on a quarterly basis.

561. The method of claim 554, wherein said calculating said payment comprises calculating said payment based upon at least one of:
a. predetermined fixed amount,
b. trading value of said financial instrument,
c. trading yield of said financial instrument,
d. trading yield of a liability of said issuer of said financial instrument,
e. trading value of a liability of said issuer of said financial instrument,
f. trading value of a class of capital stock issued by an issuer other than said issuer of said financial instrument,
g. trading dividend yield of a class of capital stock issued by an issuer other than said issuer of said financial instrument,
trading value of a class of capital stock of said issuer of said financial instrument,
i. trading yield of a class of capital stock of said issuer of said financial instrument,
j. trading value of a security,
k. trading yield of a security, and
l. an index.

562. The method of claim 554, wherein said calculating payment comprise calculating payment only after a predetermined period of delay.

563. The method of claim 517, further comprising preparing at least one of:
a. a projected payment schedule;
b. an incidental analysis; and
c. a remoteness analysis.

564. The method of claim 563, wherein said preparing said projected payment schedule comprises determining a schedule of said payments based on payments necessary to produce a comparable yield.

565. The method of claim 563, wherein said preparing said incidental analysis comprises determining the amount of said payment based on assumptions regarding said contingency being satisfied.

566. The method of claim 565, wherein said determining the amount of said payment based on assumptions regarding the contingency being satisfied comprises determining the amount of said payment based on at least one of:
a. a stock price growth rate, and
b. discount rates.

567. The method of claim 563, wherein said preparing said remoteness analysis comprises determining the likelihood that said payment will be made given assumptions regarding said contingency being satisfied.

568. The method of claim 567, wherein said determining the likelihood that said payment will be made given assumptions regarding said contingency being satisfied comprises determining the likelihood that said payment will be made given a stock price growth rate and a volatility.

569. The method of claim 517, wherein said attributing a number of said underlying references to said financial instrument comprises attributing a variable number of said underlying references to each unit of said financial instrument.

570. The method of claim 517, wherein said attributing a number of said underlying references to said financial instrument comprises attributing a constant number of said underlying references to each unit of said financial instrument.

571. The method of claim 517, wherein said identifying an underlying reference comprises identifying said underlying reference that said financial instrument converts into.

572. The method of claim 517, wherein said identifying an underlying reference comprises basing an exchange value of said financial instrument on said underlying reference.

573. A financial services method comprising buying a financial instrument, said financial instrument having an issuer and created by:
identifying an underlying reference for said financial instrument, said underlying reference having a value;
attributing a number of said underlying references to said financial instrument;
defining a contingency, said contingency having a trigger based upon at least one of:
a. trading value of said financial instrument,
b. trading yield of said financial instrument,
c. dividend yield of said underlying reference,
d. trading yield of a liability of said issuer of said financial instrument,
e. trading value of a liability of said issuer of said financial instrument,
f. trading value of a class of capital stock other than said underlying reference,
g. trading dividend yield of a class of capital stock issued by an issuer other than said issuer of said financial instrument,
h. trading value of a class of capital stock of said issuer of said financial instrument other than common stock,
i. trading yield of a class of capital stock of said issuer of said financial instrument,
j. trading value of a security issued by an issuer other than said issuer of said financial instrument,
k. trading yield of a security,
l. an index; wherein:
a payment becomes due on occurrence of said contingency.

574. The method of claim 573, wherein said buying said financial instrument comprises buying said financial instrument at a value based on at least one of:
a. said contingency;
b. said value of said underlying reference;
c. value of said payment;
d. length of said predetermined period of delay;
e. volatility in trading value of said underlying reference;
f. time until redemption, at option of issuer or holder;
g. time until maturity;
h. an interest rate; and
i. value for which said financial instrument must be redeemed on redemption date.

575. The method of claim 573, wherein said buying said financial instrument comprises bidding for said financial instrument.

576. The method of claim 573, wherein said buying said financial instrument comprises buying a derivative of said financial instrument.

577. The method of claim 573, wherein said buying said financial instrument comprises buying a part of said financial instrument.

578. The method of claim 573, wherein said attributing a number of said underlying references to said financial instrument comprises attributing a variable number of said underlying references to each unit of said financial instrument.

579. The method of claim 573, wherein said attributing a number of said underlying references to said financial instrument comprises attributing a constant number of said underlying references to each unit of said financial instrument.

580. The method of claim 573, wherein said identifying an underlying reference comprises identifying said underlying reference that said financial instrument converts into.

581. The method of claim 573, wherein said identifying an underlying reference comprises basing an exchange value of said financial instrument on said underlying reference.

582. A financial services method associated with a financial instrument, said financial instrument having an issuer, said method comprising:
identifying an underlying reference for said financial instrument, said underlying reference having a value;
attributing a number of said underlying references to said financial instrument;
defining a contingency, a payment becoming due on occurrence of said contingency;
calculating said payment based upon at least one of:
a. predetermined fixed amount,
b. trading value of said financial instrument,
c. trading yield of said financial instrument,
d. trading yield of a liability of said issuer of said financial instrument,
e. trading value of a liability of said issuer of said financial instrument,
f. trading value of a class of capital stock issued by an issuer other than said issuer of said financial instrument,
g. trading dividend yield of a class of capital stock other than said underlying reference,
h. trading value of a class of capital stock of said issuer of said financial instrument,
i. trading yield of a class of capital stock of said issuer of said financial instrument other than common stock,
j. trading value of a security,
k. trading yield of a security issued by an issuer other than said issuer of said financial instrument,
l. an index.

583. The method of claim 582, further comprising:
establishing a value for said financial instrument.

584. The method of claim 583 further comprising:
selling said financial instrument.

585. The method of claim 584, wherein said selling said financial instrument comprises selling said financial instrument at a value based on at least one of:
a. said contingency;
b. said value of said underlying reference;
c. value of said payment;
d. volatility in trading value of said underlying reference;
e. time until redemption, at option of issuer or holder;
f. time until maturity;
g. an interest rate; and
h. value for which said financial instrument must be redeemed on redemption date.

586. The method of claim 584, wherein said selling said financial instrument comprises auctioning said financial instrument.

587. The method of claim 584, wherein said selling said financial instrument comprises selling a derivative of said financial instrument.

588. The method of claim 584, wherein said selling said financial instrument comprises selling a part of said financial instrument.

589. The method of claim 584 further comprising:
monitoring for satisfaction of said contingency.

590. The method of claim 584, further comprising:
disbursing said payment.

591. The method of claim 583, further comprising:
monitoring for satisfaction of said contingency.

592. The method of claim 591, further comprising:
disbursing said payment.

593. The method of claim 583, further comprising:
disbursing said payment.

594. The method of claim 583, wherein said establishing a value for said financial instrument comprises basing said value for said financial instrument on at least one of:
a. said contingency;
b. said value of said underlying reference;
c. value of said payment;
d. volatility in trading value of said underlying reference;
e. time until redemption, at option of issuer or holder;
f. time until maturity;
g. an interest rate; and
h. value for which said financial instrument must be redeemed on redemption date.

595. The method of claim 582 further comprising:
selling said financial instrument.

596. The method of claim 595, wherein said selling said financial instrument comprises selling said financial instrument at a value based on at least one of:
a. said contingency;
b. said value of said underlying reference;
c. value of said payment;
d. volatility in trading value of said underlying reference;
e. time until redemption, at option of issuer or holder;
f. time until maturity;
g. an interest rate; and
h. value for which said financial instrument must be redeemed on redemption date.

597. The method of claim 595, wherein said selling said financial instrument comprises auctioning said financial instrument.

598. The method of claim 595, wherein said selling said financial instrument comprises selling a derivative of said financial instrument.

599. The method of claim 595, wherein said selling said financial instrument comprises selling a part of said financial instrument.

600. The method of claim 595 further comprising:
monitoring for satisfaction of said contingency.

601. The method of claim 595, further comprising:
disbursing said payment.

602. The method of claim 582 further comprising:
monitoring for satisfaction of said contingency.

603. The method of claim 602, wherein said monitoring for satisfaction comprises comparing market data to requirements of said contingency within at least one contingency monitoring period.

604. The method of claim 602, wherein said monitoring comprises monitoring over many contingency monitoring periods.

605. The method of claim 602, wherein said monitoring comprises monitoring realtime data.

606. The method of claim 602, further comprising:
disbursing said payment.

607. The method of claim 582, wherein said defining a contingency comprises basing said contingency on an event related to said financial instrument.

608. The method of claim 607, wherein said basing said contingency on an event related to said financial instrument comprises setting said contingency as satisfied once an observed value of said financial instrument at least:
a. exceeds a predetermined metric, or
b. is equal to a predetermined metric, or
c. is less than a predetermined metric.

609. The method of claim 582, wherein said defining a contingency comprises setting said contingency as satisfied when the closing sale value of said underlying reference within at least one said contingency monitoring period is greater than a predetermined percentage of the conversion value.

610. The method of claim 582, wherein said defining a contingency comprises setting said contingency as satisfied when the closing sale value of said underlying reference within at least one said contingency monitoring period is less than a predetermined percentage of the conversion value.

611. The method of claim 582, wherein said defining a contingency comprises basing said contingency on an instrument other than said financial instrument.

612. The method of claim 611, wherein said basing said contingency on said instrument other than said financial instrument comprises setting said contingency as satisfied once an observed value of said instrument at least:
a. exceeds a predetermined metric, or
b. is equal to a predetermined metric, or
c. is less than a predetermined metric.

613. The method of claim 582, wherein said defining a contingency comprises establishing at least one of:
a. a contingency having at least one trigger, and
b. multiple contingencies having at least one trigger.

614. The method of claim 613, wherein said establishing at least one trigger comprises setting said trigger at an amount equal to a multiple of a prevailing market rate for a financial instrument.

615. The method of claim 614, wherein said setting said trigger at an amount equal to a multiple comprises using a multiple equal to 1.

616. The method of claim 614, wherein said setting said trigger at an amount equal to a multiple comprises using a multiple less than 1.

617. The method of claim 614, wherein said setting said trigger at an amount equal to a multiple comprises using a multiple greater than 1.

618. The method of claim 613, wherein said establishing at least one trigger comprises setting said trigger equal to a multiple of a formula amount.

619. The method of claim 618, wherein said setting said trigger at an amount equal to a multiple comprises using a multiple equal to 1.

620. The method of claim 618, wherein said setting said trigger at an amount equal to a multiple comprises using a multiple less than 1.

621. The method of claim 618, wherein said setting said trigger at an amount equal to a multiple comprises using a multiple greater than 1.

622. The method of claim 582, further comprising:
disbursing said payment.

623. The method of claim 622, wherein said disbursing said payment comprises sending a negotiable instrument.

624. The method of claim 582, wherein said calculating said payment comprises calculating said payment using a periodic schedule.

625. The method of claim 624, wherein said calculating said payment using a periodic schedule comprises calculating said payment at least once per said contingency monitoring period.

626. The method of claim 624, wherein said calculating said payment using a periodic schedule comprises calculating said payment on a quarterly basis.

627. The method of claim 582, wherein said calculating payment comprise calculating payment only after a predetermined period of delay.

628. The method of claim 582, further comprising preparing at least one of:
a. a projected payment schedule;
b. an incidental analysis; and
c. a remoteness analysis.

629. The method of claim 628, wherein said preparing said projected payment schedule comprises determining a schedule of said payments based on payments necessary to produce a comparable yield.

630. The method of claim 628, wherein said preparing said incidental analysis comprises determining the amount of said payment based on assumptions regarding said contingency being satisfied.

631. The method of claim 630, wherein said determining the amount of said payment based on assumptions regarding the contingency being satisfied comprises determining the amount of said payment based on at least one of:
a. a stock price growth rate, and
b. discount rates.

632. The method of claim 628, wherein said preparing said remoteness analysis comprises determining the likelihood that said payment will be made given assumptions regarding said contingency being satisfied.

633. The method of claim 632, wherein said determining the likelihood that said payment will be made given assumptions regarding said contingency being satisfied comprises determining the likelihood that said payment will be made given a stock price growth rate and a volatility.

634. The method of claim 582, wherein said attributing a number of said underlying references to said financial instrument comprises attributing a variable number of said underlying references to each unit of said financial instrument.

635. The method of claim 582, wherein said attributing a number of said underlying references to said financial instrument comprises attributing a constant number of said underlying references to each unit of said financial instrument.

636. The method of claim 582, wherein said identifying an underlying reference comprises identifying said underlying reference that said financial instrument converts into.

637. The method of claim 582, wherein said identifying an underlying reference comprises basing an exchange value of said financial instrument on said underlying reference.

638. A financial services method comprising buying a financial instrument, said financial instrument having an issuer and created by:
identifying an underlying reference for said financial instrument, said underlying reference having a value;
attributing a number of said underlying references to said financial instrument;
defining a contingency, a payment becoming due on occurrence of said contingency;
calculating said payment based upon at least one of:
a. predetermined fixed amount,
b. trading value of said financial instrument,
c. trading yield of said financial instrument,
d. trading yield of a liability of said issuer of said financial instrument,
e. trading value of a liability of said issuer of said financial instrument,
f. trading value of a class of capital stock issued by an issuer other than said issuer of said financial instrument,
g. trading dividend yield of a class of capital stock other than said underlying reference,
h. trading value of a class of capital stock of said issuer of said financial instrument,
i. trading yield of a class of capital stock of said issuer of said financial instrument other than common stock,
j. trading value of a security,
k. trading yield of a security issued by an issuer other than said issuer of said financial instrument,
l. an index.

639. The method of claim 638, wherein said buying said financial instrument comprises buying said financial instrument at a value based on at least one of:
a. said contingency;
b. said value of said underlying reference;
c. value of said payment;
d. length of said predetermined period of delay;
e. volatility in trading value of said underlying reference;
f. time until redemption, at option of issuer or holder;
g. time until maturity;
h. an interest rate; and
i. value for which said financial instrument must be redeemed on redemption date.

640. The method of claim 638, wherein said buying said financial instrument comprises bidding for said financial instrument.

641. The method of claim 638, wherein said buying said financial instrument comprises buying a derivative of said financial instrument.

642. The method of claim 638, wherein said buying said financial instrument comprises buying a part of said financial instrument.

643. The method of claim 638, wherein said defining a contingency comprises basing said contingency on an event related to said financial instrument.

644. The method of claim 638, wherein said defining a contingency comprises basing said contingency on an instrument other than said financial instrument.

645. The method of claim 638, wherein said attributing a number of said underlying references to said financial instrument comprises attributing a variable number of said underlying references to each unit of said financial instrument.

646. The method of claim 638, wherein said attributing a number of said underlying references to said financial instrument comprises attributing a constant number of said underlying references to each unit of said financial instrument.

647. The method of claim 638, wherein said identifying an underlying reference comprises identifying said underlying reference that said financial instrument converts into.

648. The method of claim 638, wherein said identifying an underlying reference comprises basing an exchange value of said financial instrument on said underlying reference.

649. A financial services method associated with a financial instrument, said financial instrument having an issuer, said method comprising:
identifying an underlying reference for said financial instrument, said underlying reference having a value;
attributing a number of said underlying references to said financial instrument;
defining a contingency, a payment becoming due on occurrence of said contingency;
calculating said payment so that said payment equals at most an imposed maximum value.

650. The method of claim 649, further comprising:
establishing a value for said financial instrument.

651. The method of claim 650 further comprising:
selling said financial instrument.

652. The method of claim 651, wherein said selling said financial instrument comprises selling said financial instrument at a value based on at least one of:
a. said contingency;
b. said value of said underlying reference;
c. value of said payment;
d. volatility in trading value of said underlying reference;
e. time until redemption, at option of issuer or holder;
f. time until maturity;
g. an interest rate; and
h. value for which said financial instrument must be redeemed on redemption date.

653. The method of claim 651, wherein said selling said financial instrument comprises auctioning said financial instrument.

654. The method of claim 651, wherein said selling said financial instrument comprises selling a derivative of said financial instrument.

655. The method of claim 651, wherein said selling said financial instrument comprises selling a part of said financial instrument.

656. The method of claim 651 further comprising:
monitoring for satisfaction of said contingency.

657. The method of claim 651, further comprising:
disbursing said payment.

658. The method of claim 650, further comprising:
monitoring for satisfaction of said contingency.

659. The method of claim 658, further comprising:
disbursing said payment.

660. The method of claim 650, further comprising:
disbursing said payment.

661. The method of claim 650, wherein said establishing a value for said financial instrument comprises basing said value for said financial instrument on at least one of:
a. said contingency;
b. said value of said underlying reference;
c. value of said payment;
d. volatility in trading value of said underlying reference;
e. time until redemption, at option of issuer or holder;
f. time until maturity;
g. an interest rate; and
h. value for which said financial instrument must be redeemed on redemption date.

662. The method of claim 649 further comprising:
selling said financial instrument.

663. The method of claim 662, wherein said selling said financial instrument comprises selling said financial instrument at a value based on at least one of:
a. said contingency;
b. said value of said underlying reference;
c. value of said payment;
d. volatility in trading value of said underlying reference;
e. time until redemption, at option of issuer or holder;
f. time until maturity;
g. an interest rate; and
h. value for which said financial instrument must be redeemed on redemption date.

664. The method of claim 662, wherein said selling said financial instrument comprises auctioning said financial instrument.

665. The method of claim 662, wherein said selling said financial instrument comprises selling a derivative of said financial instrument.

666. The method of claim 662, wherein said selling said financial instrument comprises selling a part of said financial instrument.

667. The method of claim 662 further comprising:
monitoring for satisfaction of said contingency.

668. The method of claim 662, further comprising:
disbursing said payment.

669. The method of claim 649 further comprising:
monitoring for satisfaction of said contingency.

670. The method of claim 669, wherein said monitoring for satisfaction comprises comparing market data to requirements of said contingency within at least one contingency monitoring period.

671. The method of claim 669, wherein said monitoring comprises monitoring over many contingency monitoring periods.

672. The method of claim 669, wherein said monitoring comprises monitoring realtime data.

673. The method of claim 669, further comprising:
disbursing said payment.

674. The method of claim 649, wherein said defining a contingency comprises basing said contingency on an event related to said financial instrument.

675. The method of claim 674, wherein said basing said contingency on an event related to said financial instrument comprises setting said contingency as satisfied once an observed value of said financial instrument at least:
a. exceeds a predetermined metric, or
b. is equal to a predetermined metric, or
c. is less than a predetermined metric.

676. The method of claim 649, wherein said defining a contingency comprises setting said contingency as satisfied when the closing sale value of said underlying reference within at least one said contingency monitoring period is greater than a predetermined percentage of the conversion value.

677. The method of claim 649, wherein said defining a contingency comprises setting said contingency as satisfied when the closing sale value of said underlying reference within at least one said contingency monitoring period is less than a predetermined percentage of the conversion value.

678. The method of claim 649, wherein said defining a contingency comprises basing said contingency on an instrument other than said financial instrument.

679. The method of claim 678, wherein said basing said contingency on said instrument other than said financial instrument comprises setting said contingency as satisfied once an observed value of said instrument at least:
a. exceeds a predetermined metric, or
b. is equal to a predetermined metric, or
c. is less than a predetermined metric.

680. The method of claim 649, wherein said defining a contingency comprises establishing at least one of:
a. a contingency having at least one trigger, and
b. multiple contingencies having at least one trigger.

681. The method of claim 680, wherein said establishing at least one trigger comprises setting said trigger at an amount equal to a multiple of a prevailing market rate for a financial instrument.

682. The method of claim 681, wherein said setting said trigger at an amount equal to a multiple comprises using a multiple equal to 1.

683. The method of claim 681, wherein said setting said trigger at an amount equal to a multiple comprises using a multiple less than 1.

684. The method of claim 681, wherein said setting said trigger at an amount equal to a multiple comprises using a multiple greater than 1.

685. The method of claim 680, wherein said establishing at least one trigger comprises setting said trigger at an amount equal to a multiple of a formula amount.

686. The method of claim 685, wherein said setting said trigger at an amount equal to a multiple comprises using a multiple equal to 1.

687. The method of claim 685, wherein said setting said trigger at an amount equal to a multiple comprises using a multiple less than 1.

688. The method of claim 685, wherein said setting said trigger at an amount equal to a multiple comprises using a multiple greater than 1.

689. The method of claim 649, further comprising:
disbursing said payment.

690. The method of claim 689, wherein said disbursing said payment comprises sending a negotiable instrument.

691. The method of claim 649, wherein said calculating said payments so that said payment equals at most an imposed maximum value comprises basing said maximum value on at least one of:
a. a predetermined fixed value,
b. a predetermined maximum yield.

692. The method of claim 649, wherein said calculating said payment so that said payment equals at most an imposed maximum value comprises calculating said payment using a periodic schedule.

693. The method of claim 692, wherein said calculating said payment using a periodic schedule comprises calculating said payment at least once per said contingency monitoring period.

694. The method of claim 692, wherein said calculating said payment using a periodic schedule comprises calculating said payment on a quarterly basis.

695. The method of claim 649, wherein said calculating said payment so that said payment equals at most an imposed maximum value comprises calculating said payment based upon at least one of:
a. predetermined fixed amount,
b. trading value of said financial instrument,
c. trading yield of said financial instrument,
d. trading yield of a liability of said issuer of said financial instrument,
e. trading value of a liability of said issuer of said financial instrument,
f. trading value of a class of capital stock issued by an issuer other than said issuer of said financial instrument,
g. trading dividend yield of a class of capital stock issued by an issuer other than said issuer of said financial instrument,
h. trading value of a class of capital stock of said issuer of said financial instrument,
i. trading yield of a class of capital stock of said issuer of said financial instrument,
j. trading value of a security,
k. trading yield of a security, and
l. an index.

696. The method of claim 649, wherein said calculating payment so that said payment equals at most an imposed maximum value comprises calculating payment only after a predetermined period of delay.

697. The method of claim 649, wherein said calculating payment so that said payment equals at most an imposed maximum value comprises calculating said payment so that said payment exceeds an imposed minimum value.

698. The method of claim 649, further comprising preparing at least one of:
a. a projected payment schedule;
b. an incidental analysis; and
c. a remoteness analysis.

699. The method of claim 698, wherein said preparing said projected payment schedule comprises determining a schedule of said payments based on payments necessary to produce a comparable yield.

700. The method of claim 698, wherein said preparing said incidental analysis comprises determining the amount of said payment based on assumptions regarding said contingency being satisfied.

701. The method of claim 700, wherein said determining the amount of said payment based on assumptions regarding the contingency being satisfied comprises determining the amount of said payment based on at least one of:
a. a stock price growth rate, and
b. discount rates.

702. The method of claim 698, wherein said preparing said remoteness analysis comprises determining the likelihood that said payment will be made given assumptions regarding said contingency being satisfied.

703. The method of claim 702, wherein said determining the likelihood that said payment will be made given assumptions regarding said contingency being satisfied comprises determining the likelihood that said payment will be made given a stock price growth rate and a volatility.

704. The method of claim 649, wherein said attributing a number of said underlying references to said financial instrument comprises attributing a variable number of said underlying references to each unit of said financial instrument.

705. The method of claim 649, wherein said attributing a number of said underlying references to said financial instrument comprises attributing a constant number of said underlying references to each unit of said financial instrument.

706. The method of claim 649, wherein said identifying an underlying reference comprises identifying said underlying reference that said financial instrument converts into.

707. The method of claim 649, wherein said identifying an underlying reference comprises basing an exchange value of said financial instrument on said underlying reference.

708. A financial services method comprising buying a financial instrument created by:
identifying an underlying reference for said financial instrument, said underlying reference having a value;
attributing a number of said underlying references to said financial instrument;
defining a contingency, a payment becoming due on occurrence of said contingency;
calculating said payment so that said payment equals at most an imposed maximum value.

709. The method of claim 708, wherein said buying said financial instrument comprises buying said financial instrument at a value based on at least one of:
a. said contingency;
b. said value of said underlying reference;
c. value of said payment;
d. length of said predetermined period of delay;
e. volatility in trading value of said underlying reference;
f. time until redemption, at option of issuer or holder;
g. time until maturity;
h. an interest rate; and
i. value for which said financial instrument must be redeemed on redemption date.

710. The method of claim 708, wherein said buying said financial instrument comprises bidding for said financial instrument.

711. The method of claim 708, wherein said buying said financial instrument comprises buying a derivative of said financial instrument.

712. The method of claim 708, wherein said buying said financial instrument comprises buying a part of said financial instrument.

713. The method of claim 708, wherein said defining a contingency comprises basing said contingency on an event related to said financial instrument.

714. The method of claim 708, wherein said defining a contingency comprises basing said contingency on an instrument other than said financial instrument.

715. The method of claim 708, wherein said attributing a number of said underlying references to said financial instrument comprises attributing a variable number of said underlying references to each unit of said financial instrument.

716. The method of claim 708, wherein said attributing a number of said underlying references to said financial instrument comprises attributing a constant number of said underlying references to each unit of said financial instrument.

717. The method of claim 708, wherein said identifying an underlying reference comprises identifying said underlying reference that said financial instrument converts into.

718. The method of claim 708, wherein said identifying an underlying reference comprises basing an exchange value of said financial instrument on said underlying reference.

719. A financial services method associated with a financial instrument, said financial instrument having an issuer, said method comprising:
identifying an underlying reference for said financial instrument, said underlying reference having a value;
attributing a number of said underlying references to said financial instrument;
defining a contingency, a payment becoming due on occurrence of said contingency;
calculating said payment so that said payment exceeds an imposed minimum value.

720. The method of claim 719, further comprising:
establishing a value for said financial instrument.

721. The method of claim 720 further comprising:
selling said financial instrument.

722. The method of claim 721, wherein said selling said financial instrument comprises selling said financial instrument at a value based on at least one of:
a. said contingency;
b. said value of said underlying reference;
c. value of said payment;
d. volatility in trading value of said underlying reference;
e. time until redemption, at option of issuer or holder;
f. time until maturity;
g. an interest rate; and
h. value for which said financial instrument must be redeemed on redemption date.

723. The method of claim 721, wherein said selling said financial instrument comprises auctioning said financial instrument.

724. The method of claim 721, wherein said selling said financial instrument comprises selling a derivative of said financial instrument.

725. The method of claim 721, wherein said selling said financial instrument comprises selling a part of said financial instrument.

726. The method of claim 721 further comprising:
monitoring for satisfaction of said contingency.

727. The method of claim 721, further comprising:
disbursing said payment.

728. The method of claim 720, further comprising:
monitoring for satisfaction of said contingency.

729. The method of claim 728, further comprising:
disbursing said payment.

730. The method of claim 720, further comprising:
disbursing said payment.

731. The method of claim 720, wherein said establishing a value for said financial instrument comprises basing said value for said financial instrument on at least one of:
a. said contingency;
b. said value of said underlying reference;
c. value of said payment;
d. volatility in trading value of said underlying reference;
e. time until redemption, at option of issuer or holder;
f. time until maturity;
g. an interest rate; and
h. value for which said financial instrument must be redeemed on redemption date.

732. The method of claim 719 further comprising:
selling said financial instrument.

733. The method of claim 732, wherein said selling said financial instrument comprises selling said financial instrument at a value based on at least one of:
a. said contingency;
b. said value of said underlying reference;
c. value of said payment;
d. volatility in trading value of said underlying reference;
e. time until redemption, at option of issuer or holder;
f. time until maturity;
g. an interest rate; and
h. value for which said financial instrument must be redeemed on redemption date.

734. The method of claim 732, wherein said selling said financial instrument comprises auctioning said financial instrument.

735. The method of claim 732, wherein said selling said financial instrument comprises selling a derivative of said financial instrument.

736. The method of claim 732, wherein said selling said financial instrument comprises selling a part of said financial instrument.

737. The method of claim 732 further comprising:
monitoring for satisfaction of said contingency.

738. The method of claim 732, further comprising:
disbursing said payment.

739. The method of claim 719 further comprising:
monitoring for satisfaction of said contingency.

740. The method of claim 739, wherein said monitoring for satisfaction comprises comparing market data to requirements of said contingency within at least one contingency monitoring period.

741. The method of claim 739, wherein said monitoring comprises monitoring over many contingency monitoring periods.

742. The method of claim 739, wherein said monitoring comprises monitoring realtime data.

743. The method of claim 739, further comprising:
disbursing said payment.

744. The method of claim 719, wherein said defining a contingency comprises basing said contingency on an event related to said financial instrument.

745. The method of claim 744, wherein said basing said contingency on an event related to said financial instrument comprises setting said contingency as satisfied once an observed value of said financial instrument at least:
a. exceeds a predetermined metric, or
b. is equal to a predetermined metric, or
c. is less than a predetermined metric.

746. The method of claim 719, wherein said defining a contingency comprises setting said contingency as satisfied when the closing sale value of said underlying reference within at least one said contingency monitoring period is greater than a predetermined percentage of the conversion value.

747. The method of claim 719, wherein said defining a contingency comprises setting said contingency as satisfied when the closing sale value of said underlying reference within at least one said contingency monitoring period is less than a predetermined percentage of the conversion value.

748. The method of claim 719, wherein said defining a contingency comprises basing said contingency on an instrument other than said financial instrument.

749. The method of claim 748, wherein said basing said contingency on said instrument other than said financial instrument comprises setting said contingency as satisfied once an observed value of said instrument at least:
a. exceeds a predetermined metric, or
b. is equal to a predetermined metric, or
c. is less than a predetermined metric.

750. The method of claim 719, wherein said defining a contingency comprises establishing at least one of:
a. a contingency having at least one trigger, and
b. multiple contingencies having at least one trigger.

751. The method of claim 750, wherein said establishing at least one trigger comprises setting said trigger at an amount equal to a multiple of a prevailing market rate for a financial instrument.

752. The method of claim 751, wherein said setting said trigger at an amount equal to a multiple comprises using a multiple equal to 1.

753. The method of claim 751, wherein said setting said trigger at an amount equal to a multiple comprises using a multiple less than 1.

754. The method of claim 751, wherein said setting said trigger at an amount equal to a multiple comprises using a multiple greater than 1.

755. The method of claim 750, wherein said establishing at least one trigger comprises setting said trigger at an amount equal to a multiple of a formula amount.

756. The method of claim 755, wherein said setting said trigger at an amount equal to a multiple comprises using a multiple equal to 1.

757. The method of claim 755, wherein said setting said trigger at an amount equal to a multiple comprises using a multiple less than 1.

758. The method of claim 755, wherein said setting said trigger at an amount equal to a multiple comprises using a multiple greater than 1.

759. The method of claim 719, further comprising:
disbursing said payment.

760. The method of claim 759, wherein said disbursing said payment comprises sending a negotiable instrument.

761. The method of claim 719, wherein said calculating said payment so that said payment exceeds an imposed minimum value comprises basing said minimum value on at least one of:
a. a predetermined fixed value,
b. a predetermined minimum yield.

762. The method of claim 719, wherein said calculating said payment so that said payment exceeds an imposed minimum value comprises calculating said payment using a periodic schedule.

763. The method of claim 762, wherein said calculating said payment using a periodic schedule comprises calculating said payment at least once per said contingency monitoring period.

764. The method of claim 762, wherein said calculating said payment using a periodic schedule comprises calculating said payment on a quarterly basis.

765. The method of claim 719, wherein said calculating said payment so that said payment exceeds an imposed minimum value comprises calculating said payment based upon at least one of:
a. predetermined fixed amount,
b. trading value of said financial instrument,
c. trading yield of said financial instrument,
d. trading yield of a liability of said issuer of said financial instrument,
e. trading value of a liability of said issuer of said financial instrument,
f. trading value of a class of capital stock issued by an issuer other than said issuer of said financial instrument,
g. trading dividend yield of a class of capital stock issued by an issuer other than said issuer of said financial instrument,
h. trading value of a class of capital stock of said issuer of said financial instrument,
i. trading yield of a class of capital stock of said issuer of said financial instrument,
j. trading value of a security, k. trading yield of a security, and
l. an index.

766. The method of claim 719, wherein said calculating payment so that said payment exceeds an imposed minimum value comprises calculating payment only after a predetermined period of delay.

767. The method of claim 719, wherein said calculating payment so that said payment exceeds an imposed minimum value comprises calculating payment so that said payment equals at most an imposed maximum value.

768. The method of claim 719, further comprising preparing at least one of:
a. a projected payment schedule;
b. an incidental analysis; and
c. a remoteness analysis.

769. The method of claim 768, wherein said preparing said projected payment schedule comprises determining a schedule of said payments based on payments necessary to produce a comparable yield.

770. The method of claim 768, wherein said preparing said incidental analysis comprises determining the amount of said payment based on assumptions regarding said contingency being satisfied.

771. The method of claim 770, wherein said determining the amount of said payment based on assumptions regarding the contingency being satisfied comprises determining the amount of said payment based on at least one of:
a. a stock price growth rate, and
b. discount rates.

772. The method of claim 768, wherein said preparing said remoteness analysis comprises determining the likelihood that said payment will be made given assumptions regarding said contingency being satisfied.

773. The method of claim 772, wherein said determining the likelihood that said payment will be made given assumptions regarding said contingency being satisfied comprises determining the likelihood that said payment will be made given a stock price growth rate and a volatility.

774. The method of claim 719, wherein said attributing a number of said underlying references to said financial instrument comprises attributing a variable number of said underlying references to each unit of said financial instrument.

775. The method of claim 719, wherein said attributing a number of said underlying references to said financial instrument comprises attributing a constant number of said underlying references to each unit of said financial instrument.

776. The method of claim 719, wherein said identifying an underlying reference comprises identifying said underlying reference that said financial instrument converts into.

777. The method of claim 719, wherein said identifying an underlying reference comprises basing an exchange value of said financial instrument on said underlying reference.

778. A financial services method comprising buying a financial instrument created by:
identifying an underlying reference for said financial instrument, said underlying reference having a value;
attributing a number of said underlying references to said financial instrument;
defining a contingency, a payment becoming due on occurrence of said contingency;
calculating said payment so that said payment exceeds an imposed minimum value.

779. The method of claim 778, wherein said buying said financial instrument comprises buying said financial instrument at a value based on at least one of:
a. said contingency;
b. said value of said underlying reference;
c. value of said payment;
d. length of said predetermined period of delay;
e. volatility in trading value of said underlying reference;
f. time until redemption, at option of issuer or holder;
g. time until maturity;
h. an interest rate; and
i. value for which said financial instrument must be redeemed on redemption date.

780. The method of claim 778, wherein said buying said financial instrument comprises bidding for said financial instrument.

781. The method of claim 778, wherein said buying said financial instrument comprises buying a derivative of said financial instrument.

782. The method of claim 778, wherein said buying said financial instrument comprises buying a part of said financial instrument.

783. The method of claim 778, wherein said defining a contingency comprises basing said contingency on an event related to said financial instrument.

784. The method of claim 778, wherein said defining a contingency comprises basing said contingency on an instrument other than said financial instrument.

785. The method of claim 778, wherein said attributing a number of said underlying references to said financial instrument comprises attributing a variable number of said underlying references to each unit of said financial instrument.

786. The method of claim 778, wherein said attributing a number of said underlying references to said financial instrument comprises attributing a constant number of said underlying references to each unit of said financial instrument.

787. The method of claim 778, wherein said identifying an underlying reference comprises identifying said underlying reference that said financial instrument converts into.

788. The method of claim 778, wherein said identifying an underlying reference comprises basing an exchange value of said financial instrument on said underlying reference.

789. A financial services method associated with a financial instrument said method comprising:
identifying an underlying reference for said financial instrument, said underlying reference having a value;
attributing a number of said underlying references to said financial instrument;
defining multiple contingencies, a payment becoming due on occurrence of at least one of:
a. satisfaction of one of said multiple contingencies,
b. satisfaction of more than one of said multiple contingencies, and
c. satisfaction of all of said multiple contingencies.

790. The method of claim 789, further comprising:
establishing a value for said financial instrument.

791. The method of claim 790 further comprising:
selling said financial instrument.

792. The method of claim 791, wherein said selling said financial instrument comprises selling said financial instrument at a value based on at least one of:
a. said multiple contingencies;
b. said value of said underlying reference;
c. value of said payment;
d. volatility in trading value of said underlying reference;
e. time until redemption, at option of issuer or holder;
f. time until maturity;
g. an interest rate; and
h. value for which said financial instrument must be redeemed on redemption date.

793. The method of claim 791, wherein said selling said financial instrument comprises auctioning said financial instrument.

794. The method of claim 791, wherein said selling said financial instrument comprises selling a derivative of said financial instrument.

795. The method of claim 791, wherein said selling said financial instrument comprises selling a part of said financial instrument.

796. The method of claim 791 further comprising:
monitoring for said satisfaction of said multiple contingencies.

797. The method of claim 791, further comprising:
disbursing said payment.

798. The method of claim 791, further comprising:
calculating said payment.

799. The method of claim 790, further comprising:
monitoring for said satisfaction of said multiple contingencies.

800. The method of claim 799, further comprising:
disbursing said payment.

801. The method of claim 799, further comprising:
calculating said payment.

802. The method of claim 790, further comprising:
disbursing said payment.

803. The method of claim 790, further comprising:
calculating said payment.

804. The method of claim 790, wherein said establishing a value for said financial instrument comprises basing said value for said financial instrument on at least one of:
a. said multiple contingencies;
b. said value of said underlying reference;
c. value of said payment;
d. volatility in trading value of said underlying reference;
e. time until redemption, at option of issuer or holder;
f. time until maturity;
g. an interest rate; and
h. value for which said financial instrument must be redeemed on redemption date.

805. The method of claim 789 further comprising:
selling said financial instrument.

806. The method of claim 805, wherein said selling said financial instrument comprises selling said financial instrument at a value based on at least one of:
a. said multiple contingencies;
b. said value of said underlying reference;
c. value of said payment;
d. volatility in trading value of said underlying reference;
e. time until redemption, at option of issuer or holder;
f. time until maturity;
g. an interest rate; and
h. value for which said financial instrument must be redeemed on redemption date.

807. The method of claim 805, wherein said selling said financial instrument comprises auctioning said financial instrument.

808. The method of claim 805, wherein said selling said financial instrument comprises selling a derivative of said financial instrument.

809. The method of claim 805, wherein said selling said financial instrument comprises selling a part of said financial instrument.

810. The method of claim 805 further comprising:
monitoring for said satisfaction of said multiple contingencies.

811. The method of claim 805, further comprising:
disbursing said payment.

812. The method of claim 805, further comprising:
calculating said payment.

813. The method of claim 789 further comprising:
monitoring for said satisfaction of said multiple contingencies.

814. The method of claim 813, wherein said monitoring for said satisfaction comprises comparing market data to requirements of said multiple contingencies within at least one contingency monitoring period.

815. The method of claim 813, wherein said monitoring comprises monitoring over many contingency monitoring periods.

816. The method of claim 813, wherein said monitoring comprises monitoring realtime data.

817. The method of claim 813, further comprising:
disbursing said payment.

818. The method of claim 813, further comprising:
calculating said payment.

819. The method of claim 789, wherein said defining multiple contingencies comprises basing said contingencies on events related to said financial instrument.

820. The method of claim 789, wherein said defining multiple contingencies comprises basing said contingencies on instruments other than said financial instrument.

821. The method of claim 820, wherein said basing said contingencies on instruments other than said financial instrument comprises setting said contingencies as satisfied once observed values of said instruments at least:
a. exceed a predetermined metric, or
b. are equal to a predetermined metric, or
c. are less than a predetermined metric.

822. The method of claim 789, wherein said defining said contingencies comprises establishing multiple contingencies each with at least one trigger.

823. The method of claim 822, wherein said establishing at least one trigger comprises setting said trigger at an amount equal to a multiple of a prevailing market rate for a financial instrument.

824. The method of claim 823, wherein said setting said trigger at an amount equal to a multiple comprises using a multiple equal to 1.

825. The method of claim 823, wherein said setting said trigger at an amount equal to a multiple comprises using a multiple less than 1.

826. The method of claim 823, wherein said setting said trigger at an amount equal to a multiple comprises using a multiple greater than 1.

827. The method of claim 822, wherein said establishing at least one trigger comprises setting said trigger equal to a multiple of a formula amount.

828. The method of claim 827, wherein said setting said trigger at an amount equal to a multiple comprises using a multiple equal to 1.

829. The method of claim 827, wherein said setting said trigger at an amount equal to a multiple comprises using a multiple less than 1.

830. The method of claim 827, wherein said setting said trigger at an amount equal to a multiple comprises using a multiple greater than 1.

831. The method of claim 789, further comprising:
a. disbursing said payment.

832. The method of claim 831, wherein said disbursing said payment comprises sending a negotiable instrument.

833. The method of claim 789, further comprising:
calculating said payment.

834. The method of claim 833, wherein said calculating said payment comprises establishing a formula for calculating said payment based on said value of said underlying reference.

835. The method of claim 834, wherein said establishing a formula comprises using a fixed rate formula.

836. The method of claim 834, wherein said establishing a formula comprises using a variable rate formula.

837. The method of claim 833, wherein said calculating said payment comprises calculating said payment using a periodic schedule.

838. The method of claim 837, wherein said calculating said payment using a periodic schedule comprises calculating said payment at least once per contingency monitoring period.

839. The method of claim 837, wherein said calculating said payment using a periodic schedule comprises calculating said payment on a quarterly basis.

840. The method of claim 833, wherein said calculating said payment comprises calculating said payment based upon at least one of:
a. predetermined fixed amount,
b. trading value of said financial instrument,
c. trading yield of said financial instrument,
d. trading yield of a liability of said issuer of said financial instrument,
e. trading value of a liability of said issuer of said financial instrument,
f. trading value of a class of capital stock issued by an issuer other than said issuer of said financial instrument,
g. trading dividend yield of a class of capital stock issued by an issuer other than said issuer of said financial instrument,
h. trading value of a class of capital stock of said issuer of said financial instrument,
i. trading yield of a class of capital stock of said issuer of said financial instrument,
j. trading value of a security,
k. trading yield of a security, and
l. an index.

841. The method of claim 789, further comprising preparing at least one of:
a. a projected payment schedule;
b. an incidental analysis; and
c. a remoteness analysis.

842. The method of claim 841, wherein said preparing said projected payment schedule comprises determining a schedule of said payments based on payments necessary to produce a comparable yield.

843. The method of claim 841, wherein said preparing said incidental analysis comprises determining the amount of said payment based on assumptions regarding said contingency being satisfied.

844. The method of claim 843, wherein said determining the amount of said payment based on assumptions regarding the contingency being satisfied comprises determining the amount of said payment based on at least one of:
a. a stock price growth rate, and
b. discount rates.

845. The method of claim 841, wherein said preparing said remoteness analysis comprises determining the likelihood that said payment will be made given assumptions regarding said contingency being satisfied.

846. The method of claim 845, wherein said determining the likelihood that said payment will be made given assumptions regarding said contingency being satisfied comprises determining the likelihood that said payment will be made given a stock price growth rate and a volatility.

847. The method of claim 789, wherein said attributing a number of said underlying references to said financial instrument comprises attributing a variable number of said underlying references to each unit of said financial instrument.

848. The method of claim 789, wherein said attributing a number of said underlying references to said financial instrument comprises attributing a constant number of said underlying references to each unit of said financial instrument.

849. The method of claim 789, wherein said identifying an underlying reference comprises identifying said underlying reference that said financial instrument converts into.

850. The method of claim 789, wherein said identifying an underlying reference comprises basing an exchange value of said financial instrument on said underlying reference.

851. A financial services method comprising buying a financial instrument created by:
identifying an underlying reference for said financial instrument, said underlying reference having a value;
attributing a number of said underlying references to said financial instrument;
defining multiple contingencies, a payment becoming due on occurrence of at least one of:
a. satisfaction of one of said multiple contingencies,
b. satisfaction of more than one of said multiple contingencies, and
C. satisfaction of all of said multiple contingencies.

852. The method of claim 851, wherein said buying said financial instrument comprises buying said financial instrument at a value based on at least one of:
a. said contingency;
b. said value of said underlying reference;
c. value of said payment;
d. length of said predetermined period of delay;
e. volatility in trading value of said underlying reference;
f. time until redemption, at option of issuer or holder;
g. time until maturity;
h. an interest rate; and
i. value for which said financial instrument must be redeemed on redemption date.

853. The method of claim 851, wherein said buying said financial instrument comprises bidding for said financial instrument.

854. The method of claim 851, wherein said buying said financial instrument comprises buying a derivative of said financial instrument.

855. The method of claim 851, wherein said buying said financial instrument comprises buying a part of said financial instrument.

856. The method of claim 851, wherein said defining multiple contingencies comprises basing said multiple contingencies on events related to said financial instrument.

857. The method of claim 851, wherein said defining multiple contingencies comprises basing said multiple contingencies on instruments other than said financial instrument.

858. The method of claim 851, wherein said attributing a number of said underlying references to said financial instrument comprises attributing a variable number of said underlying references to each unit of said financial instrument.

859. The method of claim 851, wherein said attributing a number of said underlying references to said financial instrument comprises attributing a constant number of said underlying references to each unit of said financial instrument.

860. The method of claim 851, wherein said identifying an underlying reference comprises identifying said underlying reference that said financial instrument converts into.

861. The method of claim 851, wherein said identifying an underlying reference comprises basing an exchange value of said financial instrument on said underlying reference.

862. A financial services system associated with a financial instrument, said system comprising:
means for identifying an underlying reference for said financial instrument, said underlying reference having a value;
means for attributing a number of said underlying references to said financial instrument;
means for defining a contingency, a payment becoming due on occurrence of said contingency after a predetermined period of delay.

863. The system of claim 862, further comprising:
means for establishing a value for said financial instrument.

864. The system of claim 863 further comprising:
means for selling said financial instrument.

865. The method of claim 864, wherein said means for selling said financial instrument comprises means for selling said financial instrument at a value based on at least one of:
a. said contingency;
b. said value of said underlying reference;
c. value of said payment;
d. length of said predetermined period of delay;
e. volatility in trading value of said underlying reference;
f. time until redemption, at option of issuer or holder;
g. time until maturity;
h. an interest rate; and
i. value for which said financial instrument must be redeemed on redemption date.

866. The system of claim 864, wherein said means for selling said financial instrument comprises means for auctioning said financial instrument.

867. The system of claim 864, wherein said means for selling said financial instrument comprises means for selling a derivative of said financial instrument.

868. The system of claim 864, wherein said means for selling said financial instrument comprises means for selling a part of said financial instrument.

869. The system of claim 864 further comprising:
means for monitoring for satisfaction of said contingency.

870. The system of claim 864, further comprising:
means for disbursing said payment.

871. The system of claim 864, further comprising:
means for calculating said payment.

872. The system of claim 863, further comprising:
means for monitoring for satisfaction of said contingency.

873. The system of claim 872, further comprising:
means for calculating said payment.

874. The system of claim 872, further comprising:
means for disbursing said payment.

875. The system of claim 863, further comprising:
means for disbursing said payment.

876. The system of claim 863, further comprising:
means for calculating said payment.

877. The system of claim 863, wherein said means for establishing a value for said financial instrument comprises means for basing said value for said financial instrument on at least one of:
a. said contingency;
b. said value of said underlying reference;
c. value of said payment;
d. length of said predetermined period of delay;
e. volatility in trading value of said underlying reference;
f. time until redemption, at option of issuer or holder;
g. time until maturity;
h. an interest rate; and
i. value for which said financial instrument must be redeemed on redemption date.

878. The system of claim 862 further comprising:
means for selling said financial instrument.

879. The system of claim 878, wherein said means for selling said financial instrument comprises means for selling said financial instrument at a value based on at least one of:
a. said contingency;
b. said value of said underlying reference;
c. value of said payment;
d. length of said predetermined period of delay;
e. volatility in trading value of said underlying reference;
f. time until redemption, at option of issuer or holder;
g. time until maturity;
h. an interest rate; and
i. value for which said financial instrument must be redeemed on redemption date.

880. The system of claim 878, wherein said means for selling said financial instrument comprises means for auctioning said financial instrument.

881. The system of claim 878, wherein said means for selling said financial instrument comprises means for selling a derivative of said financial instrument.

882. The system of claim 878, wherein said means for selling said financial instrument comprises means for selling a part of said financial instrument.

883. The system of claim 878 further comprising:
means for monitoring for satisfaction of said contingency.

884. The system of claim 878, further comprising:
means for disbursing said payment.

885. The system of claim 878, further comprising:
means for calculating said payment.

886. The system of claim 862 further comprising:
means for monitoring for satisfaction of said contingency.

887. The system of claim 886, wherein said means for monitoring for satisfaction comprises means for comparing market data to requirements of said contingency within at least one said contingency monitoring period.

888. The system of claim 886, wherein said means for monitoring comprises means for monitoring over many said contingency monitoring periods.

889. The system of claim 886, wherein said means for monitoring comprises monitoring realtime data.

890. The system of claim 886, further comprising:
means for disbursing said payment.

891. The system of claim 886, further comprising:
means for calculating said payment.

892. The system of claim 862, wherein said means for defining a contingency comprises means for basing said contingency on an event related to said financial instrument.

893. The system of claim 892, wherein said means for basing said contingency on an event related to said financial instrument comprises means for setting said contingency as satisfied once an observed value of said financial instrument at least:
a. exceeds a predetermined metric, or
b. is equal to a predetermined metric, or
c. is less than a predetermined metric.

894. The system of claim 862, wherein said means for defining a contingency comprises means for setting said contingency as satisfied when the closing sale value of said underlying reference within at least one said contingency monitoring period is greater than a predetermined percentage of the conversion value.

895. The system of claim 862, wherein said means for defining a contingency comprises means for setting said contingency as satisfied when the closing sale value of said underlying reference within at least one said contingency monitoring period is less than a predetermined percentage of the conversion value.

896. The system of claim 862, wherein said means for defining a contingency comprises means for basing said contingency on an instrument other than said financial instrument.

897. The system of claim 896, wherein said means for basing said contingency on said instrument other than said financial instrument comprises means for setting said contingency as satisfied once an observed value of said instrument at least:
a. exceeds a predetermined metric, or
b. is equal to a predetermined metric, or
c. is less than a predetermined metric.

898. The system of claim 862, wherein said means for defining a contingency comprises means for establishing at least one of:
a. a contingency having at least one trigger, and
b. multiple contingencies each with at least one trigger.

899. The system of claim 898, wherein said means for establishing at least one trigger comprises means for setting said trigger at an amount equal to a multiple of a prevailing market rate for a financial instrument.

900. The system of claim 899, wherein said means for setting said trigger at an amount equal to a multiple comprises means for using a multiple equal to 1.

901. The system of claim 899, wherein said means for setting said trigger at an amount equal to a multiple comprises means for using a multiple less than 1.

902. The system of claim 899, wherein said means for setting said trigger at an amount equal to a multiple comprises means for using a multiple greater than 1.

903. The system of claim 898, wherein said means for establishing at least one trigger comprises means for setting said trigger at an amount equal to a multiple of a formula amount.

904. The system of claim 903, wherein said means for setting said trigger at an amount equal to a multiple comprises means for using a multiple equal to 1.

905. The system of claim 903, wherein said means for setting said trigger at an amount equal to a multiple comprises means for using a multiple less than 1.

906. The system of claim 903, wherein said means for setting said trigger at an amount equal to a multiple comprises means for using a multiple greater than 1.

907. The system of claim 862, further comprising:
means for disbursing said payment.

908. The system of claim 907, wherein said means for disbursing said payment comprises means for sending a negotiable instrument.

909. The system of claim 862, further comprising:
means for calculating said payment.

910. The system of claim 909, wherein said means for calculating said payment comprises means for establishing a formula for calculating said payment based on said value of said underlying reference.

911. The system of claim 910, wherein said means for establishing a formula comprises means for using a fixed rate formula.

912. The system of claim 910, wherein said means for establishing a formula comprises means for using a variable rate formula.

913. The system of claim 909, wherein said means for calculating said payment comprises means for calculating said payment using a periodic schedule.

914. The system of claim 913, wherein said means for calculating said payment using a periodic schedule comprises means for calculating said payment at least once per said contingency monitoring period.

915. The system of claim 913, wherein said means for calculating said payment using a periodic schedule comprises means for calculating said payment on a quarterly basis.

916. The system of claim 909, wherein said means for calculating said payment comprises means for calculating said payment based upon at least one of:
a. predetermined fixed amount,
b. trading value of said financial instrument,
c. trading yield of said financial instrument,
d. trading yield of a liability of said issuer of said financial instrument,
e. trading value of a liability of said issuer of said financial instrument,
f. trading value of a class of capital stock issued by an issuer other than said issuer of said financial instrument,
g. trading dividend yield of a class of capital stock issued by an issuer other than said issuer of said financial instrument,
h. trading value of a class of capital stock of said issuer of said financial instrument,
i. trading yield of a class of capital stock of said issuer of said financial instrument,
j. trading value of a security,
k. trading yield of a security, and
l. an index.

917. The system of claim 862, further comprising means for preparing at least one of:
a. a projected payment schedule;
b. an incidental analysis; and
c. a remoteness analysis.

918. The system of claim 917, wherein said means for preparing said projected payment schedule comprises means for determining a schedule of said payments based on payments necessary to produce a comparable yield.

919. The system of claim 917, wherein said means for preparing said incidental analysis comprises means for determining the amount of said payment based on assumptions regarding the contingency being satisfied.

920. The system of claim 919, wherein said means for determining the amount of said payment based on assumptions regarding the contingency being satisfied comprises means for determining the amount of said payment based on at least one of:
a. a stock price growth rate, and
b. discount rates.

921. The system of claim 917, wherein said means for preparing said remoteness analysis comprises means for determining the likelihood that said payment will be made given assumptions regarding said contingency being satisfied.

922. The system of claim 921, wherein said means for determining the likelihood that said payment will be made given assumptions regarding said contingency being satisfied comprises means for determining the likelihood that said payment will be made given a stock price growth rate and a volatility.

923. The system of claim 862, wherein said means for attributing a number of said underlying references to said financial instrument comprises means for attributing a variable number of said underlying references to each unit of said financial instrument.

924. The system of claim 862, wherein said means for attributing a number of said underlying references to said financial instrument comprises means for attributing a constant number of said underlying references to each unit of said financial instrument.

925. The system of claim 862, wherein said means for identifying an underlying reference comprises means for identifying said underlying reference that said financial instrument converts into.

926. The system of claim 862, wherein said means for identifying an underlying reference comprises means for basing an exchange value of said financial instrument on said underlying reference.

927. The method of claim 862, wherein said predetermined period of delay comprises a period of delay greater than a contingency monitoring period.

928. A financial services system comprising means for buying a financial instrument created by:
identifying an underlying reference for said financial instrument, said underlying reference having a value;
attributing a number of said underlying references to said financial instrument;
defining a contingency, a payment becoming due on occurrence of said contingency after a predetermined period of delay.

929. The system of claim 928, wherein said means for buying said financial instrument comprises means for buying said financial instrument at a value based on at least one of:
a. said contingency;
b. said value of said underlying reference;
c. value of said payment;
d. length of said predetermined period of delay;
e. volatility in trading value of said underlying reference;
f. time until redemption, at option of issuer or holder;
g. time until maturity;
h. an interest rate; and
i. value for which said financial instrument must be redeemed on redemption date.

930. The system of claim 928, wherein said means for buying said financial instrument comprises means for bidding for said financial instrument.

931. The system of claim 928, wherein said means for buying said financial instrument comprises means for buying a derivative of said financial instrument.

932. The system of claim 928, wherein said means for buying said financial instrument comprises means for buying a part of said financial instrument.

933. The system of claim 928, wherein said defining a contingency comprises basing said contingency on an event related to said financial instrument.

934. The system of claim 928, wherein said defining a contingency comprises basing said contingency on an instrument other than said financial instrument.

935. The system of claim 928, wherein said attributing a number of said underlying references to said financial instrument comprises attributing a variable number of said underlying references to each unit of said financial instrument.

936. The system of claim 928, wherein said attributing a number of said underlying references to said financial instrument comprises attributing a constant number of said underlying references to each unit of said financial instrument.

937. The system of claim 928, wherein said identifying an underlying reference comprises identifying said underlying reference that said financial instrument converts into.

938. The system of claim 928, wherein said identifying an underlying reference comprises basing an exchange value of said financial instrument on said underlying reference.

939. The system of claim 928, wherein said predetermined period of delay comprises a period of delay greater than a contingency monitoring period.

940. A financial services system associated with a financial instrument, said system comprising:
means for identifying an underlying reference for said financial instrument, said underlying reference having a value;
means for attributing a number of said underlying references to said financial instrument;
means for defining a contingency having at least one trigger, a payment becoming due when said trigger drops below a predetermined value.

941. The system of claim 940, further comprising:
means for establishing a value for said financial instrument.

942. The system of claim 941, further comprising:
means for selling said financial instrument.

943. The system of claim 942, wherein said means for selling said financial instrument comprises means for selling said financial instrument at a value based on at least one of:
a. said contingency;
b. said value of said underlying reference;
c. value of said payment;
d. said predetermined value;
e. volatility in trading value of said underlying reference;
f. time until redemption, at option of issuer or holder;
g. time until maturity;
h. an interest rate; and
i. value for which said financial instrument must be redeemed on redemption date.

944. The system of claim 942, wherein said means for selling said financial instrument comprises means for auctioning said financial instrument.

945. The system of claim 942, wherein said means for selling said financial instrument comprises means for selling a derivative of said financial instrument.

946. The system of claim 942, wherein said means for selling said financial instrument comprises means for selling a part of said financial instrument.

947. The system of claim 942, further comprising:
means for monitoring for satisfaction of said contingency.

948. The system of claim 942, further comprising:
means for disbursing said payment.

949. The system of claim 942, further comprising:
calculating said payment.

950. The system of claim 941, further comprising:
means for monitoring for satisfaction of said contingency.

951. The system of claim 950, further comprising:
means for disbursing said payment.

952. The system of claim 950, further comprising:
means for calculating said payment.

953. The system of claim 941, further comprising:
means for disbursing said payment.

954. The system of claim 941, further comprising:
means for calculating said payment.

955. The system of claim 941, wherein said means for establishing a value for said financial instrument comprises means for basing said value for said financial instrument on at least one of:
a. said contingency;
b. said value of said underlying reference;
c. value of said payment;
d. said predetermined value;
e. volatility in trading value of said underlying reference;
f. time until redemption, at option of issuer or holder;
g. time until maturity;
h. an interest rate; and
i. value for which said financial instrument must be redeemed on redemption date.

956. The system of claim 940 further comprising:
means for selling said financial instrument.

957. The system of claim 956, wherein said means for selling said financial instrument comprises means for selling said financial instrument at a value based on at least one of:
a. said contingency;
b. said value of said underlying reference;
c. value of said payment;
d. said predetermined value;
e. volatility in trading value of said underlying reference;
f. time until redemption, at option of issuer or holder;
g. time until maturity;
h. an interest rate; and
i. value for which said financial instrument must be redeemed on redemption date.

958. The system of claim 956, wherein said means for selling said financial instrument comprises means for auctioning said financial instrument.

959. The system of claim 956, wherein said means for selling said financial instrument comprises means for selling a derivative of said financial instrument.

960. The system of claim 956, wherein said means for selling said financial instrument comprises means for selling a part of said financial instrument.

961. The system of claim 956 further comprising:
means for monitoring for satisfaction of said contingency.

962. The system of claim 956, further comprising:
means for disbursing said payment.

963. The system of claim 956, further comprising:
means for calculating said payment.

964. The system of claim 940 further comprising:
means for monitoring for satisfaction of said contingency.

965. The system of claim 964, wherein said means for monitoring for satisfaction comprises means for comparing market data to said trigger of said contingency.

966. The system of claim 964, wherein said means for monitoring comprises means for monitoring over many said contingency monitoring periods.

967. The system of claim 964, wherein said means for monitoring comprises means for monitoring realtime data.

968. The system of claim 964, further comprising:
means for disbursing said payment.

969. The system of claim 964, further comprising:
means for calculating said payment.

970. The system of claim 940, wherein said means for defining a contingency having at least one trigger comprises means for basing said trigger on an event related to said financial instrument.

971. The system of claim 940, wherein said means for defining a contingency having at least on trigger comprises means for basing said trigger on an instrument other than said financial instrument.

972. The system of claim 940, wherein said means for defining a contingency having at least one trigger comprises means for setting said trigger at an amount equal to a multiple of a prevailing market rate for a financial instrument.

973. The system of claim 972, wherein said means for setting said trigger at an amount equal to a multiple comprises means for using a multiple equal to 1.

974. The system of claim 972, wherein said means for setting said trigger at an amount equal to a multiple comprises means for using a multiple less than 1.

975. The system of claim 972, wherein said means for setting said trigger at an amount equal to a multiple comprises means for using a multiple greater than 1.

976. The system of claim 940, wherein said means for defining a contingency having at least one trigger comprises means for setting said trigger at an amount equal to a multiple of a formula amount.

977. The system of claim 976, wherein said means for setting said trigger at an amount equal to a multiple comprises means for using a multiple equal to 1.

978. The system of claim 976, wherein said means for setting said trigger at an amount equal to a multiple comprises means for using a multiple less than

979. The system of claim 976, wherein said means for setting said trigger at an amount equal to a multiple comprises means for using a multiple greater than 1.

980. The system of claim 940, wherein said predetermined value comprises a predetermined percentage of the conversion value.

981. The system of claim 940, further comprising:
means for disbursing said payment.

982. The system of claim 981, wherein said means for disbursing said payment comprises means for sending a negotiable instrument.

983. The system of claim 940, further comprising:
means for calculating said payment.

984. The system of claim 983, wherein said means for calculating said payment comprises means for establishing a formula for calculating said payment based on said value of said underlying reference.

985. The system of claim 984, wherein said means for establishing a formula comprises means for using a fixed rate formula.

986. The system of claim 984, wherein said means for establishing a formula comprises means for using a variable rate formula.

987. The system of claim 983, wherein said means for calculating said payment comprises means for calculating said payment using a periodic schedule.

988. The system of claim 987, wherein said means for calculating said payment using a periodic schedule comprises means for calculating said payment at least once per said contingency monitoring period.

989. The system of claim 987, wherein said means for calculating said payment using a periodic schedule comprises means for calculating said payment on a quarterly basis.

990. The system of claim 983, wherein said means for calculating said payment comprises means for calculating said payment based upon at least one of:
a. predetermined fixed amount,
b. trading value of said financial instrument,
c. trading yield of said financial instrument,
d. trading yield of a liability of said issuer of said financial instrument,
e. trading value of a liability of said issuer of said financial instrument,
f. trading value of a class of capital stock issued by an issuer other than said issuer of said financial instrument,
g. trading dividend yield of a class of capital stock issued by an issuer other than said issuer of said financial instrument,
h. trading value of a class of capital stock of said issuer of said financial instrument,
i. trading yield of a class of capital stock of said issuer of said financial instrument,
j. trading value of a security,
k. trading yield of a security, and
l. an index.

991. The system of claim 983, wherein said means for calculating said payment comprises means for calculating a payment only after a predetermined period of delay.

992. The system of claim 940, further comprising means for preparing at least one of:
a. a projected payment schedule;
b. an incidental analysis; and
c. a remoteness analysis.

993. The system of claim 992, wherein said means for preparing said projected payment schedule comprises means for determining a schedule of said payments based on payments necessary to produce a comparable yield.

994. The system of claim 992, wherein said means for preparing said incidental analysis comprises means for determining the amount of said payment based on assumptions regarding the contingency being satisfied.

995. The system of claim 994, wherein said means for determining the amount of said payment based on assumptions regarding the contingency being satisfied comprises means for determining the amount of said payment based on at least one of:
a. a stock price growth rate, and
b. discount rates.

996. The system of claim 992, wherein said means for preparing said remoteness analysis comprises means for determining the likelihood that said payment will be made given assumptions regarding said contingency being satisfied.

997. The system of claim 996, wherein said means for determining the likelihood that said payment will be made given assumptions regarding said contingency being satisfied comprises means for determining the likelihood that said payment will be made given a stock price growth rate and a volatility.

998. The system of claim 940, wherein said means for attributing a number of said underlying references to said financial instrument comprises means for attributing a variable number of said underlying references to each unit of said financial instrument.

999. The system of claim 940, wherein said means for attributing a number of said underlying references to said financial instrument comprises means for attributing a constant number of said underlying references to each unit of said financial instrument.

1000. The system of claim 940, wherein said means for identifying an underlying reference comprises means for identifying said underlying reference that said financial instrument converts into.

1001. The system of claim 940, wherein said means for identifying an underlying reference comprises means for basing an exchange value of said financial instrument on said underlying reference.

1002. A financial services system comprising means for buying a financial instrument created by:
identifying an underlying reference for said financial instrument, said underlying reference having a value;
attributing a number of said underlying references to said financial instrument;
defining a contingency having at least one trigger, a payment becoming due when said trigger drops below a predetermined value.

1003. The system of claim 1002, wherein said means for buying said financial instrument comprises means for buying said financial instrument at a value based on at least one of:
a. said contingency;
b. said value of said underlying reference;
c. value of said payment;
d. length of said predetermined period of delay;
e. volatility in trading value of said underlying reference;
f. time until redemption, at option of issuer or holder;
g. time until maturity;
h. an interest rate; and
i. value for which said financial instrument must be redeemed on redemption date.

1004. The system of claim 1002, wherein said means for buying said financial instrument comprises means for bidding for said financial instrument.

1005. The system of claim 1002, wherein said means for buying said financial instrument comprises means for buying a derivative of said financial instrument.

1006. The system of claim 1002, wherein said means for buying said financial instrument comprises means for buying a part of said financial instrument.

1007. The system of claim 1002, wherein said defining a contingency comprises basing said contingency on an event related to said financial instrument.

1008. The system of claim 1002, wherein said defining a contingency comprises basing said contingency on an instrument other than said financial instrument.

1009. The system of claim 1002, wherein said attributing a number of said underlying references to said financial instrument comprises attributing a variable number of said underlying references to each unit of said financial instrument.

1010. The system of claim 1002, wherein said attributing a number of said underlying references to said financial instrument comprises attributing a constant number of said underlying references to each unit of said financial instrument.

1011. The system of claim 1002, wherein said identifying an underlying reference comprises identifying said underlying reference that said financial instrument converts into.

1012. The system of claim 1002, wherein said identifying an underlying reference comprises basing an exchange value of said financial instrument on said underlying reference.

1013. A financial services system associated with a financial instrument, said system comprising:
means for identifying an underlying reference for said financial instrument, said underlying reference having a value;
means for attributing a number of said underlying references to said financial instrument;
means for defining a contingency having multiple triggers, a payment becoming due when any one of said triggers drops below a predetermined value.

1014. The system of claim 1013, further comprising:
means for establishing a value for said financial instrument.

1015. The system of claim 1014, further comprising:
means for selling said financial instrument.

1016. The system of claim 1015, wherein said means for selling said financial instrument comprises means for selling said financial instrument at a value based on at least one of:
a. said contingency;
b. said value of said underlying reference;
c. value of said payment;
d. said predetermined value;
e. volatility in trading value of said underlying reference;
f. time until redemption, at option of issuer or holder;
g. time until maturity;
h. an interest rate; and
i. value for which said financial instrument must be redeemed on redemption date.

1017. The system of claim 1015, wherein said means for selling said financial instrument comprises means for auctioning said financial instrument.

1018. The system of claim 1015, wherein said means for selling said financial instrument comprises means for selling a derivative of said financial instrument.

1019. The system of claim 1015, wherein said means for selling said financial instrument comprises means for selling a part of said financial instrument.

1020. The system of claim 1015, further comprising:
means for monitoring for satisfaction of said contingency.

1021. The system of claim 1015, further comprising:
means for disbursing said payment.

1022. The system of claim 1015, further comprising:
calculating said payment.

1023. The system of claim 1014, further comprising:
means for monitoring for satisfaction of said contingency.

1024. The system of claim 1023, further comprising:
means for disbursing said payment.

1025. The system of claim 1023, further comprising:
means for calculating said payment.

1026. The system of claim 1014, further comprising:
means for disbursing said payment.

1027. The system of claim 1014, further comprising:
means for calculating said payment.

1028. The system of claim 1014, wherein said means for establishing a value for said financial instrument comprises means for basing said value for said financial instrument on at least one of:
a. said contingency;
b. said value of said underlying reference;
c. value of said payment;
d. said predetermined value;
e. volatility in trading value of said underlying reference;
f. time until redemption, at option of issuer or holder;
g. time until maturity;
h. an interest rate; and
i. value for which said financial instrument must be redeemed on redemption date.

1029. The system of claim 1013 further comprising:
means for selling said financial instrument.

1030. The system of claim 1029, wherein said means for selling said financial instrument comprises means for selling said financial instrument at a value based on at least one of:
a. said contingency;
b. said value of said underlying reference;
c. value of said payment;
d. said predetermined value;
e. volatility in trading value of said underlying reference;
f. time until redemption, at option of issuer or holder;
g. time until maturity;
h. an interest rate; and
i. value for which said financial instrument must be redeemed on redemption date.

1031. The system of claim 1029, wherein said means for selling said financial instrument comprises means for auctioning said financial instrument.

1032. The system of claim 1029, wherein said means for selling said financial instrument comprises means for selling a derivative of said financial instrument.

1033. The system of claim 1029, wherein said means for selling said financial instrument comprises means for selling a part of said financial instrument.

1034. The system of claim 1029 further comprising:
means for monitoring for satisfaction of said contingency.

1035. The system of claim 1029, further comprising:
means for disbursing said payment.

1036. The system of claim 1029, further comprising:
means for calculating said payment.

1037. The system of claim 1013 further comprising:
means for monitoring for satisfaction of said contingency.

1038. The system of claim 1037, wherein said means for monitoring for satisfaction comprises means for comparing market data to said trigger of said contingency.

1039. The system of claim 1037, wherein said means for monitoring comprises means for monitoring over many said contingency monitoring periods.

1040. The system of claim 1037, wherein said means for monitoring comprises means for monitoring realtime data.

1041. The system of claim 1037, further comprising:
means for disbursing said payment.

1042. The system of claim 1037, further comprising:
means for calculating said payment.

1043. The system of claim 1013, wherein said means for defining a contingency having multiple triggers comprises means for basing said triggers on events related to said financial instrument.

1044. The system of claim 1013, wherein said means for defining a contingency having multiple triggers comprises means for basing said triggers on instruments other than said financial instrument.

1045. The system of claim 1013, wherein said means for defining a contingency having multiple triggers comprises means for setting said triggers at amounts equal to a multiple of prevailing market rates for financial instruments.

1046. The system of claim 1045, wherein said means for setting said triggers at amounts equal to a multiple comprises means for using a multiple equal to 1.

1047. The system of claim 1045, wherein said means for setting said triggers at amounts equal to a multiple comprises means for using a multiple less than 1.

1048. The system of claim 1045, wherein said means for setting said triggers at amounts equal to a multiple comprises means for using a multiple greater than 1.

1049. The system of claim 1013, wherein said means for defining a contingency having multiple triggers comprises means for setting said triggers at amounts equal to a multiple of formulae amounts.

1050. The system of claim 1049, wherein said means for setting said triggers at amounts equal to a multiple comprises means for using a multiple equal to 1.

1051. The system of claim 1049, wherein said means for setting said triggers at amounts equal to a multiple comprises means for using a multiple less than 1.

1052. The system of claim 1049, wherein said means for setting said triggers at amounts equal to a multiple comprises means for using a multiple greater than 1.

1053. The system of claim 1013, wherein said predetermined value comprises a predetermined percentage of the conversion value.

1054. The system of claim 1013, further comprising:
means for disbursing said payment.

1055. The system of claim 1054, wherein said means for disbursing said payment comprises means for sending a negotiable instrument.

1056. The system of claim 1013, further comprising:
means for calculating said payment.

1057. The system of claim 1056, wherein said means for calculating said payment comprises means for establishing a formula for calculating said payment based on said value of said underlying reference.

1058. The system of claim 1057, wherein said means for establishing a formula comprises means for using a fixed rate formula.

1059. The system of claim 1057, wherein said means for establishing a formula comprises means for using a variable rate formula.

1060. The system of claim 1056, wherein said means for calculating said payment comprises means for calculating said payment using a periodic schedule.

1061. The system of claim 1060, wherein said means for calculating said payment using a periodic schedule comprises means for calculating said payment at least once per said contingency monitoring period.

1062. The system of claim 1060, wherein said means for calculating said payment using a periodic schedule comprises means for calculating said payment on a quarterly basis.

1063. The system of claim 1056, wherein said means for calculating said payment comprises means for calculating said payment based upon at least one of:
a. predetermined fixed amount,
b. trading value of said financial instrument,
c. trading yield of said financial instrument,
d. trading yield of a liability of said issuer of said financial instrument,
e. trading value of a liability of said issuer of said financial instrument,
f. trading value of a class of capital stock issued by an issuer other than said issuer of said financial instrument,
g. trading dividend yield of a class of capital stock issued by an issuer other than said issuer of said financial instrument,
h. trading value of a class of capital stock of said issuer of said financial instrument,
i. trading yield of a class of capital stock of said issuer of said financial instrument,
j. trading value of a security,
k. trading yield of a security, and
l. an index.

1064. The system of claim 1056, wherein said means for calculating said payment comprises means for calculating a payment only after a predetermined period of delay.

1065. The system of claim 1013, further comprising means for preparing at least one of:
a. a projected payment schedule;
b. an incidental analysis; and
c. a remoteness analysis.

1066. The system of claim 1065, wherein said means for preparing said projected payment schedule comprises means for determining a schedule of said payments based on payments necessary to produce a comparable yield.

1067. The system of claim 1065, wherein said means for preparing said incidental analysis comprises means for determining the amount of said payment based on assumptions regarding the contingency being satisfied.

1068. The system of claim 1067, wherein said means for determining the amount of said payment based on assumptions regarding the contingency being satisfied comprises means for determining the amount of said payment based on at least one of:
a. a stock price growth rate, and
b. discount rates.

1069. The system of claim 1065, wherein said means for preparing said remoteness analysis comprises means for determining the likelihood that said payment will be made given assumptions regarding said contingency being satisfied.

1070. The system of claim 1069, wherein said means for determining the likelihood that said payment will be made given assumptions regarding said contingency being satisfied comprises means for determining the likelihood that said payment will be made given a stock price growth rate and a volatility.

1071. The system of claim 1013, wherein said means for attributing a number of said underlying references to said financial instrument comprises means for attributing a variable number of said underlying references to each unit of said financial instrument.

1072. The system of claim 1013, wherein said means for attributing a number of said underlying references to said financial instrument comprises means for attributing a constant number of said underlying references to each unit of said financial instrument.

1073. The system of claim 1013, wherein said means for identifying an underlying reference comprises means for identifying said underlying reference that said financial instrument converts into.

1074. The system of claim 1013, wherein said means for identifying an underlying reference comprises means for basing an exchange value of said financial instrument on said underlying reference

1075. A financial services system comprising means for buying a financial instrument created by:
identifying an underlying reference for said financial instrument, said underlying reference having a value;
attributing a number of said underlying references to said financial instrument;
defining a contingency having multiple triggers, a payment becoming due when any one of said triggers drops below a predetermined value.

1076. The system of claim 1075, wherein said means for buying said financial instrument comprises means for buying said financial instrument at a value based on at least one of:
a. said contingency;
b. said value of said underlying reference;
c. value of said payment;
d. length of said predetermined period of delay;
e. volatility in trading value of said underlying reference;
f. time until redemption, at option of issuer or holder;
g. time until maturity;
h. an interest rate; and
i. value for which said financial instrument must be redeemed on redemption date.

1077. The system of claim 1075, wherein said means for buying said financial instrument comprises means for bidding for said financial instrument.

1078. The system of claim 1075, wherein said means for buying said financial instrument comprises means for buying a derivative of said financial instrument.

1079. The system of claim 1075, wherein said means for buying said financial instrument comprises means for buying a part of said financial instrument.

1080. The system of claim 1075, wherein said defining a contingency comprises basing said contingency on an event related to said financial instrument.

1081. The system of claim 1075, wherein said defining a contingency comprises basing said contingency on an instrument other than said financial instrument.

1082. The system of claim 1075, wherein said attributing a number of said underlying references to said financial instrument comprises attributing a variable number of said underlying references to each unit of said financial instrument.

1083. The system of claim 1075, wherein said attributing a number of said underlying references to said financial instrument comprises attributing a constant number of said underlying references to each unit of said financial instrument.

1084. The system of claim 1075, wherein said identifying an underlying reference comprises identifying said underlying reference that said financial instrument converts into.

1085. The system of claim 1075, wherein said identifying an underlying reference comprises basing an exchange value of said financial instrument on said underlying reference.

1086. A financial services system associated with a financial instrument, said system comprising:
means for identifying an underlying reference for said financial instrument, said underlying reference having a value;
means for attributing a number of said underlying references to said financial instrument;
means for defining a contingency having multiple triggers, a payment becoming due when multiple triggers drop below respective predetermined values.

1087. The system of claim 1086, further comprising:
means for establishing a value for said financial instrument.

1088. The system of claim 1087, further comprising:
means for selling said financial instrument.

1089. The system of claim 1088, wherein said means for selling said financial instrument comprises means for selling said financial instrument at a value based on at least one of:
a. said contingency;
b. said value of said underlying reference;
c. value of said payment;
d. said predetermined values;
e. volatility in trading value of said underlying reference;
f. time until redemption, at option of issuer or holder;
g. time until maturity;
h. an interest rate; and
i. value for which said financial instrument must be redeemed on redemption date.

1090. The system of claim 1088, wherein said means for selling said financial instrument comprises means for auctioning said financial instrument.

1091. The system of claim 1088, wherein said means for selling said financial instrument comprises means for selling a derivative of said financial instrument.

1092. The system of claim 1088, wherein said means for selling said financial instrument comprises means for selling a part of said financial instrument.

1093. The system of claim 1088, further comprising:
means for monitoring for satisfaction of said contingency.

1094. The system of claim 1088, further comprising:
means for disbursing said payment.

1095. The system of claim 1088, further comprising:
calculating said payment.

1096. The system of claim 1087, further comprising:
means for monitoring for satisfaction of said contingency.

1097. The system of claim 1096, further comprising:
means for disbursing said payment.

1098. The system of claim 1096, further comprising:
means for calculating said payment.

1099. The system of claim 1087, further comprising:
means for disbursing said payment.

1100. The system of claim 1087, further comprising:
means for calculating said payment.

1101. The system of claim 1087, wherein said means for establishing a value for said financial instrument comprises means for basing said value for said financial instrument on at least one of:
a. said contingency;
b. said value of said underlying reference;
c. value of said payment;
d. said predetermined values;
e. volatility in trading value of said underlying reference;
f. time until redemption, at option of issuer or holder;
g. time until maturity;
h. an interest rate; and
i. value for which said financial instrument must be redeemed on redemption date.

1102. The system of claim 1086 further comprising:
means for selling said financial instrument.

1103. The system of claim 1102, wherein said means for selling said financial instrument comprises means for selling said financial instrument at a value based on at least one of:
a. said contingency;
b. said value of said underlying reference;
c. value of said payment;
d. said predetermined values;
e. volatility in trading value of said underlying reference;
f. time until redemption, at option of issuer or holder;
g. time until maturity;
h. an interest rate; and
i. value for which said financial instrument must be redeemed on redemption date.

1104. The system of claim 1102, wherein said means for selling said financial instrument comprises means for auctioning said financial instrument.

1105. The system of claim 1102, wherein said means for selling said financial instrument comprises means for selling a derivative of said financial instrument.

1106. The system of claim 1102, wherein said means for selling said financial instrument comprises means for selling a part of said financial instrument.

1107. The system of claim 1102 further comprising:
means for monitoring for satisfaction of said contingency.

1108. The system of claim 1102, further comprising:
means for disbursing said payment.

1109. The system of claim 1102, further comprising:
means for calculating said payment.

1110. The system of claim 1086 further comprising:
means for monitoring for satisfaction of said contingency.

1111. The system of claim 1110, wherein said means for monitoring for satisfaction comprises means for comparing market data to said trigger of said contingency.

1112. The system of claim 1110, wherein said means for monitoring comprises means for monitoring over many said contingency monitoring periods.

1113. The system of claim 1110, wherein said means for monitoring comprises means for monitoring realtime data.

1114. The system of claim 1110, further comprising:
means for disbursing said payment.

1115. The system of claim 1110, further comprising:
means for calculating said payment.

1116. The system of claim 1086, wherein said means for defining a contingency having multiple triggers comprises means for basing said triggers on events related to said financial instrument.

1117. The system of claim 1086, wherein said means for defining a contingency having multiple triggers comprises means for basing said triggers on instruments other than said financial instrument.

1118. The system of claim 1086, wherein said means for defining a contingency having multiple triggers comprises means for setting said triggers at amounts equal to a multiple of prevailing market rates for financial instruments.

1119. The system of claim 1118, wherein said means for setting said triggers at amounts equal to a multiple comprises means for using a multiple equal to 1.

1120. The system of claim 1118, wherein said means for setting said triggers at amounts equal to a multiple comprises means for using a multiple less than 1.

1121. The system of claim 1118, wherein said means for setting said triggers at amounts equal to a multiple comprises means for using a multiple greater than 1.

1122. The system of claim 1086, wherein said means for defining a contingency having multiple triggers comprises means for setting said triggers at amounts equal to a multiple of formulae amounts.

1123. The system of claim 1122, wherein said means for setting said triggers at amounts equal to a multiple comprises means for using a multiple equal to 1.

1124. The system of claim 1122, wherein said means for setting said triggers at amounts equal to a multiple comprises means for using a multiple less than 1.

1125. The system of claim 1122, wherein said means for setting said triggers at amounts equal to a multiple comprises means for using a multiple greater than 1.

1126. The system of claim 1086, wherein said predetermined values comprise predetermined percentages of the conversion value.

1127. The system of claim 1086, further comprising:
means for disbursing said payment.

1128. The system of claim 1127, wherein said means for disbursing said payment comprises means for sending a negotiable instrument.

1129. The system of claim 1086, further comprising:
means for calculating said payment.

1130. The system of claim 1129, wherein said means for calculating said payment comprises means for establishing a formula for calculating said payment based on said value of said underlying reference.

1131. The system of claim 1130, wherein said means for establishing a formula comprises means for using a fixed rate formula.

1132. The system of claim 1130, wherein said means for establishing a formula comprises means for using a variable rate formula.

1133. The system of claim 1129, wherein said means for calculating said payment comprises means for calculating said payment using a periodic schedule.

1134. The system of claim 1133, wherein said means for calculating said payment using a periodic schedule comprises means for calculating said payment at least once per said contingency monitoring period.

1135. The system of claim 1133, wherein said means for calculating said payment using a periodic schedule comprises means for calculating said payment on a quarterly basis.

1136. The system of claim 1129, wherein said means for calculating said payment comprises means for calculating said payment based upon at least one of:
a. predetermined fixed amount,
b. trading value of said financial instrument,
c. trading yield of said financial instrument,
d. trading yield of a liability of said issuer of said financial instrument,
e. trading value of a liability of said issuer of said financial instrument,
f. trading value of a class of capital stock issued by an issuer other than said issuer of said financial instrument,
g. trading dividend yield of a class of capital stock issued by an issuer other than said issuer of said financial instrument,
h. trading value of a class of capital stock of said issuer of said financial instrument,
i. trading yield of a class of capital stock of said issuer of said financial instrument,
j. trading value of a security,
k. trading yield of a security, and
l. an index.

1137. The system of claim 1129, wherein said means for calculating said payment comprises means for calculating a payment only after a predetermined period of delay.

1138. The system of claim 1086, further comprising means for preparing at least one of:
a. a projected payment schedule;
b. an incidental analysis; and
c. a remoteness analysis.

1139. The system of claim 1138, wherein said means for preparing said projected payment schedule comprises means for determining a schedule of said payments based on payments necessary to produce a comparable yield.

1140. The system of claim 1138, wherein said means for preparing said incidental analysis comprises means for determining the amount of said payment based on assumptions regarding the contingency being satisfied.

1141. The system of claim 1140, wherein said means for determining the amount of said payment based on assumptions regarding the contingency being satisfied comprises means for determining the amount of said payment based on at least one of:
a. a stock price growth rate, and
b. discount rates.

1142. The system of claim 1138, wherein said means for preparing said remoteness analysis comprises means for determining the likelihood that said payment will be made given assumptions regarding said contingency being satisfied.

1143. The system of claim 1142, wherein said means for determining the likelihood that said payment will be made given assumptions regarding said contingency being satisfied comprises means for determining the likelihood that said payment will be made given a stock price growth rate and a volatility.

1144. The system of claim 1086, wherein said means for attributing a number of said underlying references to said financial instrument comprises means for attributing a variable number of said underlying references to each unit of said financial instrument.

1145. The system of claim 1086, wherein said means for attributing a number of said underlying references to said financial instrument comprises means for attributing a constant number of said underlying references to each unit of said financial instrument.

1146. The system of claim 1086, wherein said means for identifying an underlying reference comprises means for identifying said underlying reference that said financial instrument converts into.

1147. The system of claim 1086, wherein said means for identifying an underlying reference comprises means for basing an exchange value of said financial instrument on said underlying reference.

1148. A financial services system comprising means for buying a financial instrument created by:
identifying an underlying reference for said financial instrument, said underlying reference having a value;
attributing a number of said underlying references to said financial instrument;
defining a contingency having multiple triggers, a payment becoming due when multiple triggers drop below respective predetermined values.

1149. The system of claim 1148, wherein said means for buying said financial instrument comprises means for buying said financial instrument at a value based on at least one of:
a. said contingency;
b. said value of said underlying reference;
c. value of said payment;
d. length of said predetermined period of delay;
e. volatility in trading value of said underlying reference;
f. time until redemption, at option of issuer or holder;
g. time until maturity;
h. an interest rate; and
i. value for which said financial instrument must be redeemed on redemption date.

1150. The system of claim 1148, wherein said means for buying said financial instrument comprises means for bidding for said financial instrument.

1151. The system of claim 1148, wherein said means for buying said financial instrument comprises means for buying a derivative of said financial instrument.

1152. The system of claim 1148, wherein said means for buying said financial instrument comprises means for buying a part of said financial instrument.

1153. The system of claim 1148, wherein said defining multiple contingencies comprises basing said multiple contingencies on events related to said financial instrument.

1154. The system of claim 1148, wherein said defining multiple contingencies comprises basing said multiple contingencies on instruments other than said financial instrument.

1155. The system of claim 1148, wherein said attributing a number of said underlying references to said financial instrument comprises attributing a variable number of said underlying references to each unit of said financial instrument.

1156. The system of claim 1148, wherein said attributing a number of said underlying references to said financial instrument comprises attributing a constant number of said underlying references to each unit of said financial instrument.

1157. The system of claim 1148, wherein said identifying an underlying reference comprises identifying said underlying reference that said financial instrument converts into.

1158. The system of claim 1148, wherein said identifying an underlying reference comprises basing an exchange value of said financial instrument on said underlying reference.

1159. A financial services system associated with a financial instrument, said system comprising:
means for identifying an underlying reference for said financial instrument, said underlying reference having a value;
means for attributing a number of said underlying references to said financial instrument;
means for defining multiple contingencies each having at least one trigger, a payment becoming due when any said trigger of any said contingencies drops below a predetermined value.

1160. The system of claim 1159, further comprising:
means for establishing a value for said financial instrument.

1161. The system of claim 1160, further comprising:
means for selling said financial instrument.

1162. The system of claim 1161, wherein said means for selling said financial instrument comprises means for selling said financial instrument at a value based on at least one of:
a. said contingency;
b. said value of said underlying reference;
c. value of said payment;
d. said predetermined value;
e. volatility in trading value of said underlying reference;
f. time until redemption, at option of issuer or holder;
g. time until maturity;
h. an interest rate; and
i. value for which said financial instrument must be redeemed on redemption date.

1163. The system of claim 1161, wherein said means for selling said financial instrument comprises means for auctioning said financial instrument.

1164. The system of claim 1161, wherein said means for selling said financial instrument comprises means for selling a derivative of said financial instrument.

1165. The system of claim 1161, wherein said means for selling said financial instrument comprises means for selling a part of said financial instrument.

1166. The system of claim 1161, further comprising:
means for monitoring for satisfaction of said contingency.

1167. The system of claim 1161, further comprising:
means for disbursing said payment.

1168. The system of claim 1161, further comprising:
calculating said payment.

1169. The system of claim 1160, further comprising:
means for monitoring for satisfaction of said contingency.

1170. The system of claim 1169, further comprising:
means for disbursing said payment.

1171. The system of claim 1169, further comprising:
means for calculating said payment.

1172. The system of claim 1160, further comprising:
means for disbursing said payment.

1173. The system of claim 1160, further comprising:
means for calculating said payment.

1174. The system of claim 1160, wherein said means for establishing a value for said financial instrument comprises means for basing said value for said financial instrument on at least one of:
a. said contingency;
b. said value of said underlying reference;
c. value of said payment;
d. said predetermined value;
e. volatility in trading value of said underlying reference;
f. time until redemption, at option of issuer or holder;
g. time until maturity;
h. an interest rate; and
i. value for which said financial instrument must be redeemed on redemption date.

1175. The system of claim 1159 further comprising:
means for selling said financial instrument.

1176. The system of claim 1175, wherein said means for selling said financial instrument comprises means for selling said financial instrument at a value based on at least one of:
a. said contingency;
b. said value of said underlying reference;
c. value of said payment;
d. said predetermined value;
e. volatility in trading value of said underlying reference;
f. time until redemption, at option of issuer or holder;
g. time until maturity;
h. an interest rate; and
i. value for which said financial instrument must be redeemed on redemption date.

1177. The system of claim 1175, wherein said means for selling said financial instrument comprises means for auctioning said financial instrument.

1178. The system of claim 1175, wherein said means for selling said financial instrument comprises means for selling a derivative of said financial instrument.

1179. The system of claim 1175, wherein said means for selling said financial instrument comprises means for selling a part of said financial instrument.

1180. The system of claim 1175 further comprising:
means for monitoring for satisfaction of said contingency.

1181. The system of claim 1175, further comprising:
means for disbursing said payment.

1182. The system of claim 1175, further comprising:
means for calculating said payment.

1183. The system of claim 1159 further comprising:
means for monitoring for satisfaction of said contingency.

1184. The system of claim 1183, wherein said means for monitoring for satisfaction comprises means for comparing market data to said trigger of said contingency.

1185. The system of claim 1183, wherein said means for monitoring comprises means for monitoring over many said contingency monitoring periods.

1186. The system of claim 1183, wherein said means for monitoring comprises means for monitoring realtime data.

1187. The system of claim 1183, further comprising:
means for disbursing said payment.

1188. The system of claim 1183, further comprising:
means for calculating said payment.

1189. The system of claim 1159, wherein said means for defining multiple contingencies each having at least one trigger comprises means for basing said trigger on an event related to said financial instrument.

1190. The system of claim 1159, wherein said means for defining multiple contingencies each having at least one trigger comprises means for basing said trigger on an instrument other than said financial instrument.

1191. The system of claim 1159, wherein said means for defining multiple contingencies each having at least one trigger comprises means for setting said trigger at an amount equal to a multiple of a prevailing market rate for a financial instrument.

1192. The system of claim 1191, wherein said means for setting said trigger at an amount equal to a multiple comprises means for using a multiple equal to 1.

1193. The system of claim 1191, wherein said means for setting said trigger at an amount equal to a multiple comprises means for using a multiple less than 1.

1194. The system of claim 1191, wherein said means for setting said trigger at an amount equal to a multiple comprises means for using a multiple greater than 1.

1195. The system of claim 1159, wherein means for defining multiple contingencies each having at least one trigger comprises means for setting said trigger at an amount equal to a multiple of a formula amount.

1196. The system of claim 1195, wherein said means for setting said trigger at an amount equal to a multiple comprises means for using a multiple equal to 1.

1197. The system of claim 1195, wherein said means for setting said trigger at an amount equal to a multiple comprises means for using a multiple less than 1.

1198. The system of claim 1195, wherein said means for setting said trigger at an amount equal to a multiple comprises means for using a multiple greater than 1.

1199. The system of claim 1159, wherein said predetermined value comprises a predetermined percentage of the conversion value.

1200. The system of claim 1159, further comprising:
means for disbursing said payment.

1201. The system of claim 1200, wherein said means for disbursing said payment comprises means for sending a negotiable instrument.

1202. The system of claim 1159, further comprising:
means for calculating said payment.

1203. The system of claim 1202, wherein said means for calculating said payment comprises means for establishing a formula for calculating said payment based on said value of said underlying reference.

1204. The system of claim 1203, wherein said means for establishing a formula comprises means for using a fixed rate formula.

1205. The system of claim 1203, wherein said means for establishing a formula comprises means for using a variable rate formula.

1206. The system of claim 1202, wherein said means for calculating said payment comprises means for calculating said payment using a periodic schedule.

1207. The system of claim 1206, wherein said means for calculating said payment using a periodic schedule comprises means for calculating said payment at least once per said contingency monitoring period.

1208. The system of claim 1206, wherein said means for calculating said payment using a periodic schedule comprises means for calculating said payment on a quarterly basis.

1209. The system of claim 1202, wherein said means for calculating said payment comprises means for calculating said payment based upon at least one of:
a. predetermined fixed amount,
b. trading value of said financial instrument,
c. trading yield of said financial instrument,
d. trading yield of a liability of said issuer of said financial instrument,
e. trading value of a liability of said issuer of said financial instrument,
f. trading value of a class of capital stock issued by an issuer other than said issuer of said financial instrument,
g. trading dividend yield of a class of capital stock issued by an issuer other than said issuer of said financial instrument,
h. trading value of a class of capital stock of said issuer of said financial instrument,
i. trading yield of a class of capital stock of said issuer of said financial instrument,
j. trading value of a security,
k. trading yield of a security, and
l. an index.

1210. The system of claim 1202, wherein said means for calculating said payment comprises means for calculating a payment only after a predetermined period of delay.

1211. The system of claim 1159, further comprising means for preparing at least one of:
a. a projected payment schedule;
b. an incidental analysis; and
c. a remoteness analysis.

1212. The system of claim 1211, wherein said means for preparing said projected payment schedule comprises means for determining a schedule of said payments based on payments necessary to produce a comparable yield.

1213. The system of claim 1211, wherein said means for preparing said incidental analysis comprises means for determining the amount of said payment based on assumptions regarding the contingency being satisfied.

1214. The system of claim 1213, wherein said means for determining the amount of said payment based on assumptions regarding the contingency being satisfied comprises means for determining the amount of said payment based on at least one of:
a. a stock price growth rate, and
b. discount rates.

1215. The system of claim 1211, wherein said means for preparing said remoteness analysis comprises means for determining the likelihood that said payment will be made given assumptions regarding said contingency being satisfied.

1216. The system of claim 1215, wherein said means for determining the likelihood that said payment will be made given assumptions regarding said contingency being satisfied comprises means for determining the likelihood that said payment will be made given a stock price growth rate and a volatility.

1217. The system of claim 1159, wherein said means for attributing a number of said underlying references to said financial instrument comprises means for attributing a variable number of said underlying references to each unit of said financial instrument.

1218. The system of claim 1159, wherein said means for attributing a number of said underlying references to said financial instrument comprises means for attributing a constant number of said underlying references to each unit of said financial instrument.

1219. The system of claim 1159, wherein said means for identifying an underlying reference comprises means for identifying said underlying reference that said financial instrument converts into.

1220. The system of claim 1159, wherein said means for identifying an underlying reference comprises means for basing an exchange value of said financial instrument on said underlying reference.

1221. A financial services system comprising means for buying a financial instrument created by:
identifying an underlying reference for said financial instrument, said underlying reference having a value;
attributing a number of said underlying references to said financial instrument;
defining multiple contingencies each having at least one trigger, a payment becoming due when any said trigger of any said contingencies drops below a predetermined value.

1222. The system of claim 1221, wherein said means for buying said financial instrument comprises means for buying said financial instrument at a value based on at least one of:
a. said contingency;
b. said value of said underlying reference;
c. value of said payment;
d. length of said predetermined period of delay;
e. volatility in trading value of said underlying reference;
f. time until redemption, at option of issuer or holder;
g. time until maturity;
h. an interest rate; and
i. value for which said financial instrument must be redeemed on redemption date.

1223. The system of claim 1221, wherein said means for buying said financial instrument comprises means for bidding for said financial instrument.

1224. The system of claim 1221, wherein said means for buying said financial instrument comprises means for buying a derivative of said financial instrument.

1225. The system of claim 1221, wherein said means for buying said financial instrument comprises means for buying a part of said financial instrument.

1226. The system of claim 1221, wherein said defining multiple contingencies comprises basing said multiple contingencies on events related to said financial instrument.

1227. The system of claim 1221, wherein said defining multiple contingencies comprises basing said multiple contingencies on instruments other than said financial instrument.

1228. The system of claim 1221, wherein said attributing a number of said underlying references to said financial instrument comprises attributing a variable number of said underlying references to each unit of said financial instrument.

1229. The system of claim 1221, wherein said attributing a number of said underlying references to said financial instrument comprises attributing a constant number of said underlying references to each unit of said financial instrument.

1230. The system of claim 1221, wherein said identifying an underlying reference comprises identifying said underlying reference that said financial instrument converts into.

1231. The system of claim 1221, wherein said identifying an underlying reference comprises basing an exchange value of said financial instrument on said underlying reference.

1232. A financial services system associated with a financial instrument, said system comprising:
means for identifying an underlying reference for said financial instrument, said underlying reference having a value;
means for attributing a number of said underlying references to said financial instrument;
means for defining multiple contingencies each with multiple triggers, a payment becoming due when one of said multiple triggers of any of said contingencies drops below a predetermined value.

1233. The system of claim 1232, further comprising:
means for establishing a value for said financial instrument.

1234. The system of claim 1233, further comprising:
means for selling said financial instrument.

1235. The system of claim 1234, wherein said means for selling said financial instrument comprises means for selling said financial instrument at a value based on at least one of:
a. said contingency;
b. said value of said underlying reference;
c. value of said payment;
d. said predetermined value;
e. volatility in trading value of said underlying reference;
f. time until redemption, at option of issuer or holder;
g. time until maturity;
h. an interest rate; and
i. value for which said financial instrument must be redeemed on redemption date.

1236. The system of claim 1234, wherein said means for selling said financial instrument comprises means for auctioning said financial instrument.

1237. The system of claim 1234, wherein said means for selling said financial instrument comprises means for selling a derivative of said financial instrument.

1238. The system of claim 1234, wherein said means for selling said financial instrument comprises means for selling a part of said financial instrument.

1239. The system of claim 1234, further comprising:
means for monitoring for satisfaction of said contingency.

1240. The system of claim 1234, further comprising:
means for disbursing said payment.

1241. The system of claim 1234, further comprising:
calculating said payment.

1242. The system of claim 1233, further comprising:
means for monitoring for satisfaction of said contingency.

1243. The system of claim 1242, further comprising:
means for disbursing said payment.

1244. The system of claim 1242, further comprising:
means for calculating said payment.

1245. The system of claim 1233, further comprising:
means for disbursing said payment.

1246. The system of claim 1233, further comprising:
means for calculating said payment.

1247. The system of claim 1233, wherein said means for establishing a value for said financial instrument comprises means for basing said value for said financial instrument on at least one of:
a. said contingency;
b. said value of said underlying reference;
c. value of said payment;
d. said predetermined value;
e. volatility in trading value of said underlying reference;
f. time until redemption, at option of issuer or holder;
g. time until maturity;
h. an interest rate; and
i. value for which said financial instrument must be redeemed on redemption date.

1248. The system of claim 1232 further comprising:
means for selling said financial instrument.

1249. The system of claim 1248, wherein said means for selling said financial instrument comprises means for selling said financial instrument at a value based on at least one of:
a. said contingency;
b. said value of said underlying reference;
c. value of said payment;
d. said predetermined value;
e. volatility in trading value of said underlying reference;
f. time until redemption, at option of issuer or holder;
g. time until maturity;
h. an interest rate; and
i. value for which said financial instrument must be redeemed on redemption date.

1250. The system of claim 1248, wherein said means for selling said financial instrument comprises means for auctioning said financial instrument.

1251. The system of claim 1248, wherein said means for selling said financial instrument comprises means for selling a derivative of said financial instrument.

1252. The system of claim 1248, wherein said means for selling said financial instrument comprises means for selling a part of said financial instrument.

1253. The system of claim 1248 further comprising:
means for monitoring for satisfaction of said contingency.

1254. The system of claim 1248, further comprising:
means for disbursing said payment.

1255. The system of claim 1248, further comprising:
means for calculating said payment.

1256. The system of claim 1232 further comprising:
means for monitoring for satisfaction of said contingency.

1257. The system of claim 1256, wherein said means for monitoring for satisfaction comprises means for comparing market data to said trigger of said contingency.

1258. The system of claim 1256, wherein said means for monitoring comprises means for monitoring over many said contingency monitoring periods.

1259. The system of claim 1256, wherein said means for monitoring comprises means for monitoring realtime data.

1260. The system of claim 1256, further comprising:
means for disbursing said payment.

1261. The system of claim 1256, further comprising:
means for calculating said payment.

1262. The system of claim 1232, wherein said means for defining multiple contingencies each with multiple triggers comprises means for basing said triggers on events related to said financial instrument.

1263. The system of claim 1232, wherein said means for defining multiple contingencies each with multiple triggers comprises means for basing said triggers on instruments other than said financial instrument.

1264. The system of claim 1232, wherein said means for defining multiple contingencies each with multiple triggers comprises means for setting said triggers at amounts equal to a multiple of prevailing market rates for financial instruments.

1265. The system of claim 1264, wherein said means for setting said triggers at amounts equal to a multiple comprises means for using a multiple equal to 1.

1266. The system of claim 1264, wherein said means for setting said triggers at amounts equal to a multiple comprises means for using a multiple less than 1.

1267. The system of claim 1264, wherein said means for setting said triggers at amounts equal to a multiple comprises means for using a multiple greater than 1.

1268. The system of claim 1232, wherein said means for defining multiple contingencies each with multiple triggers comprises means for setting said triggers at amounts equal to a multiple of formulae amounts.

1269. The system of claim 1268, wherein said means for setting said triggers at amounts equal to a multiple comprises means for using a multiple equal to 1.

1270. The system of claim 1268, wherein said means for setting said triggers at amounts equal to a multiple comprises means for using a multiple less than 1.

1271. The system of claim 1268, wherein said means for setting said triggers at amounts equal to a multiple comprises means for using a multiple greater than 1.

1272. The system of claim 1232, wherein said predetermined value comprises a predetermined percentage of the conversion value.

1273. The system of claim 1232, further comprising:
means for disbursing said payment.

1274. The system of claim 1273, wherein said means for disbursing said payment comprises means for sending a negotiable instrument.

1275. The system of claim 1232, further comprising:
means for calculating said payment.

1276. The system of claim 1275, wherein said means for calculating said payment comprises means for establishing a formula for calculating said payment based on said value of said underlying reference.

1277. The system of claim 1276, wherein said means for establishing a formula comprises means for using a fixed rate formula.

1278. The system of claim 1276, wherein said means for establishing a formula comprises means for using a variable rate formula.

1279. The system of claim 1275, wherein said means for calculating said payment comprises means for calculating said payment using a periodic schedule.

1280. The system of claim 1279, wherein said means for calculating said payment using a periodic schedule comprises means for calculating said payment at least once per said contingency monitoring period.

1281. The system of claim 1279, wherein said means for calculating said payment using a periodic schedule comprises means for calculating said payment on a quarterly basis.

1282. The system of claim 1275, wherein said means for calculating said payment comprises means for calculating said payment based upon at least one of:
a. predetermined fixed amount,
b. trading value of said financial instrument,
c. trading yield of said financial instrument,
d. trading yield of a liability of said issuer of said financial instrument,
e. trading value of a liability of said issuer of said financial instrument,
f. trading value of a class of capital stock issued by an issuer other than said issuer of said financial instrument,
g. trading dividend yield of a class of capital stock issued by an issuer other than said issuer of said financial instrument,
h. trading value of a class of capital stock of said issuer of said financial instrument,
i. trading yield of a class of capital stock of said issuer of said financial instrument,
j. trading value of a security,
k. trading yield of a security, and
l. an index.

1283. The system of claim 1275, wherein said means for calculating said payment comprises means for calculating a payment only after a predetermined period of delay.

1284. The system of claim 1232, further comprising means for preparing at least one of:
a. a projected payment schedule;
b. an incidental analysis; and
c. a remoteness analysis.

1285. The system of claim 1284, wherein said means for preparing said projected payment schedule comprises means for determining a schedule of said payments based on payments necessary to produce a comparable yield.

1286. The system of claim 1284, wherein said means for preparing said incidental analysis comprises means for determining the amount of said payment based on assumptions regarding the contingency being satisfied.

1287. The system of claim 1286, wherein said means for determining the amount of said payment based on assumptions regarding the contingency being satisfied comprises means for determining the amount of said payment based on at least one of:
a. a stock price growth rate, and
b. discount rates.

1288. The system of claim 1284, wherein said means for preparing said remoteness analysis comprises means for determining the likelihood that said payment will be made given assumptions regarding said contingency being satisfied.

1289. The system of claim 1288, wherein said means for determining the likelihood that said payment will be made given assumptions regarding said contingency being satisfied comprises means for determining the likelihood that said payment will be made given a stock price growth rate and a volatility.

1290. The system of claim 1232, wherein said means for attributing a number of said underlying references to said financial instrument comprises means for attributing a variable number of said underlying references to each unit of said financial instrument.

1291. The system of claim 1232, wherein said means for attributing a number of said underlying references to said financial instrument comprises means for attributing a constant number of said underlying references to each unit of said financial instrument.

1292. The system of claim 1232, wherein said means for identifying an underlying reference comprises means for identifying said underlying reference that said financial instrument converts into.

1293. The system of claim 1232, wherein said means for identifying an underlying reference comprises means for basing an exchange value of said financial instrument on said underlying reference.

1294. A financial services system comprising means for buying a financial instrument created by:
identifying an underlying reference for said financial instrument, said underlying reference having a value;
attributing a number of said underlying references to said financial instrument;
defining multiple contingencies each with multiple triggers, a payment becoming due when one of said multiple triggers of any of said contingencies drops below a predetermined value.

1295. The system of claim 1294, wherein said means for buying said financial instrument comprises means for buying said financial instrument at a value based on at least one of:
a. said contingency;
b. said value of said underlying reference;
c. value of said payment;
d. length of said predetermined period of delay;
e. volatility in trading value of said underlying reference;
f. time until redemption, at option of issuer or holder;
g. time until maturity;
h. an interest rate; and
i. value for which said financial instrument must be redeemed on redemption date.

1296. The system of claim 1294, wherein said means for buying said financial instrument comprises means for bidding for said financial instrument.

1297. The system of claim 1294, wherein said means for buying said financial instrument comprises means for buying a derivative of said financial instrument.

1298. The system of claim 1294, wherein said means for buying said financial instrument comprises means for buying a part of said financial instrument.

1299. The system of claim 1294, wherein said defining multiple contingencies comprises basing said multiple contingencies on events related to said financial instrument.

1300. The system of claim 1294, wherein said defining multiple contingencies comprises basing said multiple contingencies on instruments other than said financial instrument.

1301. The system of claim 1294, wherein said attributing a number of said underlying references to said financial instrument comprises attributing a variable number of said underlying references to each unit of said financial instrument.

1302. The system of claim 1294, wherein said attributing a number of said underlying references to said financial instrument comprises attributing a constant number of said underlying references to each unit of said financial instrument.

1303. The system of claim 1294, wherein said identifying an underlying reference comprises identifying said underlying reference that said financial instrument converts into.

1304. The system of claim 1294, wherein said identifying an underlying reference comprises basing an exchange value of said financial instrument on said underlying reference.

1305. A financial services system associated with a financial instrument, said system comprising:
means for identifying an underlying reference for said financial instrument, said underlying reference having a value;
means for attributing a number of said underlying references to said financial instrument;
means for defining multiple contingencies each with multiple triggers, a payment becoming due when at least two of said multiple triggers drop below respective predetermined values, at least one of said at least two triggers being a trigger of a different contingency from any other of said at least two triggers.

1306. The system of claim 1305, further comprising:
means for establishing a value for said financial instrument.

1307. The system of claim 1306, further comprising:
means for selling said financial instrument.

1308. The system of claim 1307, wherein said means for selling said financial instrument comprises means for selling said financial instrument at a value based on at least one of:
a. said contingency;
b. said value of said underlying reference;
c. value of said payment;
d. said predetermined values;
e. volatility in trading value of said underlying reference;
f. time until redemption, at option of issuer or holder;
g. time until maturity;
h. an interest rate; and
i. value for which said financial instrument must be redeemed on redemption date.

1309. The system of claim 1307, wherein said means for selling said financial instrument comprises means for auctioning said financial instrument.

1310. The system of claim 1307, wherein said means for selling said financial instrument comprises means for selling a derivative of said financial instrument.

1311. The system of claim 1307, wherein said means for selling said financial instrument comprises means for selling a part of said financial instrument.

1312. The system of claim 1307, further comprising:
means for monitoring for satisfaction of said contingency.

1313. The system of claim 1307, further comprising:
means for disbursing said payment.

1314. The system of claim 1307, further comprising:
calculating said payment.

1315. The system of claim 1306, further comprising:
means for monitoring for satisfaction of said contingency.

1316. The system of claim 1315, further comprising:
means for disbursing said payment.

1317. The system of claim 1315, further comprising:
means for calculating said payment.

1318. The system of claim 1306, further comprising:
means for disbursing said payment.

1319. The system of claim 1306, further comprising:
means for calculating said payment.

1320. The system of claim 1306, wherein said means for establishing a value for said financial instrument comprises means for basing said value for said financial instrument on at least one of:
a. said contingency;
b. said value of said underlying reference;
c. value of said payment;
d. said predetermined values;
e. volatility in trading value of said underlying reference;
f. time until redemption, at option of issuer or holder;
g. time until maturity;
h. an interest rate; and
i. value for which said financial instrument must be redeemed on redemption date.

1321. The system of claim 1305 further comprising:
means for selling said financial instrument.

1322. The system of claim 1321, wherein said means for selling said financial instrument comprises means for selling said financial instrument at a value based on at least one of:
a. said contingency;
b. said value of said underlying reference;
c. value of said payment;
d. said predetermined values;
e. volatility in trading value of said underlying reference;
f. time until redemption, at option of issuer or holder;
g. time until maturity;
h. an interest rate; and
i. value for which said financial instrument must be redeemed on redemption date.

1323. The system of claim 1321, wherein said means for selling said financial instrument comprises means for auctioning said financial instrument.

1324. The system of claim 1321, wherein said means for selling said financial instrument comprises means for selling a derivative of said financial instrument.

1325. The system of claim 1321, wherein said means for selling said financial instrument comprises means for selling a part of said financial instrument.

1326. The system of claim 1321 further comprising:
means for monitoring for satisfaction of said contingency.

1327. The system of claim 1321, further comprising:
means for disbursing said payment.

1328. The system of claim 1321, further comprising:
means for calculating said payment.

1329. The system of claim 1305 further comprising:
means for monitoring for satisfaction of said contingency.

1330. The system of claim 1329, wherein said means for monitoring for satisfaction comprises means for comparing market data to said trigger of said contingency.

1331. The system of claim 1329, wherein said means for monitoring comprises means for monitoring over many said contingency monitoring periods.

1332. The system of claim 1329, wherein said means for monitoring comprises means for monitoring realtime data.

1333. The system of claim 1329, further comprising:
means for disbursing said payment.

1334. The system of claim 1329, further comprising:
means for calculating said payment.

1335. The system of claim 1305, wherein said means for defining multiple contingencies each with multiple triggers comprises means for basing said triggers on events related to said financial instrument.

1336. The system of claim 1305, wherein said means for defining multiple contingencies each with multiple triggers comprises means for basing said triggers on instruments other than said financial instrument.

1337. The system of claim 1305, wherein said means for defining multiple contingencies each with multiple triggers comprises means for setting said triggers at amounts equal to a multiple of prevailing market rates for financial instruments.

1338. The system of claim 1337, wherein said means for setting said triggers at amounts equal to a multiple comprises means for using a multiple equal to 1.

1339. The system of claim 1337, wherein said means for setting said triggers at amounts equal to a multiple comprises means for using a multiple less than 1.

1340. The system of claim 1337, wherein said means for setting said triggers at amounts equal to a multiple comprises means for using a multiple greater than 1.

1341. The system of claim 1305, wherein said means for defining multiple contingencies each with multiple triggers comprises means for setting said triggers at amounts equal to a multiple of formulae amounts.

1342. The system of claim 1341, wherein said means for setting said triggers at amounts equal to a multiple comprises means for using a multiple equal to 1.

1343. The system of claim 1341, wherein said means for setting said triggers at amounts equal to a multiple comprises means for using a multiple less than 1.

1344. The system of claim 1341, wherein said means for setting said triggers at amounts equal to a multiple comprises means for using a multiple greater than 1.

1345. The system of claim 1305, wherein said predetermined values comprise predetermined percentages of the conversion value.

1346. The system of claim 1305, further comprising:
means for disbursing said payment.

1347. The system of claim 1346, wherein said means for disbursing said payment comprises means for sending a negotiable instrument.

1348. The system of claim 1305, further comprising:
means for calculating said payment.

1349. The system of claim 1348, wherein said means for calculating said payment comprises means for establishing a formula for calculating said payment based on said value of said underlying reference.

1350. The system of claim 1349, wherein said means for establishing a formula comprises means for using a fixed rate formula.

1351. The system of claim 1349, wherein said means for establishing a formula comprises means for using a variable rate formula.

1352. The system of claim 1348, wherein said means for calculating said payment comprises means for calculating said payment using a periodic schedule.

1353. The system of claim 1352, wherein said means for calculating said payment using a periodic schedule comprises means for calculating said payment at least once per said contingency monitoring period.

1354. The system of claim 1352, wherein said means for calculating said payment using a periodic schedule comprises means for calculating said payment on a quarterly basis.

1355. The system of claim 1348, wherein said means for calculating said payment comprises means for calculating said payment based upon at least one of:
a. predetermined fixed amount,
b. trading value of said financial instrument,
c. trading yield of said financial instrument,
d. trading yield of a liability of said issuer of said financial instrument,
e. trading value of a liability of said issuer of said financial instrument,
f. trading value of a class of capital stock issued by an issuer other than said issuer of said financial instrument,
g. trading dividend yield of a class of capital stock issued by an issuer other than said issuer of said financial instrument,
h. trading value of a class of capital stock of said issuer of said financial instrument,
i. trading yield of a class of capital stock of said issuer of said financial instrument,
j. trading value of a security,
k. trading yield of a security, and
l. an index.

1356. The system of claim 1348, wherein said means for calculating said payment comprises means for calculating a payment only after a predetermined period of delay.

1357. The system of claim 1305, further comprising means for preparing at least one of:
a. a projected payment schedule;
b. an incidental analysis; and
c. a remoteness analysis.

1358. The system of claim 1357, wherein said means for preparing said projected payment schedule comprises means for determining a schedule of said payments based on payments necessary to produce a comparable yield.

1359. The system of claim 1357, wherein said means for preparing said incidental analysis comprises means for determining the amount of said payment based on assumptions regarding the contingency being satisfied.

1360. The system of claim 1359, wherein said means for determining the amount of said payment based on assumptions regarding the contingency being satisfied comprises means for determining the amount of said payment based on at least one of:
a. a stock price growth rate, and
b. discount rates.

1361. The system of claim 1357, wherein said means for preparing said remoteness analysis comprises means for determining the likelihood that said payment will be made given assumptions regarding said contingency being satisfied.

1362. The system of claim 1361, wherein said means for determining the likelihood that said payment will be made given assumptions regarding said contingency being satisfied comprises means for determining the likelihood that said payment will be made given a stock price growth rate and a volatility.

1363. The system of claim 1305, wherein said means for attributing a number of said underlying references to said financial instrument comprises means for attributing a variable number of said underlying references to each unit of said financial instrument.

1364. The system of claim 1305, wherein said means for attributing a number of said underlying references to said financial instrument comprises means for attributing a constant number of said underlying references to each unit of said financial instrument.

1365. The system of claim 1305, wherein said means for identifying an underlying reference comprises means for identifying said underlying reference that said financial instrument converts into.

1366. The system of claim 1305, wherein said means for identifying an underlying reference comprises means for basing an exchange value of said financial instrument on said underlying reference.

1367. A financial services system comprising means for buying a financial instrument created by:
identifying an underlying reference for said financial instrument, said underlying reference having a value;
attributing a number of said underlying references to said financial instrument;
defining multiple contingencies each with multiple triggers, a payment becoming due when at least two of said multiple triggers drop below respective predetermined values, at least one of said at least two triggers being a trigger of a different contingency from any other of said at least two triggers.

1368. The system of claim 1367, wherein said means for buying said financial instrument comprises means for buying said financial instrument at a value based on at least one of:
a. said contingency;
b. said value of said underlying reference;
c. value of said payment;
d. length of said predetermined period of delay;
e. volatility in trading value of said underlying reference;
f. time until redemption, at option of issuer or holder;
g. time until maturity;
h. an interest rate; and
i. value for which said financial instrument must be redeemed on redemption date.

1369. The system of claim 1367, wherein said means for buying said financial instrument comprises means for bidding for said financial instrument.

1370. The system of claim 1367, wherein said means for buying said financial instrument comprises means for buying a derivative of said financial instrument.

1371. The system of claim 1367, wherein said means for buying said financial instrument comprises means for buying a part of said financial instrument.

1372. The system of claim 1367, wherein said defining multiple contingencies comprises basing said multiple contingencies on events related to said financial instrument.

1373. The system of claim 1367, wherein said defining multiple contingencies comprises basing said multiple contingencies on instruments other than said financial instrument.

1374. The system of claim 1367, wherein said attributing a number of said underlying references to said financial instrument comprises attributing a variable number of said underlying references to each unit of said financial instrument.

1375. The system of claim 1367, wherein said attributing a number of said underlying references to said financial instrument comprises attributing a constant number of said underlying references to each unit of said financial instrument.

1376. The system of claim 1367, wherein said identifying an underlying reference comprises identifying said underlying reference that said financial instrument converts into.

1377. The system of claim 1367, wherein said identifying an underlying reference comprises basing an exchange value of said financial instrument on said underlying reference.

1378. A financial services system associated with a financial instrument said system comprising:
means for identifying an underlying reference for said financial instrument, said underlying reference having a value;
means for attributing a number of said underlying references to said financial instrument;
means for defining a contingency, said contingency having a trigger based upon at least one of:
a. trading value of said financial instrument,
b. trading yield of said financial instrument,
c. dividend yield of said underlying reference,
d. trading yield of a liability of said issuer of said financial instrument,
e. trading value of a liability of said issuer of said financial instrument,
f. trading value of a class of capital stock other than said underlying reference,
g. trading dividend yield of a class of capital stock issued by an issuer other than said issuer of said financial instrument,
h. trading value of a class of capital stock of said issuer of said financial instrument other than common stock,
i. trading yield of a class of capital stock of said issuer of said financial instrument,
j. trading value of a security issued by an issuer other than said issuer of said financial instrument,
k. trading yield of a security,
l. an index; wherein:
a payment becomes due on occurrence of said contingency.

1379. The system of claim 1378, further comprising:
means for establishing a value for said financial instrument.

1380. The system of claim 1379 further comprising:
means for selling said financial instrument.

1381. The method of claim 1380, wherein said means for selling said financial instrument comprises means for selling said financial instrument at a value based on at least one of:
a. said contingency;
b. said value of said underlying reference;
c. value of said payment;
d. volatility in trading value of said underlying reference;
e. time until redemption, at option of issuer or holder;
f. time until maturity;
g. an interest rate; and
h. value for which said financial instrument must be redeemed on redemption date.

1382. The system of claim 1380, wherein said means for selling said financial instrument comprises means for auctioning said financial instrument.

1383. The system of claim 1380, wherein said means for selling said financial instrument comprises means for selling a derivative of said financial instrument.

1384. The system of claim 1380, wherein said means for selling said financial instrument comprises means for selling a part of said financial instrument.

1385. The system of claim 1380 further comprising:
means for monitoring for satisfaction of said contingency.

1386. The system of claim 1380, further comprising:
means for disbursing said payment.

1387. The system of claim 1380, further comprising:
means for calculating said payment.

1388. The system of claim 1379, further comprising:
means for monitoring for satisfaction of said contingency.

1389. The system of claim 1388, further comprising:
means for calculating said payment.

1390. The system of claim 1388, further comprising:
means for disbursing said payment.

1391. The system of claim 1379, further comprising:
means for disbursing said payment.

1392. The system of claim 1379, further comprising:
means for calculating said payment.

1393. The system of claim 1379, wherein said means for establishing a value for said financial instrument comprises means for basing said value for said financial instrument on at least one of:
a. said contingency;
b. said value of said underlying reference;
c. value of said payment;
d. volatility in trading value of said underlying reference;
e. time until redemption, at option of issuer or holder;
f. time until maturity;
g. an interest rate; and
h. value for which said financial instrument must be redeemed on redemption date.

1394. The system of claim 1378 further comprising:
means for selling said financial instrument.

1395. The system of claim 1394, wherein said means for selling said financial instrument comprises means for selling said financial instrument at a value based on at least one of:
a. said contingency;
b. said value of said underlying reference;
c. value of said payment;
d. volatility in trading value of said underlying reference;
e. time until redemption, at option of issuer or holder;
f. time until maturity;
g. an interest rate; and
h. value for which said financial instrument must be redeemed on redemption date.

1396. The system of claim 1394, wherein said means for selling said financial instrument comprises means for auctioning said financial instrument.

1397. The system of claim 1394, wherein said means for selling said financial instrument comprises means for selling a derivative of said financial instrument.

1398. The system of claim 1394, wherein said means for selling said financial instrument comprises means for selling a part of said financial instrument.

1399. The system of claim 1394 further comprising:
means for monitoring for satisfaction of said contingency.

1400. The system of claim 1394, further comprising:
means for disbursing said payment.

1401. The system of claim 1394, further comprising:
means for calculating said payment.

1402. The system of claim 1378 further comprising:
means for monitoring for satisfaction of said contingency.

1403. The system of claim 1402, wherein said means for monitoring for satisfaction comprises means for comparing market data to requirements of said contingency within at least one said contingency monitoring period.

1404. The system of claim 1402, wherein said means for monitoring comprises means for monitoring over many said contingency monitoring periods.

1405. The system of claim 1402, wherein said means for monitoring comprises monitoring realtime data.

1406. The system of claim 1402, further comprising:
means for disbursing said payment.

1407. The system of claim 1402, further comprising:
means for calculating said payment.

1408. The system of claim 1378, wherein said means for defining a contingency comprises means for establishing at least one of:
a. a contingency having at least one trigger, and
b. multiple contingencies each with at least one trigger.

1409. The system of claim 1408, wherein said means for establishing at least one trigger comprises means for setting said trigger at an amount equal to a multiple of a formula amount.

1410. The system of claim 1409, wherein said means for setting said trigger at an amount equal to a multiple comprises means for using a multiple equal to 1.

1411. The system of claim 1409, wherein said means for setting said trigger at an amount equal to a multiple comprises means for using a multiple less than 1.

1412. The system of claim 1409, wherein said means for setting said trigger at an amount equal to a multiple comprises means for using a multiple greater than 1.

1413. The system of claim 1378, further comprising:
means for disbursing said payment.

1414. The system of claim 1413, wherein said means for disbursing said payment comprises means for sending a negotiable instrument.

1415. The system of claim 1378, further comprising:
means for calculating said payment.

1416. The system of claim 1415, wherein said means for calculating said payment comprises means for establishing a formula for calculating said payment based on said value of said underlying reference.

1417. The system of claim 1416, wherein said means for establishing a formula comprises means for using a fixed rate formula.

1418. The system of claim 1416, wherein said means for establishing a formula comprises means for using a variable rate formula.

1419. The system of claim 1415, wherein said means for calculating said payment comprises means for calculating said payment using a periodic schedule.

1420. The system of claim 1419, wherein said means for calculating said payment using a periodic schedule comprises means for calculating said payment at least once per said contingency monitoring period.

1421. The system of claim 1419, wherein said means for calculating said payment using a periodic schedule comprises means for calculating said payment on a quarterly basis.

1422. The system of claim 1415, wherein said means for calculating said payment comprises means for calculating said payment based upon at least one of:
a. predetermined fixed amount,
b. trading value of said financial instrument,
c. trading yield of said financial instrument,
d. trading yield of a liability of said issuer of said financial instrument,
e. trading value of a liability of said issuer of said financial instrument,
f. trading value of a class of capital stock issued by an issuer other than said issuer of said financial instrument,
g. trading dividend yield of a class of capital stock issued by an issuer other than said issuer of said financial instrument,
h. trading value of a class of capital stock of said issuer of said financial instrument,
i. trading yield of a class of capital stock of said issuer of said financial instrument,
j. trading value of a security,
k. trading yield of a security, and
l. an index.

1423. The system of claim 1415, wherein said means for calculating said payment comprises means for calculating a payment only after a predetermined period of delay.

1424. The system of claim 1378, further comprising means for preparing at least one of:
a. a projected payment schedule;
b. an incidental analysis; and
c. a remoteness analysis.

1425. The system of claim 1424, wherein said means for preparing said projected payment schedule comprises means for determining a schedule of said payments based on payments necessary to produce a comparable yield.

1426. The system of claim 1424, wherein said means for preparing said incidental analysis comprises means for determining the amount of said payment based on assumptions regarding the contingency being satisfied.

1427. The system of claim 1426, wherein said means for determining the amount of said payment based on assumptions regarding the contingency being satisfied comprises means for determining the amount of said payment based on at least one of:
a. a stock price growth rate, and
b. discount rates.

1428. The system of claim 1424, wherein said means for preparing said remoteness analysis comprises means for determining the likelihood that said payment will be made given assumptions regarding said contingency being satisfied.

1429. The system of claim 1428, wherein said means for determining the likelihood that said payment will be made given assumptions regarding said contingency being satisfied comprises means for determining the likelihood that said payment will be made given a stock price growth rate and a volatility.

1430. The system of claim 1378, wherein said means for attributing a number of said underlying references to said financial instrument comprises means for attributing a variable number of said underlying references to each unit of said financial instrument.

1431. The system of claim 1378, wherein said means for attributing a number of said underlying references to said financial instrument comprises means for attributing a constant number of said underlying references to each unit of said financial instrument.

1432. The system of claim 1378, wherein said means for identifying an underlying reference comprises means for identifying said underlying reference that said financial instrument converts into.

1433. The system of claim 1378, wherein said means for identifying an underlying reference comprises means for basing an exchange value of said financial instrument on said underlying reference.

1434. A financial services system comprising means for buying a financial instrument, said financial instrument having an issue and created by:
identifying an underlying reference for said financial instrument, said underlying reference having a value;
attributing a number of said underlying references to said financial instrument;
defining a contingency, said contingency having a trigger based upon at least one of:
a. trading value of said financial instrument,
b. trading yield of said financial instrument,
c. dividend yield of said underlying reference,
d. trading yield of a liability of said issuer of said financial instrument,
e. trading value of a liability of said issuer of said financial instrument,
f. trading value of a class of capital stock other than said underlying reference,
g. trading dividend yield of a class of capital stock issued by an issuer other than said issuer of said financial instrument,
h. trading value of a class of capital stock of said issuer of said financial instrument other than common stock,
i. trading yield of a class of capital stock of said issuer of said financial instrument,
j. trading value of a security issued by an issuer other than said issuer of said financial instrument,
k. trading yield of a security,
l. an index; wherein:
a payment becomes due on occurrence of said contingency.

1435. The system of claim 1434, wherein said means for buying said financial instrument comprises means for buying said financial instrument at a value based on at least one of:
a. said contingency;
b. said value of said underlying reference;
c. value of said payment;
d. length of said predetermined period of delay;
e. volatility in trading value of said underlying reference;
f. time until redemption, at option of issuer or holder;
g. time until maturity;
h. an interest rate; and
i. value for which said financial instrument must be redeemed on redemption date.

1436. The system of claim 1434, wherein said means for buying said financial instrument comprises means for bidding for said financial instrument.

1437. The system of claim 1434, wherein said means for buying said financial instrument comprises means for buying a derivative of said financial instrument.

1438. The system of claim 1434, wherein said means for buying said financial instrument comprises means for buying a part of said financial instrument.

1439. The system of claim 1434, wherein said attributing a number of said underlying references to said financial instrument comprises attributing a variable number of said underlying references to each unit of said financial instrument.

1440. The system of claim 1434, wherein said attributing a number of said underlying references to said financial instrument comprises attributing a constant number of said underlying references to each unit of said financial instrument.

1441. The system of claim 1434, wherein said identifying an underlying reference comprises identifying said underlying reference that said financial instrument converts into.

1442. The system of claim 1434, wherein said identifying an underlying reference comprises basing an exchange value of said financial instrument on said underlying reference.

1443. A financial services system associated with a financial instrument said system comprising:
means for identifying an underlying reference for said financial instrument, said underlying reference having a value;
means for attributing a number of said underlying references to said financial instrument;
means for defining a contingency, a payment becoming due on occurrence of said contingency;
means for calculating said payment based upon at least one of:
a. predetermined fixed amount,
b. trading value of said financial instrument,
c. trading yield of said financial instrument,
d. trading yield of a liability of said issuer of said financial instrument,
e. trading value of a liability of said issuer of said financial instrument,
f. trading value of a class of capital stock issued by an issuer other than said issuer of said financial instrument,
g. trading dividend yield of a class of capital stock other than said underlying reference,
h. trading value of a class of capital stock of said issuer of said financial instrument,
i. trading yield of a class of capital stock of said issuer of said financial instrument other than common stock,
j. trading value of a security,
k. trading yield of a security issued by an issuer other than said issuer of said financial instrument,
l. an index.

1444. The system of claim 1443, further comprising:
means for establishing a value for said financial instrument.

1445. The system of claim 1444 further comprising:
means for selling said financial instrument.

1446. The method of claim 1445, wherein said means for selling said financial instrument comprises means for selling said financial instrument at a value based on at least one of:
a. said contingency;
b. said value of said underlying reference;
c. value of said payment;
d. volatility in trading value of said underlying reference;
e. time until redemption, at option of issuer or holder;
f. time until maturity;
g. an interest rate; and
h. value for which said financial instrument must be redeemed on redemption date.

1447. The system of claim 1445, wherein said means for selling said financial instrument comprises means for auctioning said financial instrument.

1448. The system of claim 1445, wherein said means for selling said financial instrument comprises means for selling a derivative of said financial instrument.

1449. The system of claim 1445, wherein said means for selling said financial instrument comprises means for selling a part of said financial instrument.

1450. The system of claim 1445 further comprising:
means for monitoring for satisfaction of said contingency.

1451. The system of claim 1445, further comprising:
means for disbursing said payment.

1452. The system of claim 1444, further comprising:
means for monitoring for satisfaction of said contingency.

1453. The system of claim 1452, further comprising:
means for disbursing said payment.

1454. The system of claim 1444, further comprising:
means for disbursing said payment.

1455. The system of claim 1444, wherein said means for establishing a value for said financial instrument comprises means for basing said value for said financial instrument on at least one of:
a. said contingency;
b. said value of said underlying reference;
c. value of said payment;
d. volatility in trading value of said underlying reference;
e. time until redemption, at option of issuer or holder;
f. time until maturity;
g. an interest rate; and
h. value for which said financial instrument must be redeemed on redemption date.

1456. The system of claim 1443 further comprising:
means for selling said financial instrument.

1457. The system of claim 1456, wherein said means for selling said financial instrument comprises means for selling said financial instrument at a value based on at least one of:
a. said contingency;
b. said value of said underlying reference;
c. value of said payment;
d. volatility in trading value of said underlying reference;
e. time until redemption, at option of issuer or holder;
f. time until maturity;
g. an interest rate; and
h. value for which said financial instrument must be redeemed on redemption date.

1458. The system of claim 1456, wherein said means for selling said financial instrument comprises means for auctioning said financial instrument.

1459. The system of claim 1456, wherein said means for selling said financial instrument comprises means for selling a derivative of said financial instrument.

1460. The system of claim 1456, wherein said means for selling said financial instrument comprises means for selling a part of said financial instrument.

1461. The system of claim 1456 further comprising:
means for monitoring for satisfaction of said contingency.

1462. The system of claim 1456, further comprising:
means for disbursing said payment.

1463. The system of claim 1443 further comprising:
means for monitoring for satisfaction of said contingency.

1464. The system of claim 1463, wherein said means for monitoring for satisfaction comprises means for comparing market data to requirements of said contingency within at least one said contingency monitoring period.

1465. The system of claim 1463, wherein said means for monitoring comprises means for monitoring over many said contingency monitoring periods.

1466. The system of claim 1463, wherein said means for monitoring comprises monitoring realtime data.

1467. The system of claim 1463, further comprising:
means for disbursing said payment.

1468. The system of claim 1443, wherein said means for defining a contingency comprises means for basing said contingency on an event related to said financial instrument.

1469. The system of claim 1468, wherein said means for basing said contingency on an event related to said financial instrument comprises means for setting said contingency as satisfied once an observed value of said financial instrument at least:
a. exceeds a predetermined metric, or
b. is equal to a predetermined metric, or
c. is less than a predetermined metric.

1470. The system of claim 1443, wherein said means for defining a contingency comprises means for setting said contingency as satisfied when the closing sale value of said underlying reference within at least one said contingency monitoring period is greater than a predetermined percentage of the conversion value.

1471. The system of claim 1443, wherein said means for defining a contingency comprises means for setting said contingency as satisfied when the closing sale value of said underlying reference within at least one said contingency monitoring period is less than a predetermined percentage of the conversion value.

1472. The system of claim 1443, wherein said means for defining a contingency comprises means for basing said contingency on an instrument other than said financial instrument.

1473. The system of claim 1472, wherein said means for basing said contingency on said instrument other than said financial instrument comprises means for setting said contingency as satisfied once an observed value of said instrument at least:
a. exceeds a predetermined metric, or
b. is equal to a predetermined metric, or
c. is less than a predetermined metric.

1474. The system of claim 1443, wherein said means for defining a contingency comprises means for establishing at least one of:
a. a contingency having at least one trigger, and
b. multiple contingencies each with at least one trigger.

1475. The system of claim 1474, wherein said means for establishing at least one trigger comprises means for setting said trigger at an amount equal to a multiple of a prevailing market rate for a financial instrument.

1476. The system of claim 1475, wherein said means for setting said trigger at an amount equal to a multiple comprises means for using a multiple equal to 1.

1477. The system of claim 1475, wherein said means for setting said trigger at an amount equal to a multiple comprises means for using a multiple less than 1.

1478. The system of claim 1475, wherein said means for setting said trigger at an amount equal to a multiple comprises means for using a multiple greater than 1.

1479. The system of claim 1474, wherein said means for establishing at least one trigger comprises means for setting said trigger at an amount equal to a multiple of a formula amount.

1480. The system of claim 1479, wherein said means for setting said trigger at an amount equal to a multiple comprises means for using a multiple equal to 1.

1481. The system of claim 1479, wherein said means for setting said trigger at an amount equal to a multiple comprises means for using a multiple less than 1.

1482. The system of claim 1479, wherein said means for setting said trigger at an amount equal to a multiple comprises means for using a multiple greater than 1.

1483. The system of claim 1443, further comprising:
means for disbursing said payment.

1484. The system of claim 1483, wherein said means for disbursing said payment comprises means for sending a negotiable instrument.

1485. The system of claim 1443, wherein said means for calculating said payment comprises means for calculating said payment using a periodic schedule.

1486. The system of claim 1485, wherein said means for calculating said payment using a periodic schedule comprises means for calculating said payment at least once per said contingency monitoring period.

1487. The system of claim 1485, wherein said means for calculating said payment using a periodic schedule comprises means for calculating said payment on a quarterly basis.

1488. The system of claim 1443, wherein said means for calculating said payment comprises means for calculating a payment only after a predetermined period of delay.

1489. The system of claim 1443, further comprising means for preparing at least one of:
a. a projected payment schedule;
b. an incidental analysis; and
c. a remoteness analysis.

1490. The system of claim 1489, wherein said means for preparing said projected payment schedule comprises means for determining a schedule of said payments based on payments necessary to produce a comparable yield.

1491. The system of claim 1489, wherein said means for preparing said incidental analysis comprises means for determining the amount of said payment based on assumptions regarding the contingency being satisfied.

1492. The system of claim 1491, wherein said means for determining the amount of said payment based on assumptions regarding the contingency being satisfied comprises means for determining the amount of said payment based on at least one of:
a. a stock price growth rate, and
b. discount rates.

1493. The system of claim 1489, wherein said means for preparing said remoteness analysis comprises means for determining the likelihood that said payment will be made given assumptions regarding said contingency being satisfied.

1494. The system of claim 1493, wherein said means for determining the likelihood that said payment will be made given assumptions regarding said contingency being satisfied comprises means for determining the likelihood that said payment will be made given a stock price growth rate and a volatility.

1495. The system of claim 1443, wherein said means for attributing a number of said underlying references to said financial instrument comprises means for attributing a variable number of said underlying references to each unit of said financial instrument.

1496. The system of claim 1443, wherein said means for attributing a number of said underlying references to said financial instrument comprises means for attributing a constant number of said underlying references to each unit of said financial instrument.

1497. The system of claim 1443, wherein said means for identifying an underlying reference comprises means for identifying said underlying reference that said financial instrument converts into.

1498. The system of claim 1443, wherein said means for identifying an underlying reference comprises means for basing an exchange value of said financial instrument on said underlying reference.

1499. A financial services system comprising means for buying a financial instrument, said financial instrument having an issuer and created by:
identifying an underlying reference for said financial instrument, said underlying reference having a value;
attributing a number of said underlying references to said financial instrument;
defining a contingency, a payment becoming due on occurrence of said contingency;
calculating said payment based upon at least one of:
a. predetermined fixed amount,
b. trading value of said financial instrument,
c. trading yield of said financial instrument,
d. trading yield of a liability of said issuer of said financial instrument,
e. trading value of a liability of said issuer of said financial instrument,
f. trading value of a class of capital stock issued by an issuer other than said issuer of said financial instrument,
g. trading dividend yield of a class of capital stock other than said underlying reference,
h. trading value of a class of capital stock of said issuer of said financial instrument,
i. trading yield of a class of capital stock of said issuer of said financial instrument other than common stock,
j. trading value of a security,
k. trading yield of a security issued by an issuer other than said issuer of said financial instrument,
l. an index.

1500. The system of claim 1499, wherein said means for buying said financial instrument comprises means for buying said financial instrument at a value based on at least one of:
a. said contingency;
b. said value of said underlying reference;
c. value of said payment;
d. length of said predetermined period of delay;
e. volatility in trading value of said underlying reference;
f. time until redemption, at option of issuer or holder;
g. time until maturity;
h. an interest rate; and
i. value for which said financial instrument must be redeemed on redemption date.

1501. The system of claim 1499, wherein said means for buying said financial instrument comprises means for bidding for said financial instrument.

1502. The system of claim 1499, wherein said means for buying said financial instrument comprises means for buying a derivative of said financial instrument.

1503. The system of claim 1499, wherein said means for buying said financial instrument comprises means for buying a part of said financial instrument.

1504. The system of claim 1499, wherein said defining a contingency comprises basing said contingency on an event related to said financial instrument.

1505. The system of claim 1499, wherein said defining a contingency comprises basing said contingency on an instrument other than said financial instrument.

1506. The system of claim 1499, wherein said attributing a number of said underlying references to said financial instrument comprises attributing a variable number of said underlying references to each unit of said financial instrument.

1507. The system of claim 1499, wherein said attributing a number of said underlying references to said financial instrument comprises attributing a constant number of said underlying references to each unit of said financial instrument.

1508. The system of claim 1499, wherein said identifying an underlying reference comprises identifying said underlying reference that said financial instrument converts into.

1509. The system of claim 1499, wherein said identifying an underlying reference comprises basing an exchange value of said financial instrument on said underlying reference.

1510. A financial services system associated with a financial instrument said system comprising:
means for identifying an underlying reference for said financial instrument, said underlying reference having a value;
means for attributing a number of said underlying references to said financial instrument;
means for defining a contingency, a payment becoming due on occurrence of said contingency;
means for calculating said payment so that said payment equals at most an imposed maximum value.

1511. The system of claim 1510, further comprising:
means for establishing a value for said financial instrument.

1512. The system of claim 1511, further comprising:
means for selling said financial instrument.

1513. The method of claim 1512, wherein said means for selling said financial instrument comprises means for selling said financial instrument at a value based on at least one of:
a. said contingency;
b. said value of said underlying reference;
c. value of said payment;
d. volatility in trading value of said underlying reference;
e. time until redemption, at option of issuer or holder;
f. time until maturity;
g. an interest rate; and
h. value for which said financial instrument must be redeemed on redemption date.

1514. The system of claim 1512, wherein said means for selling said financial instrument comprises means for auctioning said financial instrument.

1515. The system of claim 1512, wherein said means for selling said financial instrument comprises means for selling a derivative of said financial instrument.

1516. The system of claim 1512, wherein said means for selling said financial instrument comprises means for selling a part of said financial instrument.

1517. The system of claim 1512 further comprising:
means for monitoring for satisfaction of said contingency.

1518. The system of claim 1512, further comprising:
means for disbursing said payment.

1519. The system of claim 1511, further comprising:
means for monitoring for satisfaction of said contingency.

1520. The system of claim 1519, further comprising:
means for disbursing said payment.

1521. The system of claim 1511, further comprising:
means for disbursing said payment.

1522. The system of claim 1511, wherein said means for establishing a value for said financial instrument comprises means for basing said value for said financial instrument on at least one of:
a. said contingency;
b. said value of said underlying reference;
c. value of said payment;
d. volatility in trading value of said underlying reference;
e. time until redemption, at option of issuer or holder;
f. time until maturity;
g. an interest rate; and
h. value for which said financial instrument must be redeemed on redemption date.

1523. The system of claim 1510 further comprising:
means for selling said financial instrument.

1524. The system of claim 1523, wherein said means for selling said financial instrument comprises means for selling said financial instrument at a value based on at least one of:
a. said contingency;
b. said value of said underlying reference;
c. value of said payment;
d. volatility in trading value of said underlying reference;
e. time until redemption, at option of issuer or holder;
f. time until maturity;
g. an interest rate; and
h. value for which said financial instrument must be redeemed on redemption date.

1525. The system of claim 1523, wherein said means for selling said financial instrument comprises means for auctioning said financial instrument.

1526. The system of claim 1523, wherein said means for selling said financial instrument comprises means for selling a derivative of said financial instrument.

1527. The system of claim 1523, wherein said means for selling said financial instrument comprises means for selling a part of said financial instrument.

1528. The system of claim 1523 further comprising:
means for monitoring for satisfaction of said contingency.

1529. The system of claim 1523, further comprising:
means for disbursing said payment.

1530. The system of claim 1510 further comprising:
means for monitoring for satisfaction of said contingency.

1531. The system of claim 1530, wherein said means for monitoring for satisfaction comprises means for comparing market data to requirements of said contingency within at least one said contingency monitoring period.

1532. The system of claim 1530, wherein said means for monitoring comprises means for monitoring over many said contingency monitoring periods.

1533. The system of claim 1530, wherein said means for monitoring comprises monitoring realtime data.

1534. The system of claim 1530, further comprising:
means for disbursing said payment.

1535. The system of claim 1510, wherein said means for defining a contingency comprises means for basing said contingency on an event related to said financial instrument.

1536. The system of claim 1535, wherein said means for basing said contingency on an event related to said financial instrument comprises means for setting said contingency as satisfied once an observed value of said financial instrument at least:
a. exceeds a predetermined metric, or
b. is equal to a predetermined metric, or
c. is less than a predetermined metric.

1537. The system of claim 1510, wherein said means for defining a contingency comprises means for setting said contingency as satisfied when the closing sale value of said underlying reference within at least one said contingency monitoring period is greater than a predetermined percentage of the conversion value.

1538. The system of claim 1510, wherein said means for defining a contingency comprises means for setting said contingency as satisfied when the closing sale value of said underlying reference within at least one said contingency monitoring period is less than a predetermined percentage of the conversion value.

1539. The system of claim 1510, wherein said means for defining a contingency comprises means for basing said contingency on an instrument other than said financial instrument.

1540. The system of claim 1539, wherein said means for basing said contingency on said instrument other than said financial instrument comprises means for setting said contingency as satisfied once an observed value of said instrument at least:
a. exceeds a predetermined metric, or
b. is equal to a predetermined metric, or
c. is less than a predetermined metric.

1541. The system of claim 1510, wherein said means for defining a contingency comprises means for establishing at least one of:
a. a contingency having at least one trigger, and
b. multiple contingencies each with at least one trigger.

1542. The system of claim 1541, wherein said means for establishing at least one trigger comprises means for setting said trigger at an amount equal to a multiple of a prevailing market rate for a financial instrument.

1543. The system of claim 1542, wherein said means for setting said trigger at an amount equal to a multiple comprises means for using a multiple equal to 1.

1544. The system of claim 1542, wherein said means for setting said trigger at an amount equal to a multiple comprises means for using a multiple less than 1.

1545. The system of claim 1542, wherein said means for setting said trigger at an amount equal to a multiple comprises means for using a multiple greater than 1.

1546. The system of claim 1541, wherein said means for establishing at least one trigger comprises means for setting said trigger at an amount equal to a multiple of a formula amount.

1547. The system of claim 1546, wherein said means for setting said trigger at an amount equal to a multiple comprises means for using a multiple equal to 1.

1548. The system of claim 1546, wherein said means for setting said trigger at an amount equal to a multiple comprises means for using a multiple less than 1.

1549. The system of claim 1546, wherein said means for setting said trigger at an amount equal to a multiple comprises means for using a multiple greater than 1.

1550. The system of claim 1510, further comprising:
means for disbursing said payment.

1551. The system of claim 1550, wherein said means for disbursing said payment comprises means for sending a negotiable instrument.

1552. The method of claim 1510, wherein said means for calculating said payment so that said payment equals at most an imposed maximum value comprises means for basing said maximum value on at least one of:
a. a predetermined fixed value,
b. a predetermined maximum yield.

1553. The system of claim 1510, wherein said means for calculating said payment so that said payment equals at most an imposed maximum value comprises means for calculating said payment using a periodic schedule.

1554. The system of claim 1553, wherein said means for calculating said payment using a periodic schedule comprises means for calculating said payment at least once per said contingency monitoring period.

1555. The system of claim 1553, wherein said means for calculating said payment using a periodic schedule comprises means for calculating said payment on a quarterly basis.

1556. The system of claim 1510, wherein said means for calculating said payment so that said payment equals at most an imposed maximum value comprises means for calculating said payment based upon at least one of:
a. predetermined fixed amount,
b. trading value of said financial instrument,
c. trading yield of said financial instrument,
d. trading yield of a liability of said issuer of said financial instrument,
e. trading value of a liability of said issuer of said financial instrument,
f. trading value of a class of capital stock issued by an issuer other than said issuer of said financial instrument,
g. trading dividend yield of a class of capital stock issued by an issuer other than said issuer of said financial instrument,
h. trading value of a class of capital stock of said issuer of said financial instrument,
i. trading yield of a class of capital stock of said issuer of said financial instrument,
j. trading value of a security,
k. trading yield of a security, and
l. an index.

1557. The system of claim 1510, wherein said means for calculating said payment so that said payment equals at most an imposed maximum value comprises means for calculating a payment only after a predetermined period of delay.

1558. The system of claim 1510, wherein said means for calculating said payment so that said payment equals at most an imposed maximum value comprises means for calculating said payment so that said payment exceeds an imposed minimum value.

1559. The system of claim 1510, further comprising means for preparing at least one of:
a. a projected payment schedule;
b. an incidental analysis; and
c. a remoteness analysis.

1560. The system of claim 1559, wherein said means for preparing said projected payment schedule comprises means for determining a schedule of said payments based on payments necessary to produce a comparable yield.

1561. The system of claim 1559, wherein said means for preparing said incidental analysis comprises means for determining the amount of said payment based on assumptions regarding the contingency being satisfied.

1562. The system of claim 1561, wherein said means for determining the amount of said payment based on assumptions regarding the contingency being satisfied comprises means for determining the amount of said payment based on at least one of:
a. a stock price growth rate, and
b. discount rates.

1563. The system of claim 1559, wherein said means for preparing said remoteness analysis comprises means for determining the likelihood that said payment will be made given assumptions regarding said contingency being satisfied.

1564. The system of claim 1563, wherein said means for determining the likelihood that said payment will be made given assumptions regarding said contingency being satisfied comprises means for determining the likelihood that said payment will be made given a stock price growth rate and a volatility.

1565. The system of claim 1510, wherein said means for attributing a number of said underlying references to said financial instrument comprises means for attributing a variable number of said underlying references to each unit of said financial instrument.

1566. The system of claim 1510, wherein said means for attributing a number of said underlying references to said financial instrument comprises means for attributing a constant number of said underlying references to each unit of said financial instrument.

1567. The system of claim 1510, wherein said means for identifying an underlying reference comprises means for identifying said underlying reference that said financial instrument converts into.

1568. The system of claim 1510, wherein said means for identifying an underlying reference comprises means for basing an exchange value of said financial instrument on said underlying reference.

1569. A financial services system comprising means for buying a financial instrument created by:
identifying an underlying reference for said financial instrument, said underlying reference having a value;
attributing a number of said underlying references to said financial instrument;
defining a contingency, a payment becoming due on occurrence of said contingency;
calculating said payment so that said payment equals at most an imposed maximum value.

1570. The system of claim 1569, wherein said means for buying said financial instrument comprises means for buying said financial instrument at a value based on at least one of:
a. said contingency;
b. said value of said underlying reference;
c. value of said payment;
d. length of said predetermined period of delay;
e. volatility in trading value of said underlying reference;
f. time until redemption, at option of issuer or holder;
g. time until maturity;
h. an interest rate; and
i. value for which said financial instrument must be redeemed on redemption date.

1571. The system of claim 1569, wherein said means for buying said financial instrument comprises means for bidding for said financial instrument.

1572. The system of claim 1569, wherein said means for buying said financial instrument comprises means for buying a derivative of said financial instrument.

1573. The system of claim 1569, wherein said means for buying said financial instrument comprises means for buying a part of said financial instrument.

1574. The system of claim 1569, wherein said defining a contingency comprises basing said contingency on an event related to said financial instrument.

1575. The system of claim 1569, wherein said defining a contingency comprises basing said contingency on an instrument other than said financial instrument.

1576. The system of claim 1569, wherein said attributing a number of said underlying references to said financial instrument comprises attributing a variable number of said underlying references to each unit of said financial instrument.

1577. The system of claim 1569, wherein said attributing a number of said underlying references to said financial instrument comprises attributing a constant number of said underlying references to each unit of said financial instrument.

1578. The system of claim 1569, wherein said identifying an underlying reference comprises identifying said underlying reference that said financial instrument converts into.

1579. The system of claim 1569, wherein said identifying an underlying reference comprises basing an exchange value of said financial instrument on said underlying reference.

1580. A financial services system associated with a financial instrument said system comprising:
means for identifying an underlying reference for said financial instrument, said underlying reference having a value;
means for attributing a number of said underlying references to said financial instrument;
means for defining a contingency, a payment becoming due on occurrence of said contingency;
means for calculating said payment so that said payment exceeds an imposed minimum value.

1581. The system of claim 1580, further comprising:
means for establishing a value for said financial instrument.

1582. The system of claim 1581, further comprising:
means for selling said financial instrument.

1583. The method of claim 1582, wherein said means for selling said financial instrument comprises means for selling said financial instrument at a value based on at least one of:
a. said contingency;
b. said value of said underlying reference;
c. value of said payment;
d. volatility in trading value of said underlying reference;
e. time until redemption, at option of issuer or holder;
f. time until maturity;
g. an interest rate; and
h. value for which said financial instrument must be redeemed on redemption date.

1584. The system of claim 1582, wherein said means for selling said financial instrument comprises means for auctioning said financial instrument.

1585. The system of claim 1582, wherein said means for selling said financial instrument comprises means for selling a derivative of said financial instrument.

1586. The system of claim 1582, wherein said means for selling said financial instrument comprises means for selling a part of said financial instrument.

1587. The system of claim 1582 further comprising:
means for monitoring for satisfaction of said contingency.

1588. The system of claim 1582, further comprising:
means for disbursing said payment.

1589. The system of claim 1581, further comprising:
means for monitoring for satisfaction of said contingency.

1590. The system of claim 1589, further comprising:
means for disbursing said payment.

1591. The system of claim 1581, further comprising:
means for disbursing said payment.

1592. The system of claim 1581, wherein said means for establishing a value for said financial instrument comprises means for basing said value for said financial instrument on at least one of:
a. said contingency;
b. said value of said underlying reference;
c. value of said payment;
d. volatility in trading value of said underlying reference;
e. time until redemption, at option of issuer or holder;
f. time until maturity;
g. an interest rate; and
h. value for which said financial instrument must be redeemed on redemption date.

1593. The system of claim 1580 further comprising:
means for selling said financial instrument.

1594. The system of claim 1593, wherein said means for selling said financial instrument comprises means for selling said financial instrument at a value based on at least one of:
a. said contingency;
b. said value of said underlying reference;
c. value of said payment;
d. volatility in trading value of said underlying reference;
e. time until redemption, at option of issuer or holder;
f. time until maturity;
g. an interest rate; and
h. value for which said financial instrument must be redeemed on redemption date.

1595. The system of claim 1593, wherein said means for selling said financial instrument comprises means for auctioning said financial instrument.

1596. The system of claim 1593, wherein said means for selling said financial instrument comprises means for selling a derivative of said financial instrument.

1597. The system of claim 1593, wherein said means for selling said financial instrument comprises means for selling a part of said financial instrument.

1598. The system of claim 1593 further comprising:
means for monitoring for satisfaction of said contingency.

1599. The system of claim 1593, further comprising:
means for disbursing said payment.

1600. The system of claim 1580 further comprising:
means for monitoring for satisfaction of said contingency.

1601. The system of claim 1600, wherein said means for monitoring for satisfaction comprises means for comparing market data to requirements of said contingency within at least one said contingency monitoring period.

1602. The system of claim 1600, wherein said means for monitoring comprises means for monitoring over many said contingency monitoring periods.

1603. The system of claim 1600, wherein said means for monitoring comprises monitoring realtime data.

1604. The system of claim 1600, further comprising:
means for disbursing said payment.

1605. The system of claim 1580, wherein said means for defining a contingency comprises means for basing said contingency on an event related to said financial instrument.

1606. The system of claim 1605, wherein said means for basing said contingency on an event related to said financial instrument comprises means for setting said contingency as satisfied once an observed value of said financial instrument at least:
a. exceeds a predetermined metric, or
b. is equal to a predetermined metric, or
c. is less than a predetermined metric.

1607. The system of claim 1580, wherein said means for defining a contingency comprises means for setting said contingency as satisfied when the closing sale value of said underlying reference within at least one said contingency monitoring period is greater than a predetermined percentage of the conversion value.

1608. The system of claim 1580, wherein said means for defining a contingency comprises means for setting said contingency as satisfied when the closing sale value of said underlying reference within at least one said contingency monitoring period is less than a predetermined percentage of the conversion value.

1609. The system of claim 1580, wherein said means for defining a contingency comprises means for basing said contingency on an instrument other than said financial instrument.

1610. The system of claim 1609, wherein said means for basing said contingency on said instrument other than said financial instrument comprises means for setting said contingency as satisfied once an observed value of said instrument at least:
a. exceeds a predetermined metric, or
b. is equal to a predetermined metric, or
c. is less than a predetermined metric.

1611. The system of claim 1580, wherein said means for defining a contingency comprises means for establishing at least one of:
a. a contingency having at least one trigger, and
b. multiple contingencies each with at least one trigger.

1612. The system of claim 1611, wherein said means for establishing at least one trigger comprises means for setting said trigger at an amount equal to a multiple of a prevailing market rate for a financial instrument.

1613. The system of claim 1612, wherein said means for setting said trigger at an amount equal to a multiple comprises means for using a multiple equal to 1.

1614. The system of claim 1612, wherein said means for setting said trigger at an amount equal to a multiple comprises means for using a multiple less than 1.

1615. The system of claim 1612, wherein said means for setting said trigger at an amount equal to a multiple comprises means for using a multiple greater than 1.

1616. The system of claim 1611, wherein said means for establishing at least one trigger comprises means for setting said trigger at an amount equal to a multiple of a formula amount.

1617. The system of claim 1616, wherein said means for setting said trigger at an amount equal to a multiple comprises means for using a multiple equal to 1.

1618. The system of claim 1616, wherein said means for setting said trigger at an amount equal to a multiple comprises means for using a multiple less than 1.

1619. The system of claim 1616, wherein said means for setting said trigger at an amount equal to a multiple comprises means for using a multiple greater than 1.

1620. The system of claim 1580, further comprising:
means for disbursing said payment.

1621. The system of claim 1620, wherein said means for disbursing said payment comprises means for sending a negotiable instrument.

1622. The method of claim 1580, wherein said calculating said payment so that said payment exceeds an imposed minimum value comprises basing said minimum value on at least one of:
a. a predetermined fixed value,
b. a predetermined minimum yield.

1623. The system of claim 1580, wherein said means for calculating said payment so that said payment exceeds an imposed minimum value comprises means for calculating said payment using a periodic schedule.

1624. The system of claim 1623, wherein said means for calculating said payment using a periodic schedule comprises means for calculating said payment at least once per said contingency monitoring period.

1625. The system of claim 1623, wherein said means for calculating said payment using a periodic schedule comprises means for calculating said payment on a quarterly basis.

1626. The system of claim 1580, wherein said means for calculating said payment so that said payment exceeds an imposed minimum value comprises means for calculating said payment based upon at least one of:
a. predetermined fixed amount,
b. trading value of said financial instrument,
c. trading yield of said financial instrument,
d. trading yield of a liability of said issuer of said financial instrument,
e. trading value of a liability of said issuer of said financial instrument,
f. trading value of a class of capital stock issued by an issuer other than said issuer of said financial instrument,
g. trading dividend yield of a class of capital stock issued by an issuer other than said issuer of said financial instrument,
h. trading value of a class of capital stock of said issuer of said financial instrument,
i. trading yield of a class of capital stock of said issuer of said financial instrument,
j. trading value of a security,
k. trading yield of a security, and
l. an index.

1627. The system of claim 1580, wherein said means for calculating said payment so that said payment exceeds an imposed minimum value comprises means for calculating a payment only after a predetermined period of delay.

1628. The system of claim 1580, wherein said means for calculating said payment so that said payment exceeds an imposed minimum value comprises means for calculating said payment so that said payment equals at most an imposed maximum value.

1629. The system of claim 1580, further comprising means for preparing at least one of:
a. a projected payment schedule;
b. an incidental analysis; and
c. a remoteness analysis.

1630. The system of claim 1629, wherein said means for preparing said projected payment schedule comprises means for determining a schedule of said payments based on payments necessary to produce a comparable yield.

1631. The system of claim 1629, wherein said means for preparing said incidental analysis comprises means for determining the amount of said payment based on assumptions regarding the contingency being satisfied.

1632. The system of claim 1631, wherein said means for determining the amount of said payment based on assumptions regarding the contingency being satisfied comprises means for determining the amount of said payment based on at least one of:
a. a stock price growth rate, and
b. discount rates.

1633. The system of claim 1629, wherein said means for preparing said remoteness analysis comprises means for determining the likelihood that said payment will be made given assumptions regarding said contingency being satisfied.

1634. The system of claim 1633, wherein said means for determining the likelihood that said payment will be made given assumptions regarding said contingency being satisfied comprises means for determining the likelihood that said payment will be made given a stock price growth rate and a volatility.

1635. The system of claim 1580, wherein said means for attributing a number of said underlying references to said financial instrument comprises means for attributing a variable number of said underlying references to each unit of said financial instrument.

1636. The system of claim 1580, wherein said means for attributing a number of said underlying references to said financial instrument comprises means for attributing a constant number of said underlying references to each unit of said financial instrument.

1637. The system of claim 1580, wherein said means for identifying an underlying reference comprises means for identifying said underlying reference that said financial instrument converts into.

1638. The system of claim 1580, wherein said means for identifying an underlying reference comprises means for basing an exchange value of said financial instrument on said underlying reference.

1639. A financial services system comprising means for buying a financial instrument created by:
identifying an underlying reference for said financial instrument, said underlying reference having a value;
attributing a number of said underlying references to said financial instrument;
defining a contingency, a payment becoming due on occurrence of said contingency;
calculating said payment so that said payment exceeds an imposed minimum value.

1640. The system of claim 1639, wherein said means for buying said financial instrument comprises means for buying said financial instrument at a value based on at least one of:
a. said contingency;
b. said value of said underlying reference;
c. value of said payment;
d. length of said predetermined period of delay;
e. volatility in trading value of said underlying reference;
f. time until redemption, at option of issuer or holder;
g. time until maturity;
h. an interest rate; and
i. value for which said financial instrument must be redeemed on redemption date.

1641. The system of claim 1639, wherein said means for buying said financial instrument comprises means for bidding for said financial instrument.

1642. The system of claim 1639, wherein said means for buying said financial instrument comprises means for buying a derivative of said financial instrument.

1643. The system of claim 1639, wherein said means for buying said financial instrument comprises means for buying a part of said financial instrument.

1644. The system of claim 1639, wherein said defining a contingency comprises basing said contingency on an event related to said financial instrument.

1645. The system of claim 1639, wherein said defining a contingency comprises basing said contingency on an instrument other than said financial instrument.

1646. The system of claim 1639, wherein said attributing a number of said underlying references to said financial instrument comprises attributing a variable number of said underlying references to each unit of said financial instrument.

1647. The system of claim 1639, wherein said attributing a number of said underlying references to said financial instrument comprises attributing a constant number of said underlying references to each unit of said financial instrument.

1648. The system of claim 1639, wherein said identifying an underlying reference comprises identifying said underlying reference that said financial instrument converts into.

1649. The system of claim 1639, wherein said identifying an underlying reference comprises basing an exchange value of said financial instrument on said underlying reference.

1650. A financial services system associated with a financial instrument, said system comprising:
means for identifying an underlying reference for said financial instrument, said underlying reference having a value;
means for attributing a number of said underlying references to said financial instrument;
means for defining multiple contingencies, a payment becoming due on occurrence of at least one of:
a. satisfaction of one of said multiple contingencies,
b. satisfaction of more than one of said multiple contingencies, and
c. satisfaction of all of said multiple contingencies.

1651. The system of claim 1650, further comprising:
means for establishing a value for said financial instrument.

1652. The system of claim 1651 further comprising:
means for selling said financial instrument.

1653. The method of claim 1652, wherein said means for selling said financial instrument comprises means for selling said financial instrument at a value based on at least one of:
a. said multiple contingencies;
b. said value of said underlying reference;
c. value of said payment;
d. volatility in trading value of said underlying reference;
e. time until redemption, at option of issuer or holder;
f. time until maturity;
g. an interest rate; and
h. value for which said financial instrument must be redeemed on redemption date.

1654. The system of claim 1652, wherein said means for selling said financial instrument comprises means for auctioning said financial instrument.

1655. The system of claim 1652, wherein said means for selling said financial instrument comprises means for selling a derivative of said financial instrument.

1656. The system of claim 1652, wherein said means for selling said financial instrument comprises means for selling a part of said financial instrument.

1657. The system of claim 1652 further comprising:
means for monitoring for said satisfaction of said multiple contingencies.

1658. The system of claim 1652, further comprising:
means for disbursing said payment.

1659. The system of claim 1652, further comprising:
means for calculating said payment.

1660. The system of claim 1651, further comprising:
means for monitoring for said satisfaction of said multiple contingencies.

1661. The system of claim 1660, further comprising:
means for calculating said payment.

1662. The system of claim 1660, further comprising:
means for disbursing said payment.

1663. The system of claim 1651, further comprising:
means for disbursing said payment.

1664. The system of claim 1651, further comprising:
means for calculating said payment.

1665. The system of claim 1651, wherein said means for establishing a value for said financial instrument comprises means for basing said value for said financial instrument on at least one of:
a. said multiple contingencies;
b. said value of said underlying reference;
c. value of said payment;
d. volatility in trading value of said underlying reference;
e. time until redemption, at option of issuer or holder;
f. time until maturity;
g. an interest rate; and
h. value for which said financial instrument must be redeemed on redemption date.

1666. The system of claim 1650, further comprising:
means for selling said financial instrument.

1667. The system of claim 1666, wherein said means for selling said financial instrument comprises means for selling said financial instrument at a value based on at least one of:
a. said multiple contingencies;
b. said value of said underlying reference;
c. value of said payment;
d. volatility in trading value of said underlying reference;
e. time until redemption, at option of issuer or holder;
f. time until maturity;
g. an interest rate; and
h. value for which said financial instrument must be redeemed on redemption date.

1668. The system of claim 1666, wherein said means for selling said financial instrument comprises means for auctioning said financial instrument.

1669. The system of claim 1666, wherein said means for selling said financial instrument comprises means for selling a derivative of said financial instrument.

1670. The system of claim 1666, wherein said means for selling said financial instrument comprises means for selling a part of said financial instrument.

1671. The system of claim 1666, further comprising:
means for monitoring for said satisfaction of said multiple contingencies.

1672. The system of claim 1666, further comprising:
means for disbursing said payment.

1673. The system of claim 1666, further comprising:
means for calculating said payment.

1674. The system of claim 1650, further comprising:
means for monitoring for said satisfaction of said multiple contingencies.

1675. The system of claim 1674, wherein said means for monitoring for said satisfaction comprises means for comparing market data to requirements of said multiple contingencies within at least one contingency monitoring period.

1676. The system of claim 1674, wherein said means for monitoring comprises means for monitoring over many said contingency monitoring periods.

1677. The system of claim 1674, wherein said means for monitoring comprises monitoring realtime data.

1678. The system of claim 1674, further comprising:
means for disbursing said payment.

1679. The system of claim 1674, further comprising:
means for calculating said payment.

1680. The system of claim 1650, wherein said means for defining multiple contingencies comprises means for basing said contingencies on events related to said financial instrument.

1681. The system of claim 1650, wherein said means for defining multiple contingencies comprises means for basing said contingencies on instruments other than said financial instrument.

1682. The system of claim 1681, wherein said means for basing said contingencies on instruments other than said financial instrument comprises means for setting said contingencies as satisfied once observed values of said instruments at least:
a. exceed a predetermined metric, or
b. are equal to a predetermined metric, or
c. are less than a predetermined metric.

1683. The system of claim 1650, wherein said means for defining multiple contingencies comprises means for establishing multiple contingencies each with at least one trigger.

1684. The system of claim 1683, wherein said means for establishing at least one trigger comprises means for setting said trigger at an amount equal to a multiple of a prevailing market rate for a financial instrument.

1685. The system of claim 1684, wherein said means for setting said trigger at an amount equal to a multiple comprises means for using a multiple equal to 1.

1686. The system of claim 1684, wherein said means for setting said trigger at an amount equal to a multiple comprises means for using a multiple less than 1.

1687. The system of claim 1684, wherein said means for setting said trigger at an amount equal to a multiple comprises means for using a multiple greater than 1.

1688. The system of claim 1683, wherein said means for establishing at least one trigger comprises means for setting said trigger at an amount equal to a multiple of a formula amount.

1689. The system of claim 1688, wherein said means for setting said trigger at an amount equal to a multiple comprises means for using a multiple equal to 1.

1690. The system of claim 1688, wherein said means for setting said trigger at an amount equal to a multiple comprises means for using a multiple less than 1.

1691. The system of claim 1688, wherein said means for setting said trigger at an amount equal to a multiple comprises means for using a multiple greater than 1.

1692. The system of claim 1650, further comprising:
means for disbursing said payment.

1693. The system of claim 1692, wherein said means for disbursing said payment comprises means for sending a negotiable instrument.

1694. The system of claim 1650, further comprising:
means for calculating said payment.

1695. The system of claim 1694, wherein said means for calculating said payment comprises means for establishing a formula for calculating said payment based on said value of said underlying reference.

1696. The system of claim 1695, wherein said means for establishing a formula comprises means for using a fixed rate formula.

1697. The system of claim 1695, wherein said means for establishing a formula comprises means for using a variable rate formula.

1698. The system of claim 1694, wherein said means for calculating said payment comprises means for calculating said payment using a periodic schedule.

1699. The system of claim 1698, wherein said means for calculating said payment using a periodic schedule comprises means for calculating said payment at least once per contingency monitoring period.

1700. The system of claim 1698, wherein said means for calculating said payment using a periodic schedule comprises means for calculating said payment on a quarterly basis.

1701. The system of claim 1694, wherein said means for calculating said payment comprises means for calculating said payment based upon at least one of:
a. predetermined fixed amount,
b. trading value of said financial instrument,
c. trading yield of said financial instrument,
d. trading yield of a liability of said issuer of said financial instrument,
e. trading value of a liability of said issuer of said financial instrument,
f. trading value of a class of capital stock issued by an issuer other than said issuer of said financial instrument,
g. trading dividend yield of a class of capital stock issued by an issuer other than said issuer of said financial instrument,
h. trading value of a class of capital stock of said issuer of said financial instrument,
i. trading yield of a class of capital stock of said issuer of said financial instrument,
j. trading value of a security,
k. trading yield of a security, and
l. an index.

1702. The system of claim 1650, further comprising means for preparing at least one of:
a. a projected payment schedule;
b. an incidental analysis; and
c. a remoteness analysis.

1703. The system of claim 1702, wherein said means for preparing said projected payment schedule comprises means for determining a schedule of said payments based on payments necessary to produce a comparable yield.

1704. The system of claim 1702, wherein said means for preparing said incidental analysis comprises means for determining the amount of said payment based on assumptions regarding the contingency being satisfied.

1705. The system of claim 1704, wherein said means for determining the amount of said payment based on assumptions regarding the contingency being satisfied comprises means for determining the amount of said payment based on at least one of:
a. a stock price growth rate, and
b. discount rates.

1706. The system of claim 1702, wherein said means for preparing said remoteness analysis comprises means for determining the likelihood that said payment will be made given assumptions regarding said contingency being satisfied.

1707. The system of claim 1706, wherein said means for determining the likelihood that said payment will be made given assumptions regarding said contingency being satisfied comprises means for determining the likelihood that said payment will be made given a stock price growth rate and a volatility.

1708. The system of claim 1650, wherein said means for attributing a number of said underlying references to said financial instrument comprises means for attributing a variable number of said underlying references to each unit of said financial instrument.

1709. The system of claim 1650, wherein said means for attributing a number of said underlying references to said financial instrument comprises means for attributing a constant number of said underlying references to each unit of said financial instrument.

1710. The system of claim 1650, wherein said means for identifying an underlying reference comprises means for identifying said underlying reference that said financial instrument converts into.

1711. The system of claim 1650, wherein said means for identifying an underlying reference comprises means for basing an exchange value of said financial instrument on said underlying reference.

1712. A financial services system comprising means for buying a financial instrument created by:
identifying an underlying reference for said financial instrument, said underlying reference having a value;
attributing a number of said underlying references to said financial instrument;
defining multiple contingencies, a payment becoming due on occurrence of at least one of:
a. satisfaction of one of said multiple contingencies,
b. satisfaction of more than one of said multiple contingencies, and
c. satisfaction of all of said multiple contingencies.

1713. The system of claim 1712, wherein said means for buying said financial instrument comprises means for buying said financial instrument at a value based on at least one of:
a. said contingency;
b. said value of said underlying reference;
c. value of said payment;
d. length of said predetermined period of delay;
e. volatility in trading value of said underlying reference;
f. time until redemption, at option of issuer or holder;
g. time until maturity;
h. an interest rate; and
i. value for which said financial instrument must be redeemed on redemption date.

1714. The system of claim 1712, wherein said means for buying said financial instrument comprises means for bidding for said financial instrument.

1715. The system of claim 1712, wherein said means for buying said financial instrument comprises means for buying a derivative of said financial instrument.

1716. The system of claim 1712, wherein said means for buying said financial instrument comprises means for buying a part of said financial instrument.

1717. The system of claim 1712, wherein said defining multiple contingencies comprises basing said multiple contingencies on events related to said financial instrument.

1718. The system of claim 1712, wherein said defining multiple contingencies comprises basing said multiple contingencies on instruments other than said financial instrument.

1719. The system of claim 1712, wherein said attributing a number of said underlying references to said financial instrument comprises attributing a variable number of said underlying references to each unit of said financial instrument.

1720. The system of claim 1712, wherein said attributing a number of said underlying references to said financial instrument comprises attributing a constant number of said underlying references to each unit of said financial instrument.

1721. The system of claim 1712, wherein said identifying an underlying reference comprises identifying said underlying reference that said financial instrument converts into.

1722. The system of claim 1712, wherein said identifying an underlying reference comprises basing an exchange value of said financial instrument on said underlying reference.

1723. A financial services system associated with a financial instrument, said system comprising:
an underlying reference identifying unit that identifies an underlying reference;
an attribution unit that attributes a number of said underlying references to said financial instrument;
a contingency defining unit that defines a contingency, a payment becoming due on occurrence of said contingency after a predetermined period of delay.

1724. The system of claim 1723 further comprising:
a pricing value unit that establishes a value for said financial instrument.

1725. The system of claim 1724 further comprising:
a selling unit that sells said financial instrument.

1726. The system of claim 1725 further comprising:
a contingent payment monitoring unit that monitors for satisfaction of said contingency.

1727. The system of claim 1725 further comprising:
a payment unit that disburses said payment.

1728. The system of claim 1725 further comprising:
a contingent payment calculating unit that calculates said payment.

1729. The system of claim 1724 further comprising:
a contingent payment monitoring unit that monitors for satisfaction of said contingency.

1730. The-system of claim 1729 further comprising:
a payment unit that disburses said payment.

1731. The system of claim 1729 further comprising:
a contingent payment calculating unit that calculates said payment.

1732. The system of claim 1724 further comprising:
a payment unit that disburses said payment.

1733. The system of claim 1724 further comprising:
a contingent payment calculating unit that calculates said payment.

1734. The system of claim 1723 further comprising:
a selling unit that sells said financial instrument.

1735. The system of claim 1734 further comprising:
a contingent payment monitoring unit that monitors for satisfaction of said contingency.

1736. The system of claim 1734 further comprising:
a payment unit that disburses said payment.

1737. The system of claim 1734 further comprising:
a contingent payment calculating unit that calculates said payment.

1738. The system of claim 1723 further comprising:
a contingent payment monitoring unit that monitors for satisfaction of said contingency.

1739. The system of claim 1738 further comprising:
a payment unit that disburses said payment.

1740. The system of claim 1738 further comprising:
a contingent payment calculating unit that calculates said payment.

1741. The system of claim 1723 further comprising:
a payment unit that disburses said payment.

1742. The system of claim 1723 further comprising:
a contingent payment calculating unit that calculates said payment.

1743. The system of claim 1723 further comprising:
a projected payment scheduler that prepares a schedule of said payment.

1744. A financial services system associated with a financial instrument, said system comprising:
an underlying reference identifying unit that identifies an underlying reference;
an attribution unit that attributes a number of said underlying references to said financial instrument;
a contingency defining unit that defines a contingency having at least one trigger, a payment becoming due when said trigger drops below a predetermined value during a contingency monitoring period.

1745. The system of claim 1744 further comprising:
a pricing value unit that establishes a value for said financial instrument.

1746. The system of claim 1745 further comprising:
a selling unit that sells said financial instrument.

1747. The system of claim 1746 further comprising:
a contingent payment monitoring unit that monitors for satisfaction of said contingency.

1748. The system of claim 1746 further comprising:
a payment unit that disburses said payment.

1749. The system of claim 1746 further comprising:
a contingent payment calculating unit that calculates said payment.

1750. The system of claim 1745 further comprising:
a contingent payment monitoring unit that monitors for satisfaction of said contingency.

1751. The system of claim 1750 further comprising:
a payment unit that disburses said payment.

1752. The system of claim 1750 further comprising:
a contingent payment calculating unit that calculates said payment.

1753. The system of claim 1745 further comprising:
a payment unit that disburses said payment.

1754. The system of claim 1745 further comprising:
a contingent payment calculating unit that calculates said payment.

1755. The system of claim 1744 further comprising:
a selling unit that sells said financial instrument.

1756. The system of claim 1755 further comprising:
a contingent payment monitoring unit that monitors for satisfaction of said contingency.

1757. The system of claim 1755 further comprising:
a payment unit that disburses said payment.

1758. The system of claim 1755 further comprising:
a contingent payment calculating unit that calculates said payment.

1759. The system of claim 1744 further comprising:
a contingent payment monitoring unit that monitors for satisfaction of said contingency.

1760. The system of claim 1759 further comprising:
a payment unit that disburses said payment.

1761. The system of claim 1759 further comprising:
a contingent payment calculating unit that calculates said payment.

1762. The system of claim 1744 further comprising:
a payment unit that disburses said payment.

1763. The system of claim 1744 further comprising: a contingent payment calculating unit that calculates said payment.

1764. The system of claim 1744 further comprising:
a projected payment scheduler that prepares a schedule of said payment.

1765. A financial services system associated with a financial instrument, said system comprising:
an underlying reference identifying unit that identifies an underlying reference;
an attribution unit that attributes a number of said underlying references to said financial instrument;
a contingency defining unit that defines a contingency having multiple triggers, a payment becoming due when any one of said triggers drops below a predetermined value during a contingency monitoring period.

1766. The system of claim 1765 further comprising:
a pricing value unit that establishes a value for said financial instrument.

1767. The system of claim 1766 further comprising:
a selling unit that sells said financial instrument.

1768. The system of claim 1767 further comprising:
a contingent payment monitoring unit that monitors for satisfaction of said contingency.

1769. The system of claim 1767 further comprising:
a payment unit that disburses said payment.

1770. The system of claim 1767 further comprising:
a contingent payment calculating unit that calculates said payment.

1771. The system of claim 1766 further comprising:
a contingent payment monitoring unit that monitors for satisfaction of said contingency.

1772. The system of claim 1771 further comprising:
a payment unit that disburses said payment.

1773. The system of claim 1771 further comprising:
a contingent payment calculating unit that calculates said payment.

1774. The system of claim 1766 further comprising:
a payment unit that disburses said payment.

1775. The system of claim 1766 further comprising:
a contingent payment calculating unit that calculates said payment.

1776. The system of claim 1765 further comprising:
a selling unit that sells said financial instrument.

1777. The system of claim 1776 further comprising:
a contingent payment monitoring unit that monitors for satisfaction of said contingency.

1778. The system of claim 1776 further comprising:
a payment unit that disburses said payment.

1779. The system of claim 1776 further comprising:
a contingent payment calculating unit that calculates said payment.

1780. The system of claim 1765 further comprising:
a contingent payment monitoring unit that monitors for satisfaction of said contingency.

1781. The system of claim 1780 further comprising:
a payment unit that disburses said payment.

1782. The system of claim 1780 further comprising:
a contingent payment calculating unit that calculates said payment.

1783. The system of claim 1765 further comprising:
a payment unit that disburses said payment.

1784. The system of claim 1765 further comprising:
a contingent payment calculating unit that calculates said payment.

1785. The system of claim 1765 further comprising:
a projected payment scheduler that prepares a schedule of said payment.

1786. A financial services system associated with a financial instrument, said system comprising:
an underlying reference identifying unit that identifies an underlying reference;
an attribution unit that attributes a number of said underlying references to said financial instrument;
a contingency defining unit that defines a contingency having multiple triggers, a payment becoming due when multiple triggers drop below respective predetermined values during a contingency monitoring period.

1787. The system of claim 1786 further comprising:
a pricing value unit that establishes a value for said financial instrument.

1788. The system of claim 1787 further comprising:
a selling unit that sells said financial instrument.

1789. The system of claim 1788 further comprising:
a contingent payment monitoring unit that monitors for satisfaction of said contingency.

1790. The system of claim 1788 further comprising:
a payment unit that disburses said payment.

1791. The system of claim 1788 further comprising:
a contingent payment calculating unit that calculates said payment.

1792. The system of claim 1787 further comprising:
a contingent payment monitoring unit that monitors for satisfaction of said contingency.

1793. The system of claim 1792 further comprising:
a payment unit that disburses said payment.

1794. The system of claim 1792 further comprising:
a contingent payment calculating unit that calculates said payment.

1795. The system of claim 1787 further comprising:
a payment unit that disburses said payment.

1796. The system of claim 1787 further comprising:
a contingent payment calculating unit that calculates said payment.

1797. The system of claim 1786 further comprising:
a selling unit that sells said financial instrument.

1798. The system of claim 1797 further comprising:
a contingent payment monitoring unit that monitors for satisfaction of said contingency.

1799. The system of claim 1797 further comprising:
a payment unit that disburses said payment.

1800. The system of claim 1797 further comprising:
a contingent payment calculating unit that calculates said payment.

1801. The system of claim 1786 further comprising:
a contingent payment monitoring unit that monitors for satisfaction of said contingency.

1802. The system of claim 1801 further comprising:
a payment unit that disburses said payment.

1803. The system of claim 1801 further comprising:
a contingent payment calculating unit that calculates said payment.

1804. The system of claim 1786 further comprising:
a payment unit that disburses said payment.

1805. The system of claim 1786 further comprising:
a contingent payment calculating unit that calculates said payment.

1806. The system of claim 1786 further comprising:
a projected payment scheduler that prepares a schedule of said payment.

1807. A financial services system associated with a financial instrument, said system comprising:
an underlying reference identifying unit that identifies an underlying reference;
an attribution unit that attributes a number of said underlying references to said financial instrument;
a contingency defining unit that defines multiple contingencies each having at least one trigger, a payment becoming due when any said trigger drops below a predetermined value during a contingency monitoring period.

1808. The system of claim 1807 further comprising:
a pricing value unit that establishes a value for said financial instrument.

1809. The system of claim 1808 further comprising:
a selling unit that sells said financial instrument.

1810. The system of claim 1809 further comprising:
a contingent payment monitoring unit that monitors for satisfaction of said contingency.

1811. The system of claim 1809 further comprising:
a payment unit that disburses said payment.

1812. The system of claim 1809 further comprising:
a contingent payment calculating unit that calculates said payment.

1813. The system of claim 1808 further comprising:
a contingent payment monitoring unit that monitors for satisfaction of said contingency.

1814. The system of claim 1813 further comprising:
a payment unit that disburses said payment.

1815. The system of claim 1813 further comprising:
a contingent payment calculating unit that calculates said payment.

1816. The system of claim 1808 further comprising:
a payment unit that disburses said payment.

1817. The system of claim 1808 further comprising:
a contingent payment calculating unit that calculates said payment.

1818. The system of claim 1807 further comprising:
a selling unit that sells said financial instrument.

1819. The system of claim 1818 further comprising:
a contingent payment monitoring unit that monitors for satisfaction of said contingency.

1820. The system of claim 1818 further comprising:
a payment unit that disburses said payment.

1821. The system of claim 1818 further comprising:
a contingent payment calculating unit that calculates said payment.

1822. The system of claim 1807 further comprising:
a contingent payment monitoring unit that monitors for satisfaction of said contingency.

1823. The system of claim 1822 further comprising:
a payment unit that disburses said payment.

1824. The system of claim 1822 further comprising:
a contingent payment calculating unit that calculates said payment.

1825. The system of claim 1807 further comprising:
a payment unit that disburses said payment.

1826. The system of claim 1807 further comprising:
a contingent payment calculating unit that calculates said payment.

1827. The system of claim 1807 further comprising:
a projected payment scheduler that prepares a schedule of said payment.

1828. A financial services system associated with a financial instrument, said system comprising:
an underlying reference identifying unit that identifies an underlying reference;
an attribution unit that attributes a number of said underlying references to said financial instrument;
a contingency defining unit that defines multiple contingencies each having multiple triggers, a payment becoming due when one of said multiple triggers drops below a predetermined value during a contingency monitoring period.

1829. The system of claim 1828 further comprising:
a pricing value unit that establishes a value for said financial instrument.

1830. The system of claim 1829 further comprising:
a selling unit that sells said financial instrument.

1831. The system of claim 1830 further comprising:
a contingent payment monitoring unit that monitors for satisfaction of said contingency.

1832. The system of claim 1830 further comprising:
a payment unit that disburses said payment.

1833. The system of claim 1830 further comprising:
a contingent payment calculating unit that calculates said payment.

1834. The system of claim 1829 further comprising:
a contingent payment monitoring unit that monitors for satisfaction of said contingency.

1835. The system of claim 1834 further comprising:
a payment unit that disburses said payment.

1836. The system of claim 1834 further comprising:
a contingent payment calculating unit that calculates said payment.

1837. The system of claim 1829 further comprising:
a payment unit that disburses said payment.

1838. The system of claim 1829 further comprising:
a contingent payment calculating unit that calculates said payment.

1839. The system of claim 1828 further comprising:
a selling unit that sells said financial instrument.

1840. The system of claim 1839 further comprising:
a contingent payment monitoring unit that monitors for satisfaction of said contingency.

1841. The system of claim 1839 further comprising:
a payment unit that disburses said payment.

1842. The system of claim 1839 further comprising:
a contingent payment calculating unit that calculates said payment.

1843. The system of claim 1828 further comprising:
a contingent payment monitoring unit that monitors for satisfaction of said contingency.

1844. The system of claim 1843 further comprising:
a payment unit that disburses said payment.

1845. The system of claim 1843 further comprising:
a contingent payment calculating unit that calculates said payment.

1846. The system of claim 1828 further comprising:
a payment unit that disburses said payment.

1847. The system of claim 1828 further comprising:
a contingent payment calculating unit that calculates said payment.

1848. The system of claim 1828 further comprising:
a projected payment scheduler that prepares a schedule of said payment.

1849. A financial services system associated with a financial instrument, said system comprising:
an underlying reference identifying unit that identifies an underlying reference;
an attribution unit that attributes a number of said underlying references to said financial instrument;
a contingency defining unit that defines multiple contingencies each having multiple triggers, a payment becoming due when at least two of said multiple triggers drop below respective predetermined values during a contingency monitoring period, at least one of said at least two triggers being a trigger of a different contingency from any other of said at least two triggers.

1850. The system of claim 1849 further comprising:
a pricing value unit that establishes a value for said financial instrument.

1851. The system of claim 1850 further comprising:
a selling unit that sells said financial instrument.

1852. The system of claim 1851 further comprising:
a contingent payment monitoring unit that monitors for satisfaction of said contingency.

1853. The system of claim 1851 further comprising:
a payment unit that disburses said payment.

1854. The system of claim 1851 further comprising:
a contingent payment calculating unit that calculates said payment.

1855. The system of claim 1850 further comprising:
a contingent payment monitoring unit that monitors for satisfaction of said contingency.

1856. The system of claim 1855 further comprising:
a payment unit that disburses said payment.

1857. The system of claim 1855 further comprising:
a contingent payment calculating unit that calculates said payment.

1858. The system of claim 1850 further comprising:
a payment unit that disburses said payment.

1859. The system of claim 1850 further comprising:
a contingent payment calculating unit that calculates said payment.

1860. The system of claim 1849 further comprising:
a selling unit that sells said financial instrument.

1861. The system of claim 1860 further comprising:
a contingent payment monitoring unit that monitors for satisfaction of said contingency.

1862. The system of claim 1860 further comprising:
a payment unit that disburses said payment.

1863. The system of claim 1860 further comprising:
a contingent payment calculating unit that calculates said payment.

1864. The system of claim 1849 further comprising:
a contingent payment monitoring unit that monitors for satisfaction of said contingency.

1865. The system of claim 1864 further comprising:
a payment unit that disburses said payment.

1866. The system of claim 1864 further comprising:
a contingent payment calculating unit that calculates said payment.

1867. The system of claim 1849 further comprising:
a payment unit that disburses said payment.

1868. The system of claim 1849 further comprising:
a contingent payment calculating unit that calculates said payment.

1869. The system of claim 1849 further comprising:
a projected payment scheduler that prepares a schedule of said payment.

1870. A financial services system associated with a financial instrument, said system comprising:
an underlying reference identifying unit that identifies an underlying reference;
an attribution unit that attributes a number of said underlying references to said financial instrument;
a contingency defining unit that defines a contingency, said contingency having a trigger based upon at least one of:
a. trading value of said financial instrument,
b. trading yield of said financial instrument,
c. dividend yield of said underlying reference,
d. trading yield of a liability of said issuer of said financial instrument,
e. trading value of a liability of said issuer of said financial instrument,
f. trading value of a class of capital stock other than said underlying reference,
g. trading dividend yield of a class of capital stock issued by an issuer other than said issuer of said financial instrument,
h. trading value of a class of capital stock of said issuer of said financial instrument other than common stock,
i. trading yield of a class of capital stock of said issuer of said financial instrument,
j. trading value of a security issued by an issuer other than said issuer of said financial instrument,
k. trading yield of a security,
l. an index; wherein:
a payment becomes due on occurrence of said contingency.

1871. The system of claim 1870 further comprising:
a pricing value unit that establishes a value for said financial instrument.

1872. The system of claim 1871 further comprising:
a selling unit that sells said financial instrument.

1873. The system of claim 1872 further comprising:
a contingent payment monitoring unit that monitors for satisfaction of said contingency.

1874. The system of claim 1872 further comprising:
a payment unit that disburses said payment.

1875. The system of claim 1872 further comprising:
a contingent payment calculating unit that calculates said payment.

1876. The system of claim 1871 further comprising:
a contingent payment monitoring unit that monitors for satisfaction of said contingency.

1877. The system of claim 1876 further comprising:
a payment unit that disburses said payment.

1878. The system of claim 1876 further comprising:
a contingent payment calculating unit that calculates said payment.

1879. The system of claim 1871 further comprising:
a payment unit that disburses said payment.

1880. The system of claim 1871 further comprising:
a contingent payment calculating unit that calculates said payment.

1881. The system of claim 1870 further comprising:
a selling unit that sells said financial instrument.

1882. The system of claim 1881 further comprising:
a contingent payment monitoring unit that monitors for satisfaction of said contingency.

1883. The system of claim 1881 further comprising:
a payment unit that disburses said payment.

1884. The system of claim 1881 further comprising:
a contingent payment calculating unit that calculates said payment.

1885. The system of claim 1870 further comprising:
a contingent payment monitoring unit that monitors for satisfaction of said contingency.

1886. The system of claim 1885 further comprising:
a payment unit that disburses said payment.

1887. The system of claim 1885 further comprising:
a contingent payment calculating unit that calculates said payment.

1888. The system of claim 1870 further comprising:
a payment unit that disburses said payment.

1889. The system of claim 1870 further comprising:
a contingent payment calculating unit that calculates said payment.

1890. The system of claim 1870 further comprising:
a projected payment scheduler that prepares a schedule of said payment.

1891. A financial services system associated with a financial instrument, said system comprising:
an underlying reference identifying unit that identifies an underlying reference;
an attribution unit that attributes a number of said underlying references to said financial instrument;
a contingency defining unit that defines a contingency;
a contingent payment calculating unit that calculates said payment based upon at least one of:
a. trading value of said financial instrument,
b. trading yield of said financial instrument,
c. dividend yield of said underlying reference,
d. trading yield of a liability of said issuer of said financial instrument,
e. trading value of a liability of said issuer of said financial instrument,
f. trading value of a class of capital stock issued by an issuer other than said issuer of said financial instrument,
g. trading dividend yield of a class of capital stock other than said underlying reference,
h. trading value of a class of capital stock of said issuer of said financial instrument,
i. trading yield of a class of capital stock of said issuer of said financial instrument other than common stock,
j. trading value of a security,
k. trading yield of a security issued by an issuer other than said issuer of said financial instrument,
l. an index.

1892. The system of claim 1891 further comprising:
a pricing value unit that establishes a value for said financial instrument.

1893. The system of claim 1892 further comprising:
a selling unit that sells said financial instrument.

1894. The system of claim 1893 further comprising:
a contingent payment monitoring unit that monitors for satisfaction of said contingency.

1895. The system of claim 1893 further comprising:
a payment unit that disburses said payment.

1896. The system of claim 1892 further comprising:
a contingent payment monitoring unit that monitors for satisfaction of said contingency.

1897. The system of claim 1896 further comprising:
a payment unit that disburses said payment.

1898. The system of claim 1892 further comprising:
a payment unit that disburses said payment.

1899. The system of claim 1891 further comprising:
a selling unit that sells said financial instrument.

1900. The system of claim 1899 further comprising:
a contingent payment monitoring unit that monitors for satisfaction of said contingency.

1901. The system of claim 1899 further comprising:
a payment unit that disburses said payment.

1902. The system of claim 1891 further comprising:
a contingent payment monitoring unit that monitors for satisfaction of said contingency.

1903. The system of claim 1902 further comprising:
a payment unit that disburses said payment.

1904. The system of claim 1891 further comprising:
a payment unit that disburses said payment.

1905. The system of claim 1891 further comprising:
a projected payment scheduler that prepares a schedule of said payment.

1906. A financial services system associated with a financial instrument, said system comprising:
an underlying reference identifying unit that identifies an underlying reference;
an attribution unit that attributes a number of said underlying references to said financial instrument;
a contingency defining unit that defines a contingency;
a contingent payment calculating unit that calculates said payment so that said payment equals at most an imposed maximum value

1907. The system of claim 1906 further comprising:
a pricing value unit that establishes a value for said financial instrument.

1908. The system of claim 1907 further comprising:
a selling unit that sells said financial instrument.

1909. The system of claim 1908 further comprising:
a contingent payment monitoring unit that monitors for satisfaction of said contingency.

1910. The system of claim 1908 further comprising:
a payment unit that disburses said payment.

1911. The system of claim 1907 further comprising:
a contingent payment monitoring unit that monitors for satisfaction of said contingency.

1912. The system of claim 1911 further comprising:
a payment unit that disburses said payment.

1913. The system of claim 1907 further comprising:
a payment unit that disburses said payment.

1914. The system of claim 1906 further comprising:
a selling unit that sells said financial instrument.

1915. The system of claim 1914 further comprising:
a contingent payment monitoring unit that monitors for satisfaction of said contingency.

1916. The system of claim 1914 further comprising:
a payment unit that disburses said payment.

1917. The system of claim 1906 further comprising:
a contingent payment monitoring unit that monitors for satisfaction of said contingency.

1918. The system of claim 1917 further comprising:
a payment unit that disburses said payment.

1919. The system of claim 1906 further comprising:
a payment unit that disburses said payment.

1920. The system of claim 1906 further comprising:
a projected payment scheduler that prepares a schedule of said payment.

1921. A financial services system associated with a financial instrument, said system comprising:
an underlying reference identifying unit that identifies an underlying reference;
an attribution unit that attributes a number of said underlying references to said financial instrument;
a contingency defining unit that defines a contingency;
a contingent payment calculating unit that calculates said payment so that said payment exceeds an imposed minimum value.

1922. The system of claim 1921 further comprising:
a pricing value unit that establishes a value for said financial instrument.

1923. The system of claim 1922 further comprising:
a selling unit that sells said financial instrument.

1924. The system of claim 1923 further comprising:
a contingent payment monitoring unit that monitors for satisfaction of said contingency.

1925. The system of claim 1923 further comprising:
a payment unit that disburses said payment.

1926. The system of claim 1922 further comprising:
a contingent payment monitoring unit that monitors for satisfaction of said contingency.

1927. The system of claim 1926 further comprising:
a payment unit that disburses said payment.

1928. The system of claim 1922 further comprising:
a payment unit that disburses said payment.

1929. The system of claim 1921 further comprising:
a selling unit that sells said financial instrument.

1930. The system of claim 1929 further comprising:
a contingent payment monitoring unit that monitors for satisfaction of said contingency.

1931. The system of claim 1929 further comprising:
a payment unit that disburses said payment.

1932. The system of claim 1921 further comprising:
a contingent payment monitoring unit that monitors for satisfaction of said contingency.

1933. The system of claim 1932 further comprising:
a payment unit that disburses said payment.

1934. The system of claim 1921 further comprising:
a payment unit that disburses said payment.

1935. The system of claim 1921 further comprising:
a projected payment scheduler that prepares a schedule of said payment.

1936. A financial services system associated with a financial instrument, said system comprising:
an underlying reference identifying unit that identifies an underlying reference;
an attribution unit that attributes a number of said underlying references to said financial instrument;
a contingency defining unit that defines multiple contingencies, a payment becoming due on occurrence of at least one of:
a. satisfaction of one of said multiple contingencies,
b. satisfaction of more than one of said multiple contingencies, and
c. satisfaction of all of said multiple contingencies.

1937. The system of claim 1936 further comprising:
a pricing value unit that establishes a value for said financial instrument.

1938. The system of claim 1937 further comprising:
a selling unit that sells said financial instrument.

1939. The system of claim 1938 further comprising:
a contingent payment monitoring unit that monitors for said satisfaction of said multiple contingencies.

1940. The system of claim 1938 further comprising:
a payment unit that disburses said payment.

1941. The system of claim 1938 further comprising:
a contingent payment calculating unit that calculates said payment.

1942. The system of claim 1937 further comprising:
a contingent payment monitoring unit that monitors for said satisfaction of said multiple contingencies.

1943. The system of claim 1942 further comprising:
a payment unit that disburses said payment.

1944. The system of claim 1942 further comprising:
a contingent payment calculating unit that calculates said payment.

1945. The system of claim 1937 further comprising:
a payment unit that disburses said payment.

1946. The system of claim 1937 further comprising:
a contingent payment calculating unit that calculates said payment.

1947. The system of claim 1936 further comprising:
a selling unit that sells said financial instrument.

1948. The system of claim 1947 further comprising:
a contingent payment monitoring unit that monitors for said satisfaction of said multiple contingencies.

1949. The system of claim 1947 further comprising:
a payment unit that disburses said payment.

1950. The system of claim 1947 further comprising:
a contingent payment calculating unit that calculates said payment.

1951. The system of claim 1936 further comprising:
a contingent payment monitoring unit that monitors for said satisfaction of said multiple contingencies.

1952. The system of claim 1951 further comprising:
a payment unit that disburses said payment.

1953. The system of claim 1951 further comprising:
a contingent payment calculating unit that calculates said payment.

1954. The system of claim 1936 further comprising:
a payment unit that disburses said payment.

1955. The system of claim 1936 further comprising:
a contingent payment calculating unit that calculates said payment.

1956. The system of claim 1936 further comprising:
a projected payment scheduler that prepares a schedule of said payment.

1957. A financial instrument derived in accordance with a method, said method comprising:
identifying an underlying reference for said financial instrument, said underlying reference having a value;
attributing a number of said underlying references to said financial instrument;
defining a contingency, a payment becoming due on occurrence of said contingency after a predetermined period of delay.

1958. The financial instrument derived in accordance with said method of claim 1936, said method further comprising:
establishing a value for said financial instrument.

1959. The financial instrument derived in accordance with said method of claim 1958, said method further comprising:
selling said financial instrument.

1960. The financial instrument derived in accordance with said method of claim 1959, wherein said selling said financial instrument comprises selling said financial instrument at a value based on at least one of:
a. said contingency;
b. said value of said underlying reference;
c. value of said payment;
d. length of said predetermined period of delay;
e. volatility in trading value of said underlying reference;
f. time until redemption, at option of issuer or holder;
g. time until maturity;
h. an interest rate; and
i. value for which said financial instrument must be redeemed on redemption date.

1961. The financial instrument derived in accordance with said method of claim 1959, wherein said selling said financial instrument comprises auctioning said financial instrument.

1962. The financial instrument derived in accordance with said method of claim 1959, wherein said selling said financial instrument comprises selling a derivative of said financial instrument.

1963. The financial instrument derived in accordance with said method of claim 1959, wherein said selling said financial instrument comprises selling a part of said financial instrument.

1964. The financial instrument derived in accordance with said method of claim 1959, said method further comprising:
monitoring for satisfaction of said contingency.

1965. The financial instrument derived in accordance with said method of claim 1959, said method further comprising:
disbursing said payment.

1966. The financial instrument derived in accordance with said method of claim 1959, said method further comprising:
calculating said payment.

1967. The financial instrument derived in accordance with said method of claim 1958, said method further comprising:
monitoring for satisfaction of said contingency.

1968. The financial instrument derived in accordance with said method of claim 1967, said method further comprising:
disbursing said payment.

1969. The financial instrument derived in accordance with said method of claim 1967, said method further comprising:
calculating said payment.

1970. The financial instrument derived in accordance with said method of claim 1958, said method further comprising:
disbursing said payment.

1971. The financial instrument derived in accordance with said method of claim 1958, said method further comprising:
calculating said payment.

1972. The financial instrument derived in accordance with said method of claim 1958, wherein said establishing a value for said financial instrument comprises basing said value for said financial instrument on at least one of:
a. said contingency;
b. said value of said underlying reference;
c. value of said payment;
d. length of said predetermined period of delay;
e. volatility in trading value of said underlying reference;
f. time until redemption, at option of issuer or holder;
g. time until maturity;
h. an interest rate; and
i. value for which said financial instrument must be redeemed on redemption date.

1973. The financial instrument derived in accordance with said method of claim 1936, said method further comprising:
selling said financial instrument.

1974. The financial instrument derived in accordance with said method of claim 1973, wherein said selling said financial instrument comprises selling said financial instrument at a value based on at least one of:
a. said contingency;
b. said value of said underlying reference;
c. value of said payment;
d. length of said predetermined period of delay;
e. volatility in trading value of said underlying reference;
f. time until redemption, at option of issuer or holder;
g. time until maturity;
h. an interest rate; and
i. value for which said financial instrument must be redeemed on redemption date.

1975. The financial instrument derived in accordance with said method of claim 1973, wherein said selling said financial instrument comprises auctioning said financial instrument.

1976. The financial instrument derived in accordance with said method of claim 1973, wherein said selling said financial instrument comprises selling a derivative of said financial instrument.

1977. The financial instrument derived in accordance with said method of claim 1973, wherein said selling said financial instrument comprises selling a part of said financial instrument.

1978. The financial instrument derived in accordance with said method of claim 1973, said method further comprising:
monitoring for satisfaction of said contingency.

1979. The financial instrument derived in accordance with said method of claim 1973, said method further comprising:
disbursing said payment.

1980. The financial instrument derived in accordance with said method of claim 1973, said method further comprising:
calculating said payment.

1981. The financial instrument derived in accordance with said method of claim 1936, said method further comprising:
monitoring for satisfaction of said contingency.

1982. The financial instrument derived in accordance with said method of claim 1981, wherein said monitoring for satisfaction comprises comparing market data to requirements of said contingency within at least one said contingency monitoring period.

1983. The financial instrument derived in accordance with said method of claim 1981, wherein said monitoring comprises monitoring over many said contingency monitoring periods.

1984. The financial instrument derived in accordance with said method of claim 1981, wherein said monitoring comprises monitoring realtime data.

1985. The financial instrument derived in accordance with said method of claim 1981, said method further comprising:
disbursing said payment.

1986. The financial instrument derived in accordance with said method of claim 1981, said method further comprising:
calculating said payment.

1987. The financial instrument derived in accordance with said method of claim 1936, wherein said defining a contingency comprises basing said contingency on an event related to said financial instrument.

1988. The financial instrument derived in accordance with said method of claim 1987, wherein said basing said contingency on an event related to said financial instrument comprises setting said contingency as satisfied once an observed value of said financial instrument at least:
a. exceeds a predetermined metric, or
b. is equal to a predetermined metric, or
c. is less than a predetermined metric.

1989. The financial instrument derived in accordance with said method of claim 1936, wherein said defining a contingency comprises setting said contingency as satisfied when the closing sale value of said underlying reference within at least one said contingency monitoring period is greater than a predetermined percentage of the conversion value.

1990. The financial instrument derived in accordance with said method of claim 1936, wherein said defining a contingency comprises setting said contingency as satisfied when the closing sale value of said underlying reference within at least one said contingency monitoring period is less than a predetermined percentage of the conversion value.

1991. The financial instrument derived in accordance with said method of claim 1936, wherein said defining a contingency comprises basing said contingency on an instrument other than said financial instrument.

1992. The financial instrument derived in accordance with said method of claim 1991, wherein said basing said contingency on said instrument other than said financial instrument comprises setting said contingency as satisfied once an observed value of said instrument at least:
a. exceeds a predetermined metric, or
b. is equal to a predetermined metric, or
c. is less than a predetermined metric.

1993. The financial instrument derived in accordance with said method of claim 1936, wherein said defining a contingency comprises establishing at least one of:
a. a contingency having at least one trigger, and
b. multiple contingencies each with at least one trigger.

1994. The financial instrument derived in accordance with said method of claim 1993, wherein said establishing at least one trigger comprises setting said trigger at an amount equal to a multiple of a prevailing market rate for a financial instrument.

1995. The financial instrument derived in accordance with said method of claim 1994, wherein said setting said trigger at an amount equal to a multiple comprises using a multiple equal to 1.

1996. The financial instrument derived in accordance with said method of claim 1994, wherein said setting said trigger at an amount equal to a multiple comprises using a multiple less than 1.

1997. The financial instrument derived in accordance with said method of claim 1994, wherein said setting said trigger at an amount equal to a multiple comprises using a multiple greater than 1.

1998. The financial instrument derived in accordance with said method of claim 1993, wherein said establishing at least one trigger comprises setting said trigger at an amount equal to a multiple of a formula amount.

1999. The financial instrument derived in accordance with said method of claim 1998, wherein said setting said trigger at an amount equal to a multiple comprises using a multiple equal to 1.

2000. The financial instrument derived in accordance with said method of claim 1998, wherein said setting said trigger at an amount equal to a multiple comprises using a multiple less than 1.

2001. The financial instrument derived in accordance with said method of claim 1998, wherein said setting said trigger at an amount equal to a multiple comprises using a multiple greater than 1.

2002. The financial instrument derived in accordance with said method of claim 1936, said method further comprising:
disbursing said payment.

2003. The financial instrument derived in accordance with said method of claim 2002, wherein said disbursing said payment comprises sending a negotiable instrument.

2004. The financial instrument derived in accordance with said method of claim 1936, said method further comprising:
calculating said payment.

2005. The financial instrument derived in accordance with said method of claim 2004, wherein said calculating said payment comprises establishing a formula for calculating said payment based on said value of said underlying reference.

2006. The financial instrument derived in accordance with said method of claim 2005, wherein said establishing a formula comprises using a fixed rate formula.

2007. The financial instrument derived in accordance with said method of claim 2005, wherein said establishing a formula comprises using a variable rate formula.

2008. The financial instrument derived in accordance with said method of claim 2004, wherein said calculating said payment comprises calculating said payment using a periodic schedule.

2009. The financial instrument derived in accordance with said method of claim 2008, wherein said calculating said payment using a periodic schedule comprises calculating said payment at least once per said contingency monitoring period.

2010. The financial instrument derived in accordance with said method of claim 2008, wherein said calculating said payment using a periodic schedule comprises calculating said payment on a quarterly basis.

2011. The financial instrument derived in accordance with said method of claim 2004, wherein said calculating said payment comprises calculating said payment based upon at least one of:
a. predetermined fixed amount,
b. trading value of said financial instrument,
c. trading yield of said financial instrument,
d. trading yield of a liability of said issuer of said financial instrument,
e. trading value of a liability of said issuer of said financial instrument,
f. trading value of a class of capital stock issued by an issuer other than said issuer of said financial instrument,
g. trading dividend yield of a class of capital stock issued by an issuer other than said issuer of said financial instrument,
h. trading value of a class of capital stock of said issuer of said financial instrument,
i. trading yield of a class of capital stock of said issuer of said financial instrument,
j. trading value of a security,
k. trading yield of a security, and
l. an index.

2012. The financial instrument derived in accordance with said method of claim 1936, further comprising preparing at least one of:
a. a projected payment schedule;
b. an incidental analysis; and
c. a remoteness analysis.

2013. The financial instrument derived in accordance with said method of claim 2012, wherein said preparing said projected payment schedule comprises determining a schedule of said payments based on payments necessary to produce a comparable yield.

2014. The financial instrument derived in accordance with said method of claim 2012, wherein said preparing said incidental analysis comprises determining the amount of said payment based on assumptions regarding said contingency being satisfied.

2015. The financial instrument derived in accordance with said method of claim 2014, wherein said determining the amount of said payment based on assumptions regarding the contingency being satisfied comprises determining the amount of said payment based on at least one of:
a. a stock price growth rate, and
b. discount rates.

2016. The financial instrument derived in accordance with said method of claim 2012, wherein said preparing said remoteness analysis comprises determining the likelihood that said payment will be made given assumptions regarding said contingency being satisfied.

2017. The financial instrument derived in accordance with said method of claim 2016, wherein said determining the likelihood that said payment will be made given assumptions regarding said contingency being satisfied comprises determining the likelihood that said payment will be made given a stock price growth rate and a volatility.

2018. The financial instrument derived in accordance with said method of claim 1936, wherein said attributing a number of said underlying references to said financial instrument comprises attributing a variable number of said underlying references to each unit of said financial instrument.

2019. The financial instrument derived in accordance with said method of claim 1936, wherein said attributing a number of said underlying references to said financial instrument comprises attributing a constant number of said underlying references to each unit of said financial instrument.

2020. The financial instrument derived in accordance with said method of claim 1936, wherein said identifying an underlying reference comprises identifying said underlying reference that said financial instrument converts into.

2021. The financial instrument derived in accordance with said method of claim 1936, wherein said identifying an underlying reference comprises basing an exchange value of said financial instrument on said underlying reference.

2022. The financial instrument derived in accordance with said method of claim 1936, wherein said predetermined period of delay comprises a period of delay greater than a contingency monitoring period.

2023. A financial instrument derived in accordance with a method, said method comprising buying said financial instrument created by:
identifying an underlying reference for said financial instrument, said underlying reference having a value;
attributing a number of said underlying references to said financial instrument;
defining a contingency, a payment becoming due on occurrence of said contingency after a predetermined period of delay.

2024. The financial instrument derived in accordance with said method of claim 2023, wherein said buying said financial instrument comprises buying said financial instrument at a value based on at least one of:
a. said contingency;
b. said value of said underlying reference;
c. value of said payment;
d. length of said predetermined period of delay;
e. volatility in trading value of said underlying reference;
f. time until redemption, at option of issuer or holder;
g. time until maturity;
h. an interest rate; and
i. value for which said financial instrument must be redeemed on redemption date.

2025. The financial instrument derived in accordance with said method of claim 2023, wherein said buying said financial instrument comprises bidding for said financial instrument.

2026. The financial instrument derived in accordance with said method of claim 2023, wherein said buying said financial instrument comprises buying a derivative of said financial instrument.

2027. The financial instrument derived in accordance with said method of claim 2023, wherein said buying said financial instrument comprises buying a part of said financial instrument.

2028. The financial instrument derived in accordance with said method of claim 2023, wherein said defining a contingency comprises basing said contingency on an event related to said financial instrument.

2029. The financial instrument derived in accordance with said method of claim 2023, wherein said defining a contingency comprises basing said contingency on an instrument other than said financial instrument.

2030. The financial instrument derived in accordance with said method of claim 2023, wherein said attributing a number of said underlying references to said financial instrument comprises attributing a variable number of said underlying references to each unit of said financial instrument.

2031. The financial instrument derived in accordance with said method of claim 2023, wherein said attributing a number of said underlying references to said financial instrument comprises attributing a constant number of said underlying references to each unit of said financial instrument.

2032. The financial instrument derived in accordance with said method of claim 2023, wherein said identifying an underlying reference comprises identifying said underlying reference that said financial instrument converts into.

2033. The financial instrument derived in accordance with said method of claim 2023, wherein said identifying an underlying reference comprises basing an exchange value of said financial instrument on said underlying reference.

2034. The financial instrument derived in accordance with said method of claim 2023, wherein said predetermined period of delay comprises a period of delay greater than a contingency monitoring period.

2035. A financial instrument derived in accordance with a method, said method comprising:
identifying an underlying reference for said financial instrument, said underlying reference having a value;
attributing a number of said underlying references to said financial instrument;
defining a contingency having at least one trigger, a payment becoming due when said trigger drops below a predetermined value.

2036. The financial instrument derived in accordance with said method of claim 2035, said method further comprising:
establishing a value for said financial instrument.

2037. The financial instrument derived in accordance with said method of claim 2036, said method further comprising:
selling said financial instrument.

2038. The financial instrument derived in accordance with said method of claim 2037, wherein said selling said financial instrument comprises selling said financial instrument at a value based on at least one of:
a. said contingency;
b. said value of said underlying reference;
c. value of said payment;
d. said predetermined value;
e. volatility in trading value of said underlying reference;
f. time until redemption, at option of issuer or holder;
g. time until maturity;
h. an interest rate; and
i. value for which said financial instrument must be redeemed on redemption date.

2039. The financial instrument derived in accordance with said method of claim 2037, wherein said selling said financial instrument comprises auctioning said financial instrument.

2040. The financial instrument derived in accordance with said method of claim 2037, wherein said selling said financial instrument comprises selling a derivative of said financial instrument.

2041. The financial instrument derived in accordance with said method of claim 2037, wherein said selling said financial instrument comprises selling a part of said financial instrument.

2042. The financial instrument derived in accordance with said method of claim 2037, said method further comprising:
monitoring for satisfaction of said contingency.

2043. The financial instrument derived in accordance with said method of claim 2037, said method further comprising:
disbursing said payment.

2044. The financial instrument derived in accordance with said method of claim 2037, said method further comprising:
calculating said payment.

2045. The financial instrument derived in accordance with said method of claim 2036, said method further comprising:
monitoring for satisfaction of said contingency.

2046. The financial instrument derived in accordance with said method of claim 2045, said method further comprising:
disbursing said payment.

2047. The financial instrument derived in accordance with said method of claim 2045, said method further comprising:
calculating said payment.

2048. The financial instrument derived in accordance with said method of claim 2036, said method further comprising:
disbursing said payment.

2049. The financial instrument derived in accordance with said method of claim 2036, said method further comprising:
calculating said payment.

2050. The financial instrument derived in accordance with said method of claim 2036, wherein said establishing a value for said financial instrument comprises basing said value for said financial instrument on at least one of:
a. said contingency;
b. said value of said underlying reference;
c. value of said payment;
d. said predetermined value;
e. volatility in trading value of said underlying reference;
f. time until redemption, at option of issuer or holder;
g. time until maturity;
h. an interest rate; and
i. value for which said financial instrument must be redeemed on redemption date.

2051. The financial instrument derived in accordance with said method of claim 2035 further comprising:
selling said financial instrument.

2052. The financial instrument derived in accordance with said method of claim 2051, wherein said selling said financial instrument comprises selling said financial instrument at a value based on at least one of:
a. said contingency;
b. said value of said underlying reference;
c. value of said payment;
d. said predetermined value;
e. volatility in trading value of said underlying reference;
f. time until redemption, at option of issuer or holder;
g. time until maturity;
h. an interest rate; and
i. value for which said financial instrument must be redeemed on redemption date.

2053. The financial instrument derived in accordance with said method of claim 2051, wherein said selling said financial instrument comprises auctioning said financial instrument.

2054. The financial instrument derived in accordance with said method of claim 2051, wherein said selling said financial instrument comprises selling a derivative of said financial instrument.

2055. The financial instrument derived in accordance with said method of claim 2051, wherein said selling said financial instrument comprises selling a part of said financial instrument.

2056. The financial instrument derived in accordance with said method of claim 2051 further comprising:
monitoring for satisfaction of said contingency.

2057. The financial instrument derived in accordance with said method of claim 2051, said method further comprising:
disbursing said payment.

2058. The financial instrument derived in accordance with said method of claim 2051, said method further comprising:
calculating said payment.

2059. The financial instrument derived in accordance with said method of claim 2035 further comprising:
monitoring for satisfaction of said contingency.

2060. The financial instrument derived in accordance with said method of claim 2059, wherein said monitoring for satisfaction comprises comparing market data to said trigger of said contingency.

2061. The financial instrument derived in accordance with said method of claim 2059, wherein said monitoring comprises monitoring over many said contingency monitoring periods.

2062. The financial instrument derived in accordance with said method of claim 2059, wherein said monitoring comprises monitoring realtime data.

2063. The financial instrument derived in accordance with said method of claim 2059, said method further comprising:
disbursing said payment.

2064. The financial instrument derived in accordance with said method of claim 2059, said method further comprising:
calculating said payment.

2065. The financial instrument derived in accordance with said method of claim 2035, wherein said defining a contingency having at least one trigger comprises basing said trigger on an event related to said financial instrument.

2066. The financial instrument derived in accordance with said method of claim 2035, wherein said defining a contingency having at least on trigger comprises basing said trigger on an instrument other than said financial instrument.

2067. The financial instrument derived in accordance with said method of claim 2035, wherein said defining a contingency having at least one trigger comprises setting said trigger at an amount equal to a multiple of a prevailing market rate for a financial instrument.

2068. The financial instrument derived in accordance with said method of claim 2067, wherein said setting said trigger at an amount equal to a multiple comprises using a multiple equal to 1.

2069. The financial instrument derived in accordance with said method of claim 2067, wherein said setting said trigger at an amount equal to a multiple comprises using a multiple less than 1.

2070. The financial instrument derived in accordance with said method of claim 2067, wherein said setting said trigger at an amount equal to a multiple comprises using a multiple greater than 1.

2071. The financial instrument derived in accordance with said method of claim 2035, wherein said defining a contingency having at least one trigger comprises setting said trigger at an amount equal to a multiple of a formula amount.

2072. The financial instrument derived in accordance with said method of claim 2071, wherein said setting said trigger at an amount equal to a multiple comprises using a multiple equal to 1.

2073. The financial instrument derived in accordance with said method of claim 2071, wherein said setting said trigger at an amount equal to a multiple comprises using a multiple less than 1.

2074. The financial instrument derived in accordance with said method of claim 2071, wherein said setting said trigger at an amount equal to a multiple comprises using a multiple greater than 1.

2075. The financial instrument derived in accordance with said method of claim 2035, wherein said predetermined value comprises a predetermined percentage of the conversion value.

2076. The financial instrument derived in accordance with said method of claim 2035, said method further comprising:
disbursing said payment.

2077. The financial instrument derived in accordance with said method of claim 2076, wherein said disbursing said payment comprises sending a negotiable instrument.

2078. The financial instrument derived in accordance with said method of claim 2035, said method further comprising:
calculating said payment.

2079. The financial instrument derived in accordance with said method of claim 2078, wherein said calculating said payment comprises establishing a formula for calculating said payment based on said value of said underlying reference.

2080. The financial instrument derived in accordance with said method of claim 2079, wherein said establishing a formula comprises using a fixed rate formula.

2081. The financial instrument derived in accordance with said method of claim 2079, wherein said establishing a formula comprises using a variable rate formula.

2082. The financial instrument derived in accordance with said method of claim 2078, wherein said calculating said payment comprises calculating said payment using a periodic schedule.

2083. The financial instrument derived in accordance with said method of claim 2082, wherein said calculating said payment using a periodic schedule comprises calculating said payment at least once per said contingency monitoring period.

2084. The financial instrument derived in accordance with said method of claim 2082, wherein said calculating said payment using a periodic schedule comprises calculating said payment on a quarterly basis.

2085. The financial instrument derived in accordance with said method of claim 2078, wherein said calculating said payment comprises calculating said payment based upon at least one of:
a. predetermined fixed amount,
b. trading value of said financial instrument,
c. trading yield of said financial instrument,
d. trading yield of a liability of said issuer of said financial instrument,
e. trading value of a liability of said issuer of said financial instrument,
f. trading value of a class of capital stock issued by an issuer other than said issuer of said financial instrument,
g. trading dividend yield of a class of capital stock issued by an issuer other than said issuer of said financial instrument,
h. trading value of a class of capital stock of said issuer of said financial instrument,
i. trading yield of a class of capital stock of said issuer of said financial instrument,
j. trading value of a security,
k. trading yield of a security, and
l. an index.

2086. The financial instrument derived in accordance with said method of claim 2078, wherein said calculating said payment comprises calculating a payment only after a predetermined period of delay.

2087. The financial instrument derived in accordance with said method of claim 2035, further comprising preparing at least one of:
a. a projected payment schedule;
b. an incidental analysis; and
c. a remoteness analysis.

2088. The financial instrument derived in accordance with said method of claim 2087, wherein said preparing said projected payment schedule comprises determining a schedule of said payments based on payments necessary to produce a comparable yield.

2089. The financial instrument derived in accordance with said method of claim 2087, wherein said preparing said incidental analysis comprises determining the amount of said payment based on assumptions regarding said contingency being satisfied.

2090. The financial instrument derived in accordance with said method of claim 2089, wherein said determining the amount of said payment based on assumptions regarding the contingency being satisfied comprises determining the amount of said payment based on at least one of:
a. a stock price growth rate, and
b. discount rates.

2091. The financial instrument derived in accordance with said method of claim 2087, wherein said preparing said remoteness analysis comprises determining the likelihood that said payment will be made given assumptions regarding said contingency being satisfied.

2092. The financial instrument derived in accordance with said method of claim 2091, wherein said determining the likelihood that said payment will be made given assumptions regarding said contingency being satisfied comprises determining the likelihood that said payment will be made given a stock price growth rate and a volatility.

2093. The financial instrument derived in accordance with said method of claim 2035, wherein said attributing a number of said underlying references to said financial instrument comprises attributing a variable number of said underlying references to each unit of said financial instrument.

2094. The financial instrument derived in accordance with said method of claim 2035, wherein said attributing a number of said underlying references to said financial instrument comprises attributing a constant number of said underlying references to each unit of said financial instrument.

2095. The financial instrument derived in accordance with said method of claim 2035, wherein said identifying an underlying reference comprises identifying said underlying reference that said financial instrument converts into.

2096. The financial instrument derived in accordance with said method of claim 2035, wherein said identifying an underlying reference comprises basing an exchange value of said financial instrument on said underlying reference.

2097. A financial instrument derived in accordance with a method, said method comprising buying said financial instrument created by:
identifying an underlying reference for said financial instrument, said underlying reference having a value;
attributing a number of said underlying references to said financial instrument;
defining a contingency having at least one trigger, a payment becoming due when said trigger drops below a predetermined value.

2098. The financial instrument derived in accordance with said method of claim 2097, wherein said buying said financial instrument comprises buying said financial instrument at a value based on at least one of:
a. said contingency;
b. said value of said underlying reference;
c. value of said payment;
d. length of said predetermined period of delay;
e. volatility in trading value of said underlying reference;
f. time until redemption, at option of issuer or holder;
g. time until maturity;
h. an interest rate; and
i. value for which said financial instrument must be redeemed on redemption date.

2099. The financial instrument derived in accordance with said method of claim 2097, wherein said buying said financial instrument comprises bidding for said financial instrument.

2100. The financial instrument derived in accordance with said method of claim 2097, wherein said buying said financial instrument comprises buying a derivative of said financial instrument.

2101. The financial instrument derived in accordance with said method of claim 2097, wherein said buying said financial instrument comprises buying a part of said financial instrument.

2102. The financial instrument derived in accordance with said method of claim 2097, wherein said defining a contingency comprises basing said contingency on an event related to said financial instrument.

2103. The financial instrument derived in accordance with said method of claim 2097, wherein said defining a contingency comprises basing said contingency on an instrument other than said financial instrument.

2104. The financial instrument derived in accordance with said method of claim 2097, wherein said attributing a number of said underlying references to said financial instrument comprises attributing a variable number of said underlying references to each unit of said financial instrument.

2105. The financial instrument derived in accordance with said method of claim 2097, wherein said attributing a number of said underlying references to said financial instrument comprises attributing a constant number of said underlying references to each unit of said financial instrument.

2106. The financial instrument derived in accordance with said method of claim 2097, wherein said identifying an underlying reference comprises identifying said underlying reference that said financial instrument converts into.

2107. The financial instrument derived in accordance with said method of claim 2097, wherein said identifying an underlying reference comprises basing an exchange value of said financial instrument on said underlying reference.

2108. A financial instrument derived in accordance with a method, said method comprising:
identifying an underlying reference for said financial instrument, said underlying reference having a value;
attributing a number of said underlying references to said financial instrument;
defining a contingency having multiple triggers, a payment becoming due when any one of said triggers drops below a predetermined value.

2109. The financial instrument derived in accordance with said method of claim 2108, said method further comprising:
establishing a value for said financial instrument.

2110. The financial instrument derived in accordance with said method of claim 2109, said method further comprising:
selling said financial instrument.

2111. The financial instrument derived in accordance with said method of claim 2110, wherein said selling said financial instrument comprises selling said financial instrument at a value based on at least one of:
a. said contingency;
b. said value of said underlying reference;
c. value of said payment;
d. said predetermined value;
e. volatility in trading value of said underlying reference;
f. time until redemption, at option of issuer or holder;
g. time until maturity;
h. an interest rate; and
i. value for which said financial instrument must be redeemed on redemption date.

2112. The financial instrument derived in accordance with said method of claim 2110, wherein said selling said financial instrument comprises auctioning said financial instrument.

2113. The financial instrument derived in accordance with said method of claim 2110, wherein said selling said financial instrument comprises selling a derivative of said financial instrument.

2114. The financial instrument derived in accordance with said method of claim 2110, wherein said selling said financial instrument comprises selling a part of said financial instrument.

2115. The financial instrument derived in accordance with said method of claim 2110, said method further comprising:
monitoring for satisfaction of said contingency.

2116. The financial instrument derived in accordance with said method of claim 2110, said method further comprising:
disbursing said payment.

2117. The financial instrument derived in accordance with said method of claim 2110, said method further comprising:
calculating said payment.

2118. The financial instrument derived in accordance with said method of claim 2109, said method further comprising:
monitoring for satisfaction of said contingency.

2119. The financial instrument derived in accordance with said method of claim 2118, said method further comprising:
disbursing said payment.

2120. The financial instrument derived in accordance with said method of claim 2118, said method further comprising:
calculating said payment.

2121. The financial instrument derived in accordance with said method of claim 2109, said method further comprising:
disbursing said payment.

2122. The financial instrument derived in accordance with said method of claim 2109, said method further comprising:
calculating said payment.

2123. The financial instrument derived in accordance with said method of claim 2109, wherein said establishing a value for said financial instrument comprises basing said value for said financial instrument on at least one of:
a. said contingency;
b. said value of said underlying reference;
c. value of said payment;
d. said predetermined value;
e. volatility in trading value of said underlying reference;
f. time until redemption, at option of issuer or holder;
g. time until maturity;
h. an interest rate; and
i. value for which said financial instrument must be redeemed on redemption date.

2124. The financial instrument derived in accordance with said method of claim 2108 further comprising:
selling said financial instrument.

2125. The financial instrument derived in accordance with said method of claim 2124, wherein said selling said financial instrument comprises selling said financial instrument at a value based on at least one of:
a. said contingency;
b. said value of said underlying reference;
c. value of said payment;
d. said predetermined value;
e. volatility in trading value of said underlying reference;
f. time until redemption, at option of issuer or holder;
g. time until maturity;
h. an interest rate; and
i. value for which said financial instrument must be redeemed on redemption date.

2126. The financial instrument derived in accordance with said method of claim 2124, wherein said selling said financial instrument comprises auctioning said financial instrument.

2127. The financial instrument derived in accordance with said method of claim 2124, wherein said selling said financial instrument comprises selling a derivative of said financial instrument.

2128. The financial instrument derived in accordance with said method of claim 2124, wherein said selling said financial instrument comprises selling a part of said financial instrument.

2129. The financial instrument derived in accordance with said method of claim 2124 further comprising:
monitoring for satisfaction of said contingency.

2130. The financial instrument derived in accordance with said method of claim 2124, said method further comprising:
disbursing said payment.

2131. The financial instrument derived in accordance with said method of claim 2124, said method further comprising:
calculating said payment.

2132. The financial instrument derived in accordance with said method of claim 2108 further comprising:
monitoring for satisfaction of said contingency.

2133. The financial instrument derived in accordance with said method of claim 2132, wherein said monitoring for satisfaction comprises comparing market data to said trigger of said contingency.

2134. The financial instrument derived in accordance with said method of claim 2132, wherein said monitoring comprises monitoring over many said contingency monitoring periods.

2135. The financial instrument derived in accordance with said method of claim 2132, wherein said monitoring comprises monitoring realtime data.

2136. The financial instrument derived in accordance with said method of claim 2132, said method further comprising:
disbursing said payment.

2137. The financial instrument derived in accordance with said method of claim 2132, said method further comprising:
calculating said payment.

2138. The financial instrument derived in accordance with said method of claim 2108, wherein said defining a contingency having multiple triggers comprises basing said triggers on events related to said financial instrument.

2139. The financial instrument derived in accordance with said method of claim 2108, wherein said defining a contingency having multiple triggers comprises basing said triggers on instruments other than said financial instrument.

2140. The financial instrument derived in accordance with said method of claim 2108, wherein said defining a contingency having multiple triggers comprises setting said triggers at amounts equal to a multiple of prevailing market rates for financial instruments.

2141. The financial instrument derived in accordance with said method of claim 2140, wherein said setting said triggers at amounts equal to a multiple comprises using a multiple equal to 1.

2142. The financial instrument derived in accordance with said method of claim 2140, wherein said setting said triggers at amounts equal to a multiple comprises using a multiple less than 1.

2143. The financial instrument derived in accordance with said method of claim 2140, wherein said setting said triggers at amounts equal to a multiple comprises using a multiple greater than 1.

2144. The financial instrument derived in accordance with said method of claim 2108, wherein said defining a contingency having multiple triggers comprises setting said triggers at amounts equal to a multiple of formulae amounts.

2145. The financial instrument derived in accordance with said method of claim 2144, wherein said setting said triggers at amounts equal to a multiple comprises using a multiple equal to 1.

2146. The financial instrument derived in accordance with said method of claim 2144, wherein said setting said triggers at amounts equal to a multiple comprises using a multiple less than 1.

2147. The financial instrument derived in accordance with said method of claim 2144, wherein said setting said triggers at amounts equal to a multiple comprises using a multiple greater than 1.

2148. The financial instrument derived in accordance with said method of claim 2108, wherein said predetermined value comprises a predetermined percentage of the conversion value.

2149. The financial instrument derived in accordance with said method of claim 2108, said method further comprising:
disbursing said payment.

2150. The financial instrument derived in accordance with said method of claim 2149, wherein said disbursing said payment comprises sending a negotiable instrument.

2151. The financial instrument derived in accordance with said method of claim 2108, said method further comprising:
calculating said payment.

2152. The financial instrument derived in accordance with said method of claim 2151, wherein said calculating said payment comprises establishing a formula for calculating said payment based on said value of said underlying reference.

2153. The financial instrument derived in accordance with said method of claim 2152, wherein said establishing a formula comprises using a fixed rate formula.

2154. The financial instrument derived in accordance with said method of claim 2152, wherein said establishing a formula comprises using a variable rate formula.

2155. The financial instrument derived in accordance with said method of claim 2151, wherein said calculating said payment comprises calculating said payment using a periodic schedule.

2156. The financial instrument derived in accordance with said method of claim 2155, wherein said calculating said payment using a periodic schedule comprises calculating said payment at least once per said contingency monitoring period.

2157. The financial instrument derived in accordance with said method of claim 2155, wherein said calculating said payment using a periodic schedule comprises calculating said payment on a quarterly basis.

2158. The financial instrument derived in accordance with said method of claim 2151, wherein said calculating said payment comprises calculating said payment based upon at least one of:
a. predetermined fixed amount,
b. trading value of said financial instrument,
c. trading yield of said financial instrument,
d. trading yield of a liability of said issuer of said financial instrument,
e. trading value of a liability of said issuer of said financial instrument,
f. trading value of a class of capital stock issued by an issuer other than said issuer of said financial instrument,
g. trading dividend yield of a class of capital stock issued by an issuer other than said issuer of said financial instrument,
h. trading value of a class of capital stock of said issuer of said financial instrument,
i. trading yield of a class of capital stock of said issuer of said financial instrument,
j. trading value of a security,
k. trading yield of a security, and
l. an index.

2159. The financial instrument derived in accordance with said method of claim 2151, wherein said calculating said payment comprises calculating a payment only after a predetermined period of delay.

2160. The financial instrument derived in accordance with said method of claim 2108, further comprising preparing at least one of:
a. a projected payment schedule;
b. an incidental analysis; and
c. a remoteness analysis.

2161. The financial instrument derived in accordance with said method of claim 2160, wherein said preparing said projected payment schedule comprises determining a schedule of said payments based on payments necessary to produce a comparable yield.

2162. The financial instrument derived in accordance with said method of claim 2160, wherein said preparing said incidental analysis comprises determining the amount of said payment based on assumptions regarding said contingency being satisfied.

2163. The financial instrument derived in accordance with said method of claim 2162, wherein said determining the amount of said payment based on assumptions regarding the contingency being satisfied comprises determining the amount of said payment based on at least one of:
a. a stock price growth rate, and
b. discount rates.

2164. The financial instrument derived in accordance with said method of claim 2160, wherein said preparing said remoteness analysis comprises determining the likelihood that said payment will be made given assumptions regarding said contingency being satisfied.

2165. The financial instrument derived in accordance with said method of claim 2164, wherein said determining the likelihood that said payment will be made given assumptions regarding said contingency being satisfied comprises determining the likelihood that said payment will be made given a stock price growth rate and a volatility.

2166. The financial instrument derived in accordance with said method of claim 2108, wherein said attributing a number of said underlying references to said financial instrument comprises attributing a variable number of said underlying references to each unit of said financial instrument.

2167. The financial instrument derived in accordance with said method of claim 2108, wherein said attributing a number of said underlying references to said financial instrument comprises attributing a constant number of said underlying references to each unit of said financial instrument.

2168. The financial instrument derived in accordance with said method of claim 2108, wherein said identifying an underlying reference comprises identifying said underlying reference that said financial instrument converts into.

2169. The financial instrument derived in accordance with said method of claim 2108, wherein said identifying an underlying reference comprises basing an exchange value of said financial instrument on said underlying reference.

2170. A financial instrument derived in accordance with a method, said method comprising buying said financial instrument created by:
identifying an underlying reference for said financial instrument, said underlying reference having a value;
attributing a number of said underlying references to said financial instrument;
defining a contingency having multiple triggers, a payment becoming due when any one of said triggers drops below a predetermined value.

2171. The financial instrument derived in accordance with said method of claim 2170, wherein said buying said financial instrument comprises buying said financial instrument at a value based on at least one of:
a. said contingency;
b. said value of said underlying reference;
c. value of said payment;
d. length of said predetermined period of delay;
e. volatility in trading value of said underlying reference;
f. time until redemption, at option of issuer or holder;
g. time until maturity;
h. an interest rate; and
i. value for which said financial instrument must be redeemed on redemption date.

2172. The financial instrument derived in accordance with said method of claim 2170, wherein said buying said financial instrument comprises bidding for said financial instrument.

2173. The financial instrument derived in accordance with said method of claim 2170, wherein said buying said financial instrument comprises buying a derivative of said financial instrument.

2174. The financial instrument derived in accordance with said method of claim 2170, wherein said buying said financial instrument comprises buying a part of said financial instrument.

2175. The financial instrument derived in accordance with said method of claim 2170, wherein said defining a contingency comprises basing said contingency on an event related to said financial instrument.

2176. The financial instrument derived in accordance with said method of claim 2170, wherein said defining a contingency comprises basing said contingency on an instrument other than said financial instrument.

2177. The financial instrument derived in accordance with said method of claim 2170, wherein said attributing a number of said underlying references to said financial instrument comprises attributing a variable number of said underlying references to each unit of said financial instrument.

2178. The financial instrument derived in accordance with said method of claim 2170, wherein said attributing a number of said underlying references to said financial instrument comprises attributing a constant number of said underlying references to each unit of said financial instrument.

2179. The financial instrument derived in accordance with said method of claim 2170, wherein said identifying an underlying reference comprises identifying said underlying reference that said financial instrument converts into.

2180. The financial instrument derived in accordance with said method of claim 2170, wherein said identifying an underlying reference comprises basing an exchange value of said financial instrument on said underlying reference.

2181. A financial instrument derived in accordance with a method, said method comprising:
identifying an underlying reference for said financial instrument, said underlying reference having a value;
attributing a number of said underlying references to said financial instrument;
defining a contingency having multiple triggers, a payment becoming due when multiple triggers drop below respective predetermined values.

2182. The financial instrument derived in accordance with said method of claim 2181, said method further comprising:
establishing a value for said financial instrument.

2183. The financial instrument derived in accordance with said method of claim 2182, said method further comprising:
selling said financial instrument.

2184. The financial instrument derived in accordance with said method of claim 2183, wherein said selling said financial instrument comprises selling said financial instrument at a value based on at least one of:
a. said contingency;
b. said value of said underlying reference;
c. value of said payment;
d. said predetermined values;
e. volatility in trading value of said underlying reference;
f. time until redemption, at option of issuer or holder;
g. time until maturity;
h. an interest rate; and
i. value for which said financial instrument must be redeemed on redemption date.

2185. The financial instrument derived in accordance with said method of claim 2183, wherein said selling said financial instrument comprises auctioning said financial instrument.

2186. The financial instrument derived in accordance with said method of claim 2183, wherein said selling said financial instrument comprises selling a derivative of said financial instrument.

2187. The financial instrument derived in accordance with said method of claim 2183, wherein said selling said financial instrument comprises selling a part of said financial instrument.

2188. The financial instrument derived in accordance with said method of claim 2183, said method further comprising:
monitoring for satisfaction of said contingency.

2189. The financial instrument derived in accordance with said method of claim 2183, said method further comprising:
disbursing said payment.

2190. The financial instrument derived in accordance with said method of claim 2183, said method further comprising:
calculating said payment.

2191. The financial instrument derived in accordance with said method of claim 2182, said method further comprising:
monitoring for satisfaction of said contingency.

2192. The financial instrument derived in accordance with said method of claim 2191, said method further comprising:
disbursing said payment.

2193. The financial instrument derived in accordance with said method of claim 2191, said method further comprising:
calculating said payment.

2194. The financial instrument derived in accordance with said method of claim 2182, said method further comprising:
disbursing said payment.

2195. The financial instrument derived in accordance with said method of claim 2182, said method further comprising:
calculating said payment.

2196. The financial instrument derived in accordance with said method of claim 2182, wherein said establishing a value for said financial instrument comprises basing said value for said financial instrument on at least one of:
a. said contingency;
b. said value of said underlying reference;
c. value of said payment;
d. said predetermined values;
e. volatility in trading value of said underlying reference;
f. time until redemption, at option of issuer or holder;
g. time until maturity;
h. an interest rate; and
i. value for which said financial instrument must be redeemed on redemption date.

2197. The financial instrument derived in accordance with said method of claim 2181 further comprising:
selling said financial instrument.

2198. The financial instrument derived in accordance with said method of claim 2197, wherein said selling said financial instrument comprises selling said financial instrument at a value based on at least one of:
a. said contingency;
b. said value of said underlying reference;
c. value of said payment;
d. said predetermined values;
e. volatility in trading value of said underlying reference;
f. time until redemption, at option of issuer or holder;
g. time until maturity;
h. an interest rate; and
i. value for which said financial instrument must be redeemed on redemption date.

2199. The financial instrument derived in accordance with said method of claim 2197, wherein said selling said financial instrument comprises auctioning said financial instrument.

2200. The financial instrument derived in accordance with said method of claim 2197, wherein said selling said financial instrument comprises selling a derivative of said financial instrument.

2201. The financial instrument derived in accordance with said method of claim 2197, wherein said selling said financial instrument comprises selling a part of said financial instrument.

2202. The financial instrument derived in accordance with said method of claim 2197 further comprising:
monitoring for satisfaction of said contingency.

2203. The financial instrument derived in accordance with said method of claim 2197, said method further comprising:
disbursing said payment.

2204. The financial instrument derived in accordance with said method of claim 2197, said method further comprising:
calculating said payment.

2205. The financial instrument derived in accordance with said method of claim 2181 further comprising:
monitoring for satisfaction of said contingency.

2206. The financial instrument derived in accordance with said method of claim 2205, wherein said monitoring for satisfaction comprises comparing market data to said trigger of said contingency.

2207. The financial instrument derived in accordance with said method of claim 2205, wherein said monitoring comprises monitoring over many said contingency monitoring periods.

2208. The financial instrument derived in accordance with said method of claim 2205, wherein said monitoring comprises monitoring realtime data.

2209. The financial instrument derived in accordance with said method of claim 2205, said method further comprising:
disbursing said payment.

2210. The financial instrument derived in accordance with said method of claim 2205, said method further comprising:
calculating said payment.

2211. The financial instrument derived in accordance with said method of claim 2181, wherein said defining a contingency having multiple triggers comprises basing said triggers on events related to said financial instrument.

2212. The financial instrument derived in accordance with said method of claim 2181, wherein said defining a contingency having multiple triggers comprises basing said triggers on instruments other than said financial instrument.

2213. The financial instrument derived in accordance with said method of claim 2181, wherein said defining a contingency having multiple triggers comprises setting said triggers at amounts equal to a multiple of prevailing market rates for financial instruments.

2214. The financial instrument derived in accordance with said method of claim 2213, wherein said setting said triggers at amounts equal to a multiple comprises using a multiple equal to 1.

2215. The financial instrument derived in accordance with said method of claim 2213, wherein said setting said triggers at amounts equal to a multiple comprises using a multiple less than 1.

2216. The financial instrument derived in accordance with said method of claim 2213, wherein said setting said triggers at amounts equal to a multiple comprises using a multiple greater than 1.

2217. The financial instrument derived in accordance with said method of claim 2181, wherein said defining a contingency having multiple triggers comprises setting said triggers at amounts equal to a multiple of formulae amounts.

2218. The financial instrument derived in accordance with said method of claim 2217, wherein said setting said triggers at amounts equal to a multiple comprises using a multiple equal to 1.

2219. The financial instrument derived in accordance with said method of claim 2217, wherein said setting said triggers at amounts equal to a multiple comprises using a multiple less than 1.

2220. The financial instrument derived in accordance with said method of claim 2217, wherein said setting said triggers at amounts equal to a multiple comprises using a multiple greater than 1.

2221. The financial instrument derived in accordance with said method of claim 2181, wherein said predetermined values comprise predetermined percentages of the conversion value.

2222. The financial instrument derived in accordance with said method of claim 2181, said method further comprising:
disbursing said payment.

2223. The financial instrument derived in accordance with said method of claim 2222, wherein said disbursing said payment comprises sending a negotiable instrument.

2224. The financial instrument derived in accordance with said method of claim 2181, said method further comprising:
calculating said payment.

2225. The financial instrument derived in accordance with said method of claim 2224, wherein said calculating said payment comprises establishing a formula for calculating said payment based on said value of said underlying reference.

2226. The financial instrument derived in accordance with said method of claim 2225, wherein said establishing a formula comprises using a fixed rate formula.

2227. The financial instrument derived in accordance with said method of claim 2225, wherein said establishing a formula comprises using a variable rate formula.

2228. The financial instrument derived in accordance with said method of claim 2224, wherein said calculating said payment comprises calculating said payment using a periodic schedule.

2229. The financial instrument derived in accordance with said method of claim 2228, wherein said calculating said payment using a periodic schedule comprises calculating said payment at least once per said contingency monitoring period.

2230. The financial instrument derived in accordance with said method of claim 2228, wherein said calculating said payment using a periodic schedule comprises calculating said payment on a quarterly basis.

2231. The financial instrument derived in accordance with said method of claim 2224, wherein said calculating said payment comprises calculating said payment based upon at least one of:
a. predetermined fixed amount,
b. trading value of said financial instrument,
c. trading yield of said financial instrument,
d. trading yield of a liability of said issuer of said financial instrument,
e. trading value of a liability of said issuer of said financial instrument,
f. trading value of a class of capital stock issued by an issuer other than said issuer of said financial instrument,
g. trading dividend yield of a class of capital stock issued by an issuer other than said issuer of said financial instrument,
h. trading value of a class of capital stock of said issuer of said financial instrument,
i. trading yield of a class of capital stock of said issuer of said financial instrument,
j. trading value of a security,
k. trading yield of a security, and
l. an index.

2232. The financial instrument derived in accordance with said method of claim 2224, wherein said calculating said payment comprises calculating a payment only after a predetermined period of delay.

2233. The financial instrument derived in accordance with said method of claim 2181, further comprising preparing at least one of:
a. a projected payment schedule;
b. an incidental analysis; and
c. a remoteness analysis.

2234. The financial instrument derived in accordance with said method of claim 2233, wherein said preparing said projected payment schedule comprises determining a schedule of said payments based on payments necessary to produce a comparable yield.

2235. The financial instrument derived in accordance with said method of claim 2233, wherein said preparing said incidental analysis comprises determining the amount of said payment based on assumptions regarding said contingency being satisfied.

2236. The financial instrument derived in accordance with said method of claim 2235, wherein said determining the amount of said payment based on assumptions regarding the contingency being satisfied comprises determining the amount of said payment based on at least one of:
a. a stock price growth rate, and
b. discount rates.

2237. The financial instrument derived in accordance with said method of claim 2233, wherein said preparing said remoteness analysis comprises determining the likelihood that said payment will be made given assumptions regarding said contingency being satisfied.

2238. The financial instrument derived in accordance with said method of claim 2237, wherein said determining the likelihood that said payment will be made given assumptions regarding said contingency being satisfied comprises determining the likelihood that said payment will be made given a stock price growth rate and a volatility.

2239. The financial instrument derived in accordance with said method of claim 2181, wherein said attributing a number of said underlying references to said financial instrument comprises attributing a variable number of said underlying references to each unit of said financial instrument.

2240. The financial instrument derived in accordance with said method of claim 2181, wherein said attributing a number of said underlying references to said financial instrument comprises attributing a constant number of said underlying references to each unit of said financial instrument.

2241. The financial instrument derived in accordance with said method of claim 2181, wherein said identifying an underlying reference comprises identifying said underlying reference that said financial instrument converts into.

2242. The financial instrument derived in accordance with said method of claim 2181, wherein said identifying an underlying reference comprises basing an exchange value of said financial instrument on said underlying reference.

2243. A financial instrument derived in accordance with a method, said method comprising buying said financial instrument created by:
identifying an underlying reference for said financial instrument, said underlying reference having a value;
attributing a number of said underlying references to said financial instrument;
defining a contingency having multiple triggers, a payment becoming due when multiple triggers drop below respective predetermined values.

2244. The financial instrument derived in accordance with said method of claim 2243, wherein said buying said financial instrument comprises buying said financial instrument at a value based on at least one of:
a. said contingency;
b. said value of said underlying reference;
c. value of said payment;
d. length of said predetermined period of delay;
e. volatility in trading value of said underlying reference;
f. time until redemption, at option of issuer or holder;
g. time until maturity;
h. an interest rate; and
i. value for which said financial instrument must be redeemed on redemption date.

2245. The financial instrument derived in accordance with said method of claim 2243, wherein said buying said financial instrument comprises bidding for said financial instrument.

2246. The financial instrument derived in accordance with said method of claim 2243, wherein said buying said financial instrument comprises buying a derivative of said financial instrument.

2247. The financial instrument derived in accordance with said method of claim 2243, wherein said buying said financial instrument comprises buying a part of said financial instrument.

2248. The financial instrument derived in accordance with said method of claim 2243, wherein said defining a contingency comprises basing said contingency on an event related to said financial instrument.

2249. The financial instrument derived in accordance with said method of claim 2243, wherein said defining a contingency comprises basing said contingency on an instrument other than said financial instrument.

2250. The financial instrument derived in accordance with said method of claim 2243, wherein said attributing a number of said underlying references to said financial instrument comprises attributing a variable number of said underlying references to each unit of said financial instrument.

2251. The financial instrument derived in accordance with said method of claim 2243, wherein said attributing a number of said underlying references to said financial instrument comprises attributing a constant number of said underlying references to each unit of said financial instrument.

2252. The financial instrument derived in accordance with said method of claim 2243, wherein said identifying an underlying reference comprises identifying said underlying reference that said financial instrument converts into.

2253. The financial instrument derived in accordance with said method of claim 2243, wherein said identifying an underlying reference comprises basing an exchange value of said financial instrument on said underlying reference.

2254. A financial instrument derived in accordance with a method, said method comprising:
identifying an underlying reference for said financial instrument, said underlying reference having a value;
attributing a number of said underlying references to said financial instrument;
defining multiple contingencies each having at least one trigger, a payment becoming due when any said trigger of any of said contingencies drops below a predetermined value.

2255. The financial instrument derived in accordance with said method of claim 2254, said method further comprising:
establishing a value for said financial instrument.

2256. The financial instrument derived in accordance with said method of claim 2255, said method further comprising:
selling said financial instrument.

2257. The financial instrument derived in accordance with said method of claim 2256, wherein said selling said financial instrument comprises selling said financial instrument at a value based on at least one of:
a. said contingency;
b. said value of said underlying reference;
c. value of said payment;
d. said predetermined value;
e. volatility in trading value of said underlying reference;
f. time until redemption, at option of issuer or holder;
g. time until maturity;
h. an interest rate; and
i. value for which said financial instrument must be redeemed on redemption date.

2258. The financial instrument derived in accordance with said method of claim 2256, wherein said selling said financial instrument comprises auctioning said financial instrument.

2259. The financial instrument derived in accordance with said method of claim 2256, wherein said selling said financial instrument comprises selling a derivative of said financial instrument.

2260. The financial instrument derived in accordance with said method of claim 2256, wherein said selling said financial instrument comprises selling a part of said financial instrument.

2261. The financial instrument derived in accordance with said method of claim 2256, said method further comprising:
monitoring for satisfaction of said contingency.

2262. The financial instrument derived in accordance with said method of claim 2256, said method further comprising:
disbursing said payment.

2263. The financial instrument derived in accordance with said method of claim 2256, said method further comprising:
calculating said payment.

2264. The financial instrument derived in accordance with said method of claim 2255, said method further comprising:
monitoring for satisfaction of said contingency.

2265. The financial instrument derived in accordance with said method of claim 2264, said method further comprising:
disbursing said payment.

2266. The financial instrument derived in accordance with said method of claim 2264, said method further comprising:
calculating said payment.

2267. The financial instrument derived in accordance with said method of claim 2255, said method further comprising:
disbursing said payment.

2268. The financial instrument derived in accordance with said method of claim 2255, said method further comprising:
calculating said payment.

2269. The financial instrument derived in accordance with said method of claim 2255, wherein said establishing a value for said financial instrument comprises basing said value for said financial instrument on at least one of:
a. said contingency;
b. said value of said underlying reference;
c. value of said payment;
d. said predetermined value;
e. volatility in trading value of said underlying reference;
f. time until redemption, at option of issuer or holder;
g. time until maturity;
h. an interest rate; and
i. value for which said financial instrument must be redeemed on redemption date.

2270. The financial instrument derived in accordance with said method of claim 2254 further comprising:
selling said financial instrument.

2271. The financial instrument derived in accordance with said method of claim 2270, wherein said selling said financial instrument comprises selling said financial instrument at a value based on at least one of:
a. said contingency;
b. said value of said underlying reference;
c. value of said payment;
d. said predetermined value;
e. volatility in trading value of said underlying reference;
f. time until redemption, at option of issuer or holder;
g. time until maturity;
h. an interest rate; and
i. value for which said financial instrument must be redeemed on redemption date.

2272. The financial instrument derived in accordance with said method of claim 2270, wherein said selling said financial instrument comprises auctioning said financial instrument.

2273. The financial instrument derived in accordance with said method of claim 2270, wherein said selling said financial instrument comprises selling a derivative of said financial instrument.

2274. The financial instrument derived in accordance with said method of claim 2270, wherein said selling said financial instrument comprises selling a part of said financial instrument.

2275. The financial instrument derived in accordance with said method of claim 2270 further comprising:
monitoring for satisfaction of said contingency.

2276. The financial instrument derived in accordance with said method of claim 2270, said method further comprising:
disbursing said payment.

2277. The financial instrument derived in accordance with said method of claim 2270, said method further comprising:
calculating said payment.

2278. The financial instrument derived in accordance with said method of claim 2254 further comprising:
monitoring for satisfaction of said contingency.

2279. The financial instrument derived in accordance with said method of claim 2278, wherein said monitoring for satisfaction comprises comparing market data to said trigger of said contingency.

2280. The financial instrument derived in accordance with said method of claim 2278, wherein said monitoring comprises monitoring over many said contingency monitoring periods.

2281. The financial instrument derived in accordance with said method of claim 2278, wherein said monitoring comprises monitoring realtime data.

2282. The financial instrument derived in accordance with said method of claim 2278, said method further comprising:
disbursing said payment.

2283. The financial instrument derived in accordance with said method of claim 2278, said method further comprising:
calculating said payment.

2284. The financial instrument derived in accordance with said method of claim 2254, wherein said defining multiple contingencies each having at least one trigger comprises basing said trigger on an event related to said financial instrument.

2285. The financial instrument derived in accordance with said method of claim 2254, wherein said defining multiple contingencies each having at least one trigger comprises basing said trigger on an instrument other than said financial instrument.

2286. The financial instrument derived in accordance with said method of claim 2254, wherein said defining multiple contingencies each having at least one trigger comprises setting said trigger at an amount equal to a multiple of a prevailing market rate for a financial instrument.

2287. The financial instrument derived in accordance with said method of claim 2286, wherein said setting said trigger at an amount equal to a multiple comprises using a multiple equal to 1.

2288. The financial instrument derived in accordance with said method of claim 2286, wherein said setting said trigger at an amount equal to a multiple comprises using a multiple less than 1.

2289. The financial instrument derived in accordance with said method of claim 2286, wherein said setting said trigger at an amount equal to a multiple comprises using a multiple greater than 1.

2290. The financial instrument derived in accordance with said method of claim 2254, wherein said defining multiple contingencies each having at least one trigger comprises setting said trigger at an amount equal to a multiple of a formula amount.

2291. The financial instrument derived in accordance with said method of claim 2290, wherein said setting said trigger at an amount equal to a multiple comprises using a multiple equal to 1.

2292. The financial instrument derived in accordance with said method of claim 2290, wherein said setting said trigger at an amount equal to a multiple comprises using a multiple less than 1.

2293. The financial instrument derived in accordance with said method of claim 2290, wherein said setting said trigger at an amount equal to a multiple comprises using a multiple greater than 1.

2294. The financial instrument derived in accordance with said method of claim 2254, wherein said predetermined value comprises a predetermined percentage of the conversion value.

2295. The financial instrument derived in accordance with said method of claim 2254, said method further comprising:
disbursing said payment.

2296. The financial instrument derived in accordance with said method of claim 2295, wherein said disbursing said payment comprises sending a negotiable instrument.

2297. The financial instrument derived in accordance with said method of claim 2254, said method further comprising:
calculating said payment.

2298. The financial instrument derived in accordance with said method of claim 2297, wherein said calculating said payment comprises establishing a formula for calculating said payment based on said value of said underlying reference.

2299. The financial instrument derived in accordance with said method of claim 2298, wherein said establishing a formula comprises using a fixed rate formula.

2300. The financial instrument derived in accordance with said method of claim 2298, wherein said establishing a formula comprises using a variable rate formula.

2301. The financial instrument derived in accordance with said method of claim 2297, wherein said calculating said payment comprises calculating said payment using a periodic schedule.

2302. The financial instrument derived in accordance with said method of claim 2301, wherein said calculating said payment using a periodic schedule comprises calculating said payment at least once per said contingency monitoring period.

2303. The financial instrument derived in accordance with said method of claim 2301, wherein said calculating said payment using a periodic schedule comprises calculating said payment on a quarterly basis.

2304. The financial instrument derived in accordance with said method of claim 2297, wherein said calculating said payment comprises calculating said payment based upon at least one of:
a. predetermined fixed amount,
b. trading value of said financial instrument,
c. trading yield of said financial instrument,
d. trading yield of a liability of said issuer of said financial instrument,
e. trading value of a liability of said issuer of said financial instrument,
f. trading value of a class of capital stock issued by an issuer other than said issuer of said financial instrument,
g. trading dividend yield of a class of capital stock issued by an issuer other than said issuer of said financial instrument,
h. trading value of a class of capital stock of said issuer of said financial instrument,
i. trading yield of a class of capital stock of said issuer of said financial instrument,
j. trading value of a security,
k. trading yield of a security, and
l. an index.

2305. The financial instrument derived in accordance with said method of claim 2297, wherein said calculating said payment comprises calculating a payment only after a predetermined period of delay.

2306. The financial instrument derived in accordance with said method of claim 2254, further comprising preparing at least one of:
a. a projected payment schedule;
b. an incidental analysis; and
c. a remoteness analysis.

2307. The financial instrument derived in accordance with said method of claim 2306, wherein said preparing said projected payment schedule comprises determining a schedule of said payments based on payments necessary to produce a comparable yield.

2308. The financial instrument derived in accordance with said method of claim 2306, wherein said preparing said incidental analysis comprises determining the amount of said payment based on assumptions regarding said contingency being satisfied.

2309. The financial instrument derived in accordance with said method of claim 2308, wherein said determining the amount of said payment based on assumptions regarding the contingency being satisfied comprises determining the amount of said payment based on at least one of:
a. a stock price growth rate, and
b. discount rates.

2310. The financial instrument derived in accordance with said method of claim 2306, wherein said preparing said remoteness analysis comprises determining the likelihood that said payment will be made given assumptions regarding said contingency being satisfied.

2311. The financial instrument derived in accordance with said method of claim 2310, wherein said determining the likelihood that said payment will be made given assumptions regarding said contingency being satisfied comprises determining the likelihood that said payment will be made given a stock price growth rate and a volatility.

2312. The financial instrument derived in accordance with said method of claim 2254, wherein said attributing a number of said underlying references to said financial instrument comprises attributing a variable number of said underlying references to each unit of said financial instrument.

2313. The financial instrument derived in accordance with said method of claim 2254, wherein said attributing a number of said underlying references to said financial instrument comprises attributing a constant number of said underlying references to each unit of said financial instrument.

2314. The financial instrument derived in accordance with said method of claim 2254, wherein said identifying an underlying reference comprises identifying said underlying reference that said financial instrument converts into.

2315. The financial instrument derived in accordance with said method of claim 2254, wherein said identifying an underlying reference comprises basing an exchange value of said financial instrument on said underlying reference.

2316. A financial instrument derived in accordance with a method, said method comprising buying said financial instrument created by:
identifying an underlying reference for said financial instrument, said underlying reference having a value;
attributing a number of said underlying references to said financial instrument;
defining multiple contingencies each having at least one trigger, a payment becoming due when any said trigger of any of said contingencies drops below a predetermined value.

2317. The financial instrument derived in accordance with said method of claim 2316, wherein said buying said financial instrument comprises buying said financial instrument at a value based on at least one of:
a. said contingency;
b. said value of said underlying reference;
c. value of said payment;
d. length of said predetermined period of delay;
e. volatility in trading value of said underlying reference;
f. time until redemption, at option of issuer or holder;
g. time until maturity;
h. an interest rate; and
i. value for which said financial instrument must be redeemed on redemption date.

2318. The financial instrument derived in accordance with said method of claim 2316, wherein said buying said financial instrument comprises bidding for said financial instrument.

2319. The financial instrument derived in accordance with said method of claim 2316, wherein said buying said financial instrument comprises buying a derivative of said financial instrument.

2320. The financial instrument derived in accordance with said method of claim 2316, wherein said buying said financial instrument comprises buying a part of said financial instrument.

2321. The financial instrument derived in accordance with said method of claim 2316, wherein said defining multiple contingencies comprises basing said multiple contingencies on events related to said financial instrument.

2322. The financial instrument derived in accordance with said method of claim 2316, wherein said defining multiple contingencies comprises basing said multiple contingencies on instruments other than said financial instrument.

2323. The financial instrument derived in accordance with said method of claim 2316, wherein said attributing a number of said underlying references to said financial instrument comprises attributing a variable number of said underlying references to each unit of said financial instrument.

2324. The financial instrument derived in accordance with said method of claim 2316, wherein said attributing a number of said underlying references to said financial instrument comprises attributing a constant number of said underlying references to each unit of said financial instrument.

2325. The financial instrument derived in accordance with said method of claim 2316, wherein said identifying an underlying reference comprises identifying said underlying reference that said financial instrument converts into.

2326. The financial instrument derived in accordance with said method of claim 2316, wherein said identifying an underlying reference comprises basing an exchange value of said financial instrument on said underlying reference.

2327. A financial instrument derived in accordance with a method, said method comprising:
identifying an underlying reference for said financial instrument, said underlying reference having a value;
attributing a number of said underlying references to said financial instrument;
defining multiple contingencies each with multiple triggers, a payment becoming due when one of said multiple triggers of any of said contingencies drops below a predetermined value.

2328. The financial instrument derived in accordance with said method of claim 2327, said method further comprising:
establishing a value for said financial instrument.

2329. The financial instrument derived in accordance with said method of claim 2328, said method further comprising:
selling said financial instrument.

2330. The financial instrument derived in accordance with said method of claim 2329, wherein said selling said financial instrument comprises selling said financial instrument at a value based on at least one of:
a. said contingency;
b. said value of said underlying reference;
c. value of said payment;
d. said predetermined value;
e. volatility in trading value of said underlying reference;
f. time until redemption, at option of issuer or holder;
g. time until maturity;
h. an interest rate; and
i. value for which said financial instrument must be redeemed on redemption date.

2331. The financial instrument derived in accordance with said method of claim 2329, wherein said selling said financial instrument comprises auctioning said financial instrument.

2332. The financial instrument derived in accordance with said method of claim 2329, wherein said selling said financial instrument comprises selling a derivative of said financial instrument.

2333. The financial instrument derived in accordance with said method of claim 2329, wherein said selling said financial instrument comprises selling a part of said financial instrument.

2334. The financial instrument derived in accordance with said method of claim 2329, said method further comprising:
monitoring for satisfaction of said contingency.

2335. The financial instrument derived in accordance with said method of claim 2329, said method further comprising:
disbursing said payment.

2336. The financial instrument derived in accordance with said method of claim 2329, said method further comprising:
calculating said payment.

2337. The financial instrument derived in accordance with said method of claim 2328, said method further comprising:
monitoring for satisfaction of said contingency.

2338. The financial instrument derived in accordance with said method of claim 2337, said method further comprising:
disbursing said payment.

2339. The financial instrument derived in accordance with said method of claim 2337, said method further comprising:
calculating said payment.

2340. The financial instrument derived in accordance with said method of claim 2328, said method further comprising:
disbursing said payment.

2341. The financial instrument derived in accordance with said method of claim 2328, said method further comprising:
calculating said payment.

2342. The financial instrument derived in accordance with said method of claim 2328, wherein said establishing a value for said financial instrument comprises basing said value for said financial instrument on at least one of:
a. said contingency;
b. said value of said underlying reference;
c. value of said payment;
d. said predetermined value;
e. volatility in trading value of said underlying reference;
f. time until redemption, at option of issuer or holder;
g. time until maturity;
h. an interest rate; and
i. value for which said financial instrument must be redeemed on redemption date.

2343. The financial instrument derived in accordance with said method of claim 2327 further comprising:
selling said financial instrument.

2344. The financial instrument derived in accordance with said method of claim 2343, wherein said selling said financial instrument comprises selling said financial instrument at a value based on at least one of:
a. said contingency;
b. said value of said underlying reference;
c. value of said payment;
d. said predetermined value;
e. volatility in trading value of said underlying reference;
f. time until redemption, at option of issuer or holder;
g. time until maturity;
h. an interest rate; and
i. value for which said financial instrument must be redeemed on redemption date.

2345. The financial instrument derived in accordance with said method of claim 2343, wherein said selling said financial instrument comprises auctioning said financial instrument.

2346. The financial instrument derived in accordance with said method of claim 2343, wherein said selling said financial instrument comprises selling a derivative of said financial instrument.

2347. The financial instrument derived in accordance with said method of claim 2343, wherein said selling said financial instrument comprises selling a part of said financial instrument.

2348. The financial instrument derived in accordance with said method of claim 2343 further comprising:
monitoring for satisfaction of said contingency.

2349. The financial instrument derived in accordance with said method of claim 2343, said method further comprising:
disbursing said payment.

2350. The financial instrument derived in accordance with said method of claim 2343, said method further comprising:
calculating said payment.

2351. The financial instrument derived in accordance with said method of claim 2327 further comprising:
monitoring for satisfaction of said contingency.

2352. The financial instrument derived in accordance with said method of claim 2351, wherein said monitoring for satisfaction comprises comparing market data to said trigger of said contingency.

2353. The financial instrument derived in accordance with said method of claim 2351, wherein said monitoring comprises monitoring over many said contingency monitoring periods.

2354. The financial instrument derived in accordance with said method of claim 2351, wherein said monitoring comprises monitoring realtime data.

2355. The financial instrument derived in accordance with said method of claim 2351, said method further comprising:
disbursing said payment.

2356. The financial instrument derived in accordance with said method of claim 2351, said method further comprising:
calculating said payment.

2357. The financial instrument derived in accordance with said method of claim 2327, wherein said defining multiple contingencies each with multiple triggers comprises basing said triggers on events related to said financial instrument.

2358. The financial instrument derived in accordance with said method of claim 2327, wherein said defining multiple contingencies each with multiple triggers comprises basing said triggers on instruments other than said financial instrument.

2359. The financial instrument derived in accordance with said method of claim 2327, wherein said defining multiple contingencies each with multiple triggers comprises setting said triggers at amounts equal to a multiple of prevailing market rates for financial instruments.

2360. The financial instrument derived in accordance with said method of claim 2359, wherein said setting said triggers at amounts equal to a multiple comprises using a multiple equal to 1.

2361. The financial instrument derived in accordance with said method of claim 2359, wherein said setting said triggers at amounts equal to a multiple comprises using a multiple less than 1.

2362. The financial instrument derived in accordance with said method of claim 2359, wherein said setting said triggers at amounts equal to a multiple comprises using a multiple greater than 1.

2363. The financial instrument derived in accordance with said method of claim 2327, wherein said defining multiple contingencies each with multiple triggers comprises setting said triggers at amounts equal to a multiple of formulae amounts.

2364. The financial instrument derived in accordance with said method of claim 2363, wherein said setting said triggers at amounts equal to a multiple comprises using a multiple equal to 1.

2365. The financial instrument derived in accordance with said method of claim 2363, wherein said setting said triggers at amounts equal to a multiple comprises using a multiple less than 1.

2366. The financial instrument derived in accordance with said method of claim 2363, wherein said setting said triggers at amounts equal to a multiple comprises using a multiple greater than 1.

2367. The financial instrument derived in accordance with said method of claim 2327, wherein said predetermined value comprises a predetermined percentage of the conversion value.

2368. The financial instrument derived in accordance with said method of claim 2327, said method further comprising:
disbursing said payment.

2369. The financial instrument derived in accordance with said method of claim 2368, wherein said disbursing said payment comprises sending a negotiable instrument.

2370. The financial instrument derived in accordance with said method of claim 2327, said method further comprising:
calculating said payment.

2371. The financial instrument derived in accordance with said method of claim 2370, wherein said calculating said payment comprises establishing a formula for calculating said payment based on said value of said underlying reference.

2372. The financial instrument derived in accordance with said method of claim 2371, wherein said establishing a formula comprises using a fixed rate formula.

2373. The financial instrument derived in accordance with said method of claim 2371, wherein said establishing a formula comprises using a variable rate formula.

2374. The financial instrument derived in accordance with said method of claim 2370, wherein said calculating said payment comprises calculating said payment using a periodic schedule.

2375. The financial instrument derived in accordance with said method of claim 2374, wherein said calculating said payment using a periodic schedule comprises calculating said payment at least once per said contingency monitoring period.

2376. The financial instrument derived in accordance with said method of claim 2374, wherein said calculating said payment using a periodic schedule comprises calculating said payment on a quarterly basis.

2377. The financial instrument derived in accordance with said method of claim 2370, wherein said calculating said payment comprises calculating said payment based upon at least one of:
a. predetermined fixed amount,
b. trading value of said financial instrument,
c. trading yield of said financial instrument,
d. trading yield of a liability of said issuer of said financial instrument,
e. trading value of a liability of said issuer of said financial instrument,
f. trading value of a class of capital stock issued by an issuer other than said issuer of said financial instrument,
g. trading dividend yield of a class of capital stock issued by an issuer other than said issuer of said financial instrument,
h. trading value of a class of capital stock of said issuer of said financial instrument,
i. trading yield of a class of capital stock of said issuer of said financial instrument,
j. trading value of a security,
k. trading yield of a security, and
l. an index.

2378. The financial instrument derived in accordance with said method of claim 2370, wherein said calculating said payment comprises calculating a payment only after a predetermined period of delay.

2379. The financial instrument derived in accordance with said method of claim 2327, further comprising preparing at least one of:
a. a projected payment schedule;
b. an incidental analysis; and
c. a remoteness analysis.

2380. The financial instrument derived in accordance with said method of claim 2379, wherein said preparing said projected payment schedule comprises determining a schedule of said payments based on payments necessary to produce a comparable yield.

2381. The financial instrument derived in accordance with said method of claim 2379, wherein said preparing said incidental analysis comprises determining the amount of said payment based on assumptions regarding said contingency being satisfied.

2382. The financial instrument derived in accordance with said method of claim 2381, wherein said determining the amount of said payment based on assumptions regarding the contingency being satisfied comprises determining the amount of said payment based on at least one of:
a. a stock price growth rate, and
b. discount rates.

2383. The financial instrument derived in accordance with said method of claim 2379, wherein said preparing said remoteness analysis comprises determining the likelihood that said payment will be made given assumptions regarding said contingency being satisfied.

2384. The financial instrument derived in accordance with said method of claim 2383, wherein said determining the likelihood that said payment will be made given assumptions regarding said contingency being satisfied comprises determining the likelihood that said payment will be made given a stock price growth rate and a volatility.

2385. The financial instrument derived in accordance with said method of claim 2327, wherein said attributing a number of said underlying references to said financial instrument comprises attributing a variable number of said underlying references to each unit of said financial instrument.

2386. The financial instrument derived in accordance with said method of claim 2327, wherein said attributing a number of said underlying references to said financial instrument comprises attributing a constant number of said underlying references to each unit of said financial instrument.

2387. The financial instrument derived in accordance with said method of claim 2327, wherein said identifying an underlying reference comprises identifying said underlying reference that said financial instrument converts into.

2388. The financial instrument derived in accordance with said method of claim 2327, wherein said identifying an underlying reference comprises basing an exchange value of said financial instrument on said underlying reference.

2389. A financial instrument derived in accordance with a method, said method comprising buying said financial instrument created by:
identifying an underlying reference for said financial instrument, said underlying reference having a value;
attributing a number of said underlying references to said financial instrument;
defining multiple contingencies each with multiple triggers, a payment becoming due when one of said multiple triggers of any of said contingencies drops below a predetermined value.

2390. The financial instrument derived in accordance with said method of claim 2389, wherein said buying said financial instrument comprises buying said financial instrument at a value based on at least one of:
a. said contingency;
b. said value of said underlying reference;
c. value of said payment;
d. length of said predetermined period of delay;
e. volatility in trading value of said underlying reference;
f. time until redemption, at option of issuer or holder;
g. time until maturity;
h. an interest rate; and
i. value for which said financial instrument must be redeemed on redemption date.

2391. The financial instrument derived in accordance with said method of claim 2389, wherein said buying said financial instrument comprises bidding for said financial instrument.

2392. The financial instrument derived in accordance with said method of claim 2389, wherein said buying said financial instrument comprises buying a derivative of said financial instrument.

2393. The financial instrument derived in accordance with said method of claim 2389, wherein said buying said financial instrument comprises buying a part of said financial instrument.

2394. The financial instrument derived in accordance with said method of claim 2389, wherein said defining multiple contingencies comprises basing said multiple contingencies on events related to said financial instrument.

2395. The financial instrument derived in accordance with said method of claim 2389, wherein said defining multiple contingencies comprises basing said multiple contingencies on instruments other than said financial instrument.

2396. The financial instrument derived in accordance with said method of claim 2389, wherein said attributing a number of said underlying references to said financial instrument comprises attributing a variable number of said underlying references to each unit of said financial instrument.

2397. The financial instrument derived in accordance with said method of claim 2389, wherein said attributing a number of said underlying references to said financial instrument comprises attributing a constant number of said underlying references to each unit of said financial instrument.

2398. The financial instrument derived in accordance with said method of claim 2389, wherein said identifying an underlying reference comprises identifying said underlying reference that said financial instrument converts into.

2399. The financial instrument derived in accordance with said method of claim 2389, wherein said identifying an underlying reference comprises basing an exchange value of said financial instrument on said underlying reference.

2400. A financial instrument derived in accordance with a method, said method comprising:
identifying an underlying reference for said financial instrument, said underlying reference having a value;
attributing a number of said underlying references to said financial instrument;
defining multiple contingencies having multiple triggers, a payment becoming due when at least two of said multiple triggers drop below respective predetermined values, at least one of said at least two triggers being a trigger of a different contingency from any other of said at least two triggers.

2401. The financial instrument derived in accordance with said method of claim 2400, said method further comprising:
establishing a value for said financial instrument.

2402. The financial instrument derived in accordance with said method of claim 2401, said method further comprising:
selling said financial instrument.

2403. The financial instrument derived in accordance with said method of claim 2402, wherein said selling said financial instrument comprises selling said financial instrument at a value based on at least one of:
a. said contingency;
b. said value of said underlying reference;
c. value of said payment;
d. said predetermined values;
e. volatility in trading value of said underlying reference;
f. time until redemption, at option of issuer or holder;
g. time until maturity;
h. an interest rate; and
i. value for which said financial instrument must be redeemed on redemption date.

2404. The financial instrument derived in accordance with said method of claim 2402, wherein said selling said financial instrument comprises auctioning said financial instrument.

2405. The financial instrument derived in accordance with said method of claim 2402, wherein said selling said financial instrument comprises selling a derivative of said financial instrument.

2406. The financial instrument derived in accordance with said method of claim 2402, wherein said selling said financial instrument comprises selling a part of said financial instrument.

2407. The financial instrument derived in accordance with said method of claim 2402, said method further comprising:
monitoring for satisfaction of said contingency.

2408. The financial instrument derived in accordance with said method of claim 2402, said method further comprising:
disbursing said payment.

2409. The financial instrument derived in accordance with said method of claim 2402, said method further comprising:
calculating said payment.

2410. The financial instrument derived in accordance with said method of claim 2401, said method further comprising:
monitoring for satisfaction of said contingency.

2411. The financial instrument derived in accordance with said method of claim 2410, said method further comprising:
disbursing said payment.

2412. The financial instrument derived in accordance with said method of claim 2410, said method further comprising:
calculating said payment.

2413. The financial instrument derived in accordance with said method of claim 2401, said method further comprising:
disbursing said payment.

2414. The financial instrument derived in accordance with said method of claim 2401, said method further comprising:
calculating said payment.

2415. The financial instrument derived in accordance with said method of claim 2401, wherein said establishing a value for said financial instrument comprises basing said value for said financial instrument on at least one of:
a. said contingency;
b. said value of said underlying reference;
c. value of said payment;
d. said predetermined values;
e. volatility in trading value of said underlying reference;
f. time until redemption, at option of issuer or holder;
g. time until maturity;
h. an interest rate; and
i. value for which said financial instrument must be redeemed on redemption date.

2416. The financial instrument derived in accordance with said method of claim 2400 further comprising:
selling said financial instrument.

2417. The financial instrument derived in accordance with said method of claim 2416, wherein said selling said financial instrument comprises selling said financial instrument at a value based on at least one of:
a. said contingency;
b. said value of said underlying reference;
c. value of said payment;
d. said predetermined values;
e. volatility in trading value of said underlying reference;
f. time until redemption, at option of issuer or holder;
g. time until maturity;
h. an interest rate; and
i. value for which said financial instrument must be redeemed on redemption date.

2418. The financial instrument derived in accordance with said method of claim 2416, wherein said selling said financial instrument comprises auctioning said financial instrument.

2419. The financial instrument derived in accordance with said method of claim 2416, wherein said selling said financial instrument comprises selling a derivative of said financial instrument.

2420. The financial instrument derived in accordance with said method of claim 2416, wherein said selling said financial instrument comprises selling a part of said financial instrument.

2421. The financial instrument derived in accordance with said method of claim 2416 further comprising:
monitoring for satisfaction of said contingency.

2422. The financial instrument derived in accordance with said method of claim 2416, said method further comprising:
disbursing said payment.

2423. The financial instrument derived in accordance with said method of claim 2416, said method further comprising:
calculating said payment.

2424. The financial instrument derived in accordance with said method of claim 2400 further comprising:
monitoring for satisfaction of said contingency.

2425. The financial instrument derived in accordance with said method of claim 2424, wherein said monitoring for satisfaction comprises comparing market data to said trigger of said contingency.

2426. The financial instrument derived in accordance with said method of claim 2424, wherein said monitoring comprises monitoring over many said contingency monitoring periods.

2427. The financial instrument derived in accordance with said method of claim 2424, wherein said monitoring comprises monitoring realtime data.

2428. The financial instrument derived in accordance with said method of claim 2424, said method further comprising:
disbursing said payment.

2429. The financial instrument derived in accordance with said method of claim 2424, said method further comprising:
calculating said payment.

2430. The financial instrument derived in accordance with said method of claim 2400, wherein said defining multiple contingencies having multiple triggers comprises basing said triggers on events related to said financial instrument.

2431. The financial instrument derived in accordance with said method of claim 2400, wherein said defining multiple contingencies having multiple triggers comprises basing said triggers on instruments other than said financial instrument.

2432. The financial instrument derived in accordance with said method of claim 2400, wherein said defining multiple contingencies having multiple triggers comprises setting said triggers at amounts equal to a multiple of prevailing market rates for financial instruments.

2433. The financial instrument derived in accordance with said method of claim 2432, wherein said setting said triggers at amounts equal to a multiple comprises using a multiple equal to 1.

2434. The financial instrument derived in accordance with said method of claim 2432, wherein said setting said triggers at amounts equal to a multiple comprises using a multiple less than 1.

2435. The financial instrument derived in accordance with said method of claim 2432, wherein said setting said triggers at amounts equal to a multiple comprises using a multiple greater than 1.

2436. The financial instrument derived in accordance with said method of claim 2400, wherein said defining multiple contingencies having multiple triggers comprises setting said triggers at amounts equal to a multiple of formulae amounts.

2437. The financial instrument derived in accordance with said method of claim 2436, wherein said setting said triggers at amounts equal to a multiple comprises using a multiple equal to 1.

2438. The financial instrument derived in accordance with said method of claim 2436, wherein said setting said triggers at amounts equal to a multiple comprises using a multiple less than 1.

2439. The financial instrument derived in accordance with said method of claim 2436, wherein said setting said triggers at amounts equal to a multiple comprises using a multiple greater than 1.

2440. The financial instrument derived in accordance with said method of claim 2400, wherein said predetermined values comprise predetermined percentages of the conversion value.

2441. The financial instrument derived in accordance with said method of claim 2400, said method further comprising:
disbursing said payment.

2442. The financial instrument derived in accordance with said method of claim 2441, wherein said disbursing said payment comprises sending a negotiable instrument.

2443. The financial instrument derived in accordance with said method of claim 2400, said method further comprising:
calculating said payment.

2444. The financial instrument derived in accordance with said method of claim 2443, wherein said calculating said payment comprises establishing a formula for calculating said payment based on said value of said underlying reference.

2445. The financial instrument derived in accordance with said method of claim 2444, wherein said establishing a formula comprises using a fixed rate formula.

2446. The financial instrument derived in accordance with said method of claim 2444, wherein said establishing a formula comprises using a variable rate formula.

2447. The financial instrument derived in accordance with said method of claim 2443, wherein said calculating said payment comprises calculating said payment using a periodic schedule.

2448. The financial instrument derived in accordance with said method of claim 2447, wherein said calculating said payment using a periodic schedule comprises calculating said payment at least once per said contingency monitoring period.

2449. The financial instrument derived in accordance with said method of claim 2447, wherein said calculating said payment using a periodic schedule comprises calculating said payment on a quarterly basis.

2450. The financial instrument derived in accordance with said method of claim 2443, wherein said calculating said payment comprises calculating said payment based upon at least one of:
a. predetermined fixed amount,
b. trading value of said financial instrument,
c. trading yield of said financial instrument,
d. trading yield of a liability of said issuer of said financial instrument,
e. trading value of a liability of said issuer of said financial instrument,
f. trading value of a class of capital stock issued by an issuer other than said issuer of said financial instrument,
g. trading dividend yield of a class of capital stock issued by an issuer other than said issuer of said financial instrument,
h. trading value of a class of capital stock of said issuer of said financial instrument,
i. trading yield of a class of capital stock of said issuer of said financial instrument,
j. trading value of a security,
k. trading yield of a security, and
l. an index.

2451. The financial instrument derived in accordance with said method of claim 2443, wherein said calculating said payment comprises calculating a payment only after a predetermined period of delay.

2452. The financial instrument derived in accordance with said method of claim 2400, further comprising preparing at least one of:
a. a projected payment schedule;
b. an incidental analysis; and
c. a remoteness analysis.

2453. The financial instrument derived in accordance with said method of claim 2452, wherein said preparing said projected payment schedule comprises determining a schedule of said payments based on payments necessary to produce a comparable yield.

2454. The financial instrument derived in accordance with said method of claim 2452, wherein said preparing said incidental analysis comprises determining the amount of said payment based on assumptions regarding said contingency being satisfied.

2455. The financial instrument derived in accordance with said method of claim 2454, wherein said determining the amount of said payment based on assumptions regarding the contingency being satisfied comprises determining the amount of said payment based on at least one of:
a. a stock price growth rate, and
b. discount rates.

2456. The financial instrument derived in accordance with said method of claim 2452, wherein said preparing said remoteness analysis comprises determining the likelihood that said payment will be made given assumptions regarding said contingency being satisfied.

2457. The financial instrument derived in accordance with said method of claim 2456, wherein said determining the likelihood that said payment will be made given assumptions regarding said contingency being satisfied comprises determining the likelihood that said payment will be made given a stock price growth rate and a volatility.

2458. The financial instrument derived in accordance with said method of claim 2400, wherein said attributing a number of said underlying references to said financial instrument comprises attributing a variable number of said underlying references to each unit of said financial instrument.

2459. The financial instrument derived in accordance with said method of claim 2400, wherein said attributing a number of said underlying references to said financial instrument comprises attributing a constant number of said underlying references to each unit of said financial instrument.

2460. The financial instrument derived in accordance with said method of claim 2400, wherein said identifying an underlying reference comprises identifying said underlying reference that said financial instrument converts into.

2461. The financial instrument derived in accordance with said method of claim 2400, wherein said identifying an underlying reference comprises basing an exchange value of said financial instrument on said underlying reference.

2462. A financial instrument derived in accordance with a method, said method comprising buying said financial instrument created by:
identifying an underlying reference for said financial instrument, said underlying reference having a value;
attributing a number of said underlying references to said financial instrument;
defining multiple contingencies having multiple triggers, a payment becoming due when at least two of said multiple triggers drop below respective predetermined values, at least one of said at least two triggers being a trigger of a different contingency from any other of said at least two triggers.

2463. The financial instrument derived in accordance with said method of claim 2462, wherein said buying said financial instrument comprises buying said financial instrument at a value based on at least one of:
a. said contingency;
b. said value of said underlying reference;
c. value of said payment;
d. length of said predetermined period of delay;
e. volatility in trading value of said underlying reference;
f. time until redemption, at option of issuer or holder;
g. time until maturity;
h. an interest rate; and
i. value for which said financial instrument must be redeemed on redemption date.

2464. The financial instrument derived in accordance with said method of claim 2462, wherein said buying said financial instrument comprises bidding for said financial instrument.

2465. The financial instrument derived in accordance with said method of claim 2462, wherein said buying said financial instrument comprises buying a derivative of said financial instrument.

2466. The financial instrument derived in accordance with said method of claim 2462, wherein said buying said financial instrument comprises buying a part of said financial instrument.

2467. The financial instrument derived in accordance with said method of claim 2462, wherein said defining multiple contingencies comprises basing said multiple contingencies on events related to said financial instrument.

2468. The financial instrument derived in accordance with said method of claim 2462, wherein said defining multiple contingencies comprises basing said multiple contingencies on instruments other than said financial instrument.

2469. The financial instrument derived in accordance with said method of claim 2462, wherein said attributing a number of said underlying references to said financial instrument comprises attributing a variable number of said underlying references to each unit of said financial instrument.

2470. The financial instrument derived in accordance with said method of claim 2462, wherein said attributing a number of said underlying references to said financial instrument comprises attributing a constant number of said underlying references to each unit of said financial instrument.

2471. The financial instrument derived in accordance with said method of claim 2462, wherein said identifying an underlying reference comprises identifying said underlying reference that said financial instrument converts into.

2472. The financial instrument derived in accordance with said method of claim 2462, wherein said identifying an underlying reference comprises basing an exchange value of said financial instrument on said underlying reference.

2473. A financial instrument derived in accordance with a method, said method comprising:
identifying an underlying reference for said financial instrument, said underlying reference having a value;
attributing a number of said underlying references to said financial instrument;
defining a contingency, said contingency having a trigger based upon at least one of:
a. trading value of said financial instrument,
b. trading yield of said financial instrument,
c. dividend yield of said underlying reference,
d. trading yield of a liability of said issuer of said financial instrument,
e. trading value of a liability of said issuer of said financial instrument,
f. trading value of a class of capital stock other than said underlying reference,
g. trading dividend yield of a class of capital stock issued by an issuer other than said issuer of said financial instrument,
h. trading value of a class of capital stock of said issuer of said financial instrument other than common stock,
i. trading yield of a class of capital stock of said issuer of said financial instrument,
j. trading value of a security issued by an issuer other than said issuer of said financial instrument,
k. trading yield of a security,
l. an index; wherein:
a payment becomes due on occurrence of said contingency.

2474. The financial instrument derived in accordance with said method of claim 2473, further comprising:
establishing a value for said financial instrument.

2475. The financial instrument derived in accordance with said method of claim 2474 further comprising:
selling said financial instrument.

2476. The financial instrument derived in accordance with said method of claim 2475, wherein said selling said financial instrument comprises selling said financial instrument at a value based on at least one of:
a. said contingency;
b. said value of said underlying reference;
c. value of said payment;
d. volatility in trading value of said underlying reference;
e. time until redemption, at option of issuer or holder;
f. time until maturity;
g. an interest rate; and
h. value for which said financial instrument must be redeemed on redemption date.

2477. The financial instrument derived in accordance with said method of claim 2475, wherein said selling said financial instrument comprises auctioning said financial instrument.

2478. The financial instrument derived in accordance with said method of claim 2475, wherein said selling said financial instrument comprises selling a derivative of said financial instrument.

2479. The financial instrument derived in accordance with said method of claim 2475, wherein said selling said financial instrument comprises selling a part of said financial instrument.

2480. The financial instrument derived in accordance with said method of claim 2475 further comprising:
monitoring for satisfaction of said contingency.

2481. The financial instrument derived in accordance with said method of claim 2475, said method further comprising:
disbursing said payment.

2482. The financial instrument derived in accordance with said method of claim 2475, said method further comprising:
calculating said payment.

2483. The financial instrument derived in accordance with said method of claim 2474, said method further comprising:
monitoring for satisfaction of said contingency.

2484. The financial instrument derived in accordance with said method of claim 2483, said method further comprising:
disbursing said payment.

2485. The financial instrument derived in accordance with said method of claim 2483, said method further comprising:
calculating said payment.

2486. The financial instrument derived in accordance with said method of claim 2474, said method further comprising:
disbursing said payment.

2487. The financial instrument derived in accordance with said method of claim 2474, said method further comprising:
calculating said payment.

2488. The financial instrument derived in accordance with said method of claim 2474, wherein said establishing a value for said financial instrument comprises basing said value for said financial instrument on at least one of:
a. said contingency;
b. said value of said underlying reference;
c. value of said payment;
d. volatility in trading value of said underlying reference;
e. time until redemption, at option of issuer or holder;
f. time until maturity;
g. an interest rate; and
h. value for which said financial instrument must be redeemed on redemption date.

2489. The financial instrument derived in accordance with said method of claim 2473 further comprising:
selling said financial instrument.

2490. The financial instrument derived in accordance with said method of claim 2489, wherein said selling said financial instrument comprises selling said financial instrument at a value based on at least one of:
a. said contingency;
b. said value of said underlying reference;
c. value of said payment;
d. volatility in trading value of said underlying reference;
e. time until redemption, at option of issuer or holder;
f. time until maturity;
g. an interest rate; and
h. value for which said financial instrument must be redeemed on redemption date.

2491. The financial instrument derived in accordance with said method of claim 2489, wherein said selling said financial instrument comprises auctioning said financial instrument.

2492. The financial instrument derived in accordance with said method of claim 2489, wherein said selling said financial instrument comprises selling a derivative of said financial instrument.

2493. The financial instrument derived in accordance with said method of claim 2489, wherein said selling said financial instrument comprises selling a part of said financial instrument.

2494. The financial instrument derived in accordance with said method of claim 2489 further comprising:
monitoring for satisfaction of said contingency.

2495. The financial instrument derived in accordance with said method of claim 2489, said method further comprising:
disbursing said payment.

2496. The financial instrument derived in accordance with said method of claim 2489, said method further comprising:
calculating said payment.

2497. The financial instrument derived in accordance with said method of claim 2473 further comprising:
monitoring for satisfaction of said contingency.

2498. The financial instrument derived in accordance with said method of claim 2497, wherein said monitoring for satisfaction comprises comparing market data to requirements of said contingency within at least one contingency monitoring period.

2499. The financial instrument derived in accordance with said method of claim 2497, wherein said monitoring comprises monitoring over many contingency monitoring periods.

2500. The financial instrument derived in accordance with said method of claim 2497, wherein said monitoring comprises monitoring realtime data.

2501. The financial instrument derived in accordance with said method of claim 2497, said method further comprising:
disbursing said payment.

2502. The financial instrument derived in accordance with said method of claim 2497, said method further comprising:
calculating said payment.

2503. The financial instrument derived in accordance with said method of claim 2473, wherein said defining a contingency comprises establishing at least one of:
a. a contingency having at least one trigger, and
b. multiple contingencies having at least one trigger.

2504. The financial instrument derived in accordance with said method of claim 2503, wherein said establishing at least one trigger comprises setting said trigger at an amount equal to a multiple of a formula amount.

2505. The financial instrument derived in accordance with said method of claim 2504, wherein said setting said trigger at an amount equal to a multiple comprises using a multiple equal to 1.

2506. The financial instrument derived in accordance with said method of claim 2504, wherein said setting said trigger at an amount equal to a multiple comprises using a multiple less than 1.

2507. The financial instrument derived in accordance with said method of claim 2504, wherein said setting said trigger at an amount equal to a multiple comprises using a multiple greater than 1.

2508. The financial instrument derived in accordance with said method of claim 2473, said method further comprising:
disbursing said payment.

2509. The financial instrument derived in accordance with said method of claim 2508, wherein said disbursing said payment comprises sending a negotiable instrument.

2510. The financial instrument derived in accordance with said method of claim 2473, said method further comprising:
calculating said payment.

2511. The financial instrument derived in accordance with said method of claim 2510, wherein said calculating said payment comprises establishing a formula for calculating said payment based on said value of said underlying reference.

2512. The financial instrument derived in accordance with said method of claim 2511, wherein said establishing a formula comprises using a fixed rate formula.

2513. The financial instrument derived in accordance with said method of claim 2511, wherein said establishing a formula comprises using a variable rate formula.

2514. The financial instrument derived in accordance with said method of claim 2510, wherein said calculating said payment comprises calculating said payment using a periodic schedule.

2515. The financial instrument derived in accordance with said method of claim 2514, wherein said calculating said payment using a periodic schedule comprises calculating said payment at least once per said contingency monitoring period.

2516. The financial instrument derived in accordance with said method of claim 2514, wherein said calculating said payment using a periodic schedule comprises calculating said payment on a quarterly basis.

2517. The financial instrument derived in accordance with said method of claim 2510, wherein said calculating said payment comprises calculating said payment based upon at least one of:
a. predetermined fixed amount,
b. trading value of said financial instrument,
c. trading yield of said financial instrument,
d. trading yield of a liability of said issuer of said financial instrument,
e. trading value of a liability of said issuer of said financial instrument,
f. trading value of a class of capital stock issued by an issuer other than said issuer of said financial instrument,
g. trading dividend yield of a class of capital stock issued by an issuer other than said issuer of said financial instrument,
h. trading value of a class of capital stock of said issuer of said financial instrument,
i. trading yield of a class of capital stock of said issuer of said financial instrument,
j. trading value of a security,
k. trading yield of a security, and
l. an index.

2518. The financial instrument derived in accordance with said method of claim 2510, wherein said calculating said payment comprises calculating a payment only after a predetermined period of delay.

2519. The financial instrument derived in accordance with said method of claim 2473, further comprising preparing at least one of:
a. a projected payment schedule;
b. an incidental analysis; and
c. a remoteness analysis.

2520. The financial instrument derived in accordance with said method of claim 2519, wherein said preparing said projected payment schedule comprises determining a schedule of said payments based on payments necessary to produce a comparable yield.

2521. The financial instrument derived in accordance with said method of claim 2519, wherein said preparing said incidental analysis comprises determining the amount of said payment based on assumptions regarding said contingency being satisfied.

2522. The financial instrument derived in accordance with said method of claim 2521, wherein said determining the amount of said payment based on assumptions regarding the contingency being satisfied comprises determining the amount of said payment based on at least one of:
a. a stock price growth rate, and
b. discount rates.

2523. The financial instrument derived in accordance with said method of claim 2519, wherein said preparing said remoteness analysis comprises determining the likelihood that said payment will be made given assumptions regarding said contingency being satisfied.

2524. The financial instrument derived in accordance with said method of claim 2523, wherein said determining the likelihood that said payment will be made given assumptions regarding said contingency being satisfied comprises determining the likelihood that said payment will be made given a stock price growth rate and a volatility.

2525. The financial instrument derived in accordance with said method of claim 2473, wherein said attributing a number of said underlying references to said financial instrument comprises attributing a variable number of said underlying references to each unit of said financial instrument.

2526. The financial instrument derived in accordance with said method of claim 2473, wherein said attributing a number of said underlying references to said financial instrument comprises attributing a constant number of said underlying references to each unit of said financial instrument.

2527. The financial instrument derived in accordance with said method of claim 2473, wherein said identifying an underlying reference comprises identifying said underlying reference that said financial instrument converts into.

2528. The financial instrument derived in accordance with said method of claim 2473, wherein said identifying an underlying reference comprises basing an exchange value of said financial instrument on said underlying reference.

2529. A financial instrument having an issuer and derived in accordance with a method, said method comprising buying said financial instrument created by:
identifying an underlying reference for said financial instrument, said underlying reference having a value;
attributing a number of said underlying references to said financial instrument;
defining a contingency, said contingency having a trigger based upon at least one of:
a. trading value of said financial instrument,
b. trading yield of said financial instrument,
c. dividend yield of said underlying reference,
d. trading yield of a liability of said issuer of said financial instrument,
e. trading value of a liability of said issuer of said financial instrument,
f. trading value of a class of capital stock other than said underlying reference,
g. trading dividend yield of a class of capital stock issued by an issuer other than said issuer of said financial instrument,
h. trading value of a class of capital stock of said issuer of said financial instrument other than common stock,
i. trading yield of a class of capital stock of said issuer of said financial instrument,
j. trading value of a security issued by an issuer other than said issuer of said financial instrument,
k. trading yield of a security,
l. an index; wherein:
a payment becomes due on occurrence of said contingency.

2530. The financial instrument derived in accordance with said method of claim 2529, wherein said buying said financial instrument comprises buying said financial instrument at a value based on at least one of:
a. said contingency;
b. said value of said underlying reference;
c. value of said payment;
d. length of said predetermined period of delay;
e. volatility in trading value of said underlying reference;
f. time until redemption, at option of issuer or holder;
g. time until maturity;
h. an interest rate; and
i. value for which said financial instrument must be redeemed on redemption date.

2531. The financial instrument derived in accordance with said method of claim 2529, wherein said buying said financial instrument comprises bidding for said financial instrument.

2532. The financial instrument derived in accordance with said method of claim 2529, wherein said buying said financial instrument comprises buying a derivative of said financial instrument.

2533. The financial instrument derived in accordance with said method of claim 2529, wherein said buying said financial instrument comprises buying a part of said financial instrument.

2534. The financial instrument derived in accordance with said method of claim 2529, wherein said attributing a number of said underlying references to said financial instrument comprises attributing a variable number of said underlying references to each unit of said financial instrument.

2535. The financial instrument derived in accordance with said method of claim 2529, wherein said attributing a number of said underlying references to said financial instrument comprises attributing a constant number of said underlying references to each unit of said financial instrument.

2536. The financial instrument derived in accordance with said method of claim 2529, wherein said identifying an underlying reference comprises identifying said underlying reference that said financial instrument converts into.

2537. The financial instrument derived in accordance with said method of claim 2529, wherein said identifying an underlying reference comprises basing an exchange value of said financial instrument on said underlying reference.

2538. A financial instrument derived in accordance with a method, said method comprising:
identifying an underlying reference for said financial instrument, said underlying reference having a value;
attributing a number of said underlying references to said financial instrument;
defining a contingency, a payment becoming due on occurrence of said contingency;
calculating said payment based upon at least one of:
a. predetermined fixed amount,
b. trading value of said financial instrument,
c. trading yield of said financial instrument,
d. trading yield of a liability of said issuer of said financial instrument,
e. trading value of a liability of said issuer of said financial instrument,
f. trading value of a class of capital stock issued by an issuer other than said issuer of said financial instrument,
g. trading dividend yield of a class of capital stock other than said underlying reference,
h. trading value of a class of capital stock of said issuer of said financial instrument,
i. trading yield of a class of capital stock of said issuer of said financial instrument other than common stock,
j. trading value of a security,
k. trading yield of a security issued by an issuer other than said issuer of said financial instrument,
l. an index.

2539. The financial instrument derived in accordance with said method of claim 2538, further comprising:
establishing a value for said financial instrument.

2540. The financial instrument derived in accordance with said method of claim 2539 further comprising:
selling said financial instrument.

2541. The financial instrument derived in accordance with said method of claim 2540, wherein said selling said financial instrument comprises selling said financial instrument at a value based on at least one of:
a. said contingency;
b. said value of said underlying reference;
c. value of said payment;
d. volatility in trading value of said underlying reference;
e. time until redemption, at option of issuer or holder;
f. time until maturity;
g. an interest rate; and
h. value for which said financial instrument must be redeemed on redemption date.

2542. The financial instrument derived in accordance with said method of claim 2540, wherein said selling said financial instrument comprises auctioning said financial instrument.

2543. The financial instrument derived in accordance with said method of claim 2540, wherein said selling said financial instrument comprises selling a derivative of said financial instrument.

2544. The financial instrument derived in accordance with said method of claim 2540, wherein said selling said financial instrument comprises selling a part of said financial instrument.

2545. The financial instrument derived in accordance with said method of claim 2540 further comprising:
monitoring for satisfaction of said contingency.

2546. The financial instrument derived in accordance with said method of claim 2540, said method further comprising:
disbursing said payment.

2547. The financial instrument derived in accordance with said method of claim 2539, said method further comprising:
monitoring for satisfaction of said contingency.

2548. The financial instrument derived in accordance with said method of claim 2547, said method further comprising:
disbursing said payment.

2549. The financial instrument derived in accordance with said method of claim 2539, said method further comprising:
disbursing said payment.

2550. The financial instrument derived in accordance with said method of claim 2539, wherein said establishing a value for said financial instrument comprises basing said value for said financial instrument on at least one of:
a. said contingency;
b. said value of said underlying reference;
c. value of said payment;
d. volatility in trading value of said underlying reference;
e. time until redemption, at option of issuer or holder;
f. time until maturity;
g. an interest rate; and
h. value for which said financial instrument must be redeemed on redemption date.

2551. The financial instrument derived in accordance with said method of claim 2538 further comprising:
selling said financial instrument.

2552. The financial instrument derived in accordance with said method of claim 2551, wherein said selling said financial instrument comprises selling said financial instrument at a value based on at least one of:
a. said contingency;
b. said value of said underlying reference;
c. value of said payment;
d. volatility in trading value of said underlying reference;
e. time until redemption, at option of issuer or holder;
f. time until maturity;
g. an interest rate; and
h. value for which said financial instrument must be redeemed on redemption date.

2553. The financial instrument derived in accordance with said method of claim 2551, wherein said selling said financial instrument comprises auctioning said financial instrument.

2554. The financial instrument derived in accordance with said method of claim 2551, wherein said selling said financial instrument comprises selling a derivative of said financial instrument.

2555. The financial instrument derived in accordance with said method of claim 2551, wherein said selling said financial instrument comprises selling a part of said financial instrument.

2556. The financial instrument derived in accordance with said method of claim 2551 further comprising:
monitoring for satisfaction of said contingency.

2557. The financial instrument derived in accordance with said method of claim 2551, said method further comprising:
disbursing said payment.

2558. The financial instrument derived in accordance with said method of claim 2538 further comprising:
monitoring for satisfaction of said contingency.

2559. The financial instrument derived in accordance with said method of claim 2558, wherein said monitoring for satisfaction comprises comparing market data to requirements of said contingency within at least one contingency monitoring period.

2560. The financial instrument derived in accordance with said method of claim 2558, wherein said monitoring comprises monitoring over many contingency monitoring periods.

2561. The financial instrument derived in accordance with said method of claim 2558, wherein said monitoring comprises monitoring realtime data.

2562. The financial instrument derived in accordance with said method of claim 2558, said method further comprising:
disbursing said payment.

2563. The financial instrument derived in accordance with said method of claim 2538, wherein said defining a contingency comprises basing said contingency on an event related to said financial instrument.

2564. The financial instrument derived in accordance with said method of claim 2563, wherein said basing said contingency on an event related to said financial instrument comprises setting said contingency as satisfied once an observed value of said financial instrument at least:
a. exceeds a predetermined metric, or
b. is equal to a predetermined metric, or
c. is less than a predetermined metric.

2565. The financial instrument derived in accordance with said method of claim 2538, wherein said defining a contingency comprises setting said contingency as satisfied when the closing sale value of said underlying reference within at least one said contingency monitoring period is greater than a predetermined percentage of the conversion value.

2566. The financial instrument derived in accordance with said method of claim 2538, wherein said defining a contingency comprises setting said contingency as satisfied when the closing sale value of said underlying reference within at least one said contingency monitoring period is less than a predetermined percentage of the conversion value.

2567. The financial instrument derived in accordance with said method of claim 2538, wherein said defining a contingency comprises basing said contingency on an instrument other than said financial instrument.

2568. The financial instrument derived in accordance with said method of claim 2567, wherein said basing said contingency on said instrument other than said financial instrument comprises setting said contingency as satisfied once an observed value of said instrument at least:
a. exceeds a predetermined metric, or
b. is equal to a predetermined metric, or
c. is less than a predetermined metric.

2569. The financial instrument derived in accordance with said method of claim 2538, wherein said defining a contingency comprises establishing at least one of:
a. a contingency having at least one trigger, and
b. multiple contingencies having at least one trigger.

2570. The financial instrument derived in accordance with said method of claim 2569, wherein said establishing at least one trigger comprises setting said trigger at an amount equal to a multiple of a prevailing market rate for a financial instrument.

2571. The financial instrument derived in accordance with said method of claim 2570, wherein said setting said trigger at an amount equal to a multiple comprises using a multiple equal to 1.

2572. The financial instrument derived in accordance with said method of claim 2570, wherein said setting said trigger at an amount equal to a multiple comprises using a multiple less than 1.

2573. The financial instrument derived in accordance with said method of claim 2570, wherein said setting said trigger at an amount equal to a multiple comprises using a multiple greater than 1.

2574. The financial instrument derived in accordance with said method of claim 2569, wherein said establishing at least one trigger comprises setting said trigger at an amount equal to a multiple of a formula amount.

2575. The financial instrument derived in accordance with said method of claim 2574, wherein said setting said trigger at an amount equal to a multiple comprises using a multiple equal to 1.

2576. The financial instrument derived in accordance with said method of claim 2574, wherein said setting said trigger at an amount equal to a multiple comprises using a multiple less than 1.

2577. The financial instrument derived in accordance with said method of claim 2574, wherein said setting said trigger at an amount equal to a multiple comprises using a multiple greater than 1.

2578. The financial instrument derived in accordance with said method of claim 2538, said method further comprising:
disbursing said payment.

2579. The financial instrument derived in accordance with said method of claim 2578, wherein said disbursing said payment comprises sending a negotiable instrument.

2580. The financial instrument derived in accordance with said method of claim 2538, wherein said calculating said payment comprises calculating said payment using a periodic schedule.

2581. The financial instrument derived in accordance with said method of claim 2580, wherein said calculating said payment using a periodic schedule comprises calculating said payment at least once per said contingency monitoring period.

2582. The financial instrument derived in accordance with said method of claim 2580, wherein said calculating said payment using a periodic schedule comprises calculating said payment on a quarterly basis.

2583. The financial instrument derived in accordance with said method of claim 2538, wherein said calculating said payment comprises calculating a payment only after a predetermined period of delay.

2584. The financial instrument derived in accordance with said method of claim 2538, further comprising preparing at least one of:
a. a projected payment schedule;
b. an incidental analysis; and
c. a remoteness analysis.

2585. The financial instrument derived in accordance with said method of claim 2584, wherein said preparing said projected payment schedule comprises determining a schedule of said payments based on payments necessary to produce a comparable yield.

2586. The financial instrument derived in accordance with said method of claim 2584, wherein said preparing said incidental analysis comprises determining the amount of said payment based on assumptions regarding said contingency being satisfied.

2587. The financial instrument derived in accordance with said method of claim 2586, wherein said determining the amount of said payment based on assumptions regarding the contingency being satisfied comprises determining the amount of said payment based on at least one of:
a. a stock price growth rate, and
b. discount rates.

2588. The financial instrument derived in accordance with said method of claim 2584, wherein said preparing said remoteness analysis comprises determining the likelihood that said payment will be made given assumptions regarding said contingency being satisfied.

2589. The financial instrument derived in accordance with said method of claim 2588, wherein said determining the likelihood that said payment will be made given assumptions regarding said contingency being satisfied comprises determining the likelihood that said payment will be made given a stock price growth rate and a volatility.

2590. The financial instrument derived in accordance with said method of claim 2538, wherein said attributing a number of said underlying references to said financial instrument comprises attributing a variable number of said underlying references to each unit of said financial instrument.

2591. The financial instrument derived in accordance with said method of claim 2538, wherein said attributing a number of said underlying references to said financial instrument comprises attributing a constant number of said underlying references to each unit of said financial instrument.

2592. The financial instrument derived in accordance with said method of claim 2538, wherein said identifying an underlying reference comprises identifying said underlying reference that said financial instrument converts into.

2593. The financial instrument derived in accordance with said method of claim 2538, wherein said identifying an underlying reference comprises basing an exchange value of said financial instrument on said underlying reference.

2594. A financial instrument having an issuer and derived in accordance with a method, said method comprising buying said financial instrument created by:
identifying an underlying reference for said financial instrument, said underlying reference having a value;
attributing a number of said underlying references to said financial instrument;
defining a contingency, a payment becoming due on occurrence of said contingency;
calculating said payment based upon at least one of:
a. predetermined fixed amount,
b. trading value of said financial instrument,
c. trading yield of said financial instrument,
d. trading yield of a liability of said issuer of said financial instrument,
e. trading value of a liability of said issuer of said financial instrument,
f. trading value of a class of capital stock issued by an issuer other than said issuer of said financial instrument,
g. trading dividend yield of a class of capital stock other than said underlying reference,
h. trading value of a class of capital stock of said issuer of said financial instrument,
i. trading yield of a class of capital stock of said issuer of said financial instrument other than common stock,
j. trading value of a security,
k. trading yield of a security issued by an issuer other than said issuer of said financial instrument,
l. an index.

2595. The financial instrument derived in accordance with said method of claim 2594, wherein said buying said financial instrument comprises buying said financial instrument at a value based on at least one of:
a. said contingency;
b. said value of said underlying reference;
c. value of said payment;
d. length of said predetermined period of delay;
e. volatility in trading value of said underlying reference;
f. time until redemption, at option of issuer or holder;
g. time until maturity;
h. an interest rate; and
i. value for which said financial instrument must be redeemed on redemption date.

2596. The financial instrument derived in accordance with said method of claim 2594, wherein said buying said financial instrument comprises bidding for said financial instrument.

2597. The financial instrument derived in accordance with said method of claim 2594, wherein said buying said financial instrument comprises buying a derivative of said financial instrument.

2598. The financial instrument derived in accordance with said method of claim 2594, wherein said buying said financial instrument comprises buying a part of said financial instrument.

2599. The financial instrument derived in accordance with said method of claim 2594, wherein said defining a contingency comprises basing said contingency on an event related to said financial instrument.

2600. The financial instrument derived in accordance with said method of claim 2594, wherein said defining a contingency comprises basing said contingency on an instrument other than said financial instrument.

2601. The financial instrument derived in accordance with said method of claim 2594, wherein said attributing a number of said underlying references to said financial instrument comprises attributing a variable number of said underlying references to each unit of said financial instrument.

2602. The financial instrument derived in accordance with said method of claim 2594, wherein said attributing a number of said underlying references to said financial instrument comprises attributing a constant number of said underlying references to each unit of said financial instrument.

2603. The financial instrument derived in accordance with said method of claim 2594, wherein said identifying an underlying reference comprises identifying said underlying reference that said financial instrument converts into.

2604. The financial instrument derived in accordance with said method of claim 2594, wherein said identifying an underlying reference comprises basing an exchange value of said financial instrument on said underlying reference.

2605. A financial instrument derived in accordance with a method, said method comprising:
identifying an underlying reference for said financial instrument, said underlying reference having a value;
attributing a number of said underlying references to said financial instrument;
defining a contingency, a payment becoming due on occurrence of said contingency;
calculating said payment so that said payment equals at most an imposed maximum value.

2606. The financial instrument derived in accordance with said method of claim 2605, further comprising:
establishing a value for said financial instrument.

2607. The financial instrument derived in accordance with said method of claim 2606 further comprising:
selling said financial instrument.

2608. The financial instrument derived in accordance with said method of claim 2607, wherein said selling said financial instrument comprises selling said financial instrument at a value based on at least one of:
a. said contingency;
b. said value of said underlying reference;
c. value of said payment;
d. volatility in trading value of said underlying reference;
e. time until redemption, at option of issuer or holder;
f. time until maturity;
g. an interest rate; and
h. value for which said financial instrument must be redeemed on redemption date.

2609. The financial instrument derived in accordance with said method of claim 2607, wherein said selling said financial instrument comprises auctioning said financial instrument.

2610. The financial instrument derived in accordance with said method of claim 2607, wherein said selling said financial instrument comprises selling a derivative of said financial instrument.

2611. The financial instrument derived in accordance with said method of claim 2607, wherein said selling said financial instrument comprises selling a part of said financial instrument.

2612. The financial instrument derived in accordance with said method of claim 2607 further comprising:
monitoring for satisfaction of said contingency.

2613. The financial instrument derived in accordance with said method of claim 2607, said method further comprising:
disbursing said payment.

2614. The financial instrument derived in accordance with said method of claim 2606, said method further comprising:
monitoring for satisfaction of said contingency.

2615. The financial instrument derived in accordance with said method of claim 2614, said method further comprising:
disbursing said payment.

2616. The financial instrument derived in accordance with said method of claim 2606, said method further comprising:
disbursing said payment.

2617. The financial instrument derived in accordance with said method of claim 2606, wherein said establishing a value for said financial instrument comprises basing said value for said financial instrument on at least one of:
a. said contingency;
b. said value of said underlying reference;
c. value of said payment;
d. volatility in trading value of said underlying reference;
e. time until redemption, at option of issuer or holder;
f. time until maturity;
g. an interest rate; and
h. value for which said financial instrument must be redeemed on redemption date.

2618. The financial instrument derived in accordance with said method of claim 2605 further comprising:
selling said financial instrument.

2619. The financial instrument derived in accordance with said method of claim 2618, wherein said selling said financial instrument comprises selling said financial instrument at a value based on at least one of:
a. said contingency;
b. said value of said underlying reference;
c. value of said payment;
d. volatility in trading value of said underlying reference;
e. time until redemption, at option of issuer or holder;
f. time until maturity;
g. an interest rate; and
h. value for which said financial instrument must be redeemed on redemption date.

2620. The financial instrument derived in accordance with said method of claim 2618, wherein said selling said financial instrument comprises auctioning said financial instrument.

2621. The financial instrument derived in accordance with said method of claim 2618, wherein said selling said financial instrument comprises selling a derivative of said financial instrument.

2622. The financial instrument derived in accordance with said method of claim 2618, wherein said selling said financial instrument comprises selling a part of said financial instrument.

2623. The financial instrument derived in accordance with said method of claim 2618 further comprising:
monitoring for satisfaction of said contingency.

2624. The financial instrument derived in accordance with said method of claim 2618, said method further comprising:
disbursing said payment.

2625. The financial instrument derived in accordance with said method of claim 2605 further comprising:
monitoring for satisfaction of said contingency.

2626. The financial instrument derived in accordance with said method of claim 2625, wherein said monitoring for satisfaction comprises comparing market data to requirements of said contingency within at least one contingency monitoring period.

2627. The financial instrument derived in accordance with said method of claim 2625, wherein said monitoring comprises monitoring over many contingency monitoring periods.

2628. The financial instrument derived in accordance with said method of claim 2625, wherein said monitoring comprises monitoring realtime data.

2629. The financial instrument derived in accordance with said method of claim 2625, said method further comprising:
disbursing said payment.

2630. The financial instrument derived in accordance with said method of claim 2605, wherein said defining a contingency comprises basing said contingency on an event related to said financial instrument.

2631. The financial instrument derived in accordance with said method of claim 2630, wherein said basing said contingency on an event related to said financial instrument comprises setting said contingency as satisfied once an observed value of said financial instrument at least:
a. exceeds a predetermined metric, or
b. is equal to a predetermined metric, or
c. is less than a predetermined metric.

2632. The financial instrument derived in accordance with said method of claim 2605, wherein said defining a contingency comprises setting said contingency as satisfied when the closing sale value of said underlying reference within at least one said contingency monitoring period is greater than a predetermined percentage of the conversion value.

2633. The financial instrument derived in accordance with said method of claim 2605, wherein said defining a contingency comprises setting said contingency as satisfied when the closing sale value of said underlying reference within at least one said contingency monitoring period is less than a predetermined percentage of the conversion value.

2634. The financial instrument derived in accordance with said method of claim 2605, wherein said defining a contingency comprises basing said contingency on an instrument other than said financial instrument.

2635. The financial instrument derived in accordance with said method of claim 2634, wherein said basing said contingency on said instrument other than said financial instrument comprises setting said contingency as satisfied once an observed value of said instrument at least:
a. exceeds a predetermined metric, or
b. is equal to a predetermined metric, or
c. is less than a predetermined metric.

2636. The financial instrument derived in accordance with said method of claim 2605, wherein said defining a contingency comprises establishing at least one of:
a. a contingency having at least one trigger, and
b. multiple contingencies having at least one trigger.

2637. The financial instrument derived in accordance with said method of claim 2636, wherein said establishing at least one trigger comprises setting said trigger at an amount equal to a multiple of a prevailing market rate for a financial instrument.

2638. The financial instrument derived in accordance with said method of claim 2637, wherein said setting said trigger at an amount equal to a multiple comprises using a multiple equal to 1.

2639. The financial instrument derived in accordance with said method of claim 2637, wherein said setting said trigger at an amount equal to a multiple comprises using a multiple less than 1.

2640. The financial instrument derived in accordance with said method of claim 2637, wherein said setting said trigger at an amount equal to a multiple comprises using a multiple greater than 1.

2641. The financial instrument derived in accordance with said method of claim 2636, wherein said establishing at least one trigger comprises setting said trigger at an amount equal to a multiple of a formula amount.

2642. The financial instrument derived in accordance with said method of claim 2641, wherein said setting said trigger at an amount equal to a multiple comprises using a multiple equal to 1.

2643. The financial instrument derived in accordance with said method of claim 2641, wherein said setting said trigger at an amount equal to a multiple comprises using a multiple less than 1.

2644. The financial instrument derived in accordance with said method of claim 2641, wherein said setting said trigger at an amount equal to a multiple comprises using a multiple greater than 1.

2645. The financial instrument derived in accordance with said method of claim 2605, said method further comprising:
disbursing said payment.

2646. The financial instrument derived in accordance with said method of claim 2645, wherein said disbursing said payment comprises sending a negotiable instrument.

2647. The method of claim 2605, wherein said calculating said payments so that said payment equals at most an imposed maximum value comprises basing said maximum value on at least one of:
a. a predetermined fixed value,
b. a predetermined maximum yield.

2648. The financial instrument derived in accordance with said method of claim 2605, wherein said calculating said payment so that said payment equals at most an imposed maximum value comprises calculating said payment using a periodic schedule.

2649. The financial instrument derived in accordance with said method of claim 2648, wherein said calculating said payment using a periodic schedule comprises calculating said payment at least once per said contingency monitoring period.

2650. The financial instrument derived in accordance with said method of claim 2648, wherein said calculating said payment using a periodic schedule comprises calculating said payment on a quarterly basis.

2651. The financial instrument derived in accordance with said method of claim 2605, wherein said calculating said payment so that said payment equals at most an imposed maximum value comprises calculating said payment based upon at least one of:
a. predetermined fixed amount,
b. trading value of said financial instrument,
c. trading yield of said financial instrument,
d. trading yield of a liability of said issuer of said financial instrument,
e. trading value of a liability of said issuer of said financial instrument,
f. trading value of a class of capital stock issued by an issuer other than said issuer of said financial instrument,
g. trading dividend yield of a class of capital stock issued by an issuer other than said issuer of said financial instrument,
h. trading value of a class of capital stock of said issuer of said financial instrument,
i. trading yield of a class of capital stock of said issuer of said financial instrument,
j. trading value of a security,
k. trading yield of a security, and
l. an index.

2652. The financial instrument derived in accordance with said method of claim 2605, wherein said calculating said payment so that said payment equals at most an imposed maximum value comprises calculating a payment only after a predetermined period of delay.

2653. The financial instrument derived in accordance with said method of claim 2605, wherein said calculating said payment so that said payment equals at most an imposed maximum value comprises calculating said payment so that said payment exceeds an imposed minimum value.

2654. The financial instrument derived in accordance with said method of claim 2605, further comprising preparing at least one of:
a. a projected payment schedule;
b. an incidental analysis; and
c. a remoteness analysis.

2655. The financial instrument derived in accordance with said method of claim 2654, wherein said preparing said projected payment schedule comprises determining a schedule of said payments based on payments necessary to produce a comparable yield.

2656. The financial instrument derived in accordance with said method of claim 2654, wherein said preparing said incidental analysis comprises determining the amount of said payment based on assumptions regarding said contingency being satisfied.

2657. The financial instrument derived in accordance with said method of claim 2656, wherein said determining the amount of said payment based on assumptions regarding the contingency being satisfied comprises determining the amount of said payment based on at least one of:
a. a stock price growth rate, and
b. discount rates.

2658. The financial instrument derived in accordance with said method of claim 2654, wherein said preparing said remoteness analysis comprises determining the likelihood that said payment will be made given assumptions regarding said contingency being satisfied.

2659. The financial instrument derived in accordance with said method of claim 2658, wherein said determining the likelihood that said payment will be made given assumptions regarding said contingency being satisfied comprises determining the likelihood that said payment will be made given a stock price growth rate and a volatility.

2660. The financial instrument derived in accordance with said method of claim 2605, wherein said attributing a number of said underlying references to said financial instrument comprises attributing a variable number of said underlying references to each unit of said financial instrument.

2661. The financial instrument derived in accordance with said method of claim 2605, wherein said attributing a number of said underlying references to said financial instrument comprises attributing a constant number of said underlying references to each unit of said financial instrument.

2662. The financial instrument derived in accordance with said method of claim 2605, wherein said identifying an underlying reference comprises identifying said underlying reference that said financial instrument converts into.

2663. The financial instrument derived in accordance with said method of claim 2605, wherein said identifying an underlying reference comprises basing an exchange value of said financial instrument on said underlying reference.

2664. A financial instrument derived in accordance with a method, said method comprising buying said financial instrument created by:
identifying an underlying reference for said financial instrument, said underlying reference having a value;
attributing a number of said underlying references to said financial instrument;
defining a contingency, a payment becoming due on occurrence of said contingency;
calculating said payment so that said payment equals at most an imposed maximum value.

2665. The financial instrument derived in accordance with said method of claim 2664, wherein said buying said financial instrument comprises buying said financial instrument at a value based on at least one of:
a. said contingency;
b. said value of said underlying reference;
c. value of said payment;
d. length of said predetermined period of delay;
e. volatility in trading value of said underlying reference;
f. time until redemption, at option of issuer or holder;
g. time until maturity;
h. an interest rate; and
i. value for which said financial instrument must be redeemed on redemption date.

2666. The financial instrument derived in accordance with said method of claim 2664, wherein said buying said financial instrument comprises bidding for said financial instrument.

2667. The financial instrument derived in accordance with said method of claim 2664, wherein said buying said financial instrument comprises buying a derivative of said financial instrument.

2668. The financial instrument derived in accordance with said method of claim 2664, wherein said buying said financial instrument comprises buying a part of said financial instrument.

2669. The financial instrument derived in accordance with said method of claim 2664, wherein said defining a contingency comprises basing said contingency on an event related to said financial instrument.

2670. The financial instrument derived in accordance with said method of claim 2664, wherein said defining a contingency comprises basing said contingency on an instrument other than said financial instrument.

2671. The financial instrument derived in accordance with said method of claim 2664, wherein said attributing a number of said underlying references to said financial instrument comprises attributing a variable number of said underlying references to each unit of said financial instrument.

2672. The financial instrument derived in accordance with said method of claim 2664, wherein said attributing a number of said underlying references to said financial instrument comprises attributing a constant number of said underlying references to each unit of said financial instrument.

2673. The financial instrument derived in accordance with said method of claim 2664, wherein said identifying an underlying reference comprises identifying said underlying reference that said financial instrument converts into.

2674. The financial instrument derived in accordance with said method of claim 2664, wherein said identifying an underlying reference comprises basing an exchange value of said financial instrument on said underlying reference.

2675. A financial instrument derived in accordance with a method, said method comprising:
identifying an underlying reference for said financial instrument, said underlying reference having a value;
attributing a number of said underlying references to said financial instrument;
defining a contingency, a payment becoming due on occurrence of said contingency;
calculating said payment so that said payment exceeds an imposed minimum value.

2676. The financial instrument derived in accordance with said method of claim 2675, further comprising:
establishing a value for said financial instrument.

2677. The financial instrument derived in accordance with said method of claim 2676 further comprising:
selling said financial instrument.

2678. The financial instrument derived in accordance with said method of claim 2677, wherein said selling said financial instrument comprises selling said financial instrument at a value based on at least one of:
a. said contingency;
b. said value of said underlying reference;
c. value of said payment;
d. volatility in trading value of said underlying reference;
e. time until redemption, at option of issuer or holder;
f. time until maturity;
g. an interest rate; and
h. value for which said financial instrument must be redeemed on redemption date.

2679. The financial instrument derived in accordance with said method of claim 2677, wherein said selling said financial instrument comprises auctioning said financial instrument.

2680. The financial instrument derived in accordance with said method of claim 2677, wherein said selling said financial instrument comprises selling a derivative of said financial instrument.

2681. The financial instrument derived in accordance with said method of claim 2677, wherein said selling said financial instrument comprises selling a part of said financial instrument.

2682. The financial instrument derived in accordance with said method of claim 2677 further comprising:
monitoring for satisfaction of said contingency.

2683. The financial instrument derived in accordance with said method of claim 2677, said method further comprising:
disbursing said payment.

2684. The financial instrument derived in accordance with said method of claim 2676, said method further comprising:
monitoring for satisfaction of said contingency.

2685. The financial instrument derived in accordance with said method of claim 2684, said method further comprising:
disbursing said payment.

2686. The financial instrument derived in accordance with said method of claim 2676, said method further comprising:
disbursing said payment.

2687. The financial instrument derived in accordance with said method of claim 2676, wherein said establishing a value for said financial instrument comprises basing said value for said financial instrument on at least one of:
a. said contingency;
b. said value of said underlying reference;
c. value of said payment;
d. volatility in trading value of said underlying reference;
e. time until redemption, at option of issuer or holder;
f. time until maturity;
g. an interest rate; and
h. value for which said financial instrument must be redeemed on redemption date.

2688. The financial instrument derived in accordance with said method of claim 2675 further comprising:
selling said financial instrument.

2689. The financial instrument derived in accordance with said method of claim 2688, wherein said selling said financial instrument comprises selling said financial instrument at a value based on at least one of:
a. said contingency;
b. said value of said underlying reference;
c. value of said payment;
d. volatility in trading value of said underlying reference;
e. time until redemption, at option of issuer or holder;
f. time until maturity;
g. an interest rate; and
h. value for which said financial instrument must be redeemed on redemption date.

2690. The financial instrument derived in accordance with said method of claim 2688, wherein said selling said financial instrument comprises auctioning said financial instrument.

2691. The financial instrument derived in accordance with said method of claim 2688, wherein said selling said financial instrument comprises selling a derivative of said financial instrument.

2692. The financial instrument derived in accordance with said method of claim 2688, wherein said selling said financial instrument comprises selling a part of said financial instrument.

2693. The financial instrument derived in accordance with said method of claim 2688 further comprising:
monitoring for satisfaction of said contingency.

2694. The financial instrument derived in accordance with said method of claim 2688, said method further comprising:
disbursing said payment.

2695. The financial instrument derived in accordance with said method of claim 2675 further comprising:
monitoring for satisfaction of said contingency.

2696. The financial instrument derived in accordance with said method of claim 2695, wherein said monitoring for satisfaction comprises comparing market data to requirements of said contingency within at least one contingency monitoring period.

2697. The financial instrument derived in accordance with said method of claim 2695, wherein said monitoring comprises monitoring over many contingency monitoring periods.

2698. The financial instrument derived in accordance with said method of claim 2695, wherein said monitoring comprises monitoring realtime data.

2699. The financial instrument derived in accordance with said method of claim 2695, said method further comprising:
disbursing said payment.

2700. The financial instrument derived in accordance with said method of claim 2675, wherein said defining a contingency comprises basing said contingency on an event related to said financial instrument.

2701. The financial instrument derived in accordance with said method of claim 2700, wherein said basing said contingency on an event related to said financial instrument comprises setting said contingency as satisfied once an observed value of said financial instrument at least:
a. exceeds a predetermined metric, or
b. is equal to a predetermined metric, or
c. is less than a predetermined metric.

2702. The financial instrument derived in accordance with said method of claim 2675, wherein said defining a contingency comprises setting said contingency as satisfied when the closing sale value of said underlying reference within at least one said contingency monitoring period is greater than a predetermined percentage of the conversion value.

2703. The financial instrument derived in accordance with said method of claim 2675, wherein said defining a contingency comprises setting said contingency as satisfied when the closing sale value of said underlying reference within at least one said contingency monitoring period is less than a predetermined percentage of the conversion value.

2704. The financial instrument derived in accordance with said method of claim 2675, wherein said defining a contingency comprises basing said contingency on an instrument other than said financial instrument.

2705. The financial instrument derived in accordance with said method of claim 2704, wherein said basing said contingency on said instrument other than said financial instrument comprises setting said contingency as satisfied once an observed value of said instrument at least:
a. exceeds a predetermined metric, or
b. is equal to a predetermined metric, or
c. is less than a predetermined metric.

2706. The financial instrument derived in accordance with said method of claim 2675, wherein said defining a contingency comprises establishing at least one of:
a. a contingency having at least one trigger, and
b. multiple contingencies having at least one trigger.

2707. The financial instrument derived in accordance with said method of claim 2706, wherein said establishing at least one trigger comprises setting said trigger at an amount equal to a multiple of a prevailing market rate for a financial instrument.

2708. The financial instrument derived in accordance with said method of claim 2707, wherein said setting said trigger at an amount equal to a multiple comprises using a multiple equal to 1.

2709. The financial instrument derived in accordance with said method of claim 2707, wherein said setting said trigger at an amount equal to a multiple comprises using a multiple less than 1.

2710. The financial instrument derived in accordance with said method of claim 2707, wherein said setting said trigger at an amount equal to a multiple comprises using a multiple greater than 1.

2711. The financial instrument derived in accordance with said method of claim 2706, wherein said establishing at least one trigger comprises setting said trigger at an amount equal to a multiple of a formula amount.

2712. The financial instrument derived in accordance with said method of claim 2711, wherein said setting said trigger at an amount equal to a multiple comprises using a multiple equal to 1.

2713. The financial instrument derived in accordance with said method of claim 2711, wherein said setting said trigger at an amount equal to a multiple comprises using a multiple less than 1.

2714. The financial instrument derived in accordance with said method of claim 2711, wherein said setting said trigger at an amount equal to a multiple comprises using a multiple greater than 1.

2715. The financial instrument derived in accordance with said method of claim 2675, said method further comprising:
disbursing said payment.

2716. The financial instrument derived in accordance with said method of claim 2715, wherein said disbursing said payment comprises sending a negotiable instrument.

2717. The method of claim 2675, wherein said calculating said payment so that said payment exceeds an imposed minimum value comprises basing said minimum value on at least one of:
a. a predetermined fixed value,
b. a predetermined minimum yield

2718. The financial instrument derived in accordance with said method of claim 2675, wherein said calculating said payment so that said payment exceeds an imposed minimum value comprises calculating said payment using a periodic schedule.

2719. The financial instrument derived in accordance with said method of claim 2718, wherein said calculating said payment using a periodic schedule comprises calculating said payment at least once per said contingency monitoring period.

2720. The financial instrument derived in accordance with said method of claim 2718, wherein said calculating said payment using a periodic schedule comprises calculating said payment on a quarterly basis.

2721. The financial instrument derived in accordance with said method of claim 2675, wherein said calculating said payment so that said payment exceeds an imposed minimum value comprises calculating said payment based upon at least one of:
a. predetermined fixed amount,
b. trading value of said financial instrument,
c. trading yield of said financial instrument,
d. trading yield of a liability of said issuer of said financial instrument,
e. trading value of a liability of said issuer of said financial instrument,
f. trading value of a class of capital stock issued by an issuer other than said issuer of said financial instrument,
g. trading dividend yield of a class of capital stock issued by an issuer other than said issuer of said financial instrument,
h. trading value of a class of capital stock of said issuer of said financial instrument,
i. trading yield of a class of capital stock of said issuer of said financial instrument,
j. trading value of a security,
k. trading yield of a security, and
l. an index.

2722. The financial instrument derived in accordance with said method of claim 2675, wherein said calculating said payment so that said payment exceeds an imposed minimum value comprises calculating a payment only after a predetermined period of delay.

2723. The financial instrument derived in accordance with said method of claim 2675, wherein said calculating said payment so that said payment exceeds an imposed minimum value comprises calculating said payment so that said payment equals at most an imposed maximum value.

2724. The financial instrument derived in accordance with said method of claim 2675, further comprising preparing at least one of:
a. a projected payment schedule;
b. an incidental analysis; and
c. a remoteness analysis.

2725. The financial instrument derived in accordance with said method of claim 2724, wherein said preparing said projected payment schedule comprises determining a schedule of said payments based on payments necessary to produce a comparable yield.

2726. The financial instrument derived in accordance with said method of claim 2724, wherein said preparing said incidental analysis comprises determining the amount of said payment based on assumptions regarding said contingency being satisfied.

2727. The financial instrument derived in accordance with said method of claim 2726, wherein said determining the amount of said payment based on assumptions regarding the contingency being satisfied comprises determining the amount of said payment based on at least one of:
a. a stock price growth rate, and
b. discount rates.

2728. The financial instrument derived in accordance with said method of claim 2724, wherein said preparing said remoteness analysis comprises determining the likelihood that said payment will be made given assumptions regarding said contingency being satisfied.

2729. The financial instrument derived in accordance with said method of claim 2728, wherein said determining the likelihood that said payment will be made given assumptions regarding said contingency being satisfied comprises determining the likelihood that said payment will be made given a stock price growth rate and a volatility.

2730. The financial instrument derived in accordance with said method of claim 2675, wherein said attributing a number of said underlying references to said financial instrument comprises attributing a variable number of said underlying references to each unit of said financial instrument.

2731. The financial instrument derived in accordance with said method of claim 2675, wherein said attributing a number of said underlying references to said financial instrument comprises attributing a constant number of said underlying references to each unit of said financial instrument.

2732. The financial instrument derived in accordance with said method of claim 2675, wherein said identifying an underlying reference comprises identifying said underlying reference that said financial instrument converts into.

2733. The financial instrument derived in accordance with said method of claim 2675, wherein said identifying an underlying reference comprises basing an exchange value of said financial instrument on said underlying reference.

2734. A financial instrument derived in accordance with a method, said method comprising buying said financial instrument created by:
identifying an underlying reference for said financial instrument, said underlying reference having a value;
attributing a number of said underlying references to said financial instrument;
defining a contingency, a payment becoming due on occurrence of said contingency;
calculating said payment so that said payment exceeds an imposed minimum value.

2735. The financial instrument derived in accordance with said method of claim 2734, wherein said buying said financial instrument comprises buying said financial instrument at a value based on at least one of:
a. said contingency;
b. said value of said underlying reference;
c. value of said payment;
d. length of said predetermined period of delay;
e. volatility in trading value of said underlying reference;
f. time until redemption, at option of issuer or holder;
g. time until maturity;
h. an interest rate; and
i. value for which said financial instrument must be redeemed on redemption date.

2736. The financial instrument derived in accordance with said method of claim 2734, wherein said buying said financial instrument comprises bidding for said financial instrument.

2737. The financial instrument derived in accordance with said method of claim 2734, wherein said buying said financial instrument comprises buying a derivative of said financial instrument.

2738. The financial instrument derived in accordance with said method of claim 2734, wherein said buying said financial instrument comprises buying a part of said financial instrument.

2739. The financial instrument derived in accordance with said method of claim 2734, wherein said defining a contingency comprises basing said contingency on an event related to said financial instrument.

2740. The financial instrument derived in accordance with said method of claim 2734, wherein said defining a contingency comprises basing said contingency on an instrument other than said financial instrument.

2741. The financial instrument derived in accordance with said method of claim 2734, wherein said attributing a number of said underlying references to said financial instrument comprises attributing a variable number of said underlying references to each unit of said financial instrument.

2742. The financial instrument derived in accordance with said method of claim 2734, wherein said attributing a number of said underlying references to said financial instrument comprises attributing a constant number of said underlying references to each unit of said financial instrument.

2743. The financial instrument derived in accordance with said method of claim 2734, wherein said identifying an underlying reference comprises identifying said underlying reference that said financial instrument converts into.

2744. The financial instrument derived in accordance with said method of claim 2734, wherein said identifying an underlying reference comprises basing an exchange value of said financial instrument on said underlying reference.

2745. A financial instrument derived in accordance with a method, said method comprising:
identifying an underlying reference for said financial instrument, said underlying reference having a value;
attributing a number of said underlying references to said financial instrument;
defining multiple contingencies, a payment becoming due on occurrence of at least one of:
a. satisfaction of one of said multiple contingencies,
b. satisfaction of more than one of said multiple contingencies, and
c. satisfaction of all of said multiple contingencies.

2746. The financial instrument derived in accordance with said method of claim 2745, said method further comprising:
establishing a value for said financial instrument.

2747. The financial instrument derived in accordance with said method of claim 2746, said method further comprising:
selling said financial instrument.

2748. The financial instrument derived in accordance with said method of claim 2747, wherein said selling said financial instrument comprises selling said financial instrument at a value based on at least one of:
a. said multiple contingencies;
b. said value of said underlying reference;
c. value of said payment;
d. volatility in trading value of said underlying reference;
e. time until redemption, at option of issuer or holder;
f. time until maturity;
g. an interest rate; and
h. value for which said financial instrument must be redeemed on redemption date.

2749. The financial instrument derived in accordance with said method of claim 2747, wherein said selling said financial instrument comprises auctioning said financial instrument.

2750. The financial instrument derived in accordance with said method of claim 2747, wherein said selling said financial instrument comprises selling a derivative of said financial instrument.

2751. The financial instrument derived in accordance with said method of claim 2747, wherein said selling said financial instrument comprises selling a part of said financial instrument.

2752. The financial instrument derived in accordance with said method of claim 2747, said method further comprising:
monitoring for said satisfaction of said multiple contingencies.

2753. The financial instrument derived in accordance with said method of claim 2747, said method further comprising:
disbursing said payment.

2754. The financial instrument derived in accordance with said method of claim 2747, said method further comprising:
calculating said payment.

2755. The financial instrument derived in accordance with said method of claim 2746, said method further comprising:
monitoring for said satisfaction of said multiple contingencies.

2756. The financial instrument derived in accordance with said method of claim 2755, said method further comprising:
disbursing said payment.

2757. The financial instrument derived in accordance with said method of claim 2755, said method further comprising:
calculating said payment.

2758. The financial instrument derived in accordance with said method of claim 2746, said method further comprising:
disbursing said payment.

2759. The financial instrument derived in accordance with said method of claim 2746, said method further comprising:
calculating said payment.

2760. The financial instrument derived in accordance with said method of claim 2746, wherein said establishing a value for said financial instrument comprises basing said value for said financial instrument on at least one of:
a. said multiple contingencies;
b. said value of said underlying reference;
c. value of said payment;
d. volatility in trading value of said underlying reference;
e. time until redemption, at option of issuer or holder;
f. time until maturity;
g. an interest rate; and
h. value for which said financial instrument must be redeemed on redemption date.,

2761. The financial instrument derived in accordance with said method of claim 2745, said method further comprising:
selling said financial instrument.

2762. The financial instrument derived in accordance with said method of claim 2761, wherein said selling said financial instrument comprises selling said financial instrument at a value based on at least one of:
a. said multiple contingencies;
b. said value of said underlying reference;
c. value of said payment;
d. volatility in trading value of said underlying reference;
e. time until redemption, at option of issuer or holder;
f. time until maturity;
g. an interest rate; and
h. value for which said financial instrument must be redeemed on redemption date.

2763. The financial instrument derived in accordance with said method of claim 2761, wherein said selling said financial instrument comprises auctioning said financial instrument.

2764. The financial instrument derived in accordance with said method of claim 2761, wherein said selling said financial instrument comprises selling a derivative of said financial instrument.

2765. The financial instrument derived in accordance with said method of claim 2761, wherein said selling said financial instrument comprises selling a part of said financial instrument.

2766. The financial instrument derived in accordance with said method of claim 2761, said method further comprising:
monitoring for said satisfaction of said multiple contingencies.

2767. The financial instrument derived in accordance with said method of claim 2761, said method further comprising:
disbursing said payment.

2768. The financial instrument derived in accordance with said method of claim 2761, said method further comprising:
calculating said payment.

2769. The financial instrument derived in accordance with said method of claim 2745, said method further comprising:
monitoring for said satisfaction of said multiple contingencies.

2770. The financial instrument derived in accordance with said method of claim 2769, wherein said monitoring for said satisfaction comprises comparing market data to requirements of said multiple contingencies within at least one contingency monitoring period.

2771. The financial instrument derived in accordance with said method of claim 2769, wherein said monitoring comprises monitoring over many contingency monitoring periods.

2772. The financial instrument derived in accordance with said method of claim 2769, wherein said monitoring comprises monitoring realtime data.

2773. The financial instrument derived in accordance with said method of claim 2769, said method further comprising:
disbursing said payment.

2774. The financial instrument derived in accordance with said method of claim 2769, said method further comprising:
calculating said payment.

2775. The financial instrument derived in accordance with said method of claim 2745, wherein said defining multiple contingencies comprises basing said contingencies on events related to said financial instrument.

2776. The financial instrument derived in accordance with said method of claim 2745, wherein said defining multiple contingencies comprises basing said contingencies on instruments other than said financial instrument.

2777. The financial instrument derived in accordance with said method of claim 2776, wherein said basing said contingencies on instruments other than said financial instrument comprises setting said contingencies as satisfied once observed values of said instruments at least:
a. exceed a predetermined metric, or
b. are equal to a predetermined metric, or
c. are less than a predetermined metric.

2778. The financial instrument derived in accordance with said method of claim 2745, wherein said defining said contingencies comprises establishing multiple contingencies each with at least one trigger.

2779. The financial instrument derived in accordance with said method of claim 2778, wherein said establishing at least one trigger comprises setting said trigger at an amount equal to a multiple of a prevailing market rate for a financial instrument.

2780. The financial instrument derived in accordance with said method of claim 2779, wherein said setting said trigger at an amount equal to a multiple comprises using a multiple equal to 1.

2781. The financial instrument derived in accordance with said method of claim 2779, wherein said setting said trigger at an amount equal to a multiple comprises using a multiple less than 1.

2782. The financial instrument derived in accordance with said method of claim 2779, wherein said setting said trigger at an amount equal to a multiple comprises using a multiple greater than 1.

2783. The financial instrument derived in accordance with said method of claim 2778, wherein said establishing at least one trigger comprises setting said trigger at an amount equal to a multiple of a formula amount.

2784. The financial instrument derived in accordance with said method of claim 2783, wherein said setting said trigger at an amount equal to a multiple comprises using a multiple equal to 1.

2785. The financial instrument derived in accordance with said method of claim 2783, wherein said setting said trigger at an amount equal to a multiple comprises using a multiple less than 1.

2786. The financial instrument derived in accordance with said method of claim 2783, wherein said setting said trigger at an amount equal to a multiple comprises using a multiple greater than 1.

2787. The financial instrument derived in accordance with said method of claim 2745, said method further comprising:
disbursing said payment.

2788. The financial instrument derived in accordance with said method of claim 2787, wherein said disbursing said payment comprises sending a negotiable instrument.

2789. The financial instrument derived in accordance with said method of claim 2745, said method further comprising:
calculating said payment.

2790. The financial instrument derived in accordance with said method of claim 2789, wherein said calculating said payment comprises establishing a formula for calculating said payment based on said value of said underlying reference.

2791. The financial instrument derived in accordance with said method of claim 2790, wherein said establishing a formula comprises using a fixed rate formula.

2792. The financial instrument derived in accordance with said method of claim 2790, wherein said establishing a formula comprises using a variable rate formula.

2793. The financial instrument derived in accordance with said method of claim 2789, wherein said calculating said payment comprises calculating said payment using a periodic schedule.

2794. The financial instrument derived in accordance with said method of claim 2793, wherein said calculating said payment using a periodic schedule comprises calculating said payment at least once per contingency monitoring period.

2795. The financial instrument derived in accordance with said method of claim 2793, wherein said calculating said payment using a periodic schedule comprises calculating said payment on a quarterly basis.

2796. The financial instrument derived in accordance with said method of claim 2789, wherein said calculating said payment comprises calculating said payment based upon at least one of:
a. predetermined fixed amount,
b. trading value of said financial instrument,
c. trading yield of said financial instrument,
d. trading yield of a liability of said issuer of said financial instrument,
e. trading value of a liability of said issuer of said financial instrument,
f. trading value of a class of capital stock issued by an issuer other than said issuer of said financial instrument,
g. trading dividend yield of a class of capital stock issued by an issuer other than said issuer of said financial instrument,
h. trading value of a class of capital stock of said issuer of said financial instrument,
i. trading yield of a class of capital stock of said issuer of said financial instrument,
j. trading value of a security,
k. trading yield of a security, and
l. an index.

2797. The financial instrument derived in accordance with said method of claim 2745, further comprising preparing at least one of:
a. a projected payment schedule;
b. an incidental analysis; and
c. a remoteness analysis.

2798. The financial instrument derived in accordance with said method of claim 2797, wherein said preparing said projected payment schedule comprises determining a schedule of said payments based on payments necessary to produce a comparable yield.

2799. The financial instrument derived in accordance with said method of claim 2797, wherein said preparing said incidental analysis comprises determining the amount of said payment based on assumptions regarding said contingency being satisfied.

2800. The financial instrument derived in accordance with said method of claim 2799, wherein said determining the amount of said payment based on assumptions regarding the contingency being satisfied comprises determining the amount of said payment based on at least one of:
a. a stock price growth rate, and
b. discount rates.

2801. The financial instrument derived in accordance with said method of claim 2797, wherein said preparing said remoteness analysis comprises determining the likelihood that said payment will be made given assumptions regarding said contingency being satisfied.

2802. The financial instrument derived in accordance with said method of claim 2801, wherein said determining the likelihood that said payment will be made given assumptions regarding said contingency being satisfied comprises determining the likelihood that said payment will be made given a stock price growth rate and a volatility.

2803. The financial instrument derived in accordance with said method of claim 2745, wherein said attributing a number of said underlying references to said financial instrument comprises attributing a variable number of said underlying references to each unit of said financial instrument.

2804. The financial instrument derived in accordance with said method of claim 2745, wherein said attributing a number of said underlying references to said financial instrument comprises attributing a constant number of said underlying references to each unit of said financial instrument.

2805. The financial instrument derived in accordance with said method of claim 2745, wherein said identifying an underlying reference comprises identifying said underlying reference that said financial instrument converts into.

2806. The financial instrument derived in accordance with said method of claim 2745, wherein said identifying an underlying reference comprises basing an exchange value of said financial instrument on said underlying reference.

2807. A financial instrument derived in accordance with a method, said method comprising buying said financial instrument created by:
identifying an underlying reference for said financial instrument, said underlying reference having a value;
attributing a number of said underlying references to said financial instrument;
defining multiple contingencies, a payment becoming due on occurrence of at least one of:
a. satisfaction of one of said multiple contingencies,
b. satisfaction of more than one of said multiple contingencies, and
c. satisfaction of all of said multiple contingencies.

2808. The financial instrument derived in accordance with said method of claim 2807, wherein said buying said financial instrument comprises buying said financial instrument at a value based on at least one of:
a. said contingency;
b. said value of said underlying reference;
c. value of said payment;
d. length of said predetermined period of delay;
e. volatility in trading value of said underlying reference;
f. time until redemption, at option of issuer or holder;
g. time until maturity;
h. an interest rate; and
i. value for which said financial instrument must be redeemed on redemption date.

2809. The financial instrument derived in accordance with said method of claim 2807, wherein said buying said financial instrument comprises bidding for said financial instrument.

2810. The financial instrument derived in accordance with said method of claim 2807, wherein said buying said financial instrument comprises buying a derivative of said financial instrument.

2811. The financial instrument derived in accordance with said method of claim 2807, wherein said buying said financial instrument comprises buying a part of said financial instrument.

2812. The financial instrument derived in accordance with said method of claim 2807, wherein said defining a contingency comprises basing said contingency on an event related to said financial instrument.

2813. The financial instrument derived in accordance with said method of claim 2807, wherein said defining a contingency comprises basing said contingency on an instrument other than said financial instrument.

2814. The financial instrument derived in accordance with said method of claim 2807, wherein said attributing a number of said underlying references to said financial instrument comprises attributing a variable number of said underlying references to each unit of said financial instrument.

2815. The financial instrument derived in accordance with said method of claim 2807, wherein said attributing a number of said underlying references to said financial instrument comprises attributing a constant number of said underlying references to each unit of said financial instrument.

2816. The financial instrument derived in accordance with said method of claim 2807, wherein said identifying an underlying reference comprises identifying said underlying reference that said financial instrument converts into.

2817. The financial instrument derived in accordance with said method of claim 2807, wherein said identifying an underlying reference comprises basing an exchange value of said financial instrument on said underlying reference.

2818. A machine-readable data storage medium encoded with a set of machine-executable instructions for using a data processing system to perform a financial services method associated with a financial instrument, said method comprising:
identifying an underlying reference for said financial instrument, said underlying reference having a value;
attributing a number of said underlying references to said financial instrument;
defining a contingency, a payment becoming due on occurrence of said contingency after a predetermined period of delay.

2819. The machine-readable data storage medium of claim 2818, wherein said method further comprises:
establishing a value for said financial instrument.

2820. The machine-readable data storage medium of claim 2819, wherein said method further comprises:
selling said financial instrument.

2821. The machine-readable data storage medium of claim 2820, wherein said method further comprises:
monitoring for satisfaction of said contingency.

2822. The machine-readable data storage medium of claim 2820, wherein said method further comprises:
disbursing said payment.

2823. The machine-readable data storage medium of claim 2820, wherein said method further comprises:
calculating said payment.

2824. The machine-readable data storage medium of claim 2819, wherein said method further comprises:
monitoring for satisfaction of said contingency.

2825. The machine-readable data storage medium of claim 2824, wherein said method further comprises:
disbursing said payment.

2826. The machine-readable data storage medium of claim 2824, wherein said method further comprises:
calculating said payment.

2827. The machine-readable data storage medium of claim 2819, wherein said method further comprises:
disbursing said payment.

2828. The machine-readable data storage medium of claim 2819, wherein said method further comprises:
calculating said payment.

2829. The machine-readable data storage medium of claim 2818, wherein said method further comprises:
selling said financial instrument.

2830. The machine-readable data storage medium of claim 2829, wherein said method further comprises:
monitoring for satisfaction of said contingency.

2831. The machine-readable data storage medium of claim 2829, wherein said method further comprises:
disbursing said payment.

2832. The machine-readable data storage medium of claim 2829, wherein said method further comprises:
calculating said payment.

2833. The machine-readable data storage medium of claim 2818, wherein said method further comprises:
monitoring for satisfaction of said contingency.

2834. The machine-readable data storage medium of claim 2833, wherein said method further comprises:
disbursing said payment.

2835. The machine-readable data storage medium of claim 2833, wherein said method further comprises:
calculating said payment.

2836. The machine-readable data storage medium of claim 2818, wherein said method further comprises:
disbursing said payment.

2837. The machine-readable data storage medium of claim 2818, wherein said method further comprises:
calculating said payment.

2838. The machine-readable data storage medium of any of one claims 2818, 2819, 2820, 2821, 2822, 2823, 2824, 2825, 2826, 2827, 2828, 2829, 2830, 2831,2832, 2833, 2834, 2835, 2836 and 2837, said data storage medium being magnetic.

2839. The magnetic machine-readable data storage medium of claim 2838, said data storage medium being a floppy diskette.

2840. The magnetic machine-readable data storage medium of claim 2838, said data storage medium being a hard disk.

2841. The machine-readable data storage medium of any one of claims 2818,2819, 2820, 2821, 2822, 2823, 2824, 2825, 2826, 2827, 2828, 2829, 2830, 2831, 2832, 2833, 2834, 2835, 2836 and 2837,said data storage medium being optically readable.

2842. The optically readable storage medium of claim 2841, said data storage medium being one of (a) a CD-ROM, (b) a CD-R, and (c) a CD-RW.

2843. The optically readable data storage medium of claim 2841, said data storage medium being a magneto-optical disk.

2844. A machine-readable data storage medium encoded with a set of machine-executable instructions for using a data processing system to perform a financial services method associated with a financial instrument, said method comprising:
identifying an underlying reference for said financial instrument, said underlying reference having a value;
attributing a number of said underlying references to said financial instrument;
defining a contingency having at least one trigger, a payment becoming due when said trigger drops below a predetermined value.

2845. The machine-readable data storage medium of claim 2844, wherein said method further comprises:
establishing a value for said financial instrument.

2846. The machine-readable data storage medium of claim 2845, wherein said method further comprises:
selling said financial instrument.

2847. The machine-readable data storage medium of claim 2846, wherein said method further comprises:
monitoring for satisfaction of said contingency.

2848. The machine-readable data storage medium of claim 2846, wherein said method further comprises:
disbursing said payment.

2849. The machine-readable data storage medium of claim 2846, wherein said method further comprises:
calculating said payment.

2850. The machine-readable data storage medium of claim 2845, wherein said method further comprises:
monitoring for satisfaction of said contingency.

2851. The machine-readable data storage medium of claim 2850, wherein said method further comprises:
disbursing said payment.

2852. The machine-readable data storage medium of claim 2850, wherein said method further comprises:
calculating said payment.

2853. The machine-readable data storage medium of claim 2845, wherein said method further comprises:
disbursing said payment.

2854. The machine-readable data storage medium of claim 2845, wherein said method further comprises:
calculating said payment.

2855. The machine-readable data storage medium of claim 2844, wherein said method further comprises:
selling said financial instrument.

2856. The machine-readable data storage medium of claim 2855, wherein said method further comprises:
monitoring for satisfaction of said contingency.

2857. The machine-readable data storage medium of claim 2855, wherein said method further comprises:
disbursing said payment.

2858. The machine-readable data storage medium of claim 2855, wherein said method further comprises:
calculating said payment.

2859. The machine-readable data storage medium of claim 2844, wherein said method further comprises:
monitoring for satisfaction of said contingency.

2860. The machine-readable data storage medium of claim 2859, wherein said method further comprises:
disbursing said payment.

2861. The machine-readable data storage medium of claim 2859, wherein said method further comprises:
calculating said payment.

2862. The machine-readable data storage medium of claim 2844, wherein said method further comprises:
disbursing said payment.

2863. The machine-readable data storage medium of claim 2844, wherein said method further comprises:
calculating said payment.

2864. The machine-readable data storage medium of any one of claims 2844, 2845, 2846, 2847, 2848, 2849, 2850, 2851, 2852, 2853, 2854, 2855, 2856, 2857, 2858, 2859, 2860, 2861, 2862 and 2863, said data storage medium being magnetic.

2865. The magnetic machine-readable data storage medium of claim 2864, said data storage medium being a floppy diskette.

2866. The magnetic machine-readable data storage medium of claim 2864, said data storage medium being a hard disk.

2867. The machine-readable data storage medium of any one of claims 2844, 2845, 2846, 2847, 2848, 2849, 2850, 2851, 2852, 2853, 2854, 2855, 2856, 2857, 2858, 2859, 2860, 2861, 2862 and 2863, said data storage medium being optically readable.

2868. The optically readable storage medium of claim 2867, said data storage medium being one of (a) a CD-ROM, (b) a CD-R, and (c) a CD-RW.

2869. The optically readable data storage medium of claim 2867, said data storage medium being a magneto-optical disk.

2870. A machine-readable data storage medium encoded with a set of machine-executable instructions for using a data processing system to perform a financial services method associated with a financial instrument, said method comprising:
identifying an underlying reference for said financial instrument, said underlying reference having a value;
attributing a number of said underlying references to said financial instrument;
defining a contingency having multiple triggers, a payment becoming due when any one of said triggers drops below a predetermined value.

2871. The machine-readable data storage medium of claim 2870, wherein said method further comprises:
establishing a value for said financial instrument.

2872. The machine-readable data storage medium of claim 2871, wherein said method further comprises:
selling said financial instrument.

2873. The machine-readable data storage medium of claim 2872, wherein said method further comprises:
monitoring for satisfaction of said contingency.

2874. The machine-readable data storage medium of claim 2872, wherein said method further comprises:
disbursing said payment.

2875. The machine-readable data storage medium of claim 2872, wherein said method further comprises:
calculating said payment.

2876. The machine-readable data storage medium of claim 2871, wherein said method further comprises:
monitoring for satisfaction of said contingency.

2877. The machine-readable data storage medium of claim 2876, wherein said method further comprises:
disbursing said payment.

2878. The machine-readable data storage medium of claim 2876, wherein said method further comprises:
calculating said payment.

2879. The machine-readable data storage medium of claim 2871, wherein said method further comprises:
disbursing said payment.

2880. The machine-readable data storage medium of claim 2871, wherein said method further comprises:
calculating said payment.

2881. The machine-readable data storage medium of claim 2870, wherein said method further comprises:
selling said financial instrument.

2882. The machine-readable data storage medium of claim 2881, wherein said method further comprises:
monitoring for satisfaction of said contingency.

2883. The machine-readable data storage medium of claim 2881, wherein said method further comprises:
disbursing said payment.

2884. The machine-readable data storage medium of claim 2881, wherein said method further comprises:
calculating said payment.

2885. The machine-readable data storage medium of claim 2870, wherein said method further comprises:
monitoring for satisfaction of said contingency.

2886. The machine-readable data storage medium of claim 2885, wherein said method further comprises:
disbursing said payment.

2887. The machine-readable data storage medium of claim 2885, wherein said method further comprises:
calculating said payment.

2888. The machine-readable data storage medium of claim 2870, wherein said method further comprises:
disbursing said payment.

2889. The machine-readable data storage medium of claim 2870, wherein said method further comprises:
calculating said payment.

2890. The machine-readable data storage medium of any one of claims 2870, 2871, 2872, 2873, 2874, 2875, 2876, 2877, 2878, 2879, 2880, 2881, 2882, 2883, 2884, 2885, 2886, 2887, 2888 and 2889, said data storage medium being magnetic.

2891. The magnetic machine-readable data storage medium of claim 2890, said data storage medium being a floppy diskette.

2892. The magnetic machine-readable data storage medium of claim 2890, said data storage medium being a hard disk.

2893. The machine-readable data storage medium of any one of claims 2870, 2871, 2872, 2873, 2874, 2875, 2876, 2877, 2878, 2879, 2880, 2881, 2882, 2883, 2884, 2885, 2886, 2887, 2888 and 2889, said data storage medium being optically readable.

2894. The optically readable storage medium of claim 2893, said data storage medium being one of (a) a CD-ROM, (b) a CD-R, and (c) a CD-RW.

2895. The optically readable data storage medium of claim 2893, said data storage medium being a magneto-optical disk.

2896. A machine-readable data storage medium encoded with a set of machine-executable instructions for using a data processing system to perform a financial services method associated with a financial instrument, said method comprising:
identifying an underlying reference for said financial instrument, said underlying reference having a value;
attributing a number of said underlying references to said financial instrument;
defining a contingency having multiple triggers, a payment becoming due when multiple triggers drop below respective predetermined values.

2897. The machine-readable data storage medium of claim 2896, wherein said method further comprises:
establishing a value for said financial instrument.

2898. The machine-readable data storage medium of claim 2897, wherein said method further comprises:
selling said financial instrument.

2899. The machine-readable data storage medium of claim 2898, wherein said method further comprises:
monitoring for satisfaction of said contingency.

2900. The machine-readable data storage medium of claim 2898, wherein said method further comprises:
disbursing said payment.

2901. The machine-readable data storage medium of claim 2898, wherein said method further comprises:
calculating said payment.

2902. The machine-readable data storage medium of claim 2897, wherein said method further comprises:
monitoring for satisfaction of said contingency.

2903. The machine-readable data storage medium of claim 2902, wherein said method further comprises:
disbursing said payment.

2904. The machine-readable data storage medium of claim 2902, wherein said method further comprises:
calculating said payment.

2905. The machine-readable data storage medium of claim 2897, wherein said method further comprises:
disbursing said payment.

2906. The machine-readable data storage medium of claim 2897, wherein said method further comprises:
calculating said payment.

2907. The machine-readable data storage medium of claim 2896, wherein said method further comprises:
selling said financial instrument.

2908. The machine-readable data storage medium of claim 2907, wherein said method further comprises:
monitoring for satisfaction of said contingency.

2909. The machine-readable data storage medium of claim 2907, wherein said method further comprises:
disbursing said payment.

2910. The machine-readable data storage medium of claim 2907, wherein said method further comprises:
calculating said payment.

2911. The machine-readable data storage medium of claim 2896, wherein said method further comprises:
monitoring for satisfaction of said contingency.

2912. The machine-readable data storage medium of claim 2911, wherein said method further comprises:
disbursing said payment.

2913. The machine-readable data storage medium of claim 2911, wherein said method further comprises:
calculating said payment.

2914. The machine-readable data storage medium of claim 2896, wherein said method further comprises:
disbursing said payment.

2915. The machine-readable data storage medium of claim 2896, wherein said method further comprises:
calculating said payment.

2916. The machine-readable data storage medium of any one of claims 2896, 2897, 2898, 2899, 2900, 2901, 2902, 2903, 2904, 2905, 2906, 2907, 2908, 2909, 2910, 2911, 2912, 2913, 2914 and 2915, said data storage medium being magnetic.

2917. The magnetic machine-readable data storage medium of claim 2916, said data storage medium being a floppy diskette.

2918. The magnetic machine-readable data storage medium of claim 2916, said data storage medium being a hard disk.

2919. The machine-readable data storage medium of any one of claims 2896, 2897, 2898, 2899, 2900, 2901, 2902, 2903, 2904, 2905, 2906, 2907, 2908, 2909, 2910, 2911, 2912, 2913, 2914 and 2915, said data storage medium being optically readable.

2920. The optically readable storage medium of claim 2919, said data storage medium being one of (a) a CD-ROM, (b) a CD-R, and (c) a CD-RW.

2921. The optically readable data storage medium of claim 2919, said data storage medium being a magneto-optical disk.

2922. A machine-readable data storage medium encoded with a set of machine-executable instructions for using a data processing system to perform a financial services method associated with a financial instrument, said method comprising:
identifying an underlying reference for said financial instrument, said underlying reference having a value;
attributing a number of said underlying references to said financial instrument;
defining multiple contingencies each having at least one trigger, a payment becoming due when any said trigger of any of said contingencies drops below a predetermined value.

2923. The machine-readable data storage medium of claim 2922, wherein said method further comprises:
establishing a value for said financial instrument.

2924. The machine-readable data storage medium of claim 2923, wherein said method further comprises:
selling said financial instrument.

2925. The machine-readable data storage medium of claim 2924, wherein said method further comprises:
monitoring for satisfaction of said contingency.

2926. The machine-readable data storage medium of claim 2924, wherein said method further comprises:
disbursing said payment.

2927. The machine-readable data storage medium of claim 2924, wherein said method further comprises:
calculating said payment.

2928. The machine-readable data storage medium of claim 2923, wherein said method further comprises:
monitoring for satisfaction of said contingency.

2929. The machine-readable data storage medium of claim 2928, wherein said method further comprises:
disbursing said payment.

2930. The machine-readable data storage medium of claim 2928, wherein said method further comprises:
calculating said payment.

2931. The machine-readable data storage medium of claim 2923, wherein said method further comprises:
disbursing said payment.

2932. The machine-readable data storage medium of claim 2923, wherein said method further comprises:
calculating said payment.

2933. The machine-readable data storage medium of claim 2922, wherein said method further comprises:
selling said financial instrument.

2934. The machine-readable data storage medium of claim 2933, wherein said method further comprises:
monitoring for satisfaction of said contingency.

2935. The machine-readable data storage medium of claim 2933, wherein said method further comprises:
disbursing said payment.

2936. The machine-readable data storage medium of claim 2933, wherein said method further comprises:
calculating said payment.

2937. The machine-readable data storage medium of claim 2922, wherein said method further comprises:
monitoring for satisfaction of said contingency.

2938. The machine-readable data storage medium of claim 2937, wherein said method further comprises:
disbursing said payment.

2939. The machine-readable data storage medium of claim 2937, wherein said method further comprises:
calculating said payment.

2940. The machine-readable data storage medium of claim 2922, wherein said method further comprises:
disbursing said payment.

2941. The machine-readable data storage medium of claim 2922, wherein said method further comprises:
calculating said payment.

2942. The machine-readable data storage medium of any one of claims 2922, 2923, 2924, 2925, 2926, 2927, 2928, 2929, 2930, 2931, 2932, 2933, 2934, 2935, 2936, 2937, 2938, 2939, 2949 and 2941, said data storage medium being magnetic.

2943. The magnetic machine-readable data storage medium of claim 2942, said data storage medium being a floppy diskette.

2944. The magnetic machine-readable data storage medium of claim 2942, said data storage medium being a hard disk.

2945. The machine-readable data storage medium of any one of claims 2922, 2923, 2924, 2925, 2926, 2927, 2928, 2929, 2930, 2931, 2932, 2933, 2934, 2935, 2936, 2937, 2938, 2939, 2940 and 2941, said data storage medium being optically readable.

2946. The optically readable storage medium of claim 2945, said data storage medium being one of (a) a CD-ROM, (b) a CD-R, and (c) a CD-RW.

2947. The optically readable data storage medium of claim 2945, said data storage medium being a magneto-optical disk.

2948. A machine-readable data storage medium encoded with a set of machine-executable instructions for using a data processing system to perform a financial services method associated with a financial instrument, said method comprising:
identifying an underlying reference for said financial instrument, said underlying reference having a value;
attributing a number of said underlying references to said financial instrument;
defining multiple contingencies each with multiple triggers, a payment becoming due when one of said multiple triggers of any of said contingencies drops below a predetermined value.

2949. The machine-readable data storage medium of claim 2948, wherein said method further comprises:
establishing a value for said financial instrument.

2950. The machine-readable data storage medium of claim 2949, wherein said method further comprises:
selling said financial instrument.

2951. The machine-readable data storage medium of claim 2950, wherein said method further comprises:
monitoring for satisfaction of said contingency.

2952. The machine-readable data storage medium of claim 2950, wherein said method further comprises:
disbursing said payment.

2953. The machine-readable data storage medium of claim 2950, wherein said method further comprises:
calculating said payment.

2954. The machine-readable data storage medium of claim 2949, wherein said method further comprises:
monitoring for satisfaction of said contingency.

2955. The machine-readable data storage medium of claim 2954, wherein said method further comprises:
disbursing said payment.

2956. The machine-readable data storage medium of claim 2954, wherein said method further comprises:
calculating said payment.

2957. The machine-readable data storage medium of claim 2949, wherein said method further comprises:
disbursing said payment.

2958. The machine-readable data storage medium of claim 2949, wherein said method further comprises:
calculating said payment.

2959. The machine-readable data storage medium of claim 2948, wherein said method further comprises:
selling said financial instrument.

2960. The machine-readable data storage medium of claim 2959, wherein said method further comprises:
monitoring for satisfaction of said contingency.

2961. The machine-readable data storage medium of claim 2959, wherein said method further comprises:
disbursing said payment.

2962. The machine-readable data storage medium of claim 2959, wherein said method further comprises:
calculating said payment.

2963. The machine-readable data storage medium of claim 2948, wherein said method further comprises:
monitoring for satisfaction of said contingency.

2964. The machine-readable data storage medium of claim 2963, wherein said method further comprises:
disbursing said payment.

2965. The machine-readable data storage medium of claim 2963, wherein said method further comprises:
calculating said payment.

2966. The machine-readable data storage medium of claim 2948, wherein said method further comprises:
disbursing said payment.

2967. The machine-readable data storage medium of claim 2948, wherein said method further comprises:
calculating said payment.

2968. The machine-readable data storage medium of any one of claims 2948, 2949, 2950, 2951, 2952, 2953, 2954, 2955, 2956, 2957, 2958, 2959, 2960, 2961, 2962, 2963, 2964, 2965, 2966 and 2967, said data storage medium being magnetic.

2969. The magnetic machine-readable data storage medium of claim 2968, said data storage medium being a floppy diskette.

2970. The magnetic machine-readable data storage medium of claim 2968, said data storage medium being a hard disk.

2971. The machine-readable data storage medium of any one of claims 2948, 2949, 2950, 2951, 2952, 2953, 2954, 2955, 2956, 2957, 2958, 2959, 2960, 2961, 2962, 2963, 2964, 2965, 2966 and 2967, said data storage medium being optically readable.

2972. The optically readable storage medium of claim 2971, said data storage medium being one of (a) a CD-ROM, (b) a CD-R, and (c) a CD-RW.

2973. The optically readable data storage medium of claim 2971, said data storage medium being a magneto-optical disk.

2974. A machine-readable data storage medium encoded with a set of machine-executable instructions for using a data processing system to perform a financial services method associated with a financial instrument, said method comprising:
identifying an underlying reference for said financial instrument, said underlying reference having a value;
attributing a number of said underlying references to said financial instrument;
defining multiple contingencies having multiple triggers, a payment becoming due when at least two of said multiple triggers drop below respective predetermined values, at least one of said at least two triggers being a trigger of a different contingency from any other of said at least two triggers.

2975. The machine-readable data storage medium of claim 2974, wherein said method further comprises:
establishing a value for said financial instrument.

2976. The machine-readable data storage medium of claim 2975, wherein said method further comprises:
selling said financial instrument.

2977. The machine-readable data storage medium of claim 2976, wherein said method further comprises:
monitoring for satisfaction of said contingency.

2978. The machine-readable data storage medium of claim 2976, wherein said method further comprises:
disbursing said payment.

2979. The machine-readable data storage medium of claim 2976, wherein said method further comprises:
calculating said payment.

2980. The machine-readable data storage medium of claim 2975, wherein said method further comprises:
monitoring for satisfaction of said contingency.

2981. The machine-readable data storage medium of claim 2980, wherein said method further comprises:
disbursing said payment.

2982. The machine-readable data storage medium of claim 2980, wherein said method further comprises:
calculating said payment.

2983. The machine-readable data storage medium of claim 2975, wherein said method further comprises:
disbursing said payment.

2984. The machine-readable data storage medium of claim 2975, wherein said method further comprises:
calculating said payment.

2985. The machine-readable data storage medium of claim 2974, wherein said method further comprises:
selling said financial instrument.

2986. The machine-readable data storage medium of claim 2985, wherein said method further comprises:
monitoring for satisfaction of said contingency.

2987. The machine-readable data storage medium of claim 2985, wherein said method further comprises:
disbursing said payment.

2988. The machine-readable data storage medium of claim 2985, wherein said method further comprises:
calculating said payment.

2989. The machine-readable data storage medium of claim 2974, wherein said method further comprises:
monitoring for satisfaction of said contingency.

2990. The machine-readable data storage medium of claim 2989, wherein said method further comprises:
disbursing said payment.

2991. The machine-readable data storage medium of claim 2989, wherein said method further comprises:
calculating said payment.

2992. The machine-readable data storage medium of claim 2974, wherein said method further comprises:
disbursing said payment.

2993. The machine-readable data storage medium of claim 2974, wherein said method further comprises:
calculating said payment.

2994. The machine-readable data storage medium of any one of claims 2974, 2975, 2976, 2977, 2978, 2979, 2980, 2981, 2982, 2983, 2984, 2985, 2986, 2987, 2988, 2989, 2990, 2991, 2992 and 2993, said data storage medium being magnetic.

2995. The magnetic machine-readable data storage medium of claim 2994, said data storage medium being a floppy diskette.

2996. The magnetic machine-readable data storage medium of claim 2994, said data storage medium being a hard disk.

2997. The machine-readable data storage medium of any one of claims 2974, 2975, 2976, 2977, 2978, 2979, 2980, 2981, 2982, 2983, 2984, 2985, 2986, 2987, 2988, 2989, 2990, 2991, 2992 and 2993, said data storage medium being optically readable.

2998. The optically readable storage medium of claim 2997, said data storage medium being one of (a) a CD-ROM, (b) a CD-R, and (c) a CD-RW.

2999. The optically readable data storage medium of claim 2997, said data storage medium being a magneto-optical disk.

3000. A machine-readable data storage medium encoded with a set of machine-executable instructions for using a data processing system to perform a financial services method associated with a financial instrument, said method comprising:
identifying an underlying reference for said financial instrument, said underlying reference having a value;
attributing a number of said underlying references to said financial instrument;
defining a contingency, said contingency having a trigger based upon at least one of:
a. trading value of said financial instrument,
b. trading yield of said financial instrument,
c. dividend yield of said underlying reference,
d. trading yield of a liability of said issuer of said financial instrument,
e. trading value of a liability of said issuer of said financial instrument,
f. trading value of a class of capital stock other than said underlying reference,
g. trading dividend yield of a class of capital stock issued by an issuer other than said issuer of said financial instrument,
h. trading value of a class of capital stock of said issuer of said financial instrument other than common stock,
i. trading yield of a class of capital stock of said issuer of said financial instrument,
j. trading value of a security issued by an issuer other than said issuer of said financial instrument,
k. trading yield of a security,
l. an index; wherein:
a payment becomes due on occurrence of said contingency.

3001. The machine-readable data storage medium of claim 3000, wherein said method further comprises:
establishing a value for said financial instrument.

3002. The machine-readable data storage medium of claim 3001, wherein said method further comprises:
selling said financial instrument.

3003. The machine-readable data storage medium of claim 3002, wherein said method further comprises:
monitoring for satisfaction of said contingency.

3004. The machine-readable data storage medium of claim 3002, wherein said method further comprises:
disbursing said payment.

3005. The machine-readable data storage medium of claim 3002, wherein said method further comprises:
calculating said payment.

3006. The machine-readable data storage medium of claim 3001, wherein said method further comprises:
monitoring for satisfaction of said contingency.

3007. The machine-readable data storage medium of claim 3006, wherein said method further comprises:
disbursing said payment.

3008. The machine-readable data storage medium of claim 3006, wherein said method further comprises:
calculating said payment.

3009. The machine-readable data storage medium of claim 3001, wherein said method further comprises:
disbursing said payment.

3010. The machine-readable data storage medium of claim 3001, wherein said method further comprises:
calculating said payment.

3011. The machine-readable data storage medium of claim 3000, wherein said method further comprises:
selling said financial instrument.

3012. The machine-readable data storage medium of claim 3011, wherein said method further comprises:
monitoring for satisfaction of said contingency.

3013. The machine-readable data storage medium of claim 3011, wherein said method further comprises:
disbursing said payment.

3014. The machine-readable data storage medium of claim 3011, wherein said method further comprises:
calculating said payment.

3015. The machine-readable data storage medium of claim 3000, wherein said method further comprises:
monitoring for satisfaction of said contingency.

3016. The machine-readable data storage medium of claim 3015, wherein said method further comprises:
disbursing said payment.

3017. The machine-readable data storage medium of claim 3015, wherein said method further comprises:
calculating said payment.

3018. The machine-readable data storage medium of claim 3000, wherein said method further comprises:
disbursing said payment.

3019. The machine-readable data storage medium of claim 3000, wherein said method further comprises:
calculating said payment.

3020. The machine-readable data storage medium of any one of claims 3000, 3001, 3002, 3003, 3004, 3005, 3006, 3007, 3008, 3009, 3010, 3011, 3012, 3013, 3014, 3015, 3016, 3017, 3018 and 3019, said data storage medium being magnetic.

3021. The magnetic machine-readable data storage medium of claim 3020, said data storage medium being a floppy diskette.

3022. The magnetic machine-readable data storage medium of claim 3020, said data storage medium being a hard disk.

3023. The machine-readable data storage medium of any one of claims 3000, 3001, 3002, 3003, 3004, 3005, 3006, 3007, 3008, 3009, 3010, 3011, 3012, 3013, 3014, 3015, 3016, 3017, 3018 and 3019, said data storage medium being optically readable.

3024. The optically readable storage medium of claim 3023, said data storage medium being one of (a) a CD-ROM, (b) a CD-R, and (c) a CD-RW.

3025. The optically readable data storage medium of claim 3023, said data storage medium being a magneto-optical disk.

3026. A machine-readable data storage medium encoded with a set of machine-executable instructions for using a data processing system to perform a financial services method associated with a financial instrument, said method comprising:
identifying an underlying reference for said financial instrument, said underlying reference having a value;
attributing a number of said underlying references to said financial instrument;
defining a contingency, a payment becoming due on occurrence of said contingency;
calculating said payment based upon at least one of:
a. predetermined fixed amount,
b. trading value of said financial instrument,
c. trading yield of said financial instrument,
d. trading yield of a liability of said issuer of said financial instrument,
e. trading value of a liability of said issuer of said financial instrument,
f. trading value of a class of capital stock issued by an issuer other than said issuer of said financial instrument,
g. trading dividend yield of a class of capital stock other than said underlying reference,
h. trading value of a class of capital stock of said issuer of said financial instrument,
i. trading yield of a class of capital stock of said issuer of said financial instrument other than common stock,
j. trading value of a security,
k. trading yield of a security issued by an issuer other than said issuer of said financial instrument,
l. an index.

3027. The machine-readable data storage medium of claim 3026, wherein said method further comprises:
establishing a value for said financial instrument.

3028. The machine-readable data storage medium of claim 3027, wherein said method further comprises:
selling said financial instrument.

3029. The machine-readable data storage medium of claim 3028, wherein said method further comprises:
monitoring for satisfaction of said contingency.

3030. The machine-readable data storage medium of claim 3028, wherein said method further comprises:
disbursing said payment.

3031. The machine-readable data storage medium of claim 3027, wherein said method further comprises:
monitoring for satisfaction of said contingency.

3032. The machine-readable data storage medium of claim 3031, wherein said method further comprises:
disbursing said payment.

3033. The machine-readable data storage medium of claim 3027, wherein said method further comprises:
disbursing said payment.

3034. The machine-readable data storage medium of claim 3026, wherein said method further comprises:
selling said financial instrument.

3035. The machine-readable data storage medium of claim 3034, wherein said method further comprises:
monitoring for satisfaction of said contingency.

3036. The machine-readable data storage medium of claim 3034, wherein said method further comprises:
disbursing said payment.

3037. The machine-readable data storage medium of claim 3026, wherein said method further comprises:
monitoring for satisfaction of said contingency.

3038. The machine-readable data storage medium of claim 3037, wherein said method further comprises:
disbursing said payment.

3039. The machine-readable data storage medium of claim 3026, wherein said method further comprises:
disbursing said payment.

3040. The machine-readable data storage medium of any one of claims 3026, 3027, 3028, 3029, 3030, 3031, 3032, 3033, 3034, 3035, 3036, 3037, 3038 and 3039, said data storage medium being magnetic.

3041. The magnetic machine-readable data storage medium of claim 3040, said data storage medium being a floppy diskette.

3042. The magnetic machine-readable data storage medium of claim 3040, said data storage medium being a hard disk.

3043. The machine-readable data storage medium of any one of claims 3026, 3027, 3028, 3029, 3030, 3031, 3032, 3033, 3034, 3035, 3036, 3037, 3038 and 3039, said data storage medium being optically readable.

3044. The optically readable storage medium of claim 3043, said data storage medium being one of (a) a CD-ROM, (b) a CD-R, and (c) a CD-RW.

3045. The optically readable data storage medium of claim 3043, said data storage medium being a magneto-optical disk.

3046. A machine-readable data storage medium encoded with a set of machine-executable instructions for using a data processing system to perform a financial services method associated with a financial instrument, said method comprising:
identifying an underlying reference for said financial instrument, said underlying reference having a value;
attributing a number of said underlying references to said financial instrument;
defining a contingency, a payment becoming due on occurrence of said contingency;
calculating said payment so that said payment equals at most an imposed maximum value.

3047. The machine-readable data storage medium of claim 3046, wherein said method further comprises:
establishing a value for said financial instrument.

3048. The machine-readable data storage medium of claim 3047, wherein said method further comprises:
selling said financial instrument.

3049. The machine-readable data storage medium of claim 3048, wherein said method further comprises:
monitoring for satisfaction of said contingency.

3050. The machine-readable data storage medium of claim 3048, wherein said method further comprises:
disbursing said payment.

3051. The machine-readable data storage medium of claim 3047, wherein said method further comprises:
monitoring for satisfaction of said contingency.

3052. The machine-readable data storage medium of claim 3051, wherein said method further comprises:
disbursing said payment.

3053. The machine-readable data storage medium of claim 3047, wherein said method further comprises:
disbursing said payment.

3054. The machine-readable data storage medium of claim 3046, wherein said method further comprises:
selling said financial instrument.

3055. The machine-readable data storage medium of claim 3054, wherein said method further comprises:
monitoring for satisfaction of said contingency.

3056. The machine-readable data storage medium of claim 3054, wherein said method further comprises:
disbursing said payment.

3057. The machine-readable data storage medium of claim 3046, wherein said method further comprises:
monitoring for satisfaction of said contingency.

3058. The machine-readable data storage medium of claim 3057, wherein said method further comprises:
disbursing said payment.

3059. The machine-readable data storage medium of claim 3046, wherein said method further comprises:
disbursing said payment.

3060. The machine-readable data storage medium of any one of claims 3046, 3047, 3048, 3049, 3050, 3051, 3052, 3053, 3054, 3055, 3056, 3057, 3058 and 3059, said data storage medium being magnetic.

3061. The magnetic machine-readable data storage medium of claim 3060, said data storage medium being a floppy diskette.

3062. The magnetic machine-readable data storage medium of claim 3060, said data storage medium being a hard disk.

3063. The machine-readable data storage medium of any one of claims 3046, 3047, 3048, 3049, 3050, 3051, 3052, 3053, 3054, 3055, 3056, 3057, 3058 and 3059, said data storage medium being optically readable.

3064. The optically readable storage medium of claim 3063, said data storage medium being one of (a) a CD-ROM, (b) a CD-R, and (c) a CD-RW.

3065. The optically readable data storage medium of claim 3063, said data storage medium being a magneto-optical disk.

3066. A machine-readable data storage medium encoded with a set of machine-executable instructions for using a data processing system to perform a financial services method associated with a financial instrument, said method comprising:
identifying an underlying reference for said financial instrument, said underlying reference having a value;
attributing a number of said underlying references to said financial instrument;
defining a contingency, a payment becoming due on occurrence of said contingency;
calculating said payment so that said payment exceeds an imposed minimum value.

3067. The machine-readable data storage medium of claim 3066, wherein said method further comprises:
establishing a value for said financial instrument.

3068. The machine-readable data storage medium of claim 3067, wherein said method further comprises:
selling said financial instrument.

3069. The machine-readable data storage medium of claim 3068, wherein said method further comprises:
monitoring for satisfaction of said contingency.

3070. The machine-readable data storage medium of claim 3068, wherein said method further comprises:
disbursing said payment.

3071. The machine-readable data storage medium of claim 3067, wherein said method further comprises:
monitoring for satisfaction of said contingency.

3072. The machine-readable data storage medium of claim 3071, wherein said method further comprises:
disbursing said payment.

3073. The machine-readable data storage medium of claim 3067, wherein said method further comprises:
disbursing said payment.

3074. The machine-readable data storage medium of claim 3066, wherein said method further comprises:
selling said financial instrument.

3075. The machine-readable data storage medium of claim 3074, wherein said method further comprises:
monitoring for satisfaction of said contingency.

3076. The machine-readable data storage medium of claim 3074, wherein said method further comprises:
disbursing said payment.

3077. The machine-readable data storage medium of claim 3066, wherein said method further comprises:
monitoring for satisfaction of said contingency.

3078. The machine-readable data storage medium of claim 3077, wherein said method further comprises:
disbursing said payment.

3079. The machine-readable data storage medium of claim 3066, wherein said method further comprises:
disbursing said payment.

3080. The machine-readable data storage medium of any one of claims 3066,3067, 3068, 3069, 3070, 3071, 3072, 3073, 3074, 3075, 3076, 3077, 3078 and 3079, said data storage medium being magnetic.

3081. The magnetic machine-readable data storage medium of claim 3080, said data storage medium being a floppy diskette.

3082. The magnetic machine-readable data storage medium of claim 3080, said data storage medium being a hard disk.

3083. The machine-readable data storage medium of any one of claims 3066, 3067, 3068, 3069, 3070, 3071, 3072, 3073, 3074, 3075, 3076, 3077, 3078 and 3079, said data storage medium being optically readable.

3084. The optically readable storage medium of claim 3083, said data storage medium being one of (a) a CD-ROM, (b) a CD-R, and (c) a CD-RW.

3085. The optically readable data storage medium of claim 3083, said data storage medium being a magneto-optical disk.

3086. A machine-readable data storage medium encoded with a set of machine-executable instructions for using a data processing system to perform a financial services method associated with a financial instrument, said method comprising:
identifying an underlying reference for said financial instrument, said underlying reference having a value;
attributing a number of said underlying references to said financial instrument;
defining multiple contingencies, a payment becoming due on occurrence of at least one of:
a) satisfaction of one of said multiple contingencies,
b) satisfaction of more than one of said multiple contingencies, and
c) satisfaction of all of said multiple contingencies.

3087. The machine-readable data storage medium of claim 3086, wherein said method further comprises:
establishing a value for said financial instrument.

3088. The machine-readable data storage medium of claim 3087, wherein said method further comprises:
selling said financial instrument.

3089. The machine-readable data storage medium of claim 3088, wherein said method further comprises:
monitoring for said satisfaction of said multiple contingencies.

3090. The machine-readable data storage medium of claim 3088, wherein said method further comprises:
disbursing said payment.

3091. The machine-readable data storage medium of claim 3088, wherein said method further comprises:
calculating said payment.

3092. The machine-readable data storage medium of claim 3087, wherein said method further comprises:
monitoring for said satisfaction of said multiple contingencies.

3093. The machine-readable data storage medium of claim 3092, wherein said method further comprises:
disbursing said payment.

3094. The machine-readable data storage medium of claim 3092, wherein said method further comprises:
calculating said payment.

3095. The machine-readable data storage medium of claim 3087, wherein said method further comprises:
disbursing said payment.

3096. The machine-readable data storage medium of claim 3087, wherein said method further comprises:
calculating said payment.

3097. The machine-readable data storage medium of claim 3086, wherein said method further comprises:
selling said financial instrument.

3098. The machine-readable data storage medium of claim 3097, wherein said method further comprises:
monitoring for said satisfaction of said multiple contingencies.

3099. The machine-readable data storage medium of claim 3097, wherein said method further comprises:
disbursing said payment.

3100. The machine-readable data storage medium of claim 3097, wherein said method further comprises:
calculating said payment.

3101. The machine-readable data storage medium of claim 3086, wherein said method further comprises:
monitoring for said satisfaction of said multiple contingencies.

3102. The machine-readable data storage medium of claim 3101, wherein said method further comprises:
disbursing said payment.

3103. The machine-readable data storage medium of claim 3101, wherein said method further comprises:
calculating said payment.

3104. The machine-readable data storage medium of claim 3086, wherein said method further comprises:
disbursing said payment.

3105. The machine-readable data storage medium of claim 3086, wherein said method further comprises:
calculating said payment.

3106. The machine-readable data storage medium of any one of claims 3086, 3087, 3088, 3089, 3090, 3091, 3092, 3093, 3094, 3095, 3096, 3097, 3098, 3099, 3100, 3101, 3102, 3103, 3104 and 3105, said data storage medium being magnetic.

3107. The magnetic machine-readable data storage medium of claim 3106, said data storage medium being a floppy diskette.

3108. The magnetic machine-readable data storage medium of claim 3106, said data storage medium being a hard disk.

3109. The machine-readable data storage medium of any one of claims 3086, 3087, 3088, 3089, 3090, 3091, 3092, 3093, 3094, 3095, 3096, 3097, 3098, 3099, 3100, 3101, 3102, 3103, 3104 and 3105, said data storage medium being optically readable.

3110. The optically readable storage medium of claim 3109, said data storage medium being one of (a) a CD-ROM, (b) a CD-R, and (c) a CD-RW.

3111. The optically readable data storage medium of claim 3109, said data storage medium being a magneto-optical disk.
